(19) United States
(12) Patent Application Publication
(10) Pub. No.: US 2016/0269786 A1
(43) Pub. Date: Sep. 15, 2016

(54) A RECEIVER AND A METHOD FOR PROCESSING A BROADCAST SIGNAL INCLUDING A BROADCAST CONTENT AND AN APPLICATION RELATED TO THE BROADCAST CONTENT

(71) Applicant: LG ELECTRONICS INC., Yeongdeungpo-gu, Seoul (KR)

(72) Inventors: Jinwon LEE, Seoul (KR); Kyoungsoo MOON, Seoul (KR); Woosuk KO, Seoul (KR); Seungryul YANG, Seoul (KR); Sejin OH, Seoul (KR); Seungjoo AN, Seoul (KR); Sungryong HONG, Seoul (KR)

(21) Appl. No.: 15/036,491

(22) PCT Filed: Dec. 9, 2014
(86) PCT No.: PCT/KR2014/012051

§ 371 Date: May 13, 2016

Related U.S. Application Data
(60) Provisional application No. 61/913,877, filed on Dec. 9, 2013.
(60) Provisional application No. 61/940,498, filed on Feb. 17, 2014.

(51) Int. Cl. H04N 21/478

(52) U.S. Cl. CPC H04N 21/478

(57) ABSTRACT

The receiver comprising a receiving device for receiving a data structure that encapsulates a questionnaire which represent individual questions that can be answered by the receiver, a PDI engine for acquiring the questionnaire from the data structure, receiving a setting option of a user for the application identified by the application identifier, and storing the setting option in relation to the data structure, an application signaling parser for parsing a trigger which is a signaling element to establish timing of playout of the application, and a processor for parsing a second application identifier from the trigger, acquiring the stored setting option in relation to the data structure of which a value of the first application identifier matches to a value of the second application identifier, and determining whether process the application to be launched or not based on the setting option is disclosed

### TECHNICAL FIELD

The present invention relates to a method and apparatus for processing an application in a digital broadcasting system. More particularly, the present invention relates to a transmitting/receiving processing method and apparatus of a digital broadcast signal that are capable of setting whether or not an application will be used according to a user of a broadcast receiver in a digital broadcasting system.

### BACKGROUND ART

Since a digital broadcasting system was introduced, a digital broadcast has been changed in a service direction thereof from a conventional broadcasting station centric broadcast to a viewer centric broadcast.

In Advanced Television Systems Committee (ATSC) 2.0, which has been being standardized in recent years, a plan for providing a user with additional data related to a broadcast program/content is being studied. Meanwhile, additional data related to a broadcast program/content may be provided in the form of an application and/or declarative object (DO).

In a case in which an application or DO is unilaterally provided by a broadcasting station and a user of a receiver views a broadcast program/content, however, the application or DO may be constantly spent.

In addition, personal information of the user may be unintentionally transmitted to the broadcasting station or a content provider during forcible viewing of the application or DO.

### DISCLOSURE

### Technical Problem

An object of the present invention devised to solve the problem lies on a receiver controlling the use of an application in a conventional environment of a digital broadcasting system.

Another object of the present invention devised to solve the problem lies on a receiver controlling the use of a specific application according to tendency of a user in a conventional environment of a digital broadcasting system.

### Technical Solution

To achieve the object and other advantages and in accordance with the purpose of the invention, as embodied and broadly described herein, the present invention provides a receiver for processing a broadcast signal including a broadcast content and an application related to the broadcast content. The receiver comprises a receiving device for receiving a data structure that encapsulates a questionnaire which represent individual questions that can be answered by the receiver, wherein the data structure includes a first application identifier which uniquely identifies the application, a PDI engine for acquiring the questionnaire from the data structure, receiving a setting option of a user for the application identified by the application identifier, and storing the setting option in relation to the data structure, an application signaling parser for parsing a trigger which is a signaling element to establish timing of playout of the application, and a processor for parsing a second application identifier from the trigger, acquiring the stored setting option in relation to the data structure of which a value of the first application identifier matches to a value of the second application identifier, and determining whether process the application to be launched or not based on the setting option.

Preferably, the trigger includes location information specifying a location of a TDO (Triggered Declarative Object) parameter element containing metadata about applications and broadcast events targeted to the applications.

Preferably, the receiver further comprises an application signaling parser for parsing the TDO parameter element from the location identified by the location information, wherein the TDO parameter element includes top margin information specifying a top margin of a notification for the application, right margin information specifying a right margin of the notification, and lasting information specifying a lasting time for the notification.

Preferably, the processor further display a user interface for receiving the setting option from the user based on the top margin information, right margin information and lasting information.

Preferably, the processor further process the user interface to show a question for first selection on whether the application to be activated or not.

Preferably, the processor further process the user interface to show a question for second selection on whether the first selection applies to a current broadcast content, all broadcast contents in a current channel, or all broadcast contents in all channel.

Preferably, the TDO parameter element includes content advisory information specifying a rating for the application.

The present invention also provides a method for processing a broadcast signal including a broadcast content and an application related to the broadcast content. the method comprises receiving a data structure that encapsulates a questionnaire which represent individual questions that can be answered by the receiver, wherein the data structure includes a first application identifier which uniquely identifies the application, acquiring the questionnaire from the data structure, receiving a setting option of a user for the application identified by the application identifier, and storing the setting option in relation to the data structure, parsing a trigger which is a signaling element to establish timing of playout of the application and parsing a second application identifier from the trigger, acquiring the stored setting option in relation to the data structure of which a value of the first application identifier matches to a value of the second application identifier, and determining whether process the application to be launched or not based on the setting option.

Preferably, the trigger includes location information specifying a location of a TDO (Triggered Declarative Object) parameter element containing metadata about applications and broadcast events targeted to the applications.

Preferably, the method further comprises parsing the TDO parameter element from the location identified by the location information, wherein the TDO parameter element includes top margin information specifying a top margin of a notification for the application, right margin information specifying a right margin of the notification, and lasting information specifying a lasting time for the notification.

Preferably, the method further comprises displaying a user interface for receiving the setting option from the user based on the top margin information, right margin information and lasting information.

Preferably, the method further comprises processing the user interface to show a question for first selection on whether the application to be activated or not.

Preferably, the method further comprises processing the user interface to show a question for second selection on whether the first selection applies to a current broadcast content, all broadcast contents in a current channel, or all broadcast contents in all channel.

Preferably, the TDO parameter element includes content advisory information specifying a rating for the application.

### Advantageous Effects

According to the present invention, it is possible for a receiver or a user to control the use of an application or declarative object (DO) related to a broadcast program/content in a conventional broadcasting system environment.

According to the present invention, it is possible for a receiver to control the use of an application or DO according to a user in a conventional broadcasting system environment, thereby improving user convenience.

According to the present invention, it is possible to prevent unnecessary information of a user from being collected due to an application or DO in a conventional broadcasting system environment.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structure of an apparatus for transmitting broadcast signals for future broadcast services according to an embodiment of the present invention.

FIG. 2 illustrates an input formatting block according to one embodiment of the present invention.

FIG. 3 illustrates an input formatting block according to another embodiment of the present invention.

FIG. 4 illustrates an input formatting block according to another embodiment of the present invention.

FIG. 5 illustrates a BICM block according to an embodiment of the present invention.

FIG. 6 illustrates a BICM block according to another embodiment of the present invention.

FIG. 7 illustrates a frame building block according to one embodiment of the present invention.

FIG. 8 illustrates an OFMD generation block according to an embodiment of the present invention.

FIG. 9 illustrates a structure of an apparatus for receiving broadcast signals for future broadcast services according to an embodiment of the present invention.

FIG. 10 illustrates a frame structure according to an embodiment of the present invention.

FIG. 11 illustrates a signaling hierarchy structure of the frame according to an embodiment of the present invention.

FIG. 12 illustrates preamble signaling data according to an embodiment of the present invention.

FIG. 13 illustrates PLS1 data according to an embodiment of the present invention.

FIG. 14 illustrates PLS2 data according to an embodiment of the present invention.

FIG. 15 illustrates PLS2 data according to another embodiment of the present invention.

FIG. 16 illustrates a logical structure of a frame according to an embodiment of the present invention.

FIG. 17 illustrates PLS mapping according to an embodiment of the present invention.

FIG. 18 illustrates EAC mapping according to an embodiment of the present invention.

FIG. 19 illustrates FIC mapping according to an embodiment of the present invention.

FIG. 20 illustrates a type of DP according to an embodiment of the present invention.

FIG. 21 illustrates DP mapping according to an embodiment of the present invention.

FIG. 22 illustrates an FEC structure according to an embodiment of the present invention.

FIG. 23 illustrates a bit interleaving according to an embodiment of the present invention.

FIG. 24 illustrates a cell-word demultiplexing according to an embodiment of the present invention.

FIG. 25 illustrates a time interleaving according to an embodiment of the present invention.

FIG. 26 illustrates the basic operation of a twisted row-column block interleaver according to an embodiment of the present invention.

FIG. 27 illustrates an operation of a twisted row-column block interleaver according to another embodiment of the present invention.

FIG. 28 illustrates a diagonal-wise reading pattern of a twisted row-column block interleaver according to an embodiment of the present invention.

FIG. 29 illustrates interlaved XFECBLOCKs from each interleaving array according to an embodiment of the present invention.

FIG. 30 is a view showing a protocol stack for a next generation broadcasting system according to an embodiment of the present invention.

FIG. 31 is a view showing a broadcast receiver according to an embodiment of the present invention.

FIG. 32 is a view showing a transport frame according to an embodiment of the present invention.

FIG. 33 is a view showing a transport frame according to another embodiment of the present invention.

FIG. 34 is a view showing a transport packet (TP) and meaning of a network_protocol field of a broadcasting system according to an embodiment of the present invention.

FIG. 35 is a view showing a broadcasting server and a receiver according to an embodiment of the present invention.

FIG. 36 shows, as an embodiment of the present invention, the different service types, along with the types of components contained in each type of service, and the adjunct service relationships among the service types.

FIG. 37 shows, as an embodiment of the present invention, the containment relationship between the NRT Content Item class and the NRT File class.

FIG. 38 is a table showing an attribute based on a service type and a component type according to an embodiment of the present invention.

FIG. 39 shows, as an embodiment of the present inventions, another table describing the attributions of the service type and component type.

FIG. 40 shows, as an embodiment of the present inventions, another table describing the attributions of the service type and component type.

FIG. 41 shows, as an embodiment of the present inventions, another table describing the attributions of the service type and component type.

FIG. 42 shows, as an embodiment of the present inventions, definitions for ContentItem and OnDemand Content.

FIG. 43 shows, as an embodiment of the present inventions, an example of Complex Audio Component.

FIG. 44 is a view showing attribute information related to an application according to an embodiment of the present invention.

FIG. 45 is a view showing a procedure for broadcast personalization according to an embodiment of the present invention.

FIG. 46 is a view showing a signaling structure for user setting per application according to an embodiment of the present invention.

FIG. 47 is a view showing a signaling structure for user setting per application according to another embodiment of the present invention.

FIG. 48 is a view showing a procedure for opt-in/out setting of an application using a PDI table according to an embodiment of the present invention.

FIG. 49 is a view showing a user interface (UI) for opt-in/out setting of an application according to an embodiment of the present invention.

FIG. 50 is a view showing a processing procedure in a case in which a receiver (TV) receives a trigger of an application having the same application ID from a service provider after completing opt-in/out setting of an application using a PDI table according to an embodiment of the present invention.

FIG. 51 is a view showing an UI for setting an option of an application per user and a question thereto according to an embodiment of the present invention.

FIG. 52 is a diagram showing an automatic content recognition (ACR) based enhanced television (ETV) service system.

FIG. 53 is a diagram showing the flow of digital watermarking technology according to an embodiment of the present invention.

FIG. 54 is a diagram showing an ACR query result format according to an embodiment of the present invention.

FIG. 55 is a diagram showing the syntax of a content identifier (ID) according to an embodiment of the present invention.

FIG. 56 is a diagram showing the structure of a receiver according to the embodiment of the present invention.

FIG. 57 is a diagram showing the structure of a receiver according to another embodiment of the present invention.

FIG. 58 is a diagram illustrating a digital broadcast system according to an embodiment of the present invention.

FIG. 59 is a diagram illustrating a digital broadcast system according to an embodiment of the present invention.

FIG. 60 is a flowchart of a digital broadcast system according to another embodiment of the present invention.

FIG. 61 is a flowchart of a digital broadcast system according to another embodiment of the present invention.

FIG. 62 is a diagram illustrating a PDI Table according to an embodiment of the present invention.

FIG. 63 is a diagram illustrating a PDI Table according to another embodiment of the present invention.

FIG. 64 is a diagram illustrating a PDI table according to another embodiment of the present invention.

FIG. 65 is a diagram illustrating a PDI table according to another embodiment of the present invention.

FIG. 66 is a diagram illustrating a PDI table according to another embodiment of the present invention.

FIG. 67 is a diagram illustrating a PDI table according to another embodiment of the present invention.

FIG. 68 illustrates a PDI table according to another embodiment of the present invention.

FIG. 69 illustrates the PDI table according to another embodiment of the present invention.

FIG. 70 illustrates a PDI table according to another embodiment of the present invention.

FIG. 71 illustrates the PDI table according to another embodiment of the present invention.

FIG. 72 is a diagram illustrating a filtering criteria table according to an embodiment of the present invention.

FIG. 73 is a diagram illustrating a filtering criteria table according to another embodiment of the present invention.

FIG. 74 is a diagram illustrating a filtering criteria table according to another embodiment of the present invention.

FIG. 75 is a diagram illustrating a filtering criteria table according to another embodiment of the present invention.

FIG. 76 is a flowchart of a digital broadcast system according to another embodiment of the present invention.

FIG. 77 is a diagram illustrating a PDI table section according to an embodiment of the present invention.

FIG. 78 is a diagram illustrating a PDI table section according to another embodiment of the present invention.

FIG. 79 is a diagram illustrating a PDI table section according to another embodiment of the present invention.

FIG. 80 is a diagram illustrating a PDI table section according to another embodiment of the present invention.

FIG. 81 is a flowchart of a digital broadcast system according to another embodiment of the present invention.

FIG. 82 is a diagram illustrating XML schema of an FDT instance according to another embodiment of the present invention.

FIG. 83 is a diagram illustrating capabilities descriptor syntax according to an embodiment of the present invention.

FIG. 84 is a diagram illustration a consumption model according to an embodiment of the present invention.

FIG. 85 is a diagram illustrating filtering criteria descriptor syntax according to an embodiment of the present invention.

FIG. 86 is a diagram illustrating filtering criteria descriptor syntax according to another embodiment of the present invention.

FIG. 87 is a flowchart of a digital broadcast system according to another embodiment of the present invention.

FIG. 88 is a diagram illustrating an HTTP request table according to an embodiment of the present invention.

FIG. 89 is a flowchart illustrating a digital broadcast system according to another embodiment of the present invention.

FIG. 90 is a diagram illustrating a URL list table according to an embodiment of the present invention.

FIG. 91 is a diagram illustrating a TPT according to an embodiment of the present invention.

FIG. 92 is a flowchart of a digital broadcast system according to another embodiment of the present invention.

FIG. 93 is a flowchart of a digital broadcast system according to another embodiment of the present invention.

FIG. 94 is a flowchart of a digital broadcast system according to another embodiment of the present invention.

FIG. 95 is a flowchart of a digital broadcast system according to another embodiment of the present invention.

FIG. 96 is a diagram illustrating a receiver targeting criteria table according to an embodiment of the present invention.

FIG. 97 is a diagram illustrating a pre-registered PDI question according to an embodiment of the present invention.

FIG. 98 is a diagram illustrating a pre-registered PDI question according to an embodiment of the present invention.

FIG. 99 is a diagram illustrating a pre-registered PDI question according to an embodiment of the present invention.

FIG. 100 is a diagram illustrating a pre-registered PDI question according to an embodiment of the present invention.

FIG. 101 is a diagram illustrating a pre-registered PDI question according to an embodiment of the present invention.

FIG. 102 is a diagram illustrating a pre-registered PDI question according to an embodiment of the present invention.

FIG. 103 is a diagram illustrating a pre-registered PDI question according to an embodiment of the present invention.

FIG. 104 is a diagram illustrating a pre-registered PDI question according to an embodiment of the present invention.

FIG. 105 is a diagram illustrating a pre-registered PDI question according to an embodiment of the present invention.

FIG. 106 is a diagram illustrating a pre-registered PDI question according to an embodiment of the present invention.

FIG. 107 is a diagram illustrating an application programming interface (PDI API) according to an embodiment of the present invention.

FIG. 108 is a diagram showing PDI API according to another embodiment of the present invention.

FIG. 109 is a diagram showing PDI API according to another embodiment of the present invention.

FIG. 110 is a view showing a relationship between a receiver and a companion device in exchange of user data according to an embodiment of the present invention.

FIG. 111 is a view showing a portion of XML of PDI user data according to another embodiment of the present invention.

FIG. 112 is a view showing another portion of XML of PDI user data according to another embodiment of the present invention.

FIG. 113 is a view showing service type and service ID defined to exchange PDI user data between a broadcast receiver and a companion device according to an embodiment of the present invention.

FIG. 114 is a view showing information defined to exchange PDI user data by UPnP according to an embodiment of the present invention.

FIG. 115 is a sequence diagram showing a method of exchanging PDI user data according to an embodiment of the present invention.

FIG. 116 is a view showing state variables related to arguments for a SetUserData action according to an embodiment of the present invention.

FIG. 117 is a sequence diagram showing a method of a companion device setting PDI user data and transmitting the set PDI user data to a receiver such that the PDI user data are stored in the receiver according to an embodiment of the present invention.

FIG. 118 is a view showing state variables for transmitting PDI user data in a case in which the PDI user data are changed according to an embodiment of the present invention.

FIG. 119 is a sequence diagram showing a method of transmitting PDI user data in a case in which the PDI user data are changed according to an embodiment of the present invention.

FIG. 120 is a sequence diagram showing a method of transmitting PDI user data in a case in which the PDI user data are changed according to another embodiment of the present invention.

FIG. 121 is a sequence diagram showing a method of transmitting PDI user data in a case in which the PDI user data are changed according to another embodiment of the present invention.

FIG. 122 is a view showing state variables for bringing PDI user data on a per pair basis of question and answer according to an embodiment of the present invention.

FIG. 123 is a view showing state variables related to arguments for a GetUserDataIdsList action and a GetUserDataQA action according to an embodiment of the present invention.

FIG. 124 is a sequence diagram showing a method of exchanging question/answer pairs according to an embodiment of the present invention.

FIG. 125 is a view showing a state variable related to arguments for a SetUserDataQA action according to an embodiment of the present invention.

FIG. 126 is a sequence diagram showing a method of a companion device setting Q&A and transmitting the set Q&A to a receiver such that the Q&A are stored in the receiver according to an embodiment of the present invention.

FIG. 127 is a view showing state variables for transmitting Q&A in a case in which the Q&A are changed, e.g. updated, according to an embodiment of the present invention.

FIG. 128 is a view showing a receiver according to another embodiment of the present invention.

FIG. 129 is a view showing notification for entry into a synchronized application according to an embodiment of the present invention.

FIG. 130 is a view showing a user interface for interlocking synchronized application notification and a user agreement interface according to an embodiment of the present invention.

FIG. 131 is a view showing a user interface for agreement to the use of an application according to another embodiment of the present invention.

FIG. 132 is a view showing a portion of a TDO parameter table (TPT) (or a TDO parameter element) according to an embodiment of the present invention.

FIG. 133 is a view showing a portion of a TDO parameter table (TPT) (or a TDO parameter element) according to another embodiment of the present invention.

FIG. 134 is a view showing a screen on which notification of a synchronized application is expressed using information of a NotificationInfo element according to an embodiment of the present invention.

FIG. 135 is a view showing a broadcasting server and a receiver according to an embodiment of the present invention.

FIG. 136 is a view showing attribute information related to an application according to an embodiment of the present invention.

FIG. 137 is a view showing a Rated_dimension element in a ContentAdvisoryInfo element according to an embodiment of the present invention.

FIG. 138 is a view showing a TPT including content advisory information (ContentAdvisoryInfo element) according to an embodiment of the present invention.

FIG. 139 is a view showing an application programming interface (API) for acquiring a rating value according to an embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

The term “signaling” in the present invention may indicate that service information (SI) that is transmitted and received from a broadcast system, an Internet system, and/or a broadcast/Internet convergence system. The service information (SI) may include broadcast service information (e.g., ATSC-SI and/or DVB-SI) received from the existing broadcast systems.

The term “broadcast signal” may conceptually include not only signals and/or data received from a terrestrial broadcast, a cable broadcast, a satellite broadcast, and/or a mobile broadcast, but also signals and/or data received from bidirectional broadcast systems such as an Internet broadcast, a broadband broadcast, a communication broadcast, a data broadcast, and/or VOD (Video On Demand).

The term “PLP” may indicate a predetermined unit for transmitting data contained in a physical layer. Therefore, the term “PLP” may also be replaced with the terms ‘data unit’ or ‘data pipe’ as necessary.

A hybrid broadcast service configured to interwork with the broadcast network and/or the Internet network may be used as a representative application to be used in a digital television (DTV) service. The hybrid broadcast service transmits, in real time, enhancement data related to broadcast A/V (Audio/Video) contents transmitted through the terrestrial broadcast network over the Internet, or transmits, in real time, some parts of the broadcast A/V contents over the Internet, such that users can experience a variety of contents.

The present invention aims to provide a method for encapsulating an IP packet, an MPEG-2 TS packet, and a packet applicable to other broadcast systems in the next generation digital broadcast system in such a manner that the IP packet, the MPEG-2 TS packet, and the packet can be transmitted to a physical layer. In addition, the present invention proposes a method for transmitting layer-2 signaling using the same header format.

The contents to be described hereinafter may be implemented by the device. For example, the following processes can be carried out by a signaling processor, a protocol processor, a processor, and/or a packet generator.

Among terms used in the present invention, a real time (RD service literally means a real time service. That is, the RT service is a service which is restricted by time. On the other hand, a non-real time (NRT) service means a non-real time service excluding the RT service. That is, the NRT service is a service which is not restricted by time. Data for an NRT service will be referred to as NRT service data.

A broadcast receiver according to the present invention may receive a non-real time (NRT) service through a medium, such as terrestrial broadcasting, cable broadcasting, or the Internet. The NRT service is stored in a storage medium of the broadcast receiver and is then displayed on a display device at a predetermined time or according to a user's request. In one embodiment, the NRT service is received in the form of a file and is then stored in the storage medium. In one embodiment, the storage medium is an internal hard disc drive (HDD) mounted in the broadcast receiver. In another example, the storage medium may be a universal serial bus (USB) memory or an external HDD connected to the outside of a broadcast receiving system. Signaling information is necessary to receive files constituting the NRT service, to store the files in the storage medium, and to provide the files to a user. In the present invention, such signaling information will be referred to as NRT service signaling information or NRT service signaling data. The NRT service according to the present invention may be classified into a fixed NRT service and a mobile NRT service according to a method of obtaining an IP datagram. In particular, the fixed NRT service is provided to a fixed broadcast receiver and the mobile NRT service is provided to a mobile broadcast receiver. In the present invention, the fixed NRT service will be described as an embodiment. However, the present invention may be applied to the mobile NRT service.

Among terms used in the present invention, an application (or synchronized application) is a data service providing interactive experience to a viewer to improve viewing experience. The application may be named a triggered declarative object (TDO), a declarative object (DO), or an NRT declarative object (NDO).

Among terms used in the present invention, a trigger is a signaling element for indentifying signaling and setting a provision time of an application or an event in the application. The trigger may include location information of a TDO parameter table (TPT) (which may be named a TDO parameter element). The TPT is a signaling element including metadata for operating an application within a specific range.

The trigger may function as a time base trigger and/or an activation trigger. The time base trigger is used to set a time base for suggesting a criterion of a reproduction time of an event. The activation trigger is used to set an operation time of an application or an event in the application. The operation may correspond to start, end, pause, kill and/or resuming of an application or an event in the application. Time base messages may be used as the time base trigger or the time base trigger may be used as the time base messages. Activation messages, which will hereinafter be described, may be used as the activation trigger or the activation trigger may be used as the activation messages.

A media time is a parameter used to refer to a specific time when a content is reproduced.

The triggered declarative object (TDO) indicates additional information in a broadcast content. The TDO is a concept of triggering the additional information in the broadcast content on timing. For example, in a case in which an audition program is broadcast, current ranking of audition participants preferred by a viewer may be shown together with a corresponding broadcast content. At this time, additional information regarding the current ranking of the audition participants may be the TDO. The TDO may be changed through bidirectional communication with the viewer or may be provided in a state in which a viewer's intention is reflected in the TDO.

The present invention provides apparatuses and methods for transmitting and receiving broadcast signals for future broadcast services. Future broadcast services according to an embodiment of the present invention include a terrestrial broadcast service, a mobile broadcast service, a UHDTV service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

While MISO or MIMO uses two antennas in the following for convenience of description, the present invention is applicable to systems using two or more antennas.

The present invention may defines three physical layer (PL) profiles—base, handheld and advanced profiles—each optimized to minimize receiver complexity while attaining the performance required for a particular use case. The physical layer (PHY) profiles are subsets of all configurations that a corresponding receiver should implement.

The three PHY profiles share most of the functional blocks but differ slightly in specific blocks and/or parameters. Additional PHY profiles can be defined in the future. For the system evolution, future profiles can also be multiplexed with the existing profiles in a single RF channel through a future extension frame (FEF). The details of each PHY profile are described below.

1. Base Profile

The base profile represents a main use case for fixed receiving devices that are usually connected to a roof-top antenna. The base profile also includes portable devices that could be transported to a place but belong to a relatively stationary reception category. Use of the base profile could be extended to handheld devices or even vehicular by some improved implementations, but those use cases are not expected for the base profile receiver operation.

Target SNR range of reception is from approximately 10 to 20 dB, which includes the 15 dB SNR reception capability of the existing broadcast system (e.g. ATSC A/53). The receiver complexity and power consumption is not as critical as in the battery-operated handheld devices, which will use the handheld profile. Key system parameters for the base profile are listed in below table 1.

TABLE 1

| | |
|---|---|
| LDPC codeword length | 16K, 64K bits |
| Constellation size | 4~10 bpcu (bits per |
| | channel use) |
| Time de-interleaving | ≦2¹⁹ data cells |
| memory size | |
| Pilot patterns | Pilot pattern for |
| | fixed reception |
| FFT size | 16K, 32K points |

2. Handheld Profile

The handheld profile is designed for use in handheld and vehicular devices that operate with battery power. The devices can be moving with pedestrian or vehicle speed. The power consumption as well as the receiver complexity is very important for the implementation of the devices of the handheld profile. The target SNR range of the handheld profile is approximately 0 to 10 dB, but can be configured to reach below 0 dB when intended for deeper indoor reception.

In addition to low SNR capability, resilience to the Doppler Effect caused by receiver mobility is the most important performance attribute of the handheld profile. Key system parameters for the handheld profile are listed in the below table 2.

TABLE 2

| | |
|---|---|
| LDPC codeword length | 16K bits |
| Constellation size | 2~8 bpcu |
| Time de-interleaving | ≦2¹⁸ data cells |
| memory size | |
| Pilot patterns | Pilot patterns for mobile |
| | and indoor reception |
| FFT size | 8K, 16K points |

3. Advanced Profile

The advanced profile provides highest channel capacity at the cost of more implementation complexity. This profile requires using MIMO transmission and reception, and UHDTV service is a target use case for which this profile is specifically designed. The increased capacity can also be used to allow an increased number of services in a given bandwidth, e.g., multiple SDTV or HDTV services.

The target SNR range of the advanced profile is approximately 20 to 30 dB. MIMO transmission may initially use existing elliptically-polarized transmission equipment, with extension to full-power cross-polarized transmission in the future. Key system parameters for the advanced profile are listed in below table 3.

TABLE 3

| | |
|---|---|
| LDPC codeword length | 16K, 64K bits |
| Constellation size | 8~12 bpcu |
| Time de-interleaving | ≦2¹⁹ data cells |
| memory size | |
| Pilot patterns | Pilot pattern for |
| | fixed reception |
| FFT size | 16K, 32K points |

In this case, the base profile can be used as a profile for both the terrestrial broadcast service and the mobile broadcast service. That is, the base profile can be used to define a concept of a profile which includes the mobile profile. Also, the advanced profile can be divided advanced profile for a base profile with MIMO and advanced profile for a handheld profile with MIMO. Moreover, the three profiles can be changed according to intention of the designer.

The following terms and definitions may apply to the present invention. The following terms and definitions can be changed according to design.

auxiliary stream: sequence of cells carrying data of as yet undefined modulation and coding, which may be used for future extensions or as required by broadcasters or network operators

base data pipe: data pipe that carries service signaling data

baseband frame (or BBFRAME): set of Kbch bits which form the input to one FEC encoding process (BCH and LDPC encoding)

cell: modulation value that is carried by one carrier of the OFDM transmission

coded block: LDPC-encoded block of PLS1 data or one of the LDPC-encoded blocks of PLS2 data

data pipe: logical channel in the physical layer that carries service data or related metadata, which may carry one or multiple service(s) or service component(s).

data pipe unit: a basic unit for allocating data cells to a DP in a frame.

data symbol: OFDM symbol in a frame which is not a preamble symbol (the frame signaling symbol and frame edge symbol is included in the data symbol)

DP_ID: this 8-bit field identifies uniquely a DP within the system identified by the SYSTEM_ID dummy cell: cell carrying a pseudo-random value used to fill the remaining capacity not used for PLS signaling, DPs or auxiliary streams

emergency alert channel: part of a frame that carries EAS information data

frame: physical layer time slot that starts with a preamble and ends with a frame edge symbol

frame repetition unit: a set of frames belonging to same or different physical layer profile including a FEF, which is repeated eight times in a super-frame

fast information channel: a logical channel in a frame that carries the mapping information between a service and the corresponding base DP

FECBLOCK: set of LDPC-encoded bits of a DP data

FFT size: nominal FFT size used for a particular mode, equal to the active symbol period Ts expressed in cycles of the elementary period T

frame signaling symbol: OFDM symbol with higher pilot density used at the start of a frame in certain combinations of FFT size, guard interval and scattered pilot pattern, which carries a part of the PLS data

frame edge symbol: OFDM symbol with higher pilot density used at the end of a frame in certain combinations of FFT size, guard interval and scattered pilot pattern

frame-group: the set of all the frames having the same PHY profile type in a super-frame. future extension frame: physical layer time slot within the super-frame that could be used for future extension, which starts with a preamble

Futurecast UTB system: proposed physical layer broadcasting system, of which the input is one or more MPEG2-TS or IP or general stream(s) and of which the output is an RF signal

input stream: A stream of data for an ensemble of services delivered to the end users by the system.

normal data symbol: data symbol excluding the frame signaling symbol and the frame edge symbol

PHY profile: subset of all configurations that a corresponding receiver should implement

PLS: physical layer signaling data consisting of PLS1 and PLS2

PLS1: a first set of PLS data carried in the FSS symbols having a fixed size, coding and modulation, which carries basic information about the system as well as the parameters needed to decode the PLS2

NOTE: PLS1 data remains constant for the duration of a frame-group.

PLS2: a second set of PLS data transmitted in the FSS symbol, which carries more detailed PLS data about the system and the DPs

PLS2 dynamic data: PLS2 data that may dynamically change frame-by-frame

PLS2 static data: PLS2 data that remains static for the duration of a frame-group preamble signaling data: signaling data carried by the preamble symbol and used to identify the basic mode of the system

preamble symbol: fixed-length pilot symbol that carries basic PLS data and is located in the beginning of a frame

NOTE: The preamble symbol is mainly used for fast initial band scan to detect the system signal, its timing, frequency offset, and FFT-size.

reserved for future use: not defined by the present document but may be defined in future super-frame: set of eight frame repetition units

time interleaving block (TI block): set of cells within which time interleaving is carried out, corresponding to one use of the time interleaver memory

TI group: unit over which dynamic capacity allocation for a particular DP is carried out, made up of an integer, dynamically varying number of XFECBLOCKs

NOTE: The TI group may be mapped directly to one frame or may be mapped to multiple frames. It may contain one or more TI blocks.

Type 1 DP: DP of a frame where all DPs are mapped into the frame in TDM fashion

Type 2 DP: DP of a frame where all DPs are mapped into the frame in FDM fashion

XFECBLOCK: set of Ncells cells carrying all the bits of one LDPC FECBLOCK

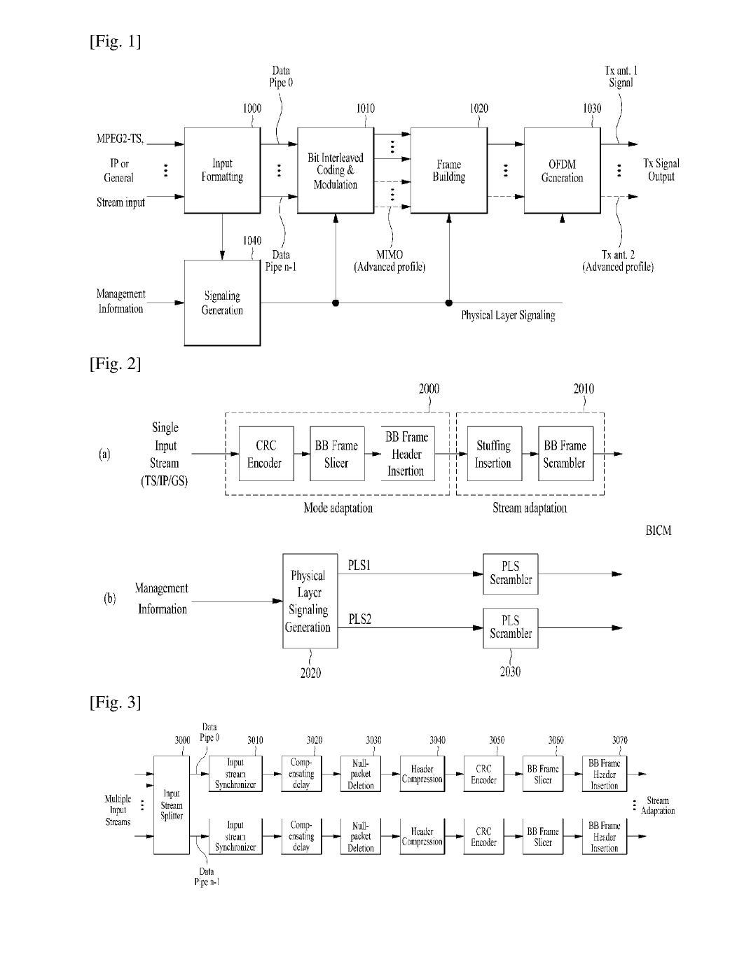

FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

FIGS. 2, 3 and 4 illustrate the input formatting block 1000 according to embodiments of the present invention. A description will be given of each figure.

FIG. 2 illustrates an input formatting block according to one embodiment of the present invention. FIG. 2 shows an input formatting module when the input signal is a single input stream.

The input formatting block illustrated in FIG. 2 corresponds to an embodiment of the input formatting block 1000 described with reference to FIG. 1.

The input to the physical layer may be composed of one or multiple data streams. Each data stream is carried by one DP. The mode adaptation modules slice the incoming data stream into data fields of the baseband frame (BBF). The system supports three types of input data streams: MPEG2-TS, Internet protocol (IP) and Generic stream (GS). MPEG2-TS is characterized by fixed length (188 byte) packets with the first byte being a sync-byte (0x47). An IP stream is composed of variable length IP datagram packets, as signaled within IP packet headers. The system supports both IPv4 and IPv6 for the IP stream. GS may be composed of variable length packets or constant length packets, signaled within encapsulation packet headers.

(a) shows a mode adaptation block 2000 and a stream adaptation 2010 for signal DP and

(b) shows a PLS generation block 2020 and a PLS scrambler 2030 for generating and processing PLS data. A description will be given of the operation of each block.

The Input Stream Splitter splits the input TS, IP, GS streams into multiple service or service component (audio, video, etc.) streams. The mode adaptation module 2010 is comprised of a CRC Encoder, BB (baseband) Frame Slicer, and BB Frame Header Insertion block.

The CRC Encoder provides three kinds of CRC encoding for error detection at the user packet (UP) level, i.e., CRC-8, CRC-16, and CRC-32. The computed CRC bytes are appended after the UP. CRC-8 is used for TS stream and CRC-32 for IP stream. If the GS stream doesn't provide the CRC encoding, the proposed CRC encoding should be applied.

BB Frame Slicer maps the input into an internal logical-bit format. The first received bit is defined to be the MSB. The BB Frame Slicer allocates a number of input bits equal to the available data field capacity. To allocate a number of input bits equal to the BBF payload, the UP packet stream is sliced to fit the data field of BBF.

BB Frame Header Insertion block can insert fixed length BBF header of 2 bytes is inserted in front of the BB Frame. The BBF header is composed of STUFFI (1 bit), SYNCD (13 bits), and RFU (2 bits). In addition to the fixed 2-Byte BBF header, BBF can have an extension field (1 or 3 bytes) at the end of the 2-byte BBF header.

The stream adaptation 2010 is comprised of stuffing insertion block and BB scrambler.

The stuffing insertion block can insert stuffing field into a payload of a BB frame. If the input data to the stream adaptation is sufficient to fill a BB-Frame, STUFFI is set to ‘0’ and the BBF has no stuffing field. Otherwise STUFFI is set to ‘1’ and the stuffing field is inserted immediately after the BBF header. The stuffing field comprises two bytes of the stuffing field header and a variable size of stuffing data.

The BB scrambler scrambles complete BBF for energy dispersal. The scrambling sequence is synchronous with the BBF. The scrambling sequence is generated by the feed-back shift register.

The PLS generation block 2020 can generate physical layer signaling (PLS) data. The PLS provides the receiver with a means to access physical layer DPs. The PLS data consists of PLS1 data and PLS2 data.

The PLS1 data is a first set of PLS data carried in the FSS symbols in the frame having a fixed size, coding and modulation, which carries basic information about the system as well as the parameters needed to decode the PLS2 data. The PLS1 data provides basic transmission parameters including parameters required to enable the reception and decoding of the PLS2 data. Also, the PLS1 data remains constant for the duration of a frame-group.

The PLS2 data is a second set of PLS data transmitted in the FSS symbol, which carries more detailed PLS data about the system and the DPs. The PLS2 contains parameters that provide sufficient information for the receiver to decode the desired DP. The PLS2 signaling further consists of two types of parameters, PLS2 Static data (PLS2-STAT data) and PLS2 dynamic data (PLS2-DYN data). The PLS2 Static data is PLS2 data that remains static for the duration of a frame-group and the PLS2 dynamic data is PLS2 data that may dynamically change frame-by-frame.

Details of the PLS data will be described later.

The PLS scrambler 2030 can scramble the generated PLS data for energy dispersal.

The above-described blocks may be omitted or replaced by blocks having similar or identical functions.

FIG. 3 illustrates an input formatting block according to another embodiment of the present invention.

The input formatting block illustrated in FIG. 3 corresponds to an embodiment of the input formatting block 1000 described with reference to FIG. 1.

FIG. 3 shows a mode adaptation block of the input formatting block when the input signal corresponds to multiple input streams.

The mode adaptation block of the input formatting block for processing the multiple input streams can independently process the multiple input streams.

Referring to FIG. 3, the mode adaptation block for respectively processing the multiple input streams can include an input stream splitter 3000, an input stream synchronizer 3010, a compensating delay block 3020, a null packet deletion block 3030, a head compression block 3040, a CRC encoder 3050, a BB frame slicer 3060 and a BB header insertion block 3070. Description will be given of each block of the mode adaptation block.

Operations of the CRC encoder 3050, BB frame slicer 3060 and BB header insertion block 3070 correspond to those of the CRC encoder, BB frame slicer and BB header insertion block described with reference to FIG. 2 and thus description thereof is omitted.

The input stream splitter 3000 can split the input TS, IP, GS streams into multiple service or service component (audio, video, etc.) streams.

The input stream synchronizer 3010 may be referred as ISSY. The ISSY can provide suitable means to guarantee Constant Bit Rate (CBR) and constant end-to-end transmission delay for any input data format. The ISSY is always used for the case of multiple DPs carrying TS, and optionally used for multiple DPs carrying GS streams.

The compensating delay block 3020 can delay the split TS packet stream following the insertion of ISSY information to allow a TS packet recombining mechanism without requiring additional memory in the receiver.

The null packet deletion block 3030, is used only for the TS input stream case. Some TS input streams or split TS streams may have a large number of null-packets present in order to accommodate VBR (variable bit-rate) services in a CBR TS stream. In this case, in order to avoid unnecessary transmission overhead, null-packets can be identified and not transmitted. In the receiver, removed null-packets can be re-inserted in the exact place where they were originally by reference to a deleted null-packet (DNP) counter that is inserted in the transmission, thus guaranteeing constant bit-rate and avoiding the need for time-stamp (PCR) updating.

The head compression block 3040 can provide packet header compression to increase transmission efficiency for TS or IP input streams. Because the receiver can have a priori information on certain parts of the header, this known information can be deleted in the transmitter.

For Transport Stream, the receiver has a-priori information about the sync-byte configuration (0x47) and the packet length (188 Byte). If the input TS stream carries content that has only one PID, i.e., for only one service component (video, audio, etc.) or service sub-component (SVC base layer, SVC enhancement layer, MVC base view or MVC dependent views), TS packet header compression can be applied (optionally) to the Transport Stream. IP packet header compression is used optionally if the input steam is an IP stream.

The above-described blocks may be omitted or replaced by blocks having similar or identical functions.

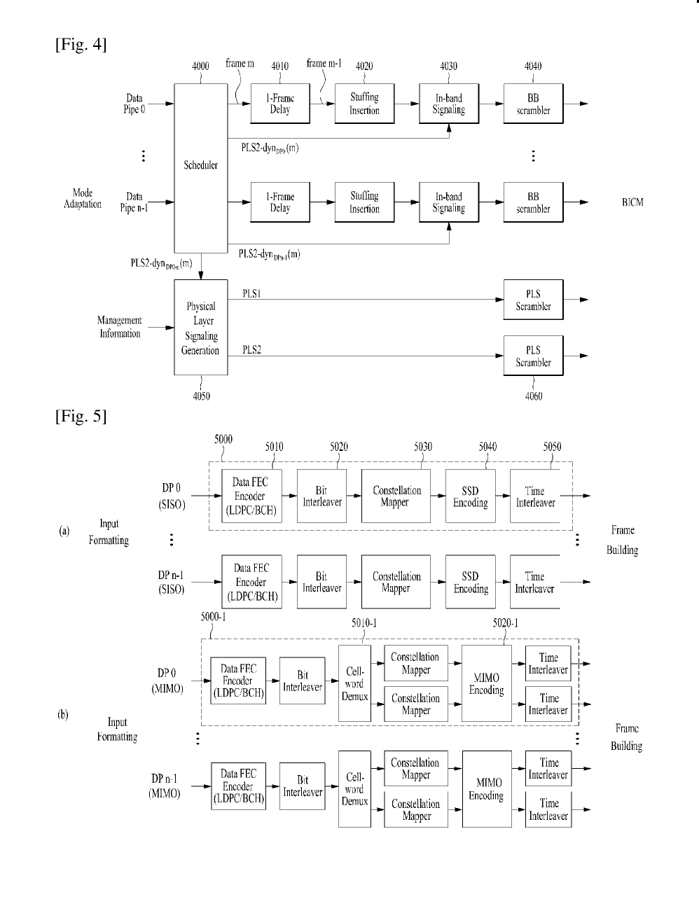

FIG. 4 illustrates an input formatting block according to another embodiment of the present invention.

The input formatting block illustrated in FIG. 4 corresponds to an embodiment of the input formatting block 1000 described with reference to FIG. 1.

FIG. 4 illustrates a stream adaptation block of the input formatting module when the input signal corresponds to multiple input streams.

Referring to FIG. 4, the mode adaptation block for respectively processing the multiple input streams can include a scheduler 4000, an 1-Frame delay block 4010, a stuffing insertion block 4020, an in-band signaling 4030, a BB Frame scrambler 4040, a PLS generation block 4050 and a PLS scrambler 4060. Description will be given of each block of the stream adaptation block.

Operations of the stuffing insertion block 4020, the BB Frame scrambler 4040, the PLS generation block 4050 and the PLS scrambler 4060 correspond to those of the stuffing insertion block, BB scrambler, PLS generation block and the PLS scrambler described with reference to FIG. 2 and thus description thereof is omitted.

The scheduler 4000 can determine the overall cell allocation across the entire frame from the amount of FECBLOCKs of each DP. Including the allocation for PLS, EAC and FIC, the scheduler generate the values of PLS2-DYN data, which is transmitted as in-band signaling or PLS cell in FSS of the frame. Details of FECBLOCK, EAC and FIC will be described later.

The 1-Frame delay block 4010 can delay the input data by one transmission frame such that scheduling information about the next frame can be transmitted through the current frame for in-band signaling information to be inserted into the DPs.

The in-band signaling 4030 can insert un-delayed part of the PLS2 data into a DP of a frame. The above-described blocks may be omitted or replaced by blocks having similar or identical functions.

FIG. 5 illustrates a BICM block according to an embodiment of the present invention.

The BICM block illustrated in FIG. 5 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The SSD encoding block 5040 can precode cells in two (2D), three (3D), and four (4D) dimensions to increase the reception robustness under difficult fading conditions.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

MIMO encoding is intended for a 2×2 MIMO system requiring at least two antennas at both the transmitter and the receiver. Two MIMO encoding modes are defined in this proposal; full-rate spatial multiplexing (FR-SM) and full-rate full-diversity spatial multiplexing (FRFD-SM). The FR-SM encoding provides capacity increase with relatively small complexity increase at the receiver side while the FRFD-SM encoding provides capacity increase and additional diversity gain with a great complexity increase at the receiver side. The proposed MIMO encoding scheme has no restriction on the antenna polarity configuration.

MIMO processing is required for the advanced profile frame, which means all DPs in the advanced profile frame are processed by the MIMO encoder. MIMO processing is applied at DP level. Pairs of the Constellation Mapper outputs NUQ (e1,i and e2,i) are fed to the input of the MIMO Encoder. Paired MIMO Encoder output (g1,i and g2,i) is transmitted by the same carrier k and OFDM symbol l of their respective TX antennas.

The above-described blocks may be omitted or replaced by blocks having similar or identical functions.

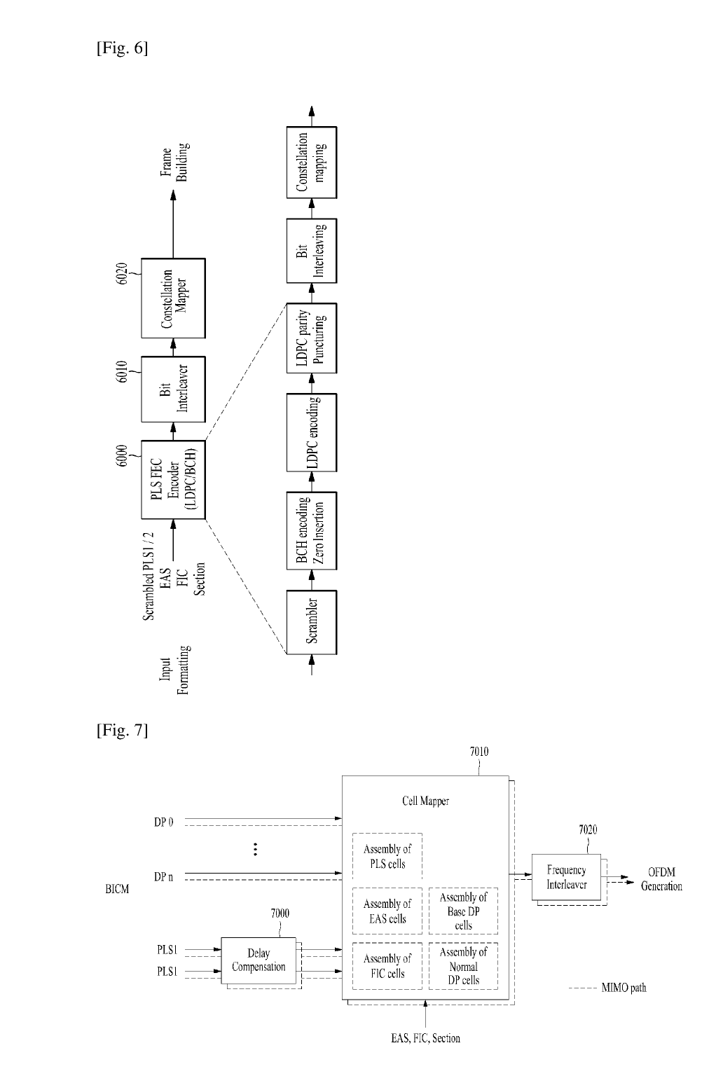

FIG. 6 illustrates a BICM block according to another embodiment of the present invention.

The BICM block illustrated in FIG. 6 corresponds to an embodiment of the BICM block 1010 described with reference to FIG. 1.

FIG. 6 illustrates a BICM block for protection of physical layer signaling (PLS), emergency alert channel (EAC) and fast information channel (FIC). EAC is a part of a frame that carries EAS information data and FIC is a logical channel in a frame that carries the mapping information between a service and the corresponding base DP. Details of the EAC and FIC will be described later.

Referring to FIG. 6, the BICM block for protection of PLS, EAC and FIC can include a PLS FEC encoder 6000, a bit interleaver 6010 and a constellation mapper 6020.

Also, the PLS FEC encoder 6000 can include a scrambler, BCH encoding/zero insertion block, LDPC encoding block and LDPC parity punturing block. Description will be given of each block of the BICM block.

The PLS FEC encoder 6000 can encode the scrambled PLS 1/2 data, EAC and FIC section.

The scrambler can scramble PLS1 data and PLS2 data before BCH encoding and shortened and punctured LDPC encoding.

The BCH encoding/zero insertion block can perform outer encoding on the scrambled PLS 1/2 data using the shortened BCH code for PLS protection and insert zero bits after the BCH encoding. For PLS1 data only, the output bits of the zero insertion may be permutted before LDPC encoding.

The LDPC encoding block can encode the output of the BCH encoding/zero insertion block using LDPC code. To generate a complete coded block, Cldpc, parity bits, Pldpc are encoded systematically from each zero-inserted PLS information block, Ildpc and appended after it.

C_{ldpc}=[I_{ldpc} P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math figure 1]

The LDPC code parameters for PLS1 and PLS2 are as following table 4.

TABLE 4

| Signaling | | | | K_{ldpc} | | | code | |
|---|---|---|---|---|---|---|---|---|
| Type | K_{sig} | K_{bch} | N_{bch}_{_{—}}_{parity} | (=N_{bch}) | N_{ldpc} | N_{ldpc}_{_{—}}_{parity} | rate | Q_{ldpc} |
| PLS1 | 342 | 1020 | 60 | 1080 | 4320 | 3240 | 1/4 | 36 |
| PLS2 | <1021 | | | | | | | |
| | >1020 | 2100 | | 2160 | 7200 | 5040 | 3/10 | 56 |

The LDPC parity punturing block can perform puncturing on the PLS1 data and PLS 2 data. When shortening is applied to the PLS1 data protection, some LDPC parity bits are punctured after LDPC encoding. Also, for the PLS2 data protection, the LDPC parity bits of PLS2 are punctured after LDPC encoding. These punctured bits are not transmitted.

The bit interleaver 6010 can interleave the each shortened and punctured PLS1 data and PLS2 data.

The constellation mapper 6020 can map the bit ineterlaeved PLS1 data and PLS2 data onto constellations.

The above-described blocks may be omitted or replaced by blocks having similar or identical functions.

FIG. 7 illustrates a frame building block according to one embodiment of the present invention.

The frame building block illustrated in FIG. 7 corresponds to an embodiment of the frame building block 1020 described with reference to FIG. 1.

Referring to FIG. 7, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver 5050. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI(program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame.

The above-described blocks may be omitted or replaced by blocks having similar or identical functions.

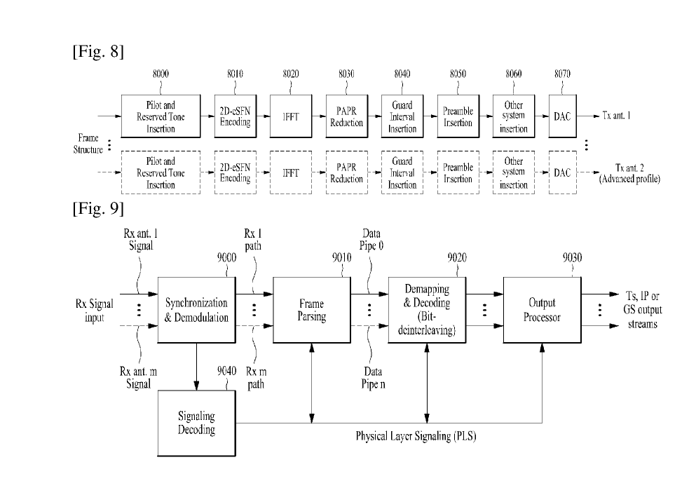

FIG. 8 illustrates an OFDM generation block according to an embodiment of the present invention.

The OFDM generation block illustrated in FIG. 8 corresponds to an embodiment of the OFDM generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 8, the OFDM generation block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070. Description will be given of each block of the frame building block.

8000 can insert pilots and the reserved tone.

Various cells within the OFDM symbol are modulated with reference information, known as pilots, which have transmitted values known a priori in the receiver. The information of pilot cells is made up of scattered pilots, continual pilots, edge pilots, FSS (frame signaling symbol) pilots and FES (frame edge symbol) pilots. Each pilot is transmitted at a particular boosted power level according to pilot type and pilot pattern. The value of the pilot information is derived from a reference sequence, which is a series of values, one for each transmitted carrier on any given symbol. The pilots can be used for frame synchronization, frequency synchronization, time synchronization, channel estimation, and transmission mode identification, and also can be used to follow the phase noise.

Reference information, taken from the reference sequence, is transmitted in scattered pilot cells in every symbol except the preamble, FSS and FES of the frame. Continual pilots are inserted in every symbol of the frame. The number and location of continual pilots depends on both the FFT size and the scattered pilot pattern. The edge carriers are edge pilots in every symbol except for the preamble symbol. They are inserted in order to allow frequency interpolation up to the edge of the spectrum. FSS pilots are inserted in FSS(s) and FES pilots are inserted in FES. They are inserted in order to allow time interpolation up to the edge of the frame.

The system according to an embodiment of the present invention supports the SFN network, where distributed MISO scheme is optionally used to support very robust transmission mode. The 2D-eSFN is a distributed MISO scheme that uses multiple TX antennas, each of which is located in the different transmitter site in the SFN network.

The 2D-eSFN encoding block 8010 can process a 2D-eSFN processing to distorts the phase of the signals transmitted from multiple transmitters, in order to create both time and frequency diversity in the SFN configuration. Hence, burst errors due to low flat fading or deep-fading for a long time can be mitigated.

The IFFT block 8020 can modulate the output from the 2D-eSFN encoding block 8010 using OFDM modulation scheme. Any cell in the data symbols which has not been designated as a pilot (or as a reserved tone) carries one of the data cells from the frequency interleaver. The cells are mapped to OFDM carriers.

The PAPR reduction block 8030 can perform a PAPR reduction on input signal using various PAPR reduction algorithm in the time domain.

The guard interval insertion block 8040 can insert guard intervals and the preamble insertion block 8050 can insert preamble in front of the signal. Details of a structure of the preamble will be described later. The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc. Data related to respective broadcast services can be transmitted through different frames.

The DAC block 8070 can convert an input digital signal into an analog signal and output the analog signal. The signal output from the DAC block 7800 can be transmitted through multiple output antennas according to the physical layer profiles. A Tx antenna according to an embodiment of the present invention can have vertical or horizontal polarity.

The above-described blocks may be omitted or replaced by blocks having similar or identical functions according to design.

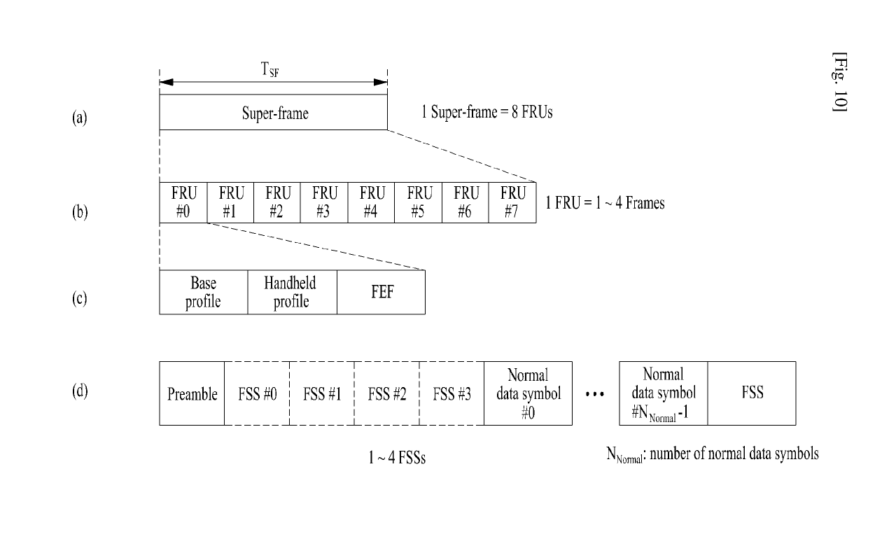

FIG. 9 illustrates a structure of an apparatus for receiving broadcast signals for future broadcast services according to an embodiment of the present invention.

The apparatus for receiving broadcast signals for future broadcast services according to an embodiment of the present invention can correspond to the apparatus for transmitting broadcast signals for future broadcast services, described with reference to FIG. 1.

The apparatus for receiving broadcast signals for future broadcast services according to an embodiment of the present invention can include a synchronization & demodulation module 9000, a frame parsing module 9010, a demapping & decoding module 9020, an output processor 9030 and a signaling decoding module 9040. A description will be given of operation of each module of the apparatus for receiving broadcast signals.

The synchronization & demodulation module 9000 can receive input signals through m Rx antennas, perform signal detection and synchronization with respect to a system corresponding to the apparatus for receiving broadcast signals and carry out demodulation corresponding to a reverse procedure of the procedure performed by the apparatus for transmitting broadcast signals.

The frame parsing module 9010 can parse input signal frames and extract data through which a service selected by a user is transmitted. If the apparatus for transmitting broadcast signals performs interleaving, the frame parsing module 9010 can carry out deinterleaving corresponding to a reverse procedure of interleaving. In this case, the positions of a signal and data that need to be extracted can be obtained by decoding data output from the signaling decoding module 9040 to restore scheduling information generated by the apparatus for transmitting broadcast signals.

The demapping & decoding module 9020 can convert the input signals into bit domain data and then deinterleave the same as necessary. The demapping & decoding module 9020 can perform demapping for mapping applied for transmission efficiency and correct an error generated on a transmission channel through decoding. In this case, the demapping & decoding module 9020 can obtain transmission parameters necessary for demapping and decoding by decoding the data output from the signaling decoding module 9040.

The output processor 9030 can perform reverse procedures of various compression/signal processing procedures which are applied by the apparatus for transmitting broadcast signals to improve transmission efficiency. In this case, the output processor 9030 can acquire necessary control information from data output from the signaling decoding module 9040.

The output of the output processor 8300 corresponds to a signal input to the apparatus for transmitting broadcast signals and may be MPEG-TSs, IP streams (v4 or v6) and generic streams.

The signaling decoding module 9040 can obtain PLS information from the signal demodulated by the synchronization & demodulation module 9000. As described above, the frame parsing module 9010, demapping & decoding module 9020 and output processor 9030 can execute functions thereof using the data output from the signaling decoding module 9040.

FIG. 10 illustrates a frame structure according to an embodiment of the present invention.

FIG. 10 shows an example configuration of the frame types and FRUs in a super-frame. (a) shows a super frame according to an embodiment of the present invention, (b) shows FRU (Frame Repetition Unit) according to an embodiment of the present invention, (c) shows frames of variable PHY profiles in the FRU and (d) shows a structure of a frame.

A super-frame may be composed of eight FRUs. The FRU is a basic multiplexing unit for TDM of the frames, and is repeated eight times in a super-frame.

Each frame in the FRU belongs to one of the PHY profiles, (base, handheld, advanced) or FEF. The maximum allowed number of the frames in the FRU is four and a given PHY profile can appear any number of times from zero times to four times in the FRU (e.g., base, base, handheld, advanced). PHY profile definitions can be extended using reserved values of the PHY_PROFILE in the preamble, if required.

The FEF part is inserted at the end of the FRU, if included. When the FEF is included in the FRU, the minimum number of FEFs is 8 in a super-frame. It is not recommended that FEF parts be adjacent to each other.

One frame is further divided into a number of OFDM symbols and a preamble. As shown in (d), the frame comprises a preamble, one or more frame signaling symbols (FSS), normal data symbols and a frame edge symbol (FES).

The preamble is a special symbol that enables fast Futurecast UTB system signal detection and provides a set of basic transmission parameters for efficient transmission and reception of the signal. The detailed description of the preamble will be will be described later.

The main purpose of the FSS(s) is to carry the PLS data. For fast synchronization and channel estimation, and hence fast decoding of PLS data, the FSS has more dense pilot pattern than the normal data symbol. The FES has exactly the same pilots as the FSS, which enables frequency-only interpolation within the FES and temporal interpolation, without extrapolation, for symbols immediately preceding the FES.

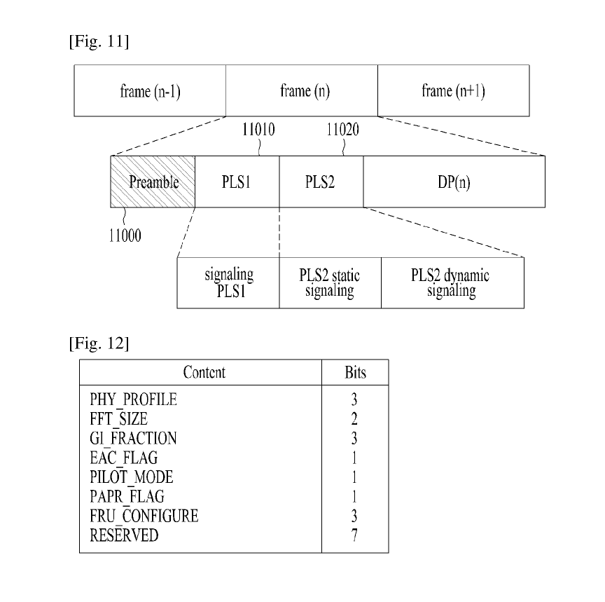

FIG. 11 illustrates a signaling hierarchy structure of the frame according to an embodiment of the present invention.

FIG. 11 illustrates the signaling hierarchy structure, which is split into three main parts: the preamble signaling data 11000, the PLS1 data 11010 and the PLS2 data 11020. The purpose of the preamble, which is carried by the preamble symbol in every frame, is to indicate the transmission type and basic transmission parameters of that frame. The PLS1 enables the receiver to access and decode the PLS2 data, which contains the parameters to access the DP of interest. The PLS2 is carried in every frame and split into two main parts: PLS2-STAT data and PLS2-DYN data. The static and dynamic portion of PLS2 data is followed by padding, if necessary.

FIG. 12 illustrates preamble signaling data according to an embodiment of the present invention.

Preamble signaling data carries 21 bits of information that are needed to enable the receiver to access PLS data and trace DPs within the frame structure. Details of the preamble signaling data are as follows:

PHY_PROFILE: This 3-bit field indicates the PHY profile type of the current frame. The mapping of different PHY profile types is given in below table 5.

TABLE 5

| Value | PHY profile |
|---|---|
| 000 | Base profile |
| 001 | Handheld profile |
| 010 | Advanced profiled |
| 011~110 | Reserved |
| 111 | FEF |

FFT_SIZE: This 2 bit field indicates the FFT size of the current frame within a frame-group, as described in below table 6.

TABLE 6

| Value | FFT size | |
|---|---|---|
| 00 | 8K | FFT |
| 01 | 16K | FFT |
| 10 | 32K | FFT |

| | |
|---|---|
| 11 | Reserved |

GI_FRACTION: This 3 bit field indicates the guard interval fraction value in the current super-frame, as described in below table 7.

TABLE 7

| Value | GI_FRACTION |
|---|---|
| 000 | ⅕ |
| 001 | 1/10 |
| 010 | 1/20 |
| 011 | 1/40 |
| 100 | 1/80 |
| 101 | 1/160 |
| 110~111 | Reserved |

EAC_FLAG: This 1 bit field indicates whether the EAC is provided in the current frame. If this field is set to ‘1’, emergency alert service (EAS) is provided in the current frame. If this field set to ‘0’, EAS is not carried in the current frame. This field can be switched dynamically within a super-frame.

PILOT_MODE: This 1-bit field indicates whether the pilot mode is mobile mode or fixed mode for the current frame in the current frame-group. If this field is set to ‘0’, mobile pilot mode is used. If the field is set to ‘1’, the fixed pilot mode is used.

PAPR_FLAG: This 1-bit field indicates whether PAPR reduction is used for the current frame in the current frame-group. If this field is set to value ‘1’, tone reservation is used for PAPR reduction. If this field is set to ‘0’, PAPR reduction is not used.

FRU_CONFIGURE: This 3-bit field indicates the PHY profile type configurations of the frame repetition units (FRU) that are present in the current super-frame. All profile types conveyed in the current super-frame are identified in this field in all preambles in the current super-frame. The 3-bit field has a different definition for each profile, as show in below table 8.

TABLE 8

| | Current | Current | Current | Current |
|---|---|---|---|---|
| | PHY_ | PHY_ | PHY_ | PHY_ |
| | PROFILE = | PROFILE = ‘001’ | PROFILE = ‘010’ | PROFILE = ‘111’ |
| | ‘000’ (base) | (handheld) | (advanced) | (FEF) |
| FRU_ | Only base | Only handheld | Only advanced | Only FEF |
| CONFIGURE = 000 | profile | profile present | profile present | present |
| | present | | | |
| FRU_ | Handheld | Base profile | Base profile | Base profile |
| CONFIGURE = 1XX | profile present | present | present | present |
| FRU_ | Advanced | Advanced | Handheld | Handheld |
| CONFIGURE = X1X | profile | profile | profile | profile |
| | present | present | present | present |
| FRU_ | FEF | FEF | FEF | Advanced |
| CONFIGURE = XX1 | present | present | present | profile |
| | | | | present |

RESERVED: This 7-bit field is reserved for future use.

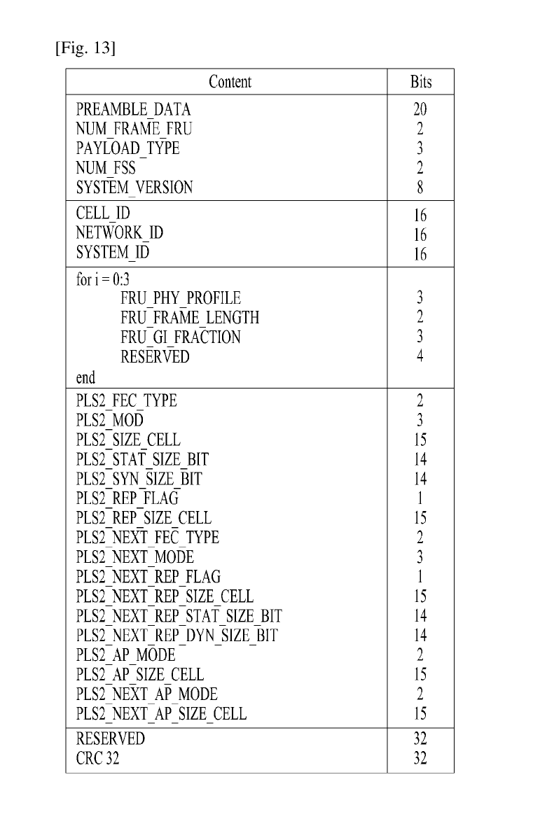

FIG. 13 illustrates PLS1 data according to an embodiment of the present invention.

PLS1 data provides basic transmission parameters including parameters required to enable the reception and decoding of the PLS2. As above mentioned, the PLS1 data remain unchanged for the entire duration of one frame-group. The detailed definition of the signaling fields of the PLS1 data are as follows:

PREAMBLE_DATA: This 20-bit field is a copy of the preamble signaling data excluding the EAC_F LAG.

NUM_FRAME_FRU: This 2-bit field indicates the number of the frames per FRU.

PAYLOAD_TYPE: This 3-bit field indicates the format of the payload data carried in the frame-group. PAYLOAD_TYPE is signaled as shown in table 9.

TABLE 9

| value | Payload type |
|---|---|
| 1XX | TS stream is transmitted |
| X1X | IP stream is transmitted |
| XX1 | GS stream is transmitted |

NUM_FSS: This 2-bit field indicates the number of FSS symbols in the current frame.

SYSTEM_VERSION: This 8-bit field indicates the version of the transmitted signal format. The

SYSTEM_VERSION is divided into two 4-bit fields, which are a major version and a minor version.

Major version: The MSB four bits of SYSTEM_VERSION field indicate major version information. A change in the major version field indicates a non-backward-compatible change. The default value is ‘0000’. For the version described in this standard, the value is set to ‘0000’.

Minor version: The LSB four bits of SYSTEM_VERSION field indicate minor version information. A change in the minor version field is backward-compatible.

CELL_ID: This is a 16-bit field which uniquely identifies a geographic cell in an ATSC network. An ATSC cell coverage area may consist of one or more frequencies, depending on the number of frequencies used per Futurecast UTB system. If the value of the CELL_ID is not known or unspecified, this field is set to ‘0’.

NETWORK_ID: This is a 16-bit field which uniquely identifies the current ATSC network.

SYSTEM_ID: This 16-bit field uniquely identifies the Futurecast UTB system within the ATSC network. The Futurecast UTB system is the terrestrial broadcast system whose input is one or more input streams (TS, IP, GS) and whose output is an RF signal. The Futurecast UTB system carries one or more PHY profiles and FEF, if any. The same Futurecast UTB system may carry different input streams and use different RF frequencies in different geographical areas, allowing local service insertion. The frame structure and scheduling is controlled in one place and is identical for all transmissions within a Futurecast UTB system. One or more Futurecast UTB systems may have the same SYSTEM_ID meaning that they all have the same physical layer structure and configuration.

The following loop consists of FRU_PHY_PROFILE, FRU_FRAME_LENGTH, FRU_GI_FRACTION, and RESERVED which are used to indicate the FRU configuration and the length of each frame type. The loop size is fixed so that four PHY profiles (including a FEF) are signaled within the FRU. If NUM_FRAME_FRU is less than 4, the unused fields are filled with zeros. FRU_PHY_PROFILE: This 3-bit field indicates the PHY profile type of the (i+1)th (i is the loop index) frame of the associated FRU. This field uses the same signaling format as shown in the table 8.

FRU_FRAME_LENGTH: This 2-bit field indicates the length of the (i+1)th frame of the associated FRU. Using FRU_FRAME_LENGTH together with FRU_GI_FRACTION, the exact value of the frame duration can be obtained.

FRU_GI_FRACTION: This 3-bit field indicates the guard interval fraction value of the (i+1)th frame of the associated FRU. FRU_GI_FRACTION is signaled according to the table 7.

RESERVED: This 4-bit field is reserved for future use.

The following fields provide parameters for decoding the PLS2 data.

PLS2_FEC_TYPE: This 2-bit field indicates the FEC type used by the PLS2 protection. The FEC type is signaled according to table 10. The details of the LDPC codes will be described later.

TABLE 10

| Content | PLS2 FEC type |
|---|---|
| 00 | 4K-1/4 and 7K-3/10 LDPC codes |
| 01~11 | Reserved |

PLS2_MOD: This 3-bit field indicates the modulation type used by the PLS2. The modulation type is signaled according to table 11.

TABLE 11

| Value | PLS2_MODE |
|---|---|
| 000 | BPSK |
| 001 | QPSK |
| 010 | QAM-16 |
| 011 | NUQ-64 |
| 100~111 | Reserved |

PLS2_SIZE_CELL: This 15-bit field indicates Ctotal_partial_block, the size (specified as the number of QAM cells) of the collection of full coded blocks for PLS2 that is carried in the current frame-group. This value is constant during the entire duration of the current frame-group.

PLS2_STAT_SIZE_BIT: This 14-bit field indicates the size, in bits, of the PLS2-STAT for the current frame-group. This value is constant during the entire duration of the current frame-group.

PLS2_DYN_SIZE_BIT: This 14-bit field indicates the size, in bits, of the PLS2-DYN for the current frame-group. This value is constant during the entire duration of the current frame-group.

PLS2_REP_FLAG: This 1-bit flag indicates whether the PLS2 repetition mode is used in the current frame-group. When this field is set to value ‘1’, the PLS2 repetition mode is activated. When this field is set to value ‘0’, the PLS2 repetition mode is deactivated.

PLS2_REP_SIZE_CELL: This 15-bit field indicates Ctotal_partial_block, the size (specified as the number of QAM cells) of the collection of partial coded blocks for PLS2 carried in every frame of the current frame-group, when PLS2 repetition is used. If repetition is not used, the value of this field is equal to 0. This value is constant during the entire duration of the current frame-group.

PLS2_NEXT_FEC_TYPE: This 2-bit field indicates the FEC type used for PLS2 that is carried in every frame of the next frame-group. The FEC type is signaled according to the table 10.

PLS2_NEXT_MOD: This 3-bit field indicates the modulation type used for PLS2 that is carried in every frame of the next frame-group. The modulation type is signaled according to the table 11.

PLS2_NEXT_REP_FLAG: This 1-bit flag indicates whether the PLS2 repetition mode is used in the next frame-group. When this field is set to value ‘1’, the PLS2 repetition mode is activated. When this field is set to value ‘0’, the PLS2 repetition mode is deactivated.

PLS2_NEXT_REP_SIZE_CELL: This 15-bit field indicates Ctotal_full_block, The size (specified as the number of QAM cells) of the collection of full coded blocks for PLS2 that is carried in every frame of the next frame-group, when PLS2 repetition is used. If repetition is not used in the next frame-group, the value of this field is equal to 0. This value is constant during the entire duration of the current frame-group.

PLS2_NEXT_REP_STAT_SIZE_BIT: This 14-bit field indicates the size, in bits, of the PLS2-STAT for the next frame-group. This value is constant in the current frame-group.

PLS2_NEXT_REP_DYN_SIZE_BIT: This 14-bit field indicates the size, in bits, of the PLS2-DYN for the next frame-group. This value is constant in the current frame-group.

PLS2_AP_MODE: This 2-bit field indicates whether additional parity is provided for PLS2 in the current frame-group. This value is constant during the entire duration of the current frame-group. The below table 12 gives the values of this field. When this field is set to ‘00’, additional parity is not used for the PLS2 in the current frame-group.

TABLE 12

| Value | PLS2-AP mode |
|---|---|
| 00 | AP is not provided |
| 01 | AP1 mode |
| 10~11 | Reserved |

PLS2_AP_SIZE_CELL: This 15-bit field indicates the size (specified as the number of QAM cells) of the additional parity bits of the PLS2. This value is constant during the entire duration of the current frame-group.

PLS2_NEXT_AP_MODE: This 2-bit field indicates whether additional parity is provided for PLS2 signaling in every frame of next frame-group. This value is constant during the entire duration of the current frame-group. The table 12 defines the values of this field

PLS2_NEXT_AP_SIZE_CELL: This 15-bit field indicates the size (specified as the number of QAM cells) of the additional parity bits of the PLS2 in every frame of the next frame-group. This value is constant during the entire duration of the current frame-group.

RESERVED: This 32-bit field is reserved for future use.

CRC_32: A 32-bit error detection code, which is applied to the entire PLS1 signaling.

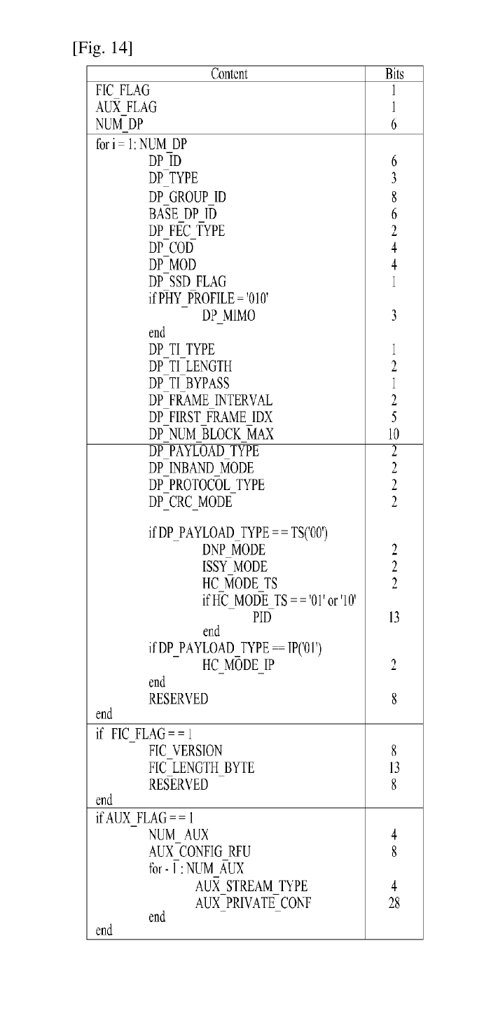

FIG. 14 illustrates PLS2 data according to an embodiment of the present invention.

FIG. 14 illustrates PLS2-STAT data of the PLS2 data. The PLS2-STAT data are the same within a frame-group, while the PLS2-DYN data provide information that is specific for the current frame.

The details of fields of the PLS2-STAT data are as follows:

FIC_FLAG: This 1-bit field indicates whether the FIC is used in the current frame-group. If this field is set to ‘1’, the FIC is provided in the current frame. If this field set to ‘0’, the FIC is not carried in the current frame. This value is constant during the entire duration of the current frame-group.

AUX_FLAG: This 1-bit field indicates whether the auxiliary stream(s) is used in the current frame-group. If this field is set to ‘1’, the auxiliary stream is provided in the current frame. If this field set to ‘0’, the auxiliary stream is not carried in the current frame. This value is constant during the entire duration of current frame-group.

NUM_DP: This 6-bit field indicates the number of DPs carried within the current frame. The value of this field ranges from 1 to 64, and the number of DPs is NUM_DP+1.

DP_ID: This 6-bit field identifies uniquely a DP within a PHY profile.

DP_TYPE: This 3-bit field indicates the type of the DP. This is signaled according to the below table 13.

TABLE 13

| Value | DP Type |
|---|---|
| 000 | DP Type 1 |
| 001 | DP Type 2 |
| 010~111 | reserved |

DP_GROUP_ID: This 8-bit field identifies the DP group with which the current DP is associated. This can be used by a receiver to access the DPs of the service components associated with a particular service, which will have the same DP_GROUP_ID.

BASE_DP_ID: This 6-bit field indicates the DP carrying service signaling data (such as PSI/SI) used in the Management layer. The DP indicated by BASE_DP_ID may be either a normal DP carrying the service signaling data along with the service data or a dedicated DP carrying only the service signaling data

DP_FEC_TYPE: This 2-bit field indicates the FEC type used by the associated DP. The FEC type is signaled according to the below table 14.

TABLE 14

| Value | FEC_TYPE |
|---|---|
| 00 | 16K LDPC |
| 01 | 64K LDPC |
| 10~11 | Reserved |

DP_COD: This 4-bit field indicates the code rate used by the associated DP. The code rate is signaled according to the below table 15.

TABLE 15

| Value | Code rate |
|---|---|
| 0000 | 5/15 |
| 0001 | 6/15 |
| 0010 | 7/15 |
| 0011 | 8/15 |
| 0100 | 9/15 |
| 0101 | 10/15 |
| 0110 | 11/15 |
| 0111 | 12/15 |
| 1000 | 13/15 |
| 1001~1111 | Reserved |

DP_MOD: This 4-bit field indicates the modulation used by the associated DP. The modulation is signaled according to the below table 16.

TABLE 16

| Value | Modulation |
|---|---|
| 0000 | QPSK |
| 0001 | QAM-16 |
| 0010 | NUQ-64 |
| 0011 | NUQ-256 |
| 0100 | NUQ-1024 |
| 0101 | NUC-16 |
| 0110 | NUC-64 |
| 0111 | NUC-256 |
| 1000 | NUC-1024 |
| 1001~1111 | reserved |

DP_SSD_FLAG: This 1-bit field indicates whether the SSD mode is used in the associated DP.

If this field is set to value ‘1’, SSD is used. If this field is set to value ‘0’, SSD is not used.

The following field appears only if PHY_PROFILE is equal to ‘010’, which indicates the advanced profile:

DP_MIMO: This 3-bit field indicates which type of MIMO encoding process is applied to the associated DP. The type of MIMO encoding process is signaled according to the table 17.

TABLE 17

| Value | MIMO encoding |
|---|---|
| 000 | FR-SM |
| 001 | FRFD-SM |
| 010~111 | reserved |

DP_TI_TYPE: This 1-bit field indicates the type of time-interleaving. A value of ‘0’ indicates that one TI group corresponds to one frame and contains one or more TI-blocks. A value of ‘1’ indicates that one TI group is carried in more than one frame and contains only one TI-block.

DP_TI_LENGTH: The use of this 2-bit field (the allowed values are only 1, 2, 4, 8) is determined by the values set within the DP_TI_TYPE field as follows:

If the DP_TI_TYPE is set to the value ‘1’, this field indicates PI, the number of the frames to which each TI group is mapped, and there is one TI-block per TI group (NTI=1). The allowed PI values with 2-bit field are defined in the below table 18.

If the DP_TI_TYPE is set to the value ‘0’, this field indicates the number of TI-blocks NTI per TI group, and there is one TI group per frame (PI=1). The allowed PI values with 2-bit field are defined in the below table 18.

TABLE 18

| 2-bit field | P_{I} | N_{TI} |
|---|---|---|
| 00 | 1 | 1 |
| 01 | 2 | 2 |
| 10 | 4 | 3 |
| 11 | 8 | 4 |

DP_FRAME_INTERVAL: This 2-bit field indicates the frame interval (IJUMP) within the frame-group for the associated DP and the allowed values are 1, 2, 4, 8 (the corresponding 2-bit field is ‘00’, ‘01’, ‘10’, or ‘11’, respectively). For DPs that do not appear every frame of the frame-group, the value of this field is equal to the interval between successive frames. For example, if a DP appears on the frames 1, 5, 9, 13, etc., this field is set to ‘4’. For DPs that appear in every frame, this field is set to ‘1’.

DP_TI_BYPASS: This 1-bit field determines the availability of time interleaver 5050. If time interleaving is not used for a DP, it is set to ‘1’. Whereas if time interleaving is used it is set to ‘0’.

DP_FIRST_FRAME_IDX: This 5-bit field indicates the index of the first frame of the super-frame in which the current DP occurs. The value of DP_FIRST_FRAME_IDX ranges from 0 to 31

DP_NUM_BLOCK_MAX: This 10-bit field indicates the maximum value of DP_NUM_BLOCKS for this DP. The value of this field has the same range as DP_NUM_BLOCKS.

DP_PAYLOAD_TYPE: This 2-bit field indicates the type of the payload data carried by the given DP. DP_PAYLOAD_TYPE is signaled according to the below table 19.

TABLE 19

| Value | Payload Type |
|---|---|
| 00 | TS. |
| 01 | IP |
| 10 | GS |
| 11 | reserved |

DP_INBAND_MODE: This 2-bit field indicates whether the current DP carries in-band signaling information. The in-band signaling type is signaled according to the below table 20.

TABLE 20

| Value | In-band mode |
|---|---|
| 00 | In-band signaling is not carried. |
| 01 | INBAND-PLS is carried only |
| 10 | INBAND-ISSY is carried only |
| 11 | INBAND-PLS and INBAND-ISSY are carried |

DP_PROTOCOL_TYPE: This 2-bit field indicates the protocol type of the payload carried by the given DP. It is signaled according to the below table 21 when input payload types are selected.

TABLE 21

| | If DP_ PAYLOAD_ | If DP_ PAYLOAD_ | If DP_ PAYLOAD_ |
|---|---|---|---|
| Value | Is TS | Is IP | Is GS |
| 00 | MPEG2-TS | IPv4 | (Note) |
| 01 | Reserved | IPv6 | Reserved |
| 10 | Reserved | Reserved | Reserved |
| 11 | Reserved | Reserved | Reserved |

DP_CRC_MODE: This 2-bit field indicates whether CRC encoding is used in the Input Formatting block. The CRC mode is signaled according to the below table 22.

TABLE 22

| Value | CRC mode |
|---|---|
| 00 | Not used |
| 01 | CRC-8 |
| 10 | CRC-16 |
| 11 | CRC-32 |

DNP_MODE: This 2-bit field indicates the null-packet deletion mode used by the associated DP when DP_PAYLOAD_TYPE is set to TS (‘00’). DNP_MODE is signaled according to the below table 23. If DP_PAYLOAD_TYPE is not TS (‘00’), DNP_MODE is set to the value ‘00’.

TABLE 23

| Value | Null-packet deletion mode |
|---|---|
| 00 | Not used |
| 01 | DNP-NORMAL |
| 10 | DNP-OFFSET |
| 11 | reserved |

ISSY_MODE: This 2-bit field indicates the ISSY mode used by the associated DP when DP_PAYLOAD_TYPE is set to TS (‘00’). The ISSY_MODE is signaled according to the below table 24 If DP_PAYLOAD_TYPE is not TS (‘00’), ISSY_MODE is set to the value ‘00’.

TABLE 24

| Value | ISSY mode |
|---|---|
| 00 | Not used |
| 01 | ISSY-UP |
| 10 | ISSY-BBF |
| 11 | reserved |

HC_MODE_TS: This 2-bit field indicates the TS header compression mode used by the associated DP when DP_PAYLOAD_TYPE is set to TS (‘00’). The HC_MODE_TS is signaled according to the below table 25.

TABLE 25

| Value | Header compression mode |
|---|---|
| 00 | HC_MODE_TS 1 |
| 01 | HC_MODE_TS 2 |
| 10 | HC_MODE_TS 3 |
| 11 | HC_MODE_TS 4 |

HC_MODE_IP: This 2-bit field indicates the IP header compression mode when DP_PAYLOAD_TYPE is set to IP (‘01’). The HC_MODE_IP is signaled according to the below table 26.

TABLE 26

| Value | Header compression mode |
|---|---|
| 00 | No compression |
| 01 | HC_MODE_IP 1 |
| 10~11 | reserved |

PID: This 13-bit field indicates the PID number for TS header compression when DP_PAYLOAD_TYPE is set to TS (‘00’) and HC_MODE_TS is set to ‘01’ or ‘10’.

RESERVED: This 8-bit field is reserved for future use.

The following field appears only if FIC_FLAG is equal to ‘1’:

FIC_VERSION: This 8-bit field indicates the version number of the FIC.

FIC_LENGTH_BYTE: This 13-bit field indicates the length, in bytes, of the FIC.

RESERVED: This 8-bit field is reserved for future use.

The following field appears only if AUX_FLAG is equal to ‘1’:

NUM_AUX: This 4-bit field indicates the number of auxiliary streams. Zero means no auxiliary streams are used.

AUX_CONFIG_RFU: This 8-bit field is reserved for future use.

AUX_STREAM_TYPE: This 4-bit is reserved for future use for indicating the type of the current auxiliary stream.

AUX_PRIVATE_CONFIG: This 28-bit field is reserved for future use for signaling auxiliary streams.

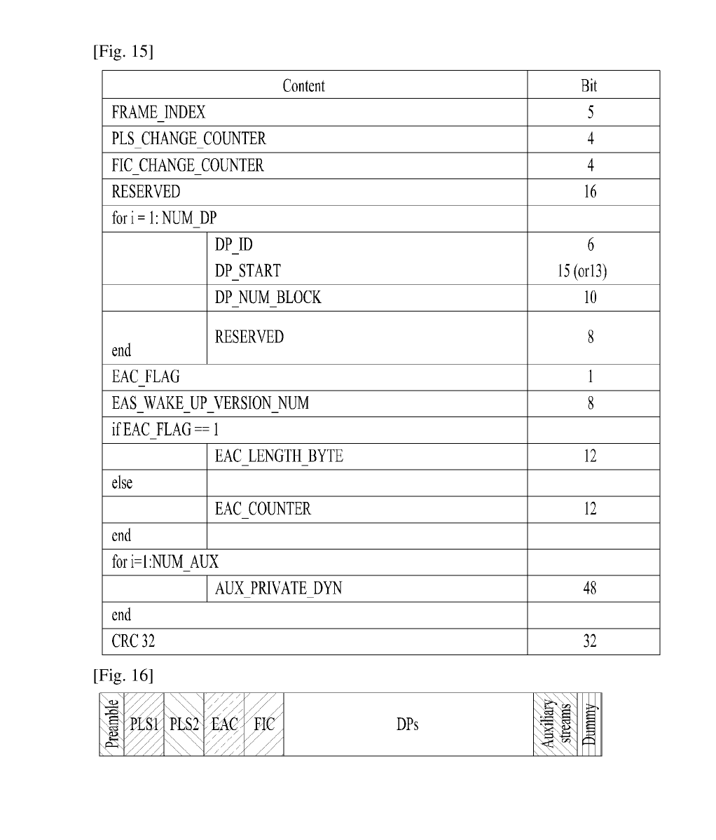

FIG. 15 illustrates PLS2 data according to another embodiment of the present invention.

FIG. 15 illustrates PLS2-DYN data of the PLS2 data. The values of the PLS2-DYN data may change during the duration of one frame-group, while the size of fields remains constant.

The details of fields of the PLS2-DYN data are as follows:

FRAME_INDEX: This 5-bit field indicates the frame index of the current frame within the super-frame. The index of the first frame of the super-frame is set to ‘0’.

PLS_CHANGE_COUNTER: This 4-bit field indicates the number of super-frames ahead where the configuration will change. The next super-frame with changes in the configuration is indicated by the value signaled within this field. If this field is set to the value ‘0000’, it means that no scheduled change is foreseen: e.g., value ‘1’ indicates that there is a change in the next super-frame.

FIC_CHANGE_COUNTER: This 4-bit field indicates the number of super-frames ahead where the configuration (i.e., the contents of the FIC) will change. The next super-frame with changes in the configuration is indicated by the value signaled within this field. If this field is set to the value ‘0000’, it means that no scheduled change is foreseen: e.g. value ‘0001’ indicates that there is a change in the next super-frame.

RESERVED: This 16-bit field is reserved for future use.

The following fields appear in the loop over NUM_DP, which describe the parameters associated with the DP carried in the current frame.

DP_ID: This 6-bit field indicates uniquely the DP within a PHY profile.

DP_START: This 15-bit (or 13-bit) field indicates the start position of the first of the DPs using the DPU addressing scheme. The DP_START field has differing length according to the PHY profile and FFT size as shown in the below table 27.

TABLE 27

| | DP_START field size | |
|---|---|---|
| PHY profile | 64K | 16K |
| Base | 13 bit | 15 bit |
| Handheld | — | 13 bit |
| Advanced | 13 bit | 15 bit |

DP_NUM_BLOCK: This 10-bit field indicates the number of FEC blocks in the current TI group for the current DP. The value of DP_NUM_BLOCK ranges from 0 to 1023

RESERVED: This 8-bit field is reserved for future use.

The following fields indicate the FIC parameters associated with the EAC.

EAC_FLAG: This 1-bit field indicates the existence of the EAC in the current frame. This bit is the same value as the EAC_FLAG in the preamble.

EAS_WAKE_UP_VERSION_NUM: This 8-bit field indicates the version number of a wake-up indication.

If the EAC_FLAG field is equal to ‘1’, the following 12 bits are allocated for EAC_LENGTH_BYTE field. If the EAC_FLAG field is equal to ‘0’, the following 12 bits are allocated for EAC_COUNTER.

EAC_LENGTH_BYTE: This 12-bit field indicates the length, in byte, of the EAC.

EAC_COUNTER: This 12-bit field indicates the number of the frames before the frame where the EAC arrives.

The following field appears only if the AUX_FLAG field is equal to ‘1’:

AUX_PRIVATE_DYN: This 48-bit field is reserved for future use for signaling auxiliary streams.

The meaning of this field depends on the value of AUX_STREAM_TYPE in the configurable PLS2-STAT.

CRC_32: A 32-bit error detection code, which is applied to the entire PLS2.

FIG. 16 illustrates a logical structure of a frame according to an embodiment of the present invention.

As above mentioned, the PLS, EAC, FIC, DPs, auxiliary streams and dummy cells are mapped into the active carriers of the OFDM symbols in the frame. The PLS1 and PLS2 are first mapped into one or more FSS(s). After that, EAC cells, if any, are mapped immediately following the PLS field, followed next by FIC cells, if any. The DPs are mapped next after the PLS or EAC, FIC, if any. Type 1 DPs follows first, and Type 2 DPs next. The details of a type of the DP will be described later. In some case, DPs may carry some special data for EAS or service signaling data. The auxiliary stream or streams, if any, follow the DPs, which in turn are followed by dummy cells. Mapping them all together in the above mentioned order, i.e. PLS, EAC, FIC, DPs, auxiliary streams and dummy data cells exactly fill the cell capacity in the frame.

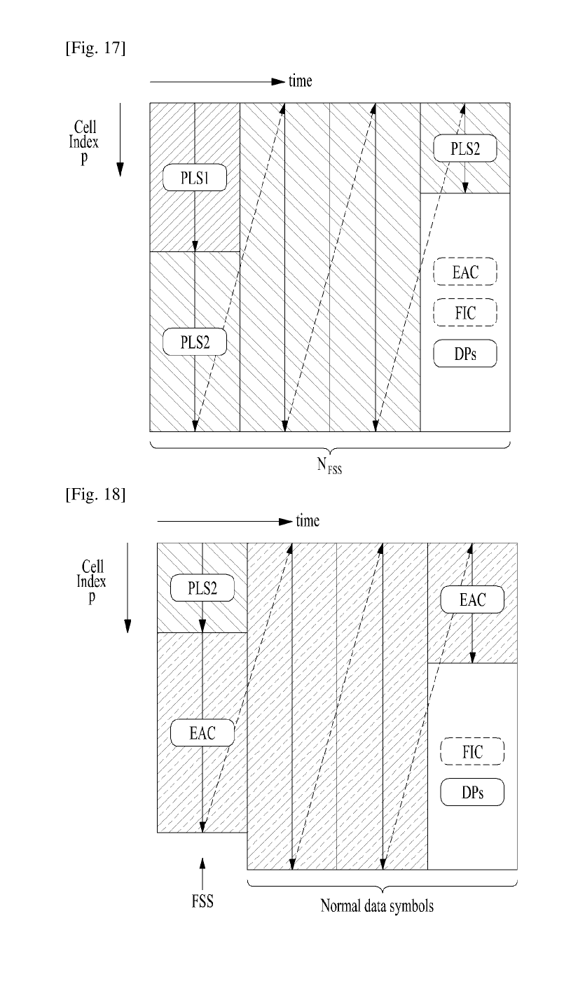

FIG. 17 illustrates PLS mapping according to an embodiment of the present invention.

PLS cells are mapped to the active carriers of FSS(s). Depending on the number of cells occupied by PLS, one or more symbols are designated as FSS(s), and the number of FSS(s) NFSS is signaled by NUM_FSS in PLS1. The FSS is a special symbol for carrying PLS cells. Since robustness and latency are critical issues in the PLS, the FSS(s) has higher density of pilots allowing fast synchronization and frequency-only interpolation within the FSS.

PLS cells are mapped to active carriers of the NFSS FSS(s) in a top-down manner as shown in an example in FIG. 17. The PLS1 cells are mapped first from the first cell of the first FSS in an increasing order of the cell index. The PLS2 cells follow immediately after the last cell of the PLS1 and mapping continues downward until the last cell index of the first FSS. If the total number of required PLS cells exceeds the number of active carriers of one FSS, mapping proceeds to the next FSS and continues in exactly the same manner as the first FSS.

After PLS mapping is completed, DPs are carried next. If EAC, FIC or both are present in the current frame, they are placed between PLS and “normal” DPs.

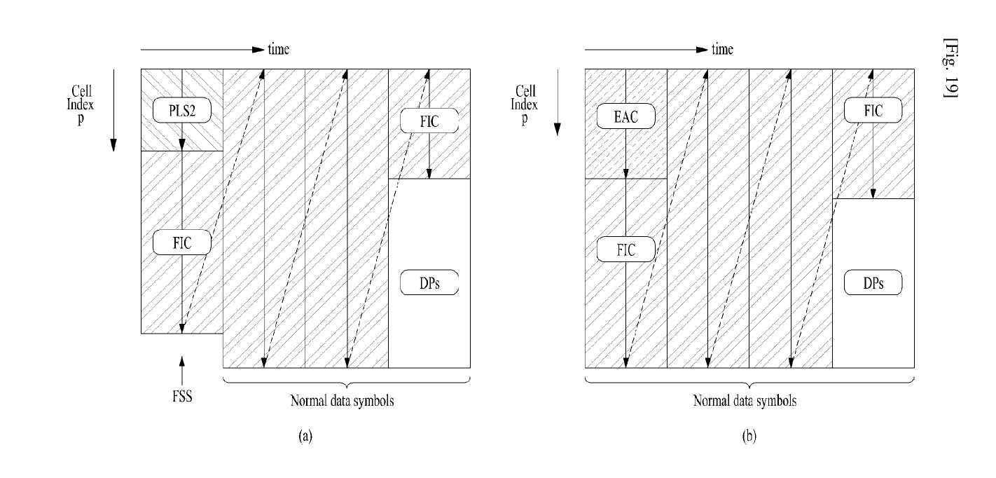

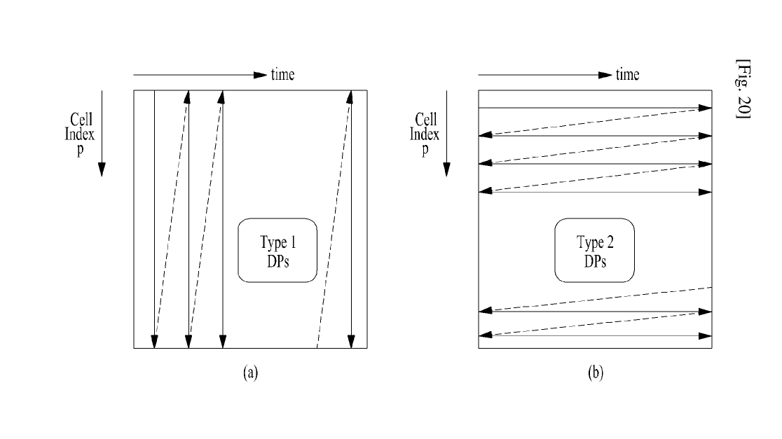

FIG. 18 illustrates EAC mapping according to an embodiment of the present invention.

EAC is a dedicated channel for carrying EAS messages and links to the DPs for EAS. EAS support is provided but EAC itself may or may not be present in every frame. EAC, if any, is mapped immediately after the PLS2 cells. EAC is not preceded by any of the FIC, DPs, auxiliary streams or dummy cells other than the PLS cells. The procedure of mapping the EAC cells is exactly the same as that of the PLS.

The EAC cells are mapped from the next cell of the PLS2 in increasing order of the cell index as shown in the example in FIG. 18. Depending on the EAS message size, EAC cells may occupy a few symbols, as shown in FIG. 18.

EAC cells follow immediately after the last cell of the PLS2, and mapping continues downward until the last cell index of the last FSS. If the total number of required EAC cells exceeds the number of remaining active carriers of the last FSS mapping proceeds to the next symbol and continues in exactly the same manner as FSS(s). The next symbol for mapping in this case is the normal data symbol, which has more active carriers than a FSS.

After EAC mapping is completed, the FIC is carried next, if any exists. If FIC is not transmitted (as signaled in the PLS2 field), DPs follow immediately after the last cell of the EAC.

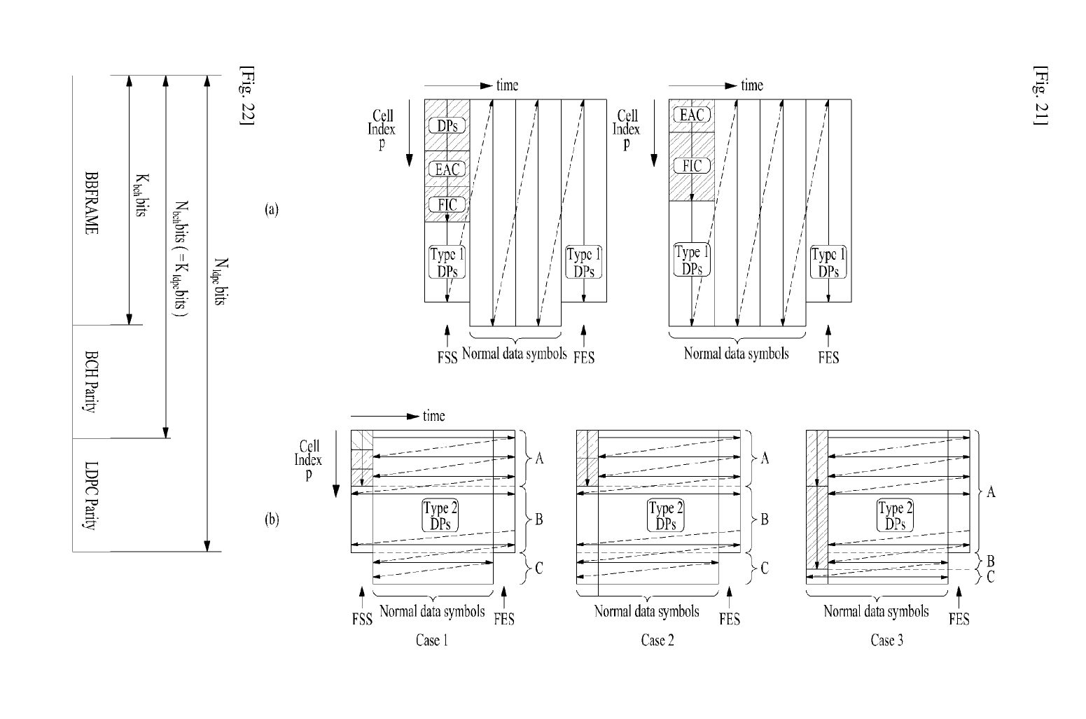

FIG. 19 illustrates FIC mapping according to an embodiment of the present invention. shows an example mapping of FIC cell without EAC and (b) shows an example mapping of FIC cell with EAC.

FIC is a dedicated channel for carrying cross-layer information to enable fast service acquisition and channel scanning. This information primarily includes channel binding information between DPs and the services of each broadcaster. For fast scan, a receiver can decode FIC and obtain information such as broadcaster ID, number of services, and BASE_DP_ID. For fast service acquisition, in addition to FIC, base DP can be decoded using BASE_DP_ID. Other than the content it carries, a base DP is encoded and mapped to a frame in exactly the same way as a normal DP. Therefore, no additional description is required for a base DP. The FIC data is generated and consumed in the Management Layer. The content of FIC data is as described in the Management Layer specification.

The FIC data is optional and the use of FIC is signaled by the FIC_FLAG parameter in the static part of the PLS2. If FIC is used, FIC_FLAG is set to ‘1’ and the signaling field for FIC is defined in the static part of PLS2. Signaled in this field are FIC_VERSION, and FIC_LENGTH_BYTE. FIC uses the same modulation, coding and time interleaving parameters as PLS2. FIC shares the same signaling parameters such as PLS2_MOD and PLS2_FEC. FIC data, if any, is mapped immediately after PLS2 or EAC if any. FIC is not preceded by any normal DPs, auxiliary streams or dummy cells. The method of mapping FIC cells is exactly the same as that of EAC which is again the same as PLS.

Without EAC after PLS, FIC cells are mapped from the next cell of the PLS2 in an increasing order of the cell index as shown in an example in (a). Depending on the FIC data size, FIC cells may be mapped over a few symbols, as shown in (b).

FIC cells follow immediately after the last cell of the PLS2, and mapping continues downward until the last cell index of the last FSS. If the total number of required FIC cells exceeds the number of remaining active carriers of the last FSS, mapping proceeds to the next symbol and continues in exactly the same manner as FSS(s). The next symbol for mapping in this case is the normal data symbol which has more active carriers than a FSS.

If EAS messages are transmitted in the current frame, EAC precedes FIC, and FIC cells are mapped from the next cell of the EAC in an increasing order of the cell index as shown in (b).

After FIC mapping is completed, one or more DPs are mapped, followed by auxiliary streams, if any, and dummy cells.

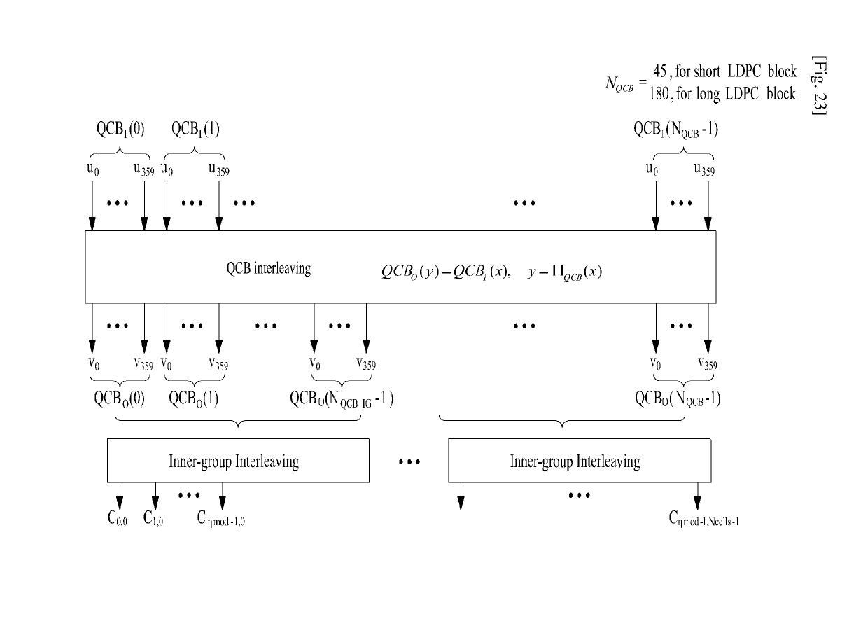

FIG. 20 illustrates a type of DP according to an embodiment of the present invention. shows type 1 DP and (b) shows type 2 DP.

After the preceding channels, i.e., PLS, EAC and FIC, are mapped, cells of the DPs are mapped. A DP is categorized into one of two types according to mapping method:

Type 1 DP: DP is mapped by TDM

Type 2 DP: DP is mapped by FDM

The type of DP is indicated by DP_TYPE field in the static part of PLS2. FIG. 20 illustrates the mapping orders of Type 1 DPs and Type 2 DPs. Type 1 DPs are first mapped in the increasing order of cell index, and then after reaching the last cell index, the symbol index is increased by one. Within the next symbol, the DP continues to be mapped in the increasing order of cell index starting from p=0. With a number of DPs mapped together in one frame, each of the Type 1 DPs are grouped in time, similar to TDM multiplexing of DPs.

Type 2 DPs are first mapped in the increasing order of symbol index, and then after reaching the last OFDM symbol of the frame, the cell index increases by one and the symbol index rolls back to the first available symbol and then increases from that symbol index. After mapping a number of DPs together in one frame, each of the Type 2 DPs are grouped in frequency together, similar to FDM multiplexing of DPs.

Type 1 DPs and Type 2 DPs can coexist in a frame if needed with one restriction; Type 1 DPs always precede Type 2 DPs. The total number of OFDM cells carrying Type 1 and Type 2 DPs cannot exceed the total number of OFDM cells available for transmission of DPs:

D_{DP1}+D_{DP2}≦D_{DP} [Math figure 2]

where DDP1 is the number of OFDM cells occupied by Type 1 DPs, DDP2 is the number of cells occupied by Type 2 DPs. Since PLS, EAC, FIC are all mapped in the same way as Type 1 DP, they all follow “Type 1 mapping rule”. Hence, overall, Type 1 mapping always precedes Type 2 mapping.

FIG. 21 illustrates DP mapping according to an embodiment of the present invention. shows an addressing of OFDM cells for mapping type 1 DPs and (b) shows an an addressing of OFDM cells for mapping for type 2 DPs.

Addressing of OFDM cells for mapping Type 1 DPs (0, . . . , DDP1-1) is defined for the active data cells of Type 1 DPs. The addressing scheme defines the order in which the cells from the TIs for each of the Type 1 DPs are allocated to the active data cells. It is also used to signal the locations of the DPs in the dynamic part of the PLS2.

Without EAC and FIC, address 0 refers to the cell immediately following the last cell carrying PLS in the last FSS. If EAC is transmitted and FIC is not in the corresponding frame, address 0 refers to the cell immediately following the last cell carrying EAC. If FIC is transmitted in the corresponding frame, address 0 refers to the cell immediately following the last cell carrying FIC. Address 0 for Type 1 DPs can be calculated considering two different cases as shown in (a). In the example in (a), PLS, EAC and FIC are assumed to be all transmitted. Extension to the cases where either or both of EAC and FIC are omitted is straightforward. If there are remaining cells in the FSS after mapping all the cells up to FIC as shown on the left side of (a).

Addressing of OFDM cells for mapping Type 2 DPs (0, . . . , DDP2-1) is defined for the active data cells of Type 2 DPs. The addressing scheme defines the order in which the cells from the TIs for each of the Type 2 DPs are allocated to the active data cells. It is also used to signal the locations of the DPs in the dynamic part of the PLS2.

Three slightly different cases are possible as shown in (b). For the first case shown on the left side of (b), cells in the last FSS are available for Type 2 DP mapping. For the second case shown in the middle, FIC occupies cells of a normal symbol, but the number of FIC cells on that symbol is not larger than CFSS. The third case, shown on the right side in (b), is the same as the second case except that the number of FIC cells mapped on that symbol exceeds CFSS.

The extension to the case where Type 1 DP(s) precede Type 2 DP(s) is straightforward since PLS, EAC and FIC follow the same “Type 1 mapping rule” as the Type 1 DP(s).

A data pipe unit (DPU) is a basic unit for allocating data cells to a DP in a frame.

A DPU is defined as a signaling unit for locating DPs in a frame. A Cell Mapper 7010 may map the cells produced by the TIs for each of the DPs. A Time interleaver 5050 outputs a series of TI-blocks and each TI-block comprises a variable number of XFECBLOCKs which is in turn composed of a set of cells. The number of cells in an XFECBLOCK, Ncells, is dependent on the FECBLOCK size, Nldpc, and the number of transmitted bits per constellation symbol. A DPU is defined as the greatest common divisor of all possible values of the number of cells in a XFECBLOCK, Ncells, supported in a given PHY profile. The length of a DPU in cells is defined as LDPU. Since each PHY profile supports different combinations of FECBLOCK size and a different number of bits per constellation symbol, LDPU is defined on a PHY profile basis.

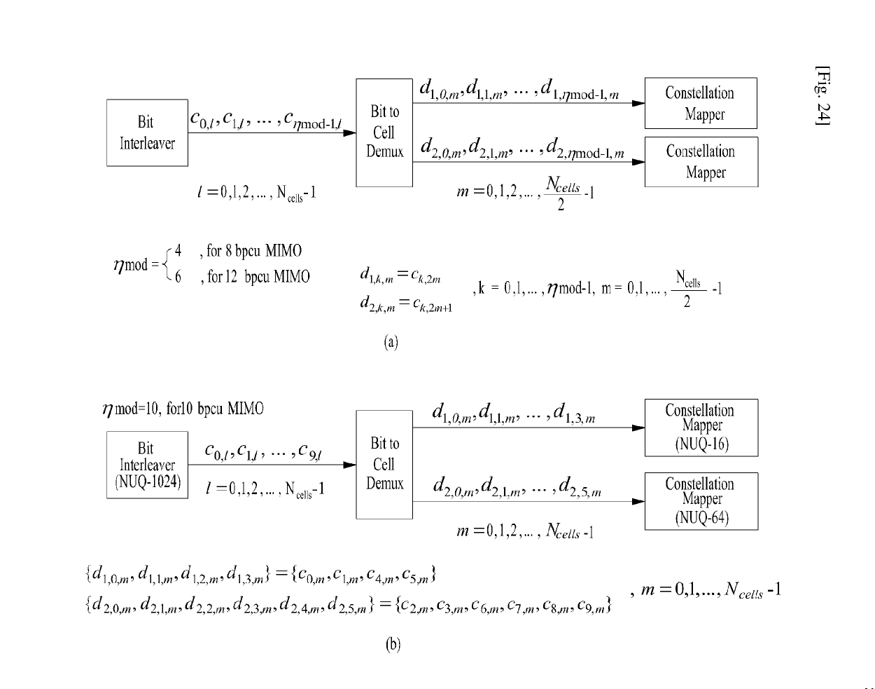

FIG. 22 illustrates an FEC structure according to an embodiment of the present invention.

FIG. 22 illustrates an FEC structure according to an embodiment of the present invention before bit interleaving. As above mentioned, Data FEC encoder may perform the FEC encoding on the input BBF to generate FECBLOCK procedure using outer coding (BCH), and inner coding (LDPC). The illustrated FEC structure corresponds to the FECBLOCK. Also, the FECBLOCK and the FEC structure have same value corresponding to a length of LDPC codeword.

The BCH encoding is applied to each BBF (Kbch bits), and then LDPC encoding is applied to BCH-encoded BBF (Kldpc bits=Nbch bits) as illustrated in FIG. 22.

The value of Nldpc is either 64800 bits (long FECBLOCK) or 16200 bits (short FECBLOCK).

The below table 28 and table 29 show FEC encoding parameters for a long FECBLOCK and a short FECBLOCK, respectively.

TABLE 28

| | | | | BCH error | |
|---|---|---|---|---|---|
| LDPC | | | | correction | |
| Rate | N_{ldpc} | K_{ldpc} | K_{bch} | capability | N_{bch}-K_{bch} |
| 5/15 | 64800 | 21600 | 21408 | 12 | 192 |
| 6/15 | | 25920 | 25728 | | |
| 7/15 | | 30240 | 30048 | | |
| 8/15 | | 34560 | 34368 | | |
| 9/15 | | 38880 | 38688 | | |
| 10/15 | | 43200 | 43008 | | |
| 11/15 | | 47520 | 47328 | | |
| 12/15 | | 51840 | 51648 | | |
| 13/15 | | 56160 | 55968 | | |

TABLE 29

| | | | | BCH error | |
|---|---|---|---|---|---|
| LDPC | | | | correction | |
| Rate | N_{ldpc} | K_{ldpc} | K_{bch} | capability | N_{bch}-K_{bch} |
| 5/15 | 16200 | 5400 | 5232 | 12 | 168 |
| 6/15 | | 6480 | 6312 | | |
| 7/15 | | 7560 | 7392 | | |
| 8/15 | | 8640 | 8472 | | |
| 9/15 | | 9720 | 9552 | | |
| 10/15 | | 10800 | 10632 | | |
| 11/15 | | 11880 | 11712 | | |
| 12/15 | | 12960 | 12792 | | |
| 13/15 | | 14040 | 13872 | | |

The details of operations of the BCH encoding and LDPC encoding are as follows:

A 12-error correcting BCH code is used for outer encoding of the BBF. The BCH generator polynomial for short FECBLOCK and long FECBLOCK are obtained by multiplying together all polynomials.

LDPC code is used to encode the output of the outer BCH encoding. To generate a completed Bldpc (FECBLOCK), Pldpc (parity bits) is encoded systematically from each Ildpc (BCH-encoded BBF), and appended to Ildpc. The completed Bldpc (FECBLOCK) are expressed as follow equation.

B_{ldpc}=[I_{ldpc} P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [equation 3]

The parameters for long FECBLOCK and short FECBLOCK are given in the above table 28 and 29, respectively.

The detailed procedure to calculate Nldpc−Kldpc parity bits for long FECBLOCK, is as follows:

1) Initialize the parity bits,

p₀=p₁=P₂= . . . =p_{N}_{_{ldpc}}_{-K}_{_{ldpc}}₋₁=0 [equation4]

2) Accumulate the first information bit—i0, at parity bit addresses specified in the first row of an addresses of parity check matrix. The details of addresses of parity check matrix will be described later. For example, for rate 13/15:

$$\begin{matrix}{p}_{983} = {p}_{983} ⊕ {i}_{0} & {p}_{2815} = {p}_{2815} ⊕ {i}_{0} \\ {p}_{4837} = {p}_{4837} ⊕ {i}_{0} & {p}_{4989} = {p}_{4989} ⊕ {i}_{0} \\ {p}_{6138} = {p}_{6138} ⊕ {i}_{0} & {p}_{6458} = {p}_{6458} ⊕ {i}_{0} \\ {p}_{6921} = {p}_{6921} ⊕ {i}_{0} & {p}_{6974} = {p}_{6974} ⊕ {i}_{0} \\ {p}_{7572} = {p}_{7572} ⊕ {i}_{0} & {p}_{8260} = {p}_{8260} ⊕ {i}_{0} \\ {p}_{8496} = {p}_{8496} ⊕ {i}_{0} & \end{matrix} \qquad [ equation 5 ]$$

3) For the next 359 information bits, is, s=1, 2, . . . , 359 accumulate is at parity bit addresses using following equation.

{x+(s mod 360)×Q_{ldpc}} mod(N_{ldpc}−K_{ldpc}) [equation 6]

where x denotes the address of the parity bit accumulator corresponding to the first bit i0, and Qldpc is a code rate dependent constant specified in the addresses of parity check matrix. Continuing with the example, Qldpc=24 for rate 13/15, so for information bit i1, the following operations are performed:

$$\begin{matrix}{p}_{1007} = {p}_{1007} ⊕ {i}_{1} & {p}_{2839} = {p}_{2839} ⊕ {i}_{1} \\ {p}_{4861} = {p}_{4861} ⊕ {i}_{1} & {p}_{5013} = {p}_{5013} ⊕ {i}_{1} \\ {p}_{6162} = {p}_{6162} ⊕ {i}_{1} & {p}_{6482} = {p}_{6482} ⊕ {i}_{1} \\ {p}_{6945} = {p}_{6945} ⊕ {i}_{1} & {p}_{6998} = {p}_{6998} ⊕ {i}_{1} \\ {p}_{7596} = {p}_{7596} ⊕ {i}_{1} & {p}_{8284} = {p}_{8284} ⊕ {i}_{1} \\ {p}_{8520} = {p}_{8520} ⊕ {i}_{1} & \end{matrix} \qquad [ equation 7 ]$$

4) For the 361st information bit i360, the addresses of the parity bit accumulators are given in the second row of the addresses of parity check matrix. In a similar manner the addresses of the parity bit accumulators for the following 359 information bits is, s=361, 362, . . . , 719 are obtained using the Math figure equation 6, where x denotes the address of the parity bit accumulator corresponding to the information bit i360, i.e., the entries in the second row of the addresses of parity check matrix.

5) In a similar manner, for every group of 360 new information bits, a new row from addresses of parity check matrixes used to find the addresses of the parity bit accumulators.

After all of the information bits are exhausted, the final parity bits are obtained as follows:

6) Sequentially perform the following operations starting with i=1

pᵢ=pᵢ□pᵢ₋₁, i=1,2, . . . ,N_{ldpc}−K_{ldpc}−1 [Math figure 8]

where final content of pi, i=0, 1, . . . Nldpc−Kldpc−1 is equal to the parity bit pi.

TABLE 30

| Code | |
|---|---|
| Rate | Q_{ldpc} |
| 5/15 | 120 |
| 6/15 | 108 |
| 7/15 | 96 |
| 8/15 | 84 |
| 9/15 | 72 |
| 10/15 | 60 |
| 11/15 | 48 |
| 12/15 | 36 |
| 13/15 | 24 |

This LDPC encoding procedure for a short FECBLOCK is in accordance with t LDPC encoding procedure for the long FECBLOCK, except replacing the table 30 with table 31, and replacing the addresses of parity check matrix for the long FECBLOCK with the addresses of parity check matrix for the short FECBLOCK.

TABLE 31

| Code Rate | Q_{ldpc} |
|---|---|
| 5/15 | 30 |
| 6/15 | 27 |
| 7/15 | 24 |
| 8/15 | 21 |
| 9/15 | 18 |
| 10/15 | 15 |
| 11/15 | 12 |
| 12/15 | 9 |
| 13/15 | 6 |

FIG. 23 illustrates a bit interleaving according to an embodiment of the present invention. The outputs of the LDPC encoder are bit-interleaved, which consists of parity interleaving followed by Quasi-Cyclic Block (QCB) interleaving and inner-group interleaving.

shows Quasi-Cyclic Block (QCB) interleaving and (b) shows inner-group interleaving.

The FECBLOCK may be parity interleaved. At the output of the parity interleaving, the LDPC codeword consists of 180 adjacent QC blocks in a long FECBLOCK and 45 adjacent QC blocks in a short FECBLOCK. Each QC block in either a long or short FECBLOCK consists of 360 bits. The parity interleaved LDPC codeword is interleaved by QCB interleaving. The unit of QCB interleaving is a QC block. The QC blocks at the output of parity interleaving are permutated by QCB interleaving as illustrated in FIG. 23, where Ncells=64800/η mod or 16200/η mod according to the FECBLOCK length. The QCB interleaving pattern is unique to each combination of modulation type and LDPC code rate.

After QCB interleaving, inner-group interleaving is performed according to modulation type and order (η mod) which is defined in the below table 32. The number of QC blocks for one inner-group, NQCB_IG, is also defined.

TABLE 32

| Modulation type | η_{mod} | N_{QCB}_IG |
|---|---|---|
| QAM-16 | 4 | 2 |
| NUC-16 | 4 | 4 |
| NUQ-64 | 6 | 3 |
| NUC-64 | 6 | 6 |
| NUQ-256 | 8 | 4 |
| NUC-256 | 8 | 8 |
| NUQ-1024 | 10 | 5 |
| NUC-1024 | 10 | 10 |

The inner-group interleaving process is performed with NQCB_IG QC blocks of the QCB interleaving output. Inner-group interleaving has a process of writing and reading the bits of the inner-group using 360 columns and NQCB_IG rows. In the write operation, the bits from the QCB interleaving output are written row-wise. The read operation is performed column-wise to read out m bits from each row, where m is equal to 1 for NUC and 2 for NUQ.

FIG. 24 illustrates a cell-word demultiplexing according to an embodiment of the present invention.

FIG. 24 shows a cell-word demultiplexing for 8 and 12 bpcu MIMO and (b) shows a cell-word demultiplexing for 10 bpcu MIMO.

Each cell word (c0,l, c1,l, . . . , cη mod−1,l) of the bit interleaving output is demultiplexed into (d1,0,m, d1,1,m . . . , d1,η mod−1,m) and (d2,0,m, d2,1,m . . . , d2,η mod−1,m) as shown in (a), which describes the cell-word demultiplexing process for one XFECBLOCK.

For the 10 bpcu MIMO case using different types of NUQ for MIMO encoding, the Bit Interleaver for NUQ-1024 is re-used. Each cell word (c0,l, c1,l, . . . , c9,l) of the Bit Interleaver output is demultiplexed into (d1,0,m, d1,1,m . . . , d1,3,m) and (d2,0,m, d2,1,m . . . , d2,5,m), as shown in (b).

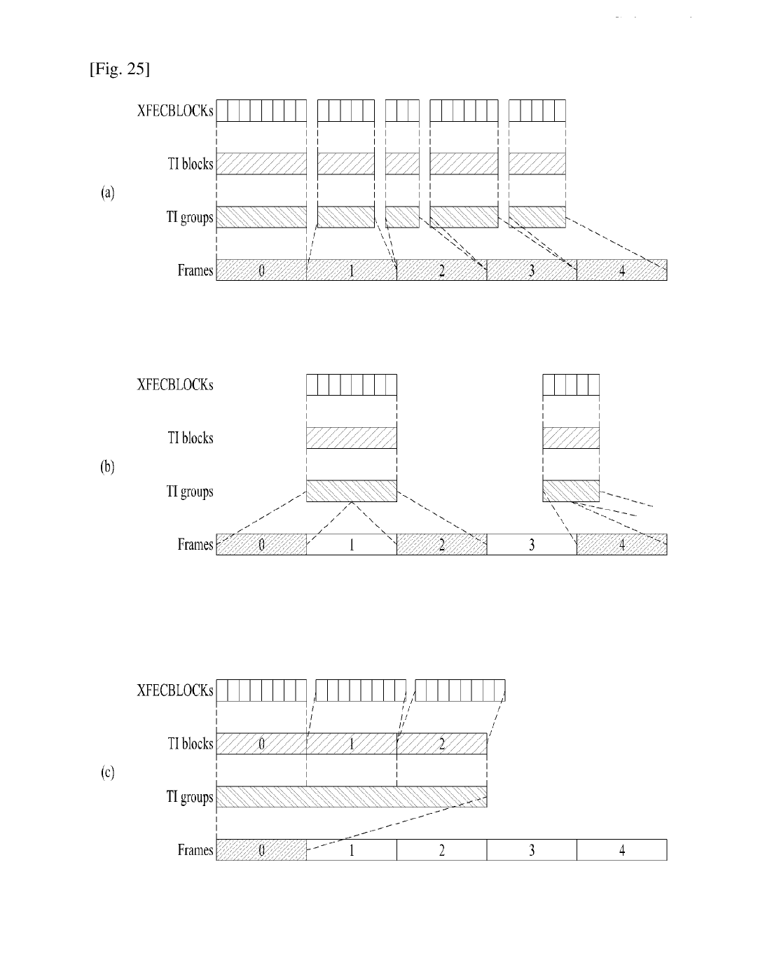

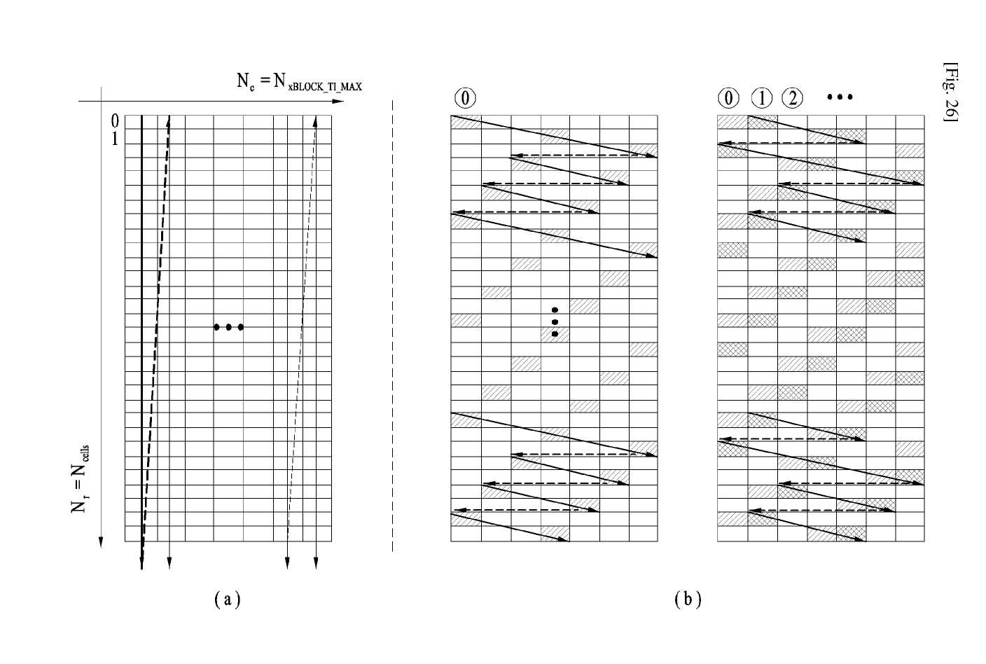

FIG. 25 illustrates a time interleaving according to an embodiment of the present invention. (a) to (c) show examples of TI mode.

The time interleaver operates at the DP level. The parameters of time interleaving (TI) may be set differently for each DP.

The following parameters, which appear in part of the PLS2-STAT data, configure the TI: DP_TI_TYPE (allowed values: 0 or 1): Represents the TI mode; ‘0’ indicates the mode with multiple TI blocks (more than one TI block) per TI group. In this case, one TI group is directly mapped to one frame (no inter-frame interleaving). ‘1’ indicates the mode with only one TI block per TI group. In this case, the TI block may be spread over more than one frame (inter-frame interleaving).

DP_TI_LENGTH: If DP_TI_TYPE=‘0’, this parameter is the number of TI blocks NTI per TI group. For DP_TI_TYPE=‘1’, this parameter is the number of frames PI spread from one TI group.

DP_NUM_BLOCK_MAX (allowed values: 0 to 1023): Represents the maximum number of XFECBLOCKs per TI group.

DP_FRAME_INTERVAL (allowed values: 1, 2, 4, 8): Represents the number of the frames IJUMP between two successive frames carrying the same DP of a given PHY profile.

DP_TI_BYPASS (allowed values: 0 or 1): If time interleaving is not used for a DP, this parameter is set to ‘1’. It is set to ‘0’ if time interleaving is used.

Additionally, the parameter DP_NUM_BLOCK from the PLS2-DYN data is used to represent the number of XFECBLOCKs carried by one TI group of the DP.

When time interleaving is not used for a DP, the following TI group, time interleaving operation, and TI mode are not considered. However, the Delay Compensation block for the dynamic configuration information from the scheduler will still be required. In each DP, the XFECBLOCKs received from the SSD/MIMO encoding are grouped into TI groups. That is, each TI group is a set of an integer number of XFECBLOCKs and will contain a dynamically variable number of XFECBLOCKs. The number of XFECBLOCKs in the TI group of index n is denoted by NxBLOCK_Group(n) and is signaled as DP_NUM_BLOCK in the PLS2-DYN data. Note that NxBLOCK_Group(n) may vary from the minimum value of 0 to the maximum value NxBLOCK_Group_MAX (corresponding to DP_NUM_BLOCK_MAX) of which the largest value is 1023.

Each TI group is either mapped directly onto one frame or spread over PI frames. Each TI group is also divided into more than one TI blocks(NTI), where each TI block corresponds to one usage of time interleaver memory. The TI blocks within the TI group may contain slightly different numbers of XFECBLOCKs. If the TI group is divided into multiple TI blocks, it is directly mapped to only one frame. There are three options for time interleaving (except the extra option of skipping the time interleaving) as shown in the below table 33.

TABLE 33

| Modes | Descriptions |
|---|---|
| Option-1 | Each TI group contains one TI block and is mapped directly to |
| | one frame as shown in (a). This option is signaled in the PLS2- |
| | STAT by DP_TI_TYPE = ‘0’ and |
| | DP_TI_LENGTH = ‘1’ (N_{TI} = 1). |
| Option-2 | Each TI group contains one TI block and is mapped to more |
| | than one frame. (b) shows an example, where one TI group is |
| | mapped to two frames, i.e., DP_TI_LENGTH = ‘2’ (P_{I} = 2) |
| | and DP_FRAME_INTERVAL (I_{JUMP} = 2). |
| | This provides greater time diversity for low data-rate services. |
| | This option is signaled in the PLS2-STAT by DP_TI_TYPE = ‘1’. |
| Option-3 | Each TI group is divided into multiple TI blocks and is mapped |
| | directly to one frame as shown in (c). Each TI block may use |
| | full TI memory, so as to provide the maximum bit-rate for a |
| | DP. This option is signaled in the PLS2-STAT signaling by |
| | DP_TI_TYPE = ‘0’ and DP_TI_LENGTH = N_{TI}, while P_{I} = 1. |

In each DP, the TI memory stores the input XFECBLOCKs (output XFECBLOCKs from the SSD/MIMO encoding block). Assume that input XFECBLOCKs are defined as

$$( {d}_{n , s , 0 , 0} , {d}_{n , s , 0 , 1} , … , {d}_{n , s , 0 , {N}_{cells} - 1} , {d}_{n , s , 1 , 0} , … , {d}_{n , s , 1 , {N}_{cells} - 1} , … , {d}_{n , s , {N}_{xBLOCK\_TI} ( n , s ) - 1 , 0} , … , {d}_{n , s , {N}_{xBLOCK\_TI} ( n , s ) - 1 , {N}_{cells} - 1} ) ,$$

where d_{n,s,r,q} is the qth cell of the rth XFECBLOCK in the sth TI block of the nth TI group and represents the outputs of SSD and MIMO encodings as follows

$${d}_{n , s , r , q} = \{ \begin{matrix}{f}_{n , s , r , q} , & the output of SSD … encoding \\ {g}_{n , s , r , q} . & the output of MIMO … encoding\end{matrix} .$$

In addition, assume that output XFECBLOCKs from the time interleaver 5050 are defined as

$$( {h}_{n , s , 0} , {h}_{n , s , 1} , … , {h}_{n , s , i} , … , {h}_{n , s , {N}_{xBLOCK\_TI} ( n , s ) \times {N}_{cells} - 1} ) ,$$

where is the h_{n,s,i} ith output cell (for i=0, . . . ,N_{xBLOCK}_{_}_{TI} (n,s)×N_{cells}−1) in the sth TI block of the nth TI group.

Typically, the time interleaver will also act as a buffer for DP data prior to the process of frame building. This is achieved by means of two memory banks for each DP. The first TI-block is written to the first bank. The second TI-block is written to the second bank while the first bank is being read from and so on.

The TI is a twisted row-column block interleaver. For the sth TI block of the nth TI group, the number of rows Nᵣ of a TI memory is equal to the number of cells N_{cells}, i.e., Nᵣ=N_{cells} while the number of columns N_{c} is equal to the number N_{xBLOCK}_{_}_{TI} (n,s).

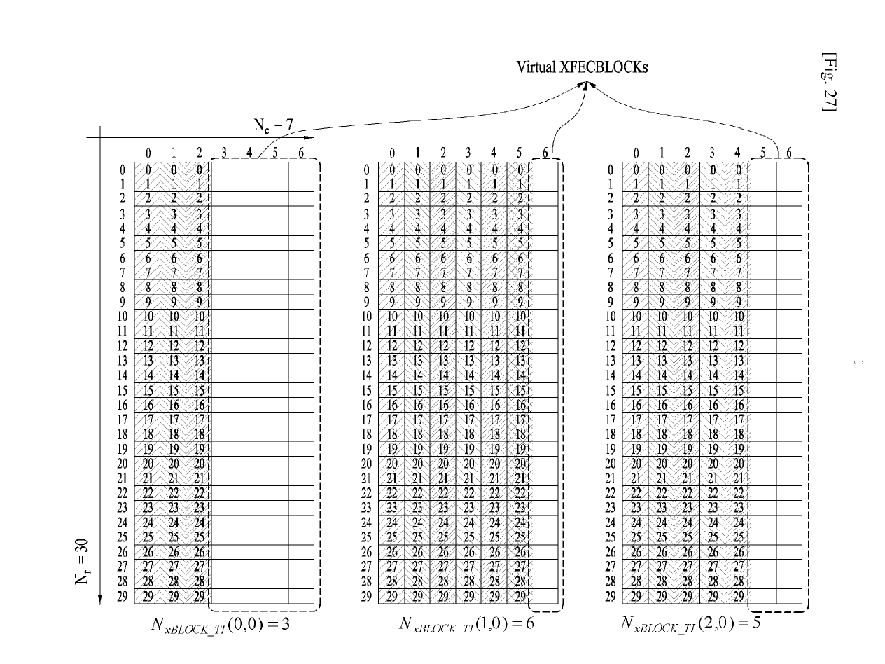

FIG. 26 illustrates the basic operation of a twisted row-column block interleaver according to an embodiment of the present invention.

FIG. 26 (a) shows a writing operation in the time interleaver and FIG. 26(b) shows a reading operation in the time interleaver The first XFECBLOCK is written column-wise into the first column of the TI memory, and the second XFECBLOCK is written into the next column, and so on as shown in (a). Then, in the interleaving array, cells are read out diagonal-wise. During diagonal-wise reading from the first row (rightwards along the row beginning with the left-most column) to the last row, Nᵣ cells are read out as shown in (b). In detail, assuming z_{n,s,i}(i=0 . . . ,NᵣN_{c}) as the TI memory cell position to be read sequentially, the reading process in such an interleaving array is performed by calculating the row index R_{n,s,i} the column index C_{n,s,i}, and the associated twisting parameter T_{n,s,i} as follows equation.

$$GENERATE ( {R}_{n , s , i} , {C}_{n , s , i} ) = \\ \{ \\ {R}_{n , s , i} = mod ( i , {N}_{r} ) , \\ {T}_{n , s , i} = mod ( {S}_{shift} \times {R}_{n , s , i} , {N}_{c} ) , \\ {C}_{n , s , i} = mod ( {T}_{n , s , i} + ⌊ \frac{i}{{N}_{r}} ⌋ , {N}_{c} ) \\ \} \qquad [ equation 9 ]$$

where S_{shift} is a common shift value for the diagonal-wise reading process regardless of N_{xBLOCk}_{_}_{TI}(n,s), and it is determined by N_{xBLOCk}_{_}_{TI}_{_}_{MAX} given in the PLS2-STAT as follows equation.

$$for \{ \begin{matrix}\begin{matrix}{N}_{xBLOCK\_TI \_MAX}^{′} = \\ {N}_{xBLOCK\_TI \_MAX} + 1 ,\end{matrix} & if {N}_{xBLOCK\_TI \_MAX} mod 2 = 0 \\ \begin{matrix}{N}_{xBLOCK\_TI \_MAX}^{′} = \\ {N}_{xBLOCK\_TI \_MAX} ,\end{matrix} & if {N}_{xBLOCK\_TI \_MAX} mod 2 = 1\end{matrix} , \\ {S}_{shift} = \frac{{N}_{xBLOCK\_TI \_MAX}^{′} - 1}{2} \qquad [ equation 10 ]$$

As a result, the cell positions to be read are calculated by a coordinate as Z_{n,s,i}=NᵣC_{n,s,i}+R_{n,s,i}.

FIG. 27 illustrates an operation of a twisted row-column block interleaver according to another embodiment of the present invention.

More specifically, FIG. 27 illustrates the interleaving array in the TI memory for each TI group, including virtual XFECBLOCKs when N_{xBLOCK}_{_}_{TI}(0,0)=3, N_{xBLOCK}_{_}_{TI}(1,0)=6, N_{xBLOCK}_{_}_{TI}(2,0)=5.

The variable number N_{xBLOCK}_{_}_{TI}(n,s)=Nᵣ will be less than or equal to N′_{xBLOCK}_{_}_{TI}_{_}_{MAX}. Thus, in order to achieve a single-memory deinterleaving at the receiver side, regardless of N_{xBLOCK}_{_}_{TI}(n,s), the interleaving array for use in a twisted row-column block interleaver is set to the size of Nᵣ×N_{c}=N_{cells}×N′_{xBLOCK TI MAX} by inserting the virtual XFECBLOCKs into the TI memory and the reading process is accomplished as follow equation.

[equation11]

p = 0;
for i = 0;i < N_{cells}N′_{xBLOCK}_{_{—}}_{TI}_{_{—}}_{MAX};i = i + l
{GENERATE(R_{n,s,i},C_{n,s,i});
Vᵢ = NᵣC_{n,s,j} + R_{n,s,j}

if Vᵢ < N_{cells}N′_{xBLOCK}_{_{—}}_{TI}(n,s)
{

Z_{n,s,p} = Vᵢ; p = p + l;
}

}

The number of TI groups is set to 3. The option of time interleaver is signaled in the PLS2-STAT data by DP_TI_TYPE=‘0’, DP_FRAME_INTERVAL=‘1’, and DP_TI_LENGTH=‘1’, i.e., NTI=1, IJUMP=1, and PI=1. The number of XFECBLOCKs, each of which has Ncells=30 cells, per TI group is signaled in the PLS2-DYN data by NxBLOCK_TI(0,0)=3, NxBLOCK_TI(1,0)=6, and NxBLOCK_TI(2,0)=5, respectively. The maximum number of XFECBLOCK is signaled in the PLS2-STAT data by NxBLOCK_Group_MAX, which leads to └N_{xBLOCK Group MAX}/N_{TI}┘=N_{xBLOCK TI MAX}=6.

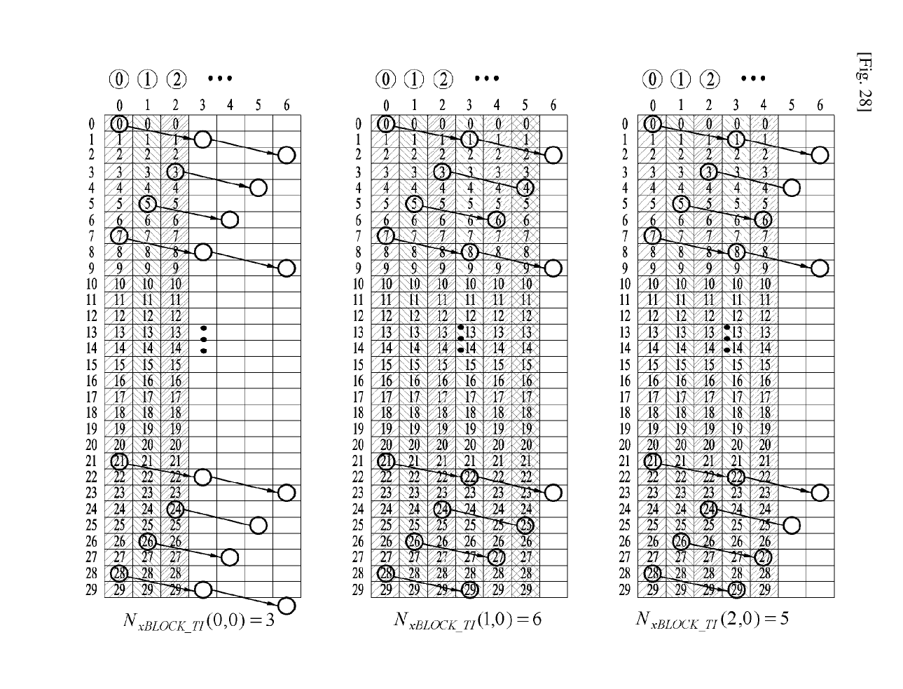

FIG. 28 illustrates a diagonal-wise reading pattern of a twisted row-column block interleaver according to an embodiment of the present invention.

More specifically FIG. 28 shows a diagonal-wise reading pattern from each interleaving array with parameters of N′_{xBLOCK}_{_}_{TI}_{_}_{MAX}=7 and Sshift=(7−1)/2=3. Note that in the reading process shown as pseudocode above, if Vᵢ≧N_{cells}N_{xBLOCK}_{_}_{TI}(n,s), the value of Vi is skipped and the next calculated value of Vi is used.

FIG. 29 illustrates interlaved XFECBLOCKs from each interleaving array according to an embodiment of the present invention.

FIG. 29 illustrates the interleaved XFECBLOCKs from each interleaving array with parameters of N′_{xBLOCK}_{_}_{TI}_{_}_{MAX}=7 and Sshift=3.

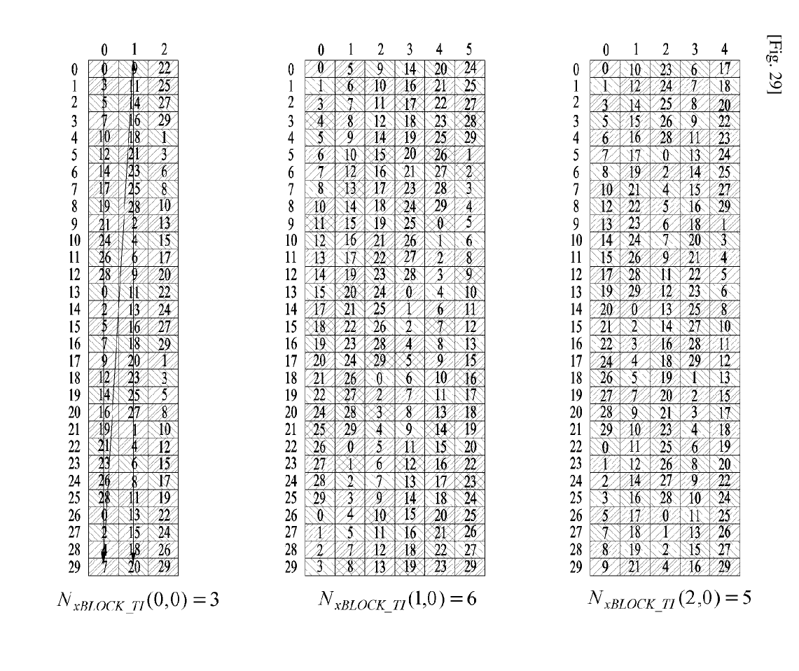

FIG. 30 is a view showing a protocol stack for a next generation broadcasting system according to an embodiment of the present invention.

The broadcasting system according to the present invention may correspond to a hybrid broadcasting system in which an Internet Protocol (IP) centric broadcast network and a broadband are coupled.

The broadcasting system according to the present invention may be designed to maintain compatibility with a conventional MPEG-2 based broadcasting system.

The broadcasting system according to the present invention may correspond to a hybrid broadcasting system based on coupling of an IP centric broadcast network, a broadband network, and/or a mobile communication network (or a cellular network).

Referring to the figure, a physical layer may use a physical protocol adopted in a broadcasting system, such as an ATSC system and/or a DVB system. For example, in the physical layer according to the present invention, a transmitter/receiver may transmit/receive a terrestrial broadcast signal and convert a transport frame including broadcast data into an appropriate form.

In an encapsulation layer, an IP datagram is acquired from information acquired from the physical layer or the acquired IP datagram is converted into a specific frame (for example, an RS Frame, GSE-lite, GSE, or a signal frame). The frame main include a set of IP datagrams. For example, in the encapsulation layer, the transmitter include data processed from the physical layer in a transport frame or the receiver extracts an MPEG-2 TS and an IP datagram from the transport frame acquired from the physical layer.

A fast information channel (FIC) includes information (for example, mapping information between a service ID and a frame) necessary to access a service and/or content. The FIC may be named a fast access channel (FAC).

The broadcasting system according to the present invention may use protocols, such as an Internet Protocol (IP), a User Datagram Protocol (UDP), a Transmission Control Protocol (TCP), an Asynchronous Layered Coding/Layered Coding Transport (ALC/LCT), a Rate Control Protocol/RTP Control Protocol (RCP/RTCP), a Hypertext Transfer Protocol (HTTP), and a File Delivery over Unidirectional Transport (FLUTE). A stack between these protocols may refer to the structure shown in the figure.

In the broadcasting system according to the present invention, data may be transported in the form of an ISO based media file format (ISOBMFF). An Electrical Service Guide (ESG), Non Real Time (NRT), Audio/Video (A/V), and/or general data may be transported in the form of the ISOBMFF.

Transport of data through a broadcast network may include transport of a linear content and/or transport of a non-linear content.

Transport of RTP/RTCP based A/V and data (closed caption, emergency alert message, etc.) may correspond to transport of a linear content.

An RTP payload may be transported in the form of an RTP/AV stream including a Network Abstraction Layer (NAL) and/or in a form encapsulated in an ISO based media file format. Transport of the RTP payload may correspond to transport of a linear content. Transport in the form encapsulated in the ISO based media file format may include an MPEG DASH media segment for A/V, etc.

Transport of a FLUTE based ESG, transport of non-timed data, transport of an NRT content may correspond to transport of a non-linear content. These may be transported in an MIME type file form and/or a form encapsulated in an ISO based media file format.

Transport in the form encapsulated in the ISO based media file format may include an MPEG DASH media segment for A/V, etc.

Transport through a broadband network may be divided into transport of a content and transport of signaling data.

Transport of the content includes transport of a linear content (A/V and data (closed caption, emergency alert message, etc.)), transport of a non-linear content (ESG, non-timed data, etc.), and transport of a MPEG DASH based Media segment (A/V and data).

Transport of the signaling data may be transport including a signaling table (including an MPD of MPEG DASH) transported through a broadcasting network.

In the broadcasting system according to the present invention, synchronization between linear/non-linear contents transported through the broadcasting network or synchronization between a content transported through the broadcasting network and a content transported through the broadband may be supported. For example, in a case in which one UD content is separately and simultaneously transported through the broadcasting network and the broadband, the receiver may adjust the timeline dependent upon a transport protocol and synchronize the content through the broadcasting network and the content through the broadband to reconfigure the contents as one UD content.

An applications layer of the broadcasting system according to the present invention may realize technical characteristics, such as Interactivity, Personalization, Second Screen, and automatic content recognition (ACR). These characteristics are important in extension from ATSC 2.0 to ATSC 3.0. For example, HTML5 may be used for a characteristic of interactivity.

In a presentation layer of the broadcasting system according to the present invention, HTML and/or HTML5 may be used to identify spatial and temporal relationships between components or interactive applications.

In the present invention, signaling includes signaling information necessary to support effective acquisition of a content and/or a service. Signaling data may be expressed in a binary or XMK form. The signaling data may be transmitted through the terrestrial broadcasting network or the broadband.

A real-time broadcast A/V content and/or data may be expressed in an ISO Base Media File Format, etc. In this case, the A/V content and/or data may be transmitted through the terrestrial broadcasting network in real time and may be transmitted based on IP/UDP/FLUTE in non-real time. Alternatively, the broadcast A/V content and/or data may be received by receiving or requesting a content in a streaming mode using Dynamic Adaptive Streaming over HTTP (DASH) through the Internet in real time. In the broadcasting system according to the embodiment of the present invention, the received broadcast A/V content and/or data may be combined to provide various enhanced services, such as an Interactive service and a second screen service, to a viewer.

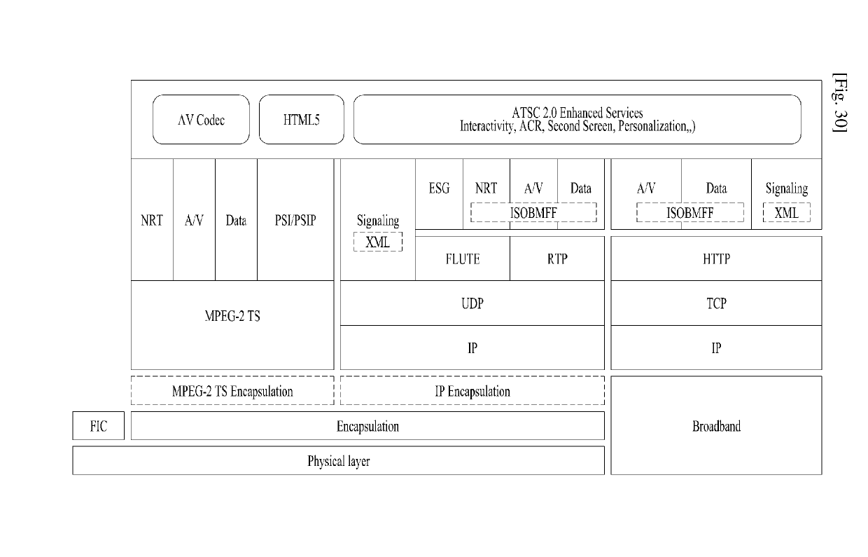

FIG. 31 is a view showing a broadcast receiver according to an embodiment of the present invention.

The broadcast receiver according to an embodiment of the present invention includes a service/content acquisition controller J2010, an Internet interface J2020, a broadcast interface J2030, a signaling decoder J2040, a service map database J2050, a decoder J2060, a targeting processor J2070, a processor J2080, a managing unit J2090, and/or a redistribution module J2100. In the figure is shown an external management device J2110 which may be located outside and/or in the broadcast receiver

The service/content acquisition controller J2010 receives a service and/or content and signaling data related thereto through a broadcast/broadband channel. Alternatively, the service/content acquisition controller J2010 may perform control for receiving a service and/or content and signaling data related thereto.

The Internet interface J2020 may include an Internet access control module. The Internet access control module receives a service, content, and/or signaling data through a broadband channel. Alternatively, the Internet access control module may control the operation of the receiver for acquiring a service, content, and/or signaling data.

The broadcast interface J2030 may include a physical layer module and/or a physical layer I/F module. The physical layer module receives a broadcast-related signal through a broadcast channel. The physical layer module processes (demodulates, decodes, etc.) the broadcast-related signal received through the broadcast channel. The physical layer I/F module acquires an Internet protocol (IP) datagram from information acquired from the physical layer module or performs conversion to a specific frame (for example, a broadcast frame, RS frame, or GSE) using the acquired IP datagram

The signaling decoder J2040 decodes signaling data or signaling information (hereinafter, referred to as ‘signaling data’) acquired through the broadcast channel, etc.

The service map database J2050 stores the decoded signaling data or signaling data processed by another device (for example, a signaling parser) of the receiver.

The decoder J2060 decodes a broadcast signal or data received by the receiver. The decoder J2060 may include a scheduled streaming decoder, a file decoder, a file database (DB), an on-demand streaming decoder, a component synchronizer, an alert signaling parser, a targeting signaling parser, a service signaling parser, and/or an application signaling parser.

The scheduled streaming decoder extracts audio/video data for real-time audio/video (A/V) from the IP datagram, etc. and decodes the extracted audio/video data.

The file decoder extracts file type data, such as NRT data and an application, from the IP datagram and decodes the extracted file type data.

The file DB stores the data extracted by the file decoder.

The on-demand streaming decoder extracts audio/video data for on-demand streaming from the IP datagram, etc. and decodes the extracted audio/video data.

The component synchronizer performs synchronization between elements constituting a content or between elements constituting a service based on the data decoded by the scheduled streaming decoder, the file decoder, and/or the on-demand streaming decoder to configure the content or the service.

The alert signaling parser extracts signaling information related to alerting from the IP datagram, etc. and parses the extracted signaling information.

The targeting signaling parser extracts signaling information related to service/content personalization or targeting from the IP datagram, etc. and parses the extracted signaling information. Targeting is an action for providing a content or service satisfying conditions of a specific viewer. In other words, targeting is an action for identifying a content or service satisfying conditions of a specific viewer and providing the identified content or service to the viewer.

The service signaling parser extracts signaling information related to service scan and/or a service/content from the IP datagram, etc. and parses the extracted signaling information. The signaling information related to the service/content includes broadcasting system information and/or broadcast signaling information.

The application signaling parser extracts signaling information related to acquisition of an application from the IP datagram, etc. and parses the extracted signaling information. The signaling information related to acquisition of the application may include a trigger, a TDO parameter table (TPT), and/or a TDO parameter element.

The targeting processor J2070 processes the information related to service/content targeting parsed by the targeting signaling parser

The processor J2080 performs a series of processes for displaying the received data. The processor J2080 may include an alert processor, an application processor, and/or an A/V processor.

The alert processor controls the receiver to acquire alert data through signaling information related to alerting and performs a process for displaying the alert data.

The application processor processes information related to an application and processes a state of an downloaded application and a display parameter related to the application.

The A/V processor performs an operation related to audio/video rendering based on decoded audio data, video data, and/or application data.

The managing unit J2090 includes a device manager and/or a data sharing & communication unit.

The device manager performs management for an external device, such as addition/deletion/renewal of an external device that can be interlocked, including connection and data exchange.

The data sharing & communication unit processes information related to data transport and exchange between the receiver and an external device (for example, a companion device) and performs an operation related thereto. The transportable and exchangeable data may be signaling data, a PDI table, PDI user data, PDI Q&A, and/or A/V data.

The redistribution module J2100 performs acquisition of information related to a service/content and/or service/content data in a case in which the receiver cannot directly receive a broadcast signal.

The external management device J2110 refers to modules, such as a broadcast service/content server, located outside the broadcast receiver for providing a broadcast service/content. A module functioning as the external management device may be provided in the broadcast receiver.

FIG. 32 is a view showing a transport frame according to an embodiment of the present invention.

The transport frame according to the embodiment of the present invention indicates a set of data transmitted from a physical layer.

The transport frame according to the embodiment of the present invention may include P1 data, L1 data, a common PLP, PLPn data, and/or auxiliary data. The common PLP may be named a common data unit.

The P1 data correspond to information used to detect a transport signal. The P1 data includes information for channel tuning. The P1 data may include information necessary to decode the L1 data. A receiver may decode the L1 data based on a parameter included in the P1 data.

The L1 data includes information regarding the structure of the PLP and configuration of the transport frame. The receiver may acquire PLPn (n being a natural number) or confirm configuration of the transport frame using the L1 data to extract necessary data.

The common PLP includes service information commonly applied to PLPn. The receiver may acquire information to be shared between PLPs through the common PLP. The common PLP may not be present according to the structure of the transport frame. The L1 data may include information for identifying whether the common PLP is included in the transport frame.

PLPn includes data for a content. A component, such as audio, video, and/or data, is transported to an interleaved PLP region consisting of PLP1 to PLPn. Information for identifying to which PLP a component constituting each service (channel) is transported may be included in the L1 data or the common PLP.

The auxiliary data may include data for a modulation scheme, a coding scheme, and/or a data processing scheme added to a next-generation broadcasting system. For example, the auxiliary data may include information for indentifying a newly defined data processing scheme. The auxiliary data may be used to extend the transport frame according to system which will be extended afterward.

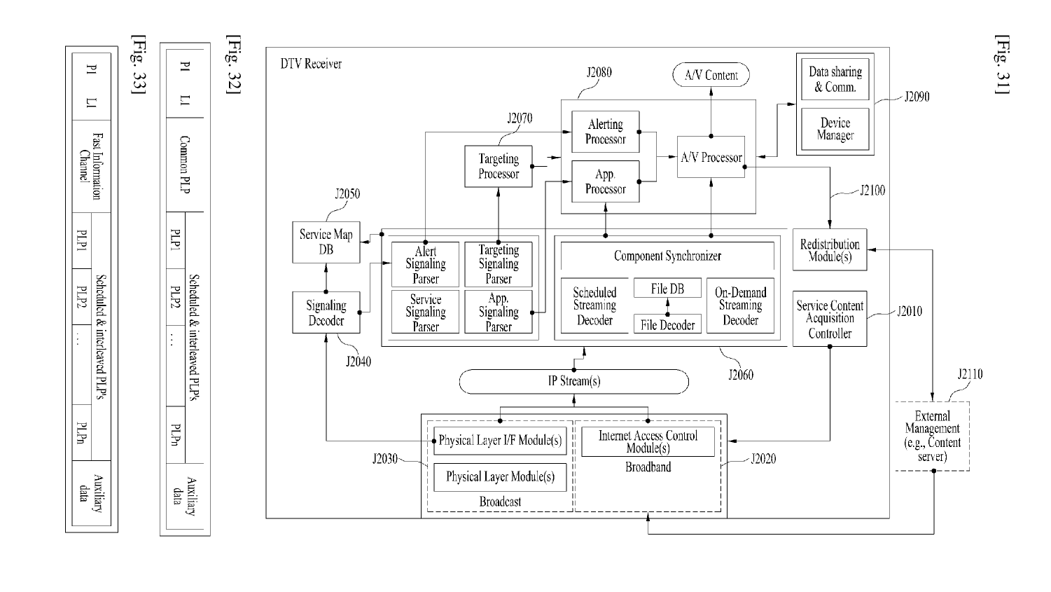

FIG. 33 is a view showing a transport frame according to another embodiment of the present invention.

The transport frame according to the embodiment of the present invention indicates a set of data transmitted from a physical layer.

The transport frame according to the embodiment of the present invention may include P1 data, L1 data, a fast information channel (FIC), PLPn data, and/or auxiliary data.

The P1 data correspond to information used to detect a transport signal. The P1 data includes information for channel tuning. The P1 data may include information necessary to decode the L1 data. A receiver may decode the L1 data based on a parameter included in the P1 data.

The L1 data includes information regarding the structure of the PLP and configuration of the transport frame. The receiver may acquire PLPn (n being a natural number) or confirm configuration of the transport frame using the L1 data to extract necessary data.

The fast information channel (FIC) may be defined as an additional channel, through which the receiver rapidly performs scanning of a broadcast service and content within a specific frequency. This channel may be defined as a physical or logical channel. Information related to a broadcast service may be transmitted/received through such a channel.

In this embodiment of the present invention, it is possible for the receiver to rapidly acquire a broadcast service and/or content included in the transport frame and information related thereto using the FIC. In addition, in a case in which services/contents produced by one or more broadcasting station are present in a corresponding transport frame, the receiver may recognize and process a service/content per broadcasting station using the FIC.

PLPn includes data for a content. A component, such as audio, video, and/or data, is transported to an interleaved PLP region consisting of PLP1 to PLPn. Information for identifying to which PLP a component constituting each service (channel) is transported may be included in the L1 data or a common PLP.

The auxiliary data may include data for a modulation scheme, a coding scheme, and/or a data processing scheme added to a next-generation broadcasting system. For example, the auxiliary data may include information for indentifying a newly defined data processing scheme. The auxiliary data may be used to extent the transport frame according to system which will be extended afterward.

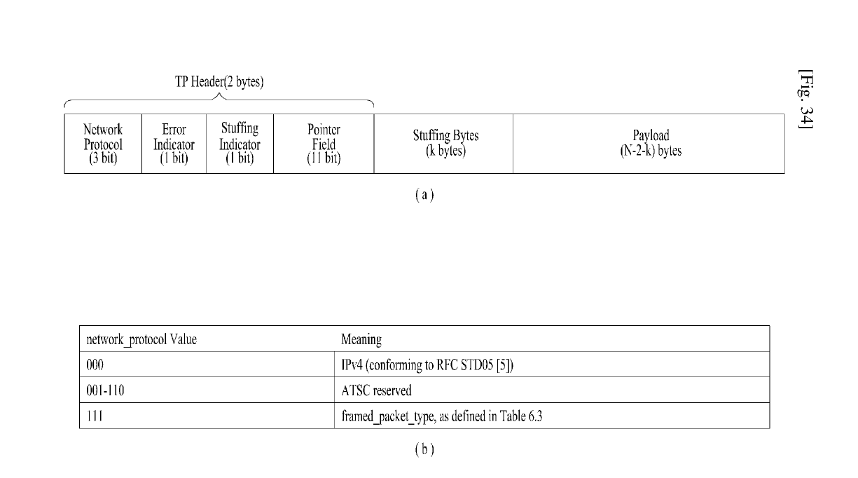

FIG. 34 is a view showing a transport packet (TP) and meaning of a network_protocol field of a broadcasting system according to an embodiment of the present invention.

The TP of the broadcasting system may include network_protocol information, error_indicator information, stuffing_indicator information, pointer_field information, stuffing_bytes information, and/or a payload.

The network_protocol information indicates which network protocol type the payload of the TP has as shown.

The error_indicator information is information for indicating that an error has been detected in a corresponding TP. For example, in a case in which a value of corresponding information is 0, it may indicate that no error has been detected. On the other hand, in a case in which a value of corresponding information is 1, it may indicate that an error has been detected.

The stuffing_indicator information indicates whether a stuffing byte is included in a corresponding TP. For example, in a case in which a value of corresponding information is 0, it may indicate that no stuffing byte is included. On the other hand, in a case in which a value of corresponding information is 1, it may indicate that a length field and a stuffing byte are included before the payload.

The pointer_field information indicates a start part of a new network protocol packet at a payload part of a corresponding TP. For example, corresponding information may have the maximum value (0x7FF) to indicate that there is no start part of a new network protocol packet. In a case in which the corresponding information has a different value, the value may correspond to an offset value from an end part of a header to a start part of a new network protocol packet.

The stuffing_bytes information is a value filling between the header and the payload when a value of the stuffing_indicator information is 1.

The payload of the TP may include an IP datagram. This type of IP datagram may be encapsulated and transported using generic stream encapsulation (GSE), etc. A transported specific IP datagram may include signaling information necessary for a receiver to scan a service/content and acquire the service/content.

FIG. 35 is a view showing a broadcasting server and a receiver according to an embodiment of the present invention.

The receiver according to the embodiment of the present invention includes a signaling parser J107020, an application manager J107030, a download manager J107060, a device storage J107070, and/or an application decoder J107080. The broadcasting server includes a content provider/broadcaster J107010 and/or an application service server J107050.

Each device included in the broadcasting server or the receiver may be embodied by hardware or software. In a case in which each device is embodied by hardware, the term ‘manager’ may be replaced with a term ‘processor’.

The content provider/broadcaster J107010 indicates a content provider or a broadcaster.

The signaling parser J107020 is a module for parsing a broadcast signal provided by the content provider or the broadcaster. The broadcast signal may include signaling data/element, broadcast content data, additional data related to broadcasting, and/or application data.

The application manager J107030 is a module for managing an application in a case in which the application is included in a broadcast signal. The application manager J107030 controls location, operation, and operation execution timing of an application using the above-described signaling information, signaling element, TPT, and/or trigger. The operation of the application may be activate (launch), suspend, resume, or terminate (exit).

The application service server J107050 is a server for providing an application. The application service server J107050 may be provided by the content provider or the broadcaster. In this case, the application service server J107050 may be included in the content provider/broadcaster J107010.

The download manager J107060 is a module for processing information related to an NRT content or an application provided by the content provider/broadcaster J107010 and/or the application service server J107050. The download manager J107060 acquires NRT-related signaling information included in a broadcast signal and extracts an NRT content included in the broadcast signal based on the signaling information. The download manager J107060 may receive and process an application provided by the application service server J107050.

The device storage J107070 may store the received broadcast signal, data, content, and/or signaling information (signaling element).

The application decoder J107080 may decode the received application and perform a process of expressing the application on the screen.

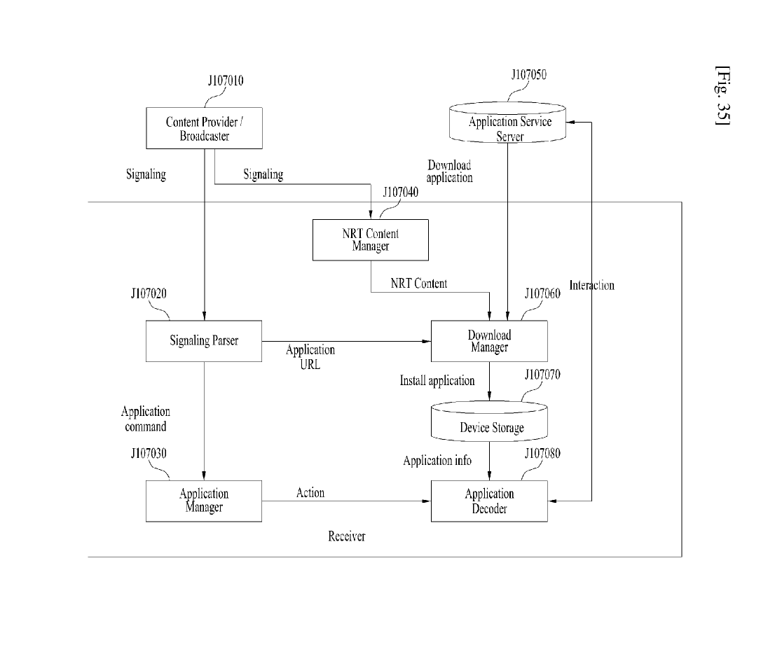

FIG. 36 shows, as an embodiment of the present invention, the different service types, along with the types of components contained in each type of service, and the adjunct service relationships among the service types.

Linear Services typically deliver TV and can also be used for services suitable for receiving devices that do not have video decoding/display capability (audio-only). A Linear Service has a single Time Base, and it can have zero or more Presentable Video Components, zero or more Presentable Audio Components, and zero or more Presentable CC Components. It can also have zero or more App-based Enhancements.

App class represents a Content Item (or Data item) for ATSC application. Relationships include: Sub-class relationship with Content Item (or Data item) class.

App-Based Enhancement class represents an App-Based Enhancement to a TV Service (or Linear Service). Attributes can include: Essential capabilities [0 . . . 1], Non-essential capabilities [0 . . . 1], Target device [0 . . . n]: Possible values include “Primary device”, “Companion device”.

Relationship can include: “Contains” relationship with App class, “Contains” relationship with Content Item(or Data Item) Component class, “Contains” relationship with Notification Stream class, and/or “Contains” relationship with OnDemand Component class.

Time base represents metadata used to establish a time line for synchronizing the components of a Linear Service. It can include below attributes.

Clock rate represents clock rate of this time base.

App-Based Service represents an App-Based Service. Relationship can include: “Contains” relationship with App-Based Enhancement class, and/or “Sub-class” relationship with Service class.

An App-Based Enhancement can include the following:

A Notification Stream, which delivers notifications of actions to be taken.

One or more applications (Apps).

Zero or more other Content Items (or Data item, NRT Content Items), which are used by the App(s).

Zero or more On Demand components, which are managed by the App(s).

Zero or one of the Apps in an App-Based Enhancement can be designated as the Primary App. If there is a designated Primary App, it is activated as soon as the Service to which it belongs is selected. Apps can also be activated by notifications in a Notification Stream, or one App can be activated by another App that is already active.

An App-Based Service is a service that contains one or more App-Based Enhancements. One App-Based Enhancement in an App-Based Service can contain a designated Primary App. An App-Based Service can optionally contain a Time Base.

An App is a special case of a Content Item (or Data item), namely a collection of files that together constitute an App.

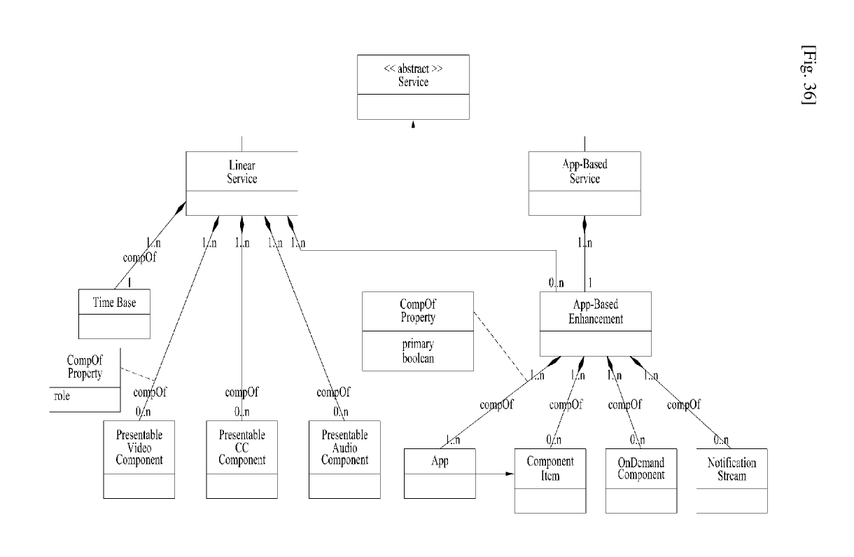

FIG. 37 shows, as an embodiment of the present invention, the containment relationship between the NRT Content Item class and the NRT File class.

An NRT Content Item contains one or more NRT Files, and an NRT File can belong to one or more NRT Content Items.

One way to look at these classes is that an NRT Content Item can be basically a presentable NRT file-based component—i.e., a set of NRT files that can be consumed without needing to be combined with other files—and an NRT file can be basically an elementary NRT file-based component—i.e., a component that is an atomic unit.

An NRT Content Item can contain Continuous Components or non-continuous components, or a combination of the two.

FIG. 38 is a table showing an attribute based on a service type and a component type according to an embodiment of the present invention.

An application (App) is a kind of NRT content item supporting interactivity. An attribute of the application may be provided by signaling data, such as TPT. The application has a sub class relationship with an NRT content item class. For example, an NRT content item may include one or more applications.

App-based enhancement is an improved event/content based on the application.

An attribute of the app-based enhancement may include the following.

Essential capabilities [0 . . . 1]—receiver capabilities needed for meaningful rendition of enhancement.

Non-essential capabilities [0 . . . 1]—receiver capabilities useful for optimal rendition of enhancement, but not absolutely necessary for meaningful rendition of enhancement.

Target device [0 . . . n]—for adjunct data services only Possible values.

The target device may be divided into a primary device and a companion device. The primary device may include a device, such as a TV receiver. The companion device may include a smart phone, a tablet PC, a laptop computer, and/or a small-sized monitor.

The app-based enhancement includes a relationship with an app class. This is for a relationship with an application included in the app-based enhancement.

The app-based enhancement includes a relationship with a relationship with an NRT content item class. This is for a relationship with an NRT content item used by an application included in the app-based enhancement.

The app-based enhancement includes a relationship with a relationship with a notification stream class. This is for a relationship with a notification stream transporting notifications for synchronization between the operation of an application and a basic linear time base.

The app-based enhancement includes a relationship with a relationship with an on-demand component class. This is for a relationship with a viewer-requested component to be managed by an application(s).

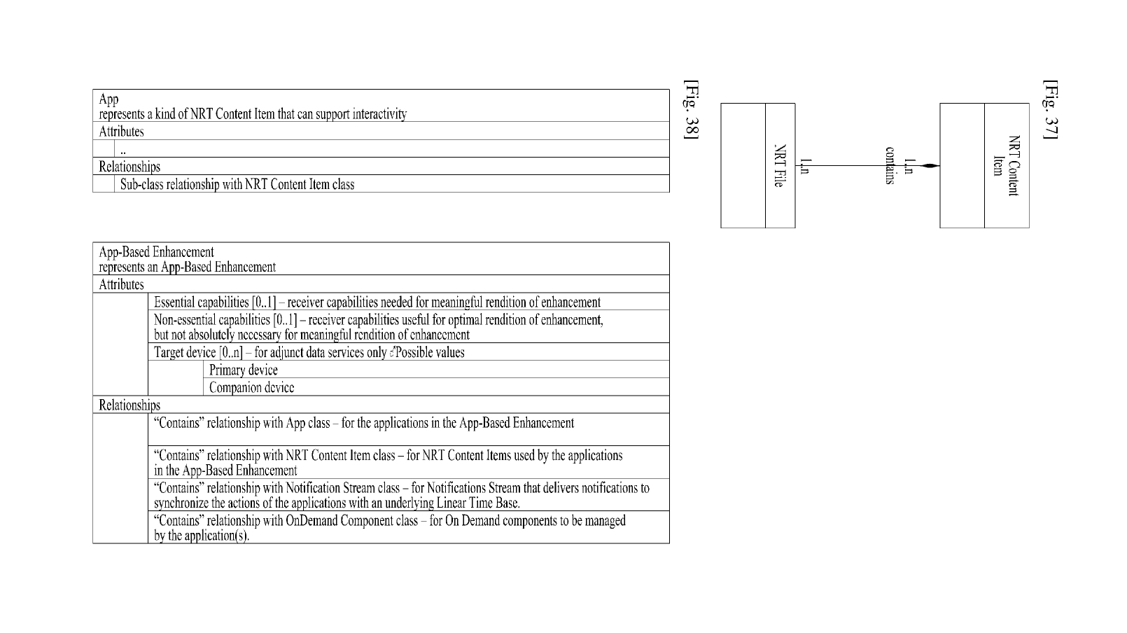

FIG. 39 shows, as an embodiment of the present inventions, another table describing the attributions of the service type and component type.

Time Base represents metadata used to establish a time line for synchronizing the components of a Linear Service.

The attribution of the Time Base may include Time Base ID and/or Clock Rate.

Time Base ID is an identifier of Time Base. Clock Rate corresponds to clock rate of the time base.

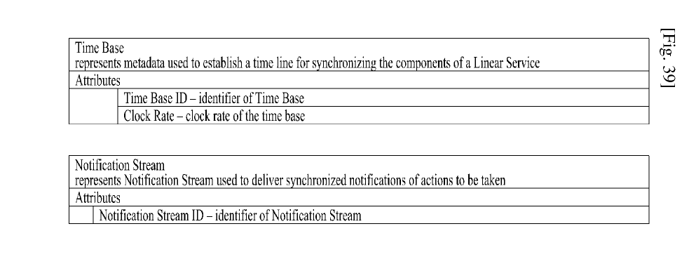

FIG. 40 shows, as an embodiment of the present inventions, another table describing the attributions of the service type and component type.

Linear Service represents a Linear Service.

Linear Service has Relationships containing a relationship with Presentable Video Component class of which attributes are roles of video component. The roles of video component may have possible values which represents either of Primary (default) video, Alternative camera view, Other alternative video component, Sign language (e.g., ASL) inset, or Follow subject video, with name of subject being followed, in the case when the follow-subject feature is supported by a separate video component.

The relationships of the Linear Service contain a relationship with Presentable Audio Component class, a relationship with Presentable CC Component class, a relationship with Time Base class, a relationship with App-Based Enhancement class, and/or a “Sub-class” relationship with Service class.

App-Based Service represents an App-Based Service.

App-Based Service has relationships containing a relationship with Time Base class, a relationship with App-Based Enhancement class, and/or a “Sub-class” relationship with Service class.

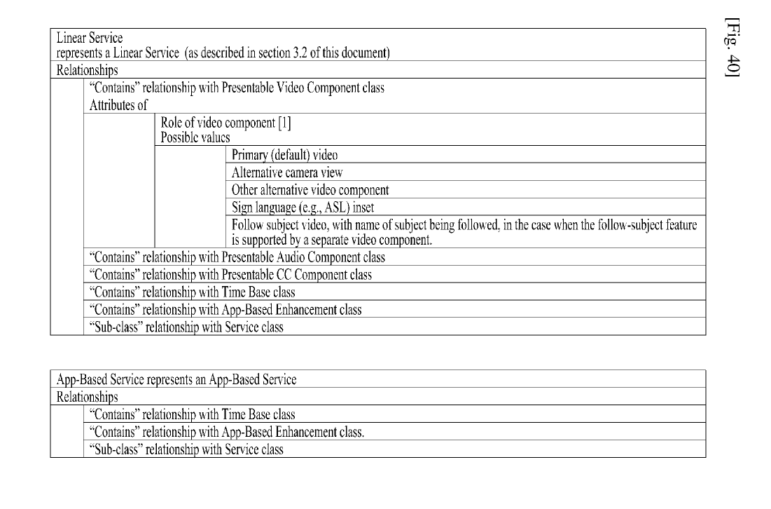

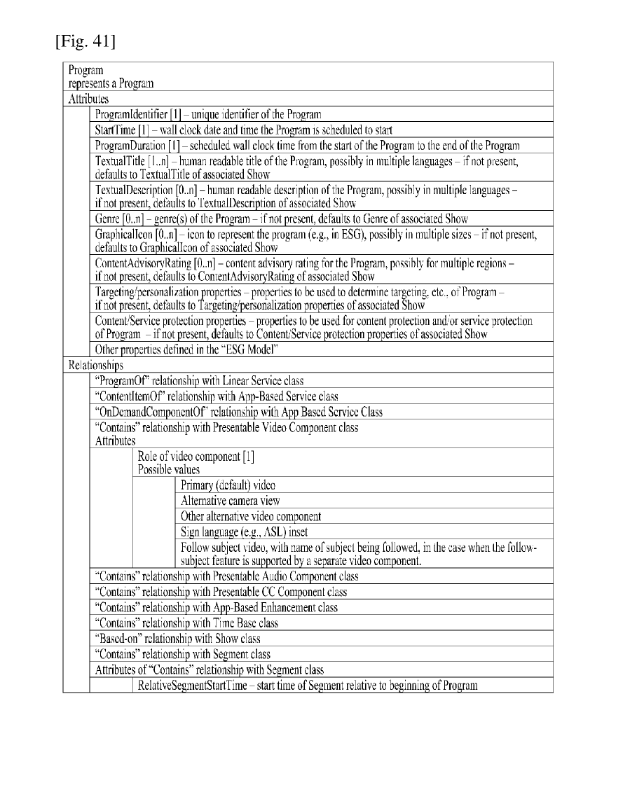

FIG. 41 shows, as an embodiment of the present inventions, another table describing the attributions of the service type and component type.

Program represents a Program.

The attributes of the Program include ProgramIdentifier, StartTime, ProgramDuration, TextualTitle, Textual Description, Genre, GraphicalIcon, ContentAdvisoryRating, Targeting/personalization properties, Content/Service protection properties, and/or other properties defined in the “ESG (Electronic Service Guide) Model”.

ProgramIdentifier [1] corresponds to a unique identifier of the Program.

StartTime [1] corresponds to an wall clock date and time the Program is scheduled to start.

ProgramDuration [1] corresponds to a scheduled wall clock time from the start of the Program to the end of the Program.

TextualTitle [1 . . . n] corresponds to a human readable title of the Program, possibly in multiple languages—if not present, defaults to TextualTitle of associated Show.

TextualDescription [0 . . . n] corresponds to a human readable description of the Program, possibly in multiple languages—if not present, defaults to TextualDescription of associated Show.

Genre [0 . . . n] corresponds to a genre(s) of the Program—if not present, defaults to Genre of associated Show.

GraphicalIcon [0 . . . n] corresponds to an icon to represent the program (e.g., in ESG), possibly in multiple sizes—if not present, defaults to GraphicalIcon of associated Show.

ContentAdvisoryRating [0 . . . n] corresponds to a content advisory rating for the Program, possibly for multiple regions—if not present, defaults to ContentAdvisoryRating of associated Show.

Targeting/personalization properties corresponds to properties to be used to determine targeting, etc., of Program—if not present, defaults to Targeting/personalization properties of associated Show.

Content/Service protection properties corresponds to properties to be used for content protection and/or service protection of Program—if not present, defaults to Content/Service protection properties of associated Show.

The Program may have relationships including: “ProgramOf” relationship with Linear Service class, “ContentItemOf” relationship with App-Based Service class, “OnDemandComponentOf” relationship with App Based Service Class, “Contains” relationship with Presentable Video Component class, “Contains” relationship with Presentable Audio Component class, “Contains” relationship with Presentable CC Component class, “Contains” relationship with App-Based Enhancement class, “Contains” relationship with Time Base class, “Based-on” relationship with Show class, and/or “Contains” relationship with Segment class.

“Contains” relationship with Presentable Video Component class may have attributes including Role of video component of which possible value indicate either Primary (default) video, Alternative camera view, Other alternative video component, Sign language (e.g., ASL) inset, and/or Follow subject video, with name of subject being followed, in the case when the follow-subject feature is supported by a separate video component.

Attributes of “Contains” relationship with Segment class may have RelativeSegmentStartTime specifying a start time of Segment relative to beginning of Program.

An NRT Content Item Component can be have the same structure as a Program, but delivered in the form of a file, rather than in streaming form. Such a Program can have an adjunct data service, such as an interactive service, associated with it.

FIG. 42 shows, as an embodiment of the present inventions, definitions for ContentItem and OnDemand Content.

Future hybrid broadcasting systems may have Linear Service and/or App-based Service for types of services. Where a Linear Service consists of continuous components presented according to a schedule and time base defined in the broadcast, and a Linear Service can also have triggered app enhancements.

The following types of services are defined, with their currently defined presentable Content Components as indicated. Other service types and components could be defined.

Linear Service is a service where the primary content consists of Continuous Components that are consumed according to a schedule and time base defined by the broadcast (except that various types of time-shifted viewing mechanisms can be used by consumers to shift the consumption times). Service components include:
Zero or more video components
Zero or more audio components
Zero or more closed caption components
Time base that is used to synchronize the components
Zero or more triggered, app-based enhancements, and/or
Zero or more auto-launch app-based enhancements.

For Zero or more triggered, app-based enhancements, each enhancement consisting of applications that are launched and caused to carry out actions in a synchronized fashion according to activation notifications delivered as part of the service. The Enhancement components can include:
A stream of activation notifications
One or more applications that are the targets of the notifications
Zero or more Content Items, and/or
Zero or more On Demand components

Optionally, one of the Apps can be designated as the “Primary App.” If there is a designated Primary App, it can be activated as soon as the underlying service is selected. Other Apps can be activated by notifications in the notification stream, or an App can be activated by another App that is already active.

For Zero or more auto-launch app-based enhancements, each enhancement consisting of an app that is launched automatically when the service is selected. Enhancement components can include:
An application that is auto-launched
A stream of zero or more activation notifications, and/or
Zero or more Content Items.

Here, a linear service can have both auto-launched app-based enhancements and triggered app-based enhancements, for example, an auto-launched app-based enhancement to do targeted ad (advertisement) insertion and a triggered app-based enhancement to provide an interactive viewing experience.

App-based Service is a service where a designated application is launched whenever the service is selected. It can consist of one App-Based enhancement, with the restriction that the App-Based enhancement in an App-Based Service contains a designated Primary App.

An App can be a special case of a Content Item, namely a collection of files that together constitute an App Service components can be shared among multiple services.

Applications in App-based Services can initiate the presentation of OnDemand content.

There are some approaches about merging the notion of an auto-launched app-based service with packaged apps. These would presumably appear in the service guide in some form. A future TV set can have following features:

A user could select an auto-launched app-based service in the service guide and designate it as a “favorite” service, or “acquire” it or something like that. This would cause the app that forms the basis of the service to be downloaded and installed on the TV set. The user would then be able to ask to view the “favorite” or “acquired” apps, and would get a display something like one gets on a smart phone, showing all the downloaded and installed apps. The user could then select any of them for execution. The effect of this would be that the service guide acts kind of like an app store.

And/or there can be an API that allows any app to identify an auto-launched app-based service as a “favorite”/“acquired” service. (The implementation of such an API can include an “Are You Sure” query to the user, to make sure a rogue app is not doing this behind the user's back.) This would have the same effect as installing a “packaged app”.

Each Service may include Content Item (which corresponds to a content). The Content Item is a collection of one or more files that is intended to be consumed as an integrated whole. The OnDemand Content is a content that is presented at times selected by viewers (typically via user interfaces provided by applications)—such content could consist of continuous content (e.g., audio/video) or non-continuous content (e.g., HTML pages or images).

FIG. 43 shows, as an embodiment of the present inventions, an example of Complex Audio Component.

A presentable audio component could be a PickOne Component that contains a complete main component and a component that contains music, dialog and effects tracks that are to be mixed. The complete main audio component and the music component could be PickOne Components that contain Elementary Components consisting of encodings at different bitrates, while the dialog and effects components could be Elementary Components.

This approach gives a much clearer picture of what a Service is all about to list only the Presentable Components of a Service directly, and then to list the member components of any Complex Components hierarchically.

To bound the possible unbounded recursion of the component model, the following restriction can be imposed: Any Continuous Component can fit into a three level hierarchy, where the top level consists of PickOne Components, the middle level consists of Composite Components, and the bottom level consists of PickOne Components. Any particular Continuous Component can contain all three levels or any subset thereof, including the null subset where the Continuous Component is simply an Elementary Component.

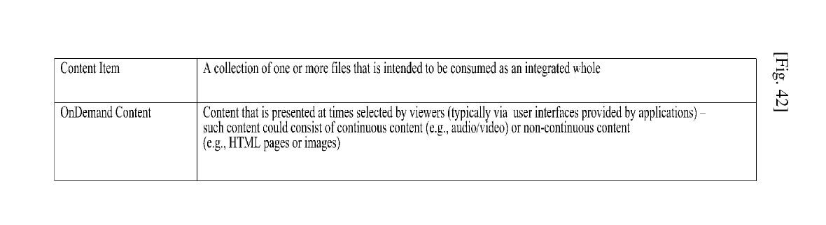

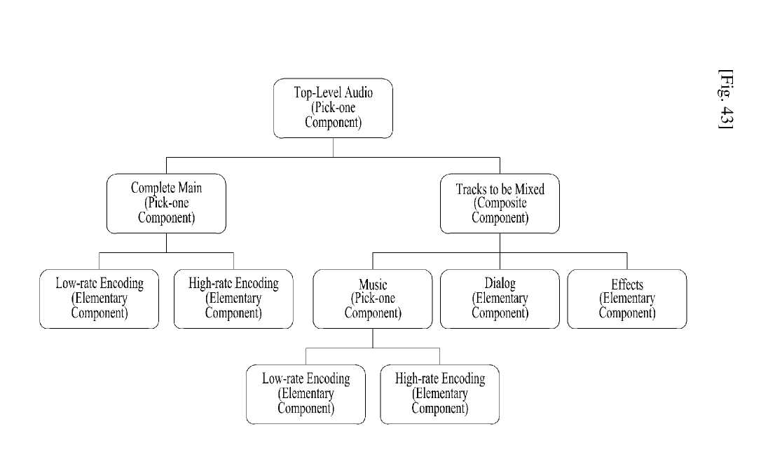

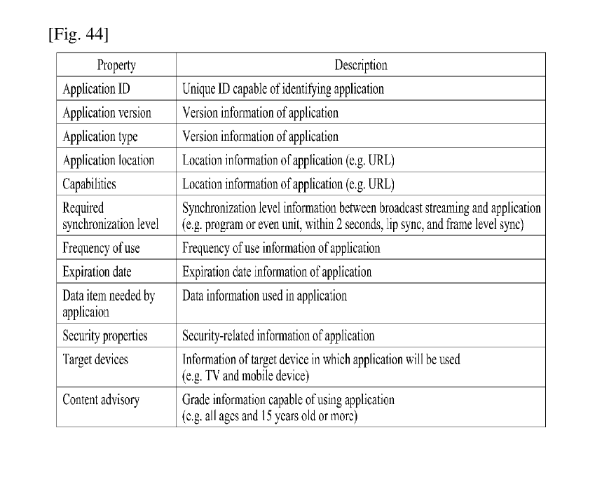

FIG. 44 is a view showing attribute information related to an application according to an embodiment of the present invention.

The attribute information related to the application may include content advisory information.

The attribute information related to the application, which may be added according to the embodiment of the present invention, may include application ID information, application version information, application type information, application location information, capabilities information, required synchronization level information, frequency of use information, expiration date information, data item needed by application information, security properties information, target devices information, and/or content advisory information.

The application ID information indicates a unique ID that is capable of identifying an application.

The application version information indicates version of an application.

The application type information indicates type of an application.

The application location information indicates location of an application. For example, the application location information may include URL that is capable of receiving an application.

The capabilities information indicates a capability attribute that is capable of rendering an application.

The required synchronization level information indicates synchronization level information between a broadcast streaming and an application. For example, the required synchronization level information may indicate a program or even unit, a time unit (for example, within 2 seconds), lip sync, and/or frame level sync.

The frequency of use information indicates a frequency of use of an application.

The expiration date information indicates expiration date and time of an application.

The data item needed by application information indicates data information used in an application.

The security properties information indicates security-related information of an application.

The target devices information indicates information of a target device in which an application will be used. For example, the target devices information may indicate that a target device in which a corresponding application is used is a TV and/or a mobile device.

The content advisory information indicates a level that is capable of using an application. For example, the content advisory information may include age limit information that is capable of using an application.

FIG. 45 is a view showing a procedure for broadcast personalization according to an embodiment of the present invention.

As previously described, a receiver may control notification of an application. However, a case in which the receiver does not or cannot control notification of an application may be considered. In this case, a user may perform opt-in/out setting per application.

In this case, a PDI (profiles, demographics, and interests) table may be used. In the broadcasting system according to the embodiment of the present invention, a broadcast content and application personalized per profile, area, and/or interest may be shown to a user using the PDI table for personalization setting. Opt-in/out setting per application may be performed using the PDI table for personalization. The opt-in is a scheme in which, only in a case in which a user sets notification of a specific application to be received, the corresponding notification is display-processed by the receiver. On the other hand, the opt-out is a scheme in which, in a case in which a user does not set the reception of notification of a specific application to be refused, the corresponding notification is received and processed.

The figure illustrates a personalization broadcast system including a digital broadcast receiver (or a receiver) for a personalization service. The personalization service according to the present embodiment is a service for selecting and supplying content appropriate for a user based on user information. In addition, the personalization broadcast system according to the present embodiment may provide a next generation broadcast service for providing a broadcast service or a personalization service.

According to an embodiment of the present invention, as an example of the user information, user's profiles, and demographics and interests information (or PDI data) are defined. Hereinafter, elements of the personalization broadcast system will be described.

The answers to the questionnaires, taken together, represent the user's Profile, Demographics, and Interests (PDI). The data structure that encapsulates the questionnaire and the answers given by a particular user is called a PDI Questionnaire or a PDI Table. A PDI Table, as provided by a network, broadcaster or content provider, includes no answer data, although the data structure accommodates the answers once they are available. The question portion of an entry in a PDI Table is informally called a “PDI Question” or “PDI-Q.” The answer to a given PDI question is referred to informally as a “PDI-A.” A set of filter criteria is informally called a “PDI-FC.”

The client device such as an ATSC 2.0-capable receiver includes a function allowing the creation of answers to the questions in the questionnaire (PDI-A instances). This PDI-generation function uses PDI-Q instances as input and produces PDI-A instances as output. Both PDI-Q and PDI-A instances are saved in non-volatile storage in the receiver. The client also provides a filtering function in which it compares PDI-A instances against PDI-FC instances to determine which content items will be suitable for downloading and use.

On the service provider side as shown, a function is implemented to maintain and distribute the PDI Table. Along with content, content metadata are created. Among the metadata are PDI-FC instances, which are based on the questions in the PDI Table.

The personalization broadcast system may include a content provider (or broadcaster) J16070 and/or a receiver J16010. The receiver J16010 according to the present embodiment may include a PDI engine (not depicted), a filtering engine J16020, a PDI store J16030, a content store J16040, a declarative content module J16050, and/or a PDI Manipulation application J16060. The receiver J16010 according to the present embodiment may receive content, etc. from the content provider J16070. The structure of the aforementioned personalization broadcast system may be changed according to a designer's intention.

The content provider J16070 according to the present embodiment may transmit content, PDI questionnaire, and/or filtering criteria to the receiver J16010. The data structure that encapsulates the questionnaire and the answers given by a particular user is called a PDI questionnaire. According to an embodiment of the present invention, the PDI questionnaire may include questions (or PDI questions) related to profiles, demographics and interests, etc. of a user.

The receiver J16010 may process the content, the PDI questionnaire, and/or the filtering criteria, which are received from the content provider J16070. Hereinafter, the digital broadcast system will be described in terms of operations of modules included in the receiver J16010.

The PDI engine according to the present embodiment may receive the PDI questionnaire provided by the content provider J16070. The PDI engine may transmit PDI questions contained in the received in the PDI questionnaire to the PDI Manipulation application J16060. When a user's input corresponding to a corresponding PDI question is present, the PDI engine may receive a user's answer and other information (hereafter, referred to as a PDI answer) related to the corresponding PDI question from the PDI Manipulation application J16060. Then, the PDI engine may process PDI questions and PDI answers in order to supply the personalization service to generate PDI data. That is, according to an embodiment of the present invention, the PDI data may contain the aforementioned PDI questions and/or PDI answers. Therefore, the PDI answers to the PDI questionnaires, taken together, represent the user's profile, demographics, and interests (or PDI).

In addition, the PDI engine according to the present embodiment may update the PDI data using the received PDI answers. In detail, the PDI engine may delete, add, and/or correct the PDI data using an ID of a PDI answer. The ID of the PDI answer will be described below in detail with regard to an embodiment of the present invention. In addition, when another module requests the PDI engine to transmit PDI data, the PDI engine may transmit PDI data appropriate for the corresponding request to the corresponding module.

The filtering engine J16020 according to the present embodiment may filter content according to the PDI data and the filtering criteria. The filtering criteria refers to a set filtering criterions for filtering only contents appropriate for a user using the PDI data. In detail, the filtering engine J16020 may receive the PDI data from the PDI engine and receive the content and/or the filtering criteria from the content provider J16070. In addition, when the convent provider J16070 transmits a parameter related to declarative content, the convent provider J16070 may transmit a filtering criteria table related to the declarative content together. Then, the filtering engine J16020 may match and compare the filtering criteria and the PDI data and filter and download the content using the comparison result. The downloaded content may be stored in the content store J16040.

According to an embodiment of the present invention, the PDI Manipulation application J16060 may display the PDI received from the PDI engine and receive the PDI answer to the corresponding PDI question from the user. The user may transmit the PDI answer to the displayed PDI question to the receiver J16010 using a remote controller. The PDI Manipulation application J16060 may transmit the received PDI answer to the PDI engine 701.

The declarative content module J16050 according to the present embodiment may access the PDI engine to acquire PDI data. In addition, the declarative content module J16050 may receive declarative content provided by the content provider J16070. According to an embodiment of the present invention, the declarative content may be content related to application executed by the receiver J16010 and may include a declarative object (DO) such as a triggered declarative object (TDO).

The declarative content module J16050 according to the present embodiment may access the PDI store J16030 to acquire the PDI question and/or the PDI answer. In this case, the declarative content module J16050 may use an application programming interface (API). In detail, the declarative content module J16050 may retrieve the PDI store J16030 using the API to acquire at least one PDI question. Then, the declarative content module J16050 may transmit the PDI question, receive the PDI answer, and transmit the received PDI answer to the PDI store J16030 through the PDI Manipulation application J16060.

The PDI store J16030 according to the present embodiment may store the PDI question and/or the PDI answer.

The content store J16040 according to the present embodiment may store the filtered content.

The PDI engine may receive the PDI questionnaire from the content provider J16070. The receiver J16010 may display PDI questions of the PDI questionnaire received through the PDI Manipulation application J16060 and receive the PDI answer to the corresponding PDI question from the user. The PDI engine may transmit PDI data containing the PDI question and/or the PDI answer to the filtering engine J16020. The filtering engine J16020 may filter content through the PDI data and the filtering criteria. Thus, the receiver J16010 may provide the filtered content to the user to embody the personalization service.

FIG. 46 is a view showing a signaling structure for user setting per application according to an embodiment of the present invention.

For opt-in/out setting per application (for example, user setting for on/off of notification of an application), a globally unique application ID used for a trigger to execute an application may be used as a PDI Table ID. The details of an application trigger table may be extracted through the above-described app signaling parser and the details of PDI table may be extracted through the above-described targeting signaling parser. The application trigger table may correspond to the above-described TPT or TDO parameter element.

Before executing an application described in the application trigger table, a receiver identifies a global ID of the corresponding application in the application trigger table. The global ID is an unique value for a specific application selected from among all applications provided by the broadcasting system. That is, the global ID is information for identifying a specific application.

The receiver identifies a PDI Table ID having the same information as the global ID of the corresponding application and sets notification of an application per user using information per user in the corresponding PDI Table.

A description of other information included in the application trigger table is replaced with a description of the above-described TPT or shown in the figure. In addition, a description of other information included in the PDI table is replaced with a description of the above-described PDI Table or shown in the figure.

FIG. 47 is a view showing a signaling structure for user setting per application according to another embodiment of the present invention.

Referring to the figure, appID or globalID may be added to a PDI table to designate an application to which information of the corresponding PDI table is applied.

Before display-processing notification of an application, a receiver identifies whether PDI-related information applied to the corresponding application is present using the appID included in the PDI table. The receiver may decide whether to display-process notification of the corresponding application based on the PDI-related information.

FIG. 48 is a view showing a procedure for opt-in/out setting of an application using a PDI table according to an embodiment of the present invention.

A service provider may have a PDI table including PDI questions related to opt-in/out setting of an application. Information included in the PDI table may be created based on information provided by a user or information collected by the service provider (step 1).

The PDI table related to setting of agreement/disagreement for an application may be transmitted to a receiver (TV). At this time, an ID of the PDI table may have the same value as an ID (appID or globalID) of the application (step 2).

The service provider may send a trigger and/or PTP for the corresponding application to the receiver (TV) (step 3).

The user may select “Setting” for opt-in/out setting of an application and an PDI setting app for the application may be executed (step 4).

User setting for opt-in/out setting of the application may be stored in a PDI store by the PDI setting app (step 5).

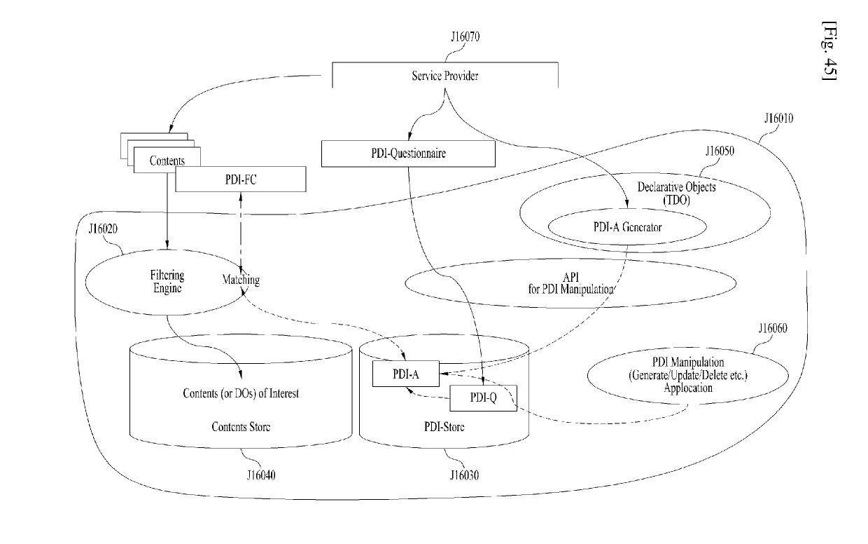

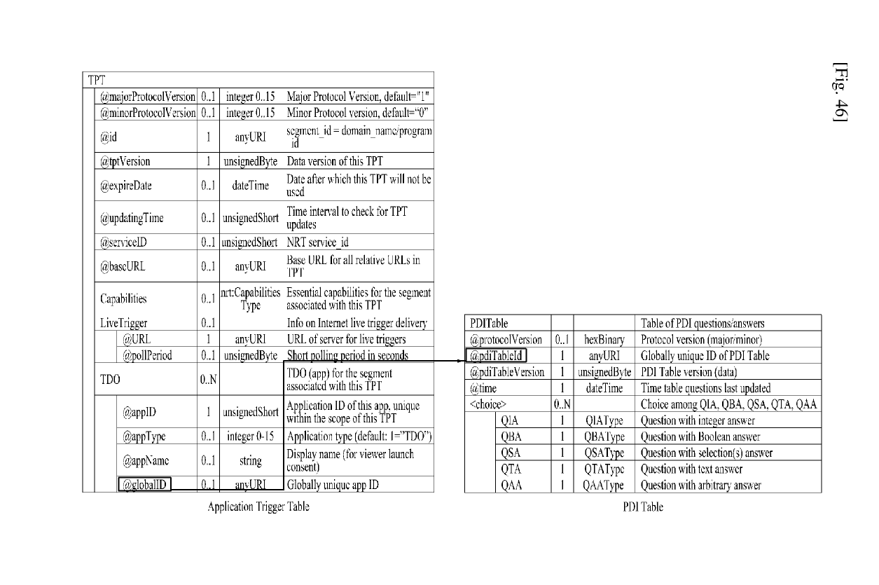

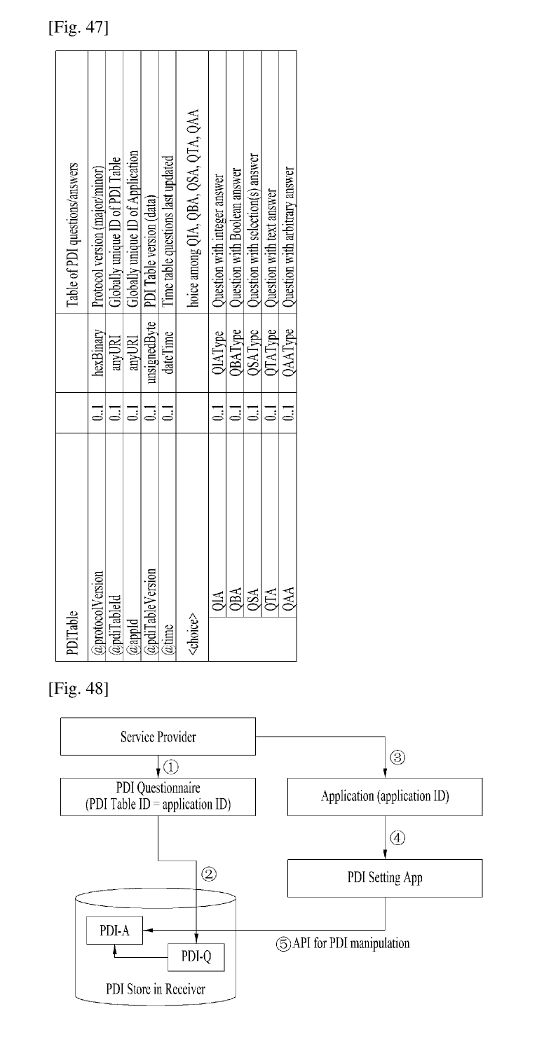

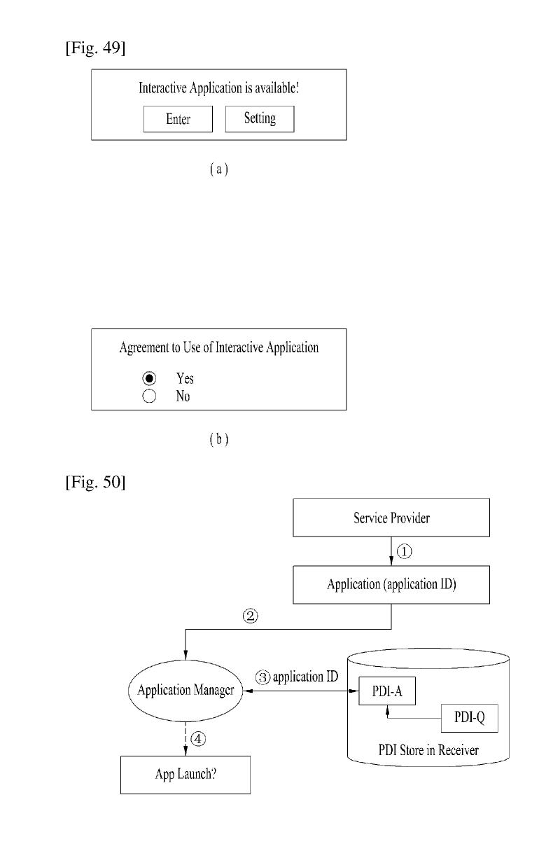

FIG. 49 is a view showing a user interface (UI) for opt-in/out setting of an application according to an embodiment of the present invention.

Upon receiving a trigger, a receiver may display a user interface (UI) as shown in (a). A user may directly execute the corresponding application (enter) or perform setting of the corresponding application.

In a case in which the user selects ‘setting’, a PDI setting app or a UI of the receiver may be further executed, through which the user may set whether the user will agree to use the corresponding application. Such information may be stored together with a PDI table.

FIG. 50 is a view showing a processing procedure in a case in which a receiver (TV) receives a trigger of an application having the same application ID from a service provider after completing opt-in/out setting of an application using a PDI table according to an embodiment of the present invention.

A service provider transmits a trigger of an application, opt-in/out setting of which is completed, to the receiver (step 1).

An application manager of the receiver (TV) may parse the corresponding trigger to acquire an application ID (step 2).

The receiver may retrieve a relevant PDI table from a PDI store using the acquired application ID and find out an answer to opt-in/out of the application, i.e. user setting.

The receiver may execute or may not execute the application according to opt-in/out setting of the application.

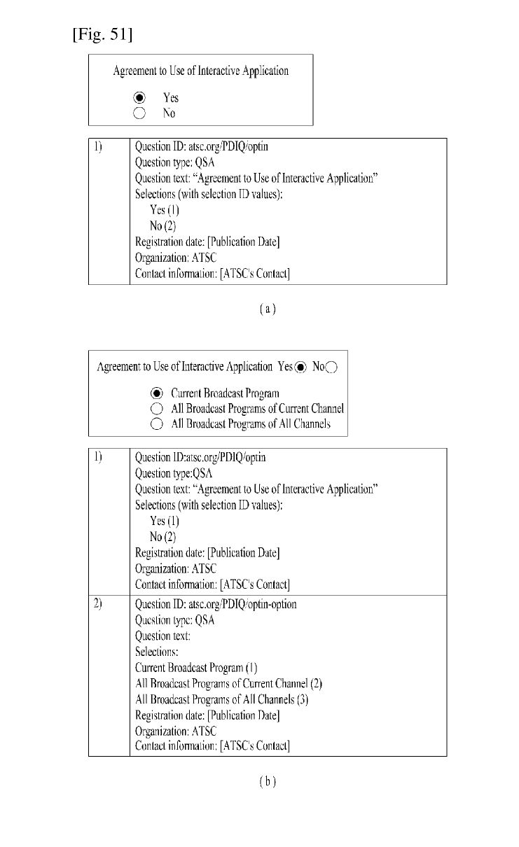

FIG. 51 is a view showing an UI for setting an option of an application per user and a question thereto according to an embodiment of the present invention.

Referring to (a) of the figure, there are shown a UI for setting whether a corresponding application will be exposed to a user and a question per application classified by an application ID. In this case, the user may set whether to use per application and information, for which whether to use has been set, may be stored in a receiver. The detailed operation of the receiver may refer to the above description.

Referring to (b) of the figure, there are shown an extended setting UI for classifying whether an application classified by an application ID will be exposed to a user and a question therefor. Basically, the user may set whether to use an application. In addition, the user may set whether this setting is effective only within a current broadcast program, within all broadcast programs of a current channel, or within all broadcast programs of all channels.

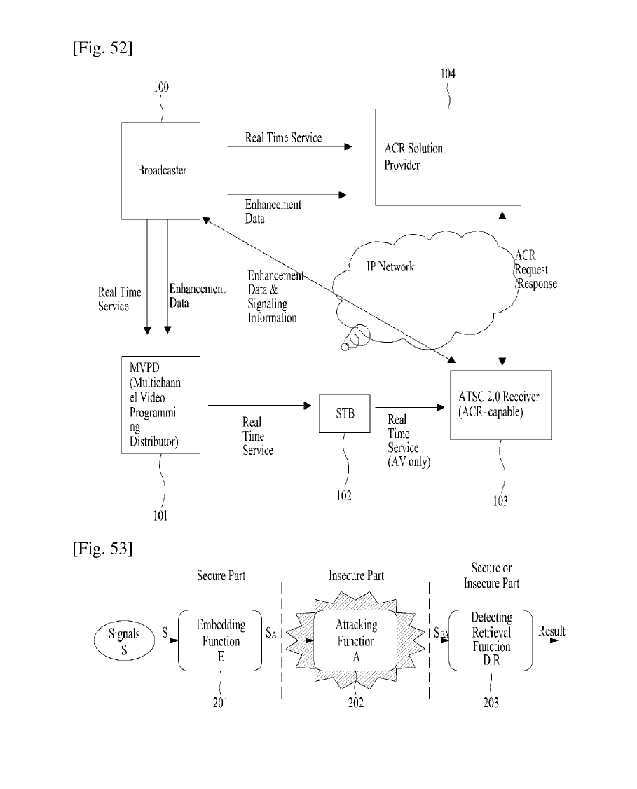

FIG. 52 is a diagram showing an automatic content recognition (ACR) based enhanced television (ETV) service system.

The ACR based ETV service system shown in FIG. 52 may include a broadcaster or content provider 100, a multichannel video programming distributor (MVPD) 101, a set-top box (STB) 102, a receiver 103 such as a digital TV receiver, and an ACR server (or an ACR Solution Provider) 104. The receiver 103 may operate according to definition of the advanced television system committee (ATSC) and may support an ACR function. A real-time broadcast service 110 may include A/V content.

A digital broadcast service may be largely divided into a terrestrial broadcast service provided by the broadcaster 100 and a multi-channel broadcast service, such as a cable broadcast or a satellite broadcast, provided by the MVPD 101. The broadcaster 100 may transmit a real-time broadcast service 110 and enhancement data (or additional data) 120 together. In this case, as shown in FIG. 52, the receiver 103 may receive only the real-time broadcast service 110 and may not receive the enhancement data 120 through the MVPD 101 and the STB 102.

Accordingly, in order to receive the enhancement data 120, the receiver 103 analyzes and processes A/V content output as the real-time broadcast service 110 and identifies broadcast program information and/or broadcast program related metadata. Using the identified broadcast program information and/or broadcast program related metadata, the receiver 103 may receive the enhancement data from the broadcaster 100 or the ACR server 104 (140). In this case, the enhancement data may be transmitted via an Internet protocol (IP) network 150.

If the enhancement data is received from a separate ACR server 104 (140), in a mechanism between the ACR server 104 and the receiver 103, a request/response model among triggered declarative object (TDO) models defined in the ATSC 2.0 standard may be applied to the ACR server 104. Hereinafter, the TDO and request/response model will be described.

TDO indicates additional information included in broadcast content. TDO serves to timely triggers additional information within broadcast content. For example, if an audition program is broadcast, a current ranking of an audition participant preferred by a viewer may be displayed along with the broadcast content. At this time, additional information of the current rating of the audition participant may be a TDO. Such a TDO may be changed through interaction with viewers or provided according to viewer's intention.

In the request/response ACR model of the standard ATSC 2.0, the digital broadcast receiver 103 is expected to generate signatures of the content periodically (e.g. every 5 seconds) and send requests containing the signatures to the ACR server 104. When the ACR server 104 gets a request from the digital broadcast receiver 103, it returns a response. The communications session is not kept open between request/response instances. In this model, it is not feasible for the ACR server 104 to initiate messages to the client.

As digital satellite broadcasting has been introduced, digital data broadcasting has appeared as a new supplementary service. An interactive data broadcast, which is a representative interactive service, may transmit not only a data signal but also an existing broadcast signal to a subscriber so as to provide various supplementary services.

A digital data broadcast may be largely divided into an independent service using a virtual channel and a broadcast-associated service via an enhanced TV (ETV). The independent service includes only text and graphics without a broadcast image signal and is provided in a format similar to an existing Internet web page. Representative examples of the independent service include a weather and stock information provision service, a TV banking service, a commercial transaction service, etc. The broadcast-associated service transmits not only a broadcast image signal but also additional text and graphic information. A viewer may obtain information regarding a viewed broadcast program via a broadcast-associated service. For example, there is a service for enabling a viewer to view a previous story or a filming location while viewing a drama.

In a broadcast-associated service of a digital data broadcast, an ETV service may be provided based on ACR technology. ACR means technology for automatically recognizing content via information hidden in the content when a device plays audio/video (A/V content) back.

In implementation of ACR technology, a watermarking or fingerprinting scheme may be used to acquire information regarding content. Watermarking refers to technology for inserting information indicating a digital content provider into digital content. Fingerprinting is equal to watermarking in that specific information is inserted into digital content and is different therefrom in that information regarding a content purchaser is inserted instead of information regarding a content provider.

FIG. 53 is a diagram showing the flow of digital watermarking technology according to an embodiment of the present invention.

As digital satellite broadcasting has been introduced, digital data broadcasting has appeared as a new supplementary service. An interactive data broadcast, which is a representative interactive service, may transmit not only a data signal but also an existing broadcast signal to a subscriber so as to provide various supplementary services.

A digital data broadcast may be largely divided into an independent service using a virtual channel and a broadcast-associated service via an enhanced TV (ETV). The independent service includes only text and graphics without a broadcast image signal and is provided in a format similar to an existing Internet web page. Representative examples of the independent service include a weather and stock information provision service, a TV banking service, a commercial transaction service, etc. The broadcast-associated service transmits not only a broadcast image signal but also additional text and graphic information. A viewer may obtain information regarding a viewed broadcast program via a broadcast-associated service. For example, there is a service for enabling a viewer to view a previous story or a filming location while viewing a drama.

In a broadcast-associated service of a digital data broadcast, an ETV service may be provided based on ACR technology. ACR means technology for automatically recognizing content via information hidden in the content when a device plays audio/video (A/V content) back.

In implementation of ACR technology, a watermarking or fingerprinting scheme may be used to acquire information regarding content. Watermarking refers to technology for inserting information indicating a digital content provider into digital content. Fingerprinting is equal to watermarking in that specific information is inserted into digital content and is different therefrom in that information regarding a content purchaser is inserted instead of information regarding a content provider.

Hereinafter, watermarking technology will be described with reference to FIG. 53 in detail.

Digital watermarking is the process of embedding information into a digital signal in a way that is difficult to remove. The signal may be audio, pictures or video, for example. If the signal is copied, then the information is also carried in the copy. A signal may carry several different watermarks at the same time.

In visible watermarking, the information is visible in the picture or video. Typically, the information is text or a logo which identifies the owner of the media. When a television broadcaster adds its logo to the corner of transmitted video, this is also a visible watermark.

In invisible watermarking, information is added as digital data to audio, picture or video, but it cannot be perceived as such, although it may be possible to detect that some amount of information is hidden. The watermark may be intended for widespread use and is thus made easy to retrieve or it may be a form of steganography, where a party communicates a secret message embedded in the digital signal. In either case, as in visible watermarking, the objective is to attach ownership or other descriptive information to the signal in a way that is difficult to remove. It is also possible to use hidden embedded information as a means of covert communication between individuals.

One application of watermarking is in copyright protection systems, which are intended to prevent or deter unauthorized copying of digital media. In this use a copy device retrieves the watermark from the signal before making a copy; the device makes a decision to copy or not depending on the contents of the watermark. Another application is in source tracing.

A watermark is embedded into a digital signal at each point of distribution. If a copy of the work is found later, then the watermark can be retrieved from the copy and the source of the distribution is known. This technique has been reportedly used to detect the source of illegally copied movies.

Annotation of digital photographs with descriptive information is another application of invisible watermarking.

While some file formats for digital media can contain additional information called metadata, digital watermarking is distinct in that the data is carried in the signal itself.

The information to be embedded is called a digital watermark, although in some contexts the phrase digital watermark means the difference between the watermarked signal and the cover signal. The signal where the watermark is to be embedded is called the host signal.

A watermarking system is usually divided into three distinct steps, embedding (201), attack (202) and detection (or extraction; 203).

In embedding (201), an algorithm accepts the host and the data to be embedded and produces a watermarked signal.

The watermarked signal is then transmitted or stored, usually transmitted to another person. If this person makes a modification, this is called an attack (202). While the modification may not be malicious, the term attack arises from copyright protection application, where pirates attempt to remove the digital watermark through modification. There are many possible modifications, for example, lossy compression of the data, cropping an image or video, or intentionally adding noise.

Detection (203) is an algorithm which is applied to the attacked signal to attempt to extract the watermark from it. If the signal was unmodified during transmission, then the watermark is still present and it can be extracted. In robust watermarking applications, the extraction algorithm should be able to correctly produce the watermark, even if the modifications were strong. In fragile watermarking, the extraction algorithm should fail if any change is made to the signal.

A digital watermark is called robust with respect to transformations if the embedded information can reliably be detected from the marked signal even if degraded by any number of transformations. Typical image degradations are JPEG compression, rotation, cropping, additive noise and quantization. For video content temporal modifications and MPEG compression are often added to this list. A watermark is called imperceptible if the watermarked content is perceptually equivalent to the original, unwatermarked content. In general it is easy to create robust watermarks or imperceptible watermarks, but the creation of robust and imperceptible watermarks has proven to be quite challenging. Robust imperceptible watermarks have been proposed as tool for the protection of digital content, for example as an embedded ‘no-copy-allowed’ flag in professional video content.

Digital watermarking techniques can be classified in several ways.

First, a watermark is called fragile if it fails to be detected after the slightest modification (Robustness). Fragile watermarks are commonly used for tamper detection (integrity proof). Modifications to an original work that are clearly noticeable are commonly not referred to as watermarks, but as generalized barcodes. A watermark is called semi-fragile if it resists benign transformations but fails detection after malignant transformations. Semi-fragile watermarks are commonly used to detect malignant transformations. A watermark is called robust if it resists a designated class of transformations. Robust watermarks may be used in copy protection applications to carry copy and access control information.

Second, a watermark is called imperceptible if the original cover signal and the marked signal are (close to) perceptually indistinguishable (Perceptibility). A watermark is called perceptible if its presence in the marked signal is noticeable, but non-intrusive.

Third, about a capacity, the length of the embedded message determines two different main classes of watermarking schemes:

The message is conceptually zero-bit long and the system is designed in order to detect the presence or the absence of the watermark in the marked object. This kind of watermarking schemes is usually referred to as Italic zero-bit or Italic presence watermarking schemes. Sometimes, this type of watermarking scheme is called 1-bit watermark, because a 1 denotes the presence (and a 0 the absence) of a watermark.

The message is a n-bit-long stream (, with n=|m|) or M={0,1}n and is modulated in the watermark. These kinds of schemes are usually referred to as multiple bit watermarking or non zero-bit watermarking schemes.

Forth, there are several ways for the embedding step. A watermarking method is referred to as spread-spectrum if the marked signal is obtained by an additive modification. Spread-spectrum watermarks are known to be modestly robust, but also to have a low information capacity due to host interference. A watermarking method is said to be of quantization type if the marked signal is obtained by quantization. Quantization watermarks suffer from low robustness, but have a high information capacity due to rejection of host interference. A watermarking method is referred to as amplitude modulation if the marked signal is embedded by additive modification which is similar to spread spectrum method but is particularly embedded in the spatial domain.

FIG. 54 is a diagram showing an ACR query result format according to an embodiment of the present invention.

According to the existing ACR service processing system, if a broadcaster transmits content for a real-time service and enhancement data for an ETV service together and a TV receiver receives the content and the ETV service, the content for the real-time service may be received but the enhancement data may not be received.

In this case, according to the embodiment of the present invention, it is possible to solve problems of the existing ACR processing system through an independent IP signaling channel using an IP network. That is, a TV receiver may receive content for a real-time service via an MVPD and receive enhancement data via an independent IP signaling channel.

In this case, according to the embodiment of the present invention, an IP signaling channel may be configured such that a PSIP stream is delivered and processed in the form of a binary stream. At this time, the IP signaling channel may be configured to use a pull method or a push method.

The IP signaling channel of the pull method may be configured according to an HTTP request/response method. According to the HTTP request/response method, a PSIP binary stream may be included in an HTTP response signal for an HTTP request signal and transmitted through SignalingChannelURL. In this case, a polling cycle may be periodically requested according to Polling_cycle in metadata delivered as an ACR query result. In addition, information about a time and/or a cycle to be updated may be included in a signaling channel and transmitted. In this case, the receiver may request signaling information from a server based on update time and/or cycle information received from the IP signaling channel.

The IP signaling channel of the push method may be configured using an XMLHTTPRequest application programming interface (API). If the XMLHTTPRequest API is used, it is possible to asynchronously receive updates from the server. This is a method of, at a receiver, asynchronously requesting signaling information from a server through an XMLHTTPRequest object and, at the server, providing signaling information via this channel in response thereto if signaling information has been changed. If there is a limitation in standby time of a session, a session timeout response may be generated and the receiver may recognize the session timeout response, request signaling information again and maintain a signaling channel between the receiver and the server.

In order to receive enhancement data through an IP signaling channel, the receiver may operate using watermarking and fingerprinting. Fingerprinting refers to technology for inserting information about a content purchaser into content instead of a content provider. If fingerprinting is used, the receiver may search a reference database to identify content. A result of identifying the content is called an ACR query result. The ACR query result may include a query provided to a TV viewer and answer information of the query in order to implement an ACR function. The receiver may provide an ETV service based on the ACR query result.

Information about the ACR query result may be inserted/embedded into/in A/V content on a watermark based ACR system and may be transmitted. The receiver may extract and acquire ACR query result information through a watermark extractor and then provide an ETV service. In this case, an ETV service may be provided without a separate ACR server and a query through an IP network may be omitted.

FIG. 54 is a diagram of an XML scheme indicating an ACR query result according to an embodiment of the present invention. As shown in FIG. 54, the XML format of the ACR query result may include a result code element 310 and the ACR query result type 300 may include a content ID element 301, a network time protocol (NTP) timestamp element 302, a signaling channel information element 303, a service information element 304 and an other-identifier element 305. The signaling channel information element 303 may include a signaling channel URL element 313, an update mode element 323 and a polling cycle element 333, and the service information element 304 may include a service name element 314, a service logo element 324 and a service description element 334.

Hereinafter, the diagram of the XML schema of the ACR query result shown in FIG. 54 will be described in detail and an example of the XML schema will be described.

The result code element 310 may indicate a result value of an ACR query. This may indicate query success or failure and a failure reason if a query fails in the form of a code value. For example, if the value of the result code element 310 is 200, this may indicate that a query succeeds and content information corresponding thereto is returned and, if the value of the result code element 310 is 404, this may indicate that content is not found.

The content ID element 301 may indicate an identifier for globally and uniquely identifying content and may include a global service identifier element, which is an identifier for identifying a service.

The NTP timestamp element 302 may indicate that a time of a specific point of a sample frame interval used for an ACR query is provided in the form of an NTP timestamp. Here, the specific point may be a start point or end point of the sample frame. NTP means a protocol for synchronizing a time of a computer with a reference clock through the Internet and may be used for time synchronization between a time server and client distributed on a computer network. Since NTP uses a universal time coordinated (UTC) time and ensures accuracy of 10 ms, the receiver may accurately process a frame synchronization operation.

The signaling channel information element 303 may indicate access information of an independent signaling channel on an IP network for an ETV service.

More specifically, the signaling channel URL element 313, which is a sub element of the signaling channel information element 303, may indicate URL information of a signaling channel. The signaling channel URL element 313 may include an update mode element 323 and a polling cycle element 333 as sub elements. The update mode element 323 may indicate a method of acquiring information via an IP signaling channel. For example, in a pull mode, the receiver may periodically perform polling according to a pull method to acquire information and, in a push mode, the server may transmit information to the receiver according to a push method. The polling cycle element 333 may indicate a basic polling cycle value of the receiver according to a pull method if the update mode element 323 is a pull mode. Then, the receiver may specify a basic polling cycle value and transmit a request signal to the server at a random time interval, thereby preventing requests from overloading in the server.

The service information element 304 may indicate information about a broadcast channel. The content id element 301 may indicate an identifier of a service which is currently being viewed by a viewer and the service information element 304 may indicate detailed information about the broadcast channel. For example, the detailed information indicated by the service information element 304 may be a channel name, a logo, or a text description.

More specifically, the service name element 314 which is a sub element of the service information element 304 may indicate a channel name, the service logo element 324 may indicate a channel logo, and the service description element 334 may indicate a channel text description.

The following shows the XML schema of elements of the ACR query result shown in FIG. 54 according to the embodiment of the present invention.

<xs:complexType name=“ACR-ResultType”>

<xs:sequence>

<xs:element name=“ContentID” type=“xs:anyURI”/>
<xs:element name=“NTPTimestamp” type=“xs:unsignedLong”/>
<xs:element name=“SignalingChannelInformation”>

<xs:complexType>

<xs:sequence>

<xs:element name=“SignalingChannelURL” maxOccurs=“unbounded”>

<xs:complexType>

<xs:simpleContent>

<xs:extension base=“xs:anyURI”>

<xs:attribute name=“UpdateMode”>

<xs:simpleType>

<xs:restriction base=“xs:string”>

<xs:enumeration value=“Pull”/>
<xs:enumeration value=“Push”/>

</xs:restriction>

</xs:simpleType>

</xs:attribute>
<xs:attribute name=“PollingCycle” type=“xs:unsignedInt”/>

</xs:extension>

</xs:simpleContent>

</xs:complexType>

</xs:element>

</xs:sequence>

</xs:complexType>

</xs:element>
<xs:element name=“ServiceInformation”>

<xs:complexType>

<xs:sequence>

<xs:element name=“ServiceName” type=“xs:string”/>
<xs:element name=“ServiceLogo” type=“xs:anyURI” minOccurs=“0”/>
<xs:element name=“ServiceDescription” type=“xs:string” minOccurs=“0”

maxOccurs=“unbounded”/>

</xs:sequence>

</xs:complexType>

</xs:element>
<xs:any namespace=“##other” processContents=“skip” minOccurs=“0”

maxOccurs=“unbounded”/>

</xs:sequence>
<xs:attribute name=“ResultCode” type=“xs:string” use=“required”/>
<xs:anyAttribute processContents=“skip”/>

</xs:complexType>

FIG. 55 is a diagram showing the syntax of a content identifier (ID) according to an embodiment of the present invention.

FIG. 55 shows the syntax of the content ID according to the ATSC standard according to the embodiment of the present invention. The ATSC content ID may be used as an identifier for identifying content received by the receiver.

The syntax of the content ID illustrated in FIG. 55 is the syntax of a content ID element of the ACR query result format described with reference to FIG. 54.

The ATSC Content Identifier is a syntax that is composed of a TSID (Transmitting Subscriber Identification) and a “house number” with a period of uniqueness. A “house number” is any number that the holder of the TSID wishes as constrained herein. Numbers are unique for each value of TSID. The syntax of the ATSC Content Identifier structure shall be as defined in FIG. 62.

‘TSID’, a 16 bit unsigned integer field, shall contain a value of transport_stream_id. The assigning authority for these values for the United States is the FC Ranges for Mexico, Canada, and the United States have been established by formal agreement among these countries. Values in other regions are established by appropriate authorities.

‘end_of_day’ field, this 5-bit unsigned integer shall be set to the hour of the day in UTC in which the broadcast day ends and the instant after which the content_id values may be re-used according to unique_for. The value of this field shall be in the range of 0-23. The values 24-31 are reserved. Note that the value of this field is expected to be static per broadcaster.

‘unique_for’ field, this 9-bit unsigned integer shall be set to the number of days, rounded up, measure relative to the hour indicated by end_of_day, during which the content_id value is not reassign to different content. The value shall be in the range 1 to 511. The value zero shall be forbidden. The value 511 shall have the special meaning of “indefinitely”. Note that the value of this field is expected to be essentially static per broadcaster, only changing when the method of house numbering is changed. Note also that decoders can treat stored content_values as unique until the unique_for fields expire, which can be implemented by decrementing all stored unique_for fields by one every day at the end_of_day until they reach zero.

‘content_id’ field, this variable length field shall be set to the value of the identifier according to the house number system or systems for the value of TSID. Each such value shall not be assigned to different content within the period of uniqueness set by the values in the end_of_day an unique_for fields. The identifier may be any combination of human readable and/or binary values and need not exactly match the form of a house number, not to exceed 242 bytes 1.

When a receiver according to the embodiment of the present invention cannot globally uniquely identify a service via the syntax of the content ID illustrated in FIG. 55, the receiver according to the present embodiment may identify the service using a global service identifier. The global service identifier according to the present embodiment may be included in the content ID element of the ACR query result format described with reference to FIG. 54.

[Example 1] below represents a global service identifier of a URI format according to an

embodiment of the present invention. A global service identifier of [Example 1] may be used for an ATSC-M/H service.

[Example 1] urn:oma:bcast:iauth:atsc:service:<region>:<xsid>:<serviceid>

<region> is a two-letter international country code as specified by ISO 639-2.

<xsid> is defined as for local services, the decimal encoding of the TSID, as defined in that region. <xsid> is also defined as for regional services (major >69), “0”.

<serviceid> is defined as <major>.<minor>, where <major> can indicate Major Channel number and <minor> can indicate Minor Channel Number.

The aforementioned global service identifier may be presented in the following URI format.

[Example 2] urn:oma:bcast:iauth:atsc:service:us:1234:5.1

[Example 3] urn:oma:bcast:iauth:atsc:service:us:0:100.200

A receiver according to the embodiment of the present invention may identify content using a global content identifier based on the aforementioned global service identifier.

[Example 4] below represents a global content identifier of a URI format according to an embodiment of the present invention. A global service identifier of [Example 4] may be used for an ATSC service. In detail, [Example 4] represents a case in which an ATSC content identifier is used as a global content identifier according to an embodiment of the present invention.

[Example 4]

urn:oma:bcastiauth:atsc:content:<region>:<xsidz>:<contentid>:<unique_for>:<end_of_day>

<region> is a two-letter international country code as specified by ISO 639-2 [4].

<xsidz> is defined as for local services, the decimal encoding of the TSID, as defined in that region, followed by “.”<serviceid> unless the emitting broadcaster can ensure the uniqueness of the global content id without use of <serviceid>. <xsidz> is also defined as for regional services (major>69), <serviceid>.

In both cases, <serviceid> is as defined in Section Al for the service carrying the content. <content_id> is the base64 [5] encoding of the content_id field defined in FIG. 55, considering the content_id field as a binary string. <unique_for> is the decimal encoding of the unique_for field defined in FIG. 55. <end_of_day> is the decimal encoding of the end_of_day field defined in FIG. 55.

The ATSC content identifier having the format defined in the aforementioned Examples may be used to identify content on an ACR processing system.

Hereinafter, a receiver designed to embody watermarking and fingerprinting technologies will be described with regard to an embodiment of the present invention with reference to FIGS. 56 and 57. Receivers illustrated in FIGS. 56 and 57 may be conFIG.d in different manners according to a designer's intention.

FIG. 56 is a diagram showing the structure of a receiver according to the embodiment of the present invention.

More specifically, FIG. 56 shows an embodiment of the configuration of a receiver supporting an ACR based ETV service using watermarking.

As shown in FIG. 56, the receiver supporting the ACR based ETV service according to the embodiment of the present invention may include an input data processor, an ATSC main service processor, an ATSC mobile/handheld (MH) service processor and/or an ACR service processor. The input data processor may include a tuner/demodulator 400 and/or a vestigial side band (VSB) decoder 401. The ATSC main service processor may include a transport protocol (TP) demux 402, a Non Real Time (NRT) guide information processor 403, a digital storage media command and Control (DSM-CC) addressable section parser 404, an Information Provider (IP)/User Datagram Protocol (UDP) parser 405, a FLUTE parser 406, a metadata module 407, a file module 408, an electronic service guide (ESG)/data carrier detect (DCD) handler 409, a storage control module 410, a file/TP switch 411, a playback control module 412, a first 1 storage device 413, an IP packet storage control module 414, an Internet access control module 415, an IP interface 416, a live/recorded switch 417, a file (object) decoder 418, a TP/Packetized Elementary Stream (PES) decoder 420, a Program Specific Information (PSI)/program and system information protocol (PSIP) decoder 421 and/or an Electronic Program Guide (EPG) handler 422. The ATSC MH service processor may include a main/MH/NRT switch 419, a MH baseband processor 423, an MH physical adaptation processor 424, an IP protocol stack 425, a file handler 426, an ESG handler 427, a second storage device 428 and/or a streaming handler 429. The ACR service processor may include a main/MH/NRT switch 419, an A/V decoder 430, an A/V process module 431, an external input handler 432, a watermark extractor 433 and/or an application 434.

Hereinafter, operation of each module of each processor will be described.

In the input data processor, the tuner/demodulator 400 may tune and demodulate a broadcast signal received from an antenna. Through this process, a VSB symbol may be extracted. The VSB decoder 401 may decode the VSB symbol extracted by the tuner/demodulator 400.

The VSB decoder 401 may output ATSC main service data and MH service data according to decoding. The ATSC main service data may be delivered to and processed by the ATSC main service processor and the MH service data may be delivered to and processed by the ATSC MH service processor.

The ATSC main service processor may process a main service signal in order to deliver main service data excluding an MH signal to the ACR service processor. The TP demux 402 may demultiplex transport packets of ATSC main service data transmitted via the VSB signal and deliver the demultiplexed transport packets to other processing modules. That is, the TP demux 402 may demultiplex a variety of information included in the transport packets and deliver information such that elements of the broadcast signal are respectively processed by modules of the broadcast receiver. The demultiplexed data may include real-time streams, DSM-CC addressable sections and/or an NRT service table/A/90&92 signaling table. More specifically, as shown in FIG. 56, the TP demux 402 may output the real-time streams to the live/recorded switch 417, output the DSM-CC addressable sections to the DSM-CC addressable section parser 404 and output the NRT service table/A/90&92 signaling table to the NRT guide information processor 403.

The NRT guide information processor 403 may receive the NRT service table/A/90&92 signaling table from the TP demux 402 and extract and deliver FLUT session information to the DSM-CC addressable section parser 404. The DSM-CC addressable section parser 404 may receive the DSM-CC addressable sections from the TP demux 402, receive the FLUT session information from the NRT guide information processor 403 and process the DSM-CC addressable sections. The IP/UDP parser 405 may receive the data output from the DSM-CC addressable section parser 404 and parse IP datagrams transmitted according to the IP/UDP. The FLUTE parser 406 may receive data output from the IP/UDP parser 405 and process FLUTE data for transmitting a data service transmitted in the form of an asynchronous layered coding (ALC) object. The metadata module 407 and the file module 408 may receive the data output from the FLUTE parser 406 and process metadata and a restored file. The ESG/DCD handler 409 may receive data output from the metadata module 407 and process an electronic service guide and/or downlink channel descriptor related to a broadcast program. The restored file may be delivered to the storage control module 410 in the form of a file object such as ATSC 2.0 content and reference fingerprint. The file object may be processed by the storage control module 410 and divided into a normal file and a TP file to be stored in the first storage device 413. The playback control module 412 may update the stored file object and deliver the file object to the file/TP switch 411 in order to decode the normal file and the TP file. The file/TP switch 411 may deliver the normal file to the file decoder 418 and deliver the TP file to the live/recorded switch 417 such that the normal file and the TP file are decoded through different paths.

The file decoder 418 may decode the normal file and deliver the decoded file to the ACR service processor. The decoded normal file may be delivered to the main/MH/NRT switch 419 of the ACR service processor. The TP file may be delivered to the TP/PES decoder 420 under the control of the live/recorded switch 417. The TP/PES decoder 420 decodes the TP file and the PSI/PSIP decoder 421 decodes the decoded TP file again. The EPG handler 422 may process the decoded TP file and process an EPG service according to ATSC.

The ATSC MH service processor may process the MH signal in order to transmit ATSC MH service data to the ACR service processor. More specifically, the MH baseband processor 423 may convert the ATSC MH service data signal into a pulse waveform suitable for transmission. The MH physical adaptation processor 424 may process the ATSC MH service data in a form suitable for an MH physical layer.

The IP protocol stack module 425 may receive the data output from the MH physical adaptation processor 424 and process data according to a communication protocol for Internet transmission/reception. The file handler 426 may receive the data output from the IP protocol stack module 425 and process a file of an application layer. The ESG handler 427 may receive the data output from the file handler 426 and process a mobile ESG. In addition, the second storage device 428 may receive the data output from the file handler 426 and store a file object. In addition, some of the data output from the IP protocol stack module 425 may become data for an ACR service of the receiver instead of a mobile ESG service according to ATSC. In this case, the streaming handler 429 may process real streaming received via a real-time transport protocol (RTP) and deliver the real streaming to the ACR service processor.

The main/MH/NRT switch 419 of the ACR service processor may receive the signal output from the ATSC main service processor and/or the ATSC MH service processor. The A/V decoder 430 may decode compression A/V data received from the main/MH/NRT switch 419. The decoded A/V data may be delivered to the A/V process module 431.

The external input handler 432 may process the A/V content received through external input and transmit the A/V content to the A/V process module 431.

The A/V process module 431 may process the A/V data received from the A/V decoder 430 and/or the external input handler 432 to be displayed on a screen. In this case, the watermark extractor 433 may extract data inserted in the form of a watermark from the A/V data. The extracted watermark data may be delivered to the application 434. The application 434 may provide an enhancement service based on an ACR function, identify broadcast content and provide enhancement data associated therewith. If the application 434 delivers the enhancement data to the A/V process module 431, the A/V process module 431 may process the received A/V data to be displayed on a screen.

In detail, the watermark extractor 433 illustrated in FIG. 56 may extract data (or watermark) inserted in the form of a watermark from the A/V data received through external input. The watermark extractor 433 may extract a watermark from the audio data, extract a watermark from the video data, and extract a watermark from audio and video data. The watermark extractor 433 may acquire channel information and/or content information from the extracted watermark.

The receiver according to the present embodiment may tune an ATSC mobile handheld (MH) channel and receive corresponding content and/or metadata using the channel information and/or the content information that are acquired by the watermark extractor 433. In addition, the receiver according to the present embodiment may receive corresponding content and/or metadata via the Internet. Then, the receiver may display the receive content and/or the metadata using trigger, etc.

FIG. 57 is a diagram showing the structure of a receiver according to another embodiment of the present invention.

More specifically, FIG. 57 shows an embodiment of the configuration of a receiver supporting an ACR based ETV service using fingerprinting.

The basic structure of the receiver illustrated in FIG. 57 is basically the same as that of the receiver illustrated in FIG. 57. However, the receiver illustrated in FIG. 57 is different from the receiver illustrated in FIG. 56 in that the receiver of FIG. 57 further includes a fingerprint extractor 535 and/or a fingerprint comparator 536 according to an embodiment of the present invention. In addition, the receiver of FIG. 57 may not include the watermark extractor 433 among the elements illustrated in FIG. 56.

The basic structure of the receiver of FIG. 57 is basically the same as the structure of the receiver illustrated in FIG. 56, and thus, a detailed description thereof will be omitted. Hereinafter, an operation of the receiver will be described in terms of the fingerprint extractor 535 and/or the fingerprint comparator 536.

The fingerprint extractor 535 may extract data (or signature) inserted into A/V content received through external input. The fingerprint extractor 535 according to the present embodiment may extract signature from audio content, extract signature from video content, or extract signature from audio content and video content.

The fingerprint comparator 536 may acquire channel information and/or content information using the signature extracted from the A/V content. The fingerprint comparator 536 according to the present embodiment may acquire the channel information and/or the content information through a local search and/or a remote search.

In detail, as illustrated in FIG. 57, a route for an operation of the fingerprint comparator 536 that accesses a storage device 537 is referred to as a local search. In addition, as illustrated in FIG. 57, a route for an operation of the fingerprint comparator 536 that accesses an internet access control module 538 is referred to as a remote search. The local search and the remote search will be described below.

In the local search according to the present embodiment, the fingerprint comparator 536 may compare the extracted signature with a reference fingerprint stored in the storage device 537. The reference fingerprint is data that the fingerprint comparator 536 further receives in order to process the extracted signature.

In detail, the fingerprint comparator 536 may match and compare the extracted signal and the reference fingerprint in order to determine whether the extracted signal and the reference fingerprint are identical to acquire channel information and/or content information.

As the comparison result, when the extracted signal is identical to the reference fingerprint, the fingerprint comparator 536 may transmit the comparison result to application. The application may transmit content information and/or channel information related to the extracted signature using the comparison result to the receiver.

As the comparison result, when the extracted signature is not matched with the reference fingerprint or the number of reference fingerprints is not sufficient, the fingerprint comparator 536 may receive a new reference fingerprint through an ATSC MH channel. Then, the fingerprint comparator 536 may re-compare the extracted signature and the reference fingerprint.

In the remote search according to the present embodiment, the fingerprint comparator 536 may receive channel information and/or content information from a signature database server on the Internet.

In detail, the fingerprint comparator 536 may access the Internet via the internet access control module 538 to access the signature database server. Then, the fingerprint comparator 536 may transmit the extracted signature as a query parameter to the signature database server.

When all broadcasters use one integrated signature database server, the fingerprint comparator 536 may transmit the query parameter to a corresponding signature database server. When broadcasters separately manage respective signature database servers, the fingerprint comparator 536 may transmit query parameters to respective signature databases. In addition, the fingerprint comparator 536 may simultaneously transmit the query parameter to two or more signature database servers.

The receiver according to the present embodiment may tune an ATSC MH channel using the channel information and/or the content information that are acquired by the fingerprint comparator 536 and receive corresponding content and/or metadata. Then, the receiver may display the received content and/or metadata using trigger, etc.

FIG. 58 is a diagram illustrating a digital broadcast system according to an embodiment of the present invention.

In detail, FIG. 58 illustrates a personalization broadcast system including a digital broadcast receiver (or a receiver) for a personalization service. The personalization service according to the present embodiment is a service for selecting and supplying content appropriate for a user based on user information. In addition, the personalization broadcast system according to the present embodiment may provide a next generation broadcast service for providing an ATSC 2.0 service or a personalization service.

According to an embodiment of the present invention, as an example of the user information, user's profiles, and demographics and interests information (or PDI data) are defined. Hereinafter, elements of the personalization broadcast system will be described.

The answers to the questionnaires, taken together, represent the user's Profile, Demographics, and Interests (PDI). The data structure that encapsulates the questionnaire and the answers given by a particular user is called a PDI Questionnaire or a PDI Table. A PDI Table, as provided by a network, broadcaster or content provider, includes no answer data, although the data structure accommodates the answers once they are available. The question portion of an entry in a PDI Table is informally called a “PDI Question” or “PDI-Q.” The answer to a given PDI question is referred to informally as a “PDI-A.” A set of filter criteria is informally called a “PDI-FC.”

The client device such as an ATSC 2.0-capable receiver includes a function allowing the creation of answers to the questions in the questionnaire (PDI-A instances). This PDI-generation function uses PDI-Q instances as input and produces PDI-A instances as output. Both PDI-Q and PDI-A instances are saved in non-volatile storage in the receiver. The client also provides a filtering function in which it compares PDI-A instances against PDI-FC instances to determine which content items will be suitable for downloading and use.

On the service provider side as shown, a function is implemented to maintain and distribute the PDI Table. Along with content, content metadata are created. Among the metadata are PDI-FC instances, which are based on the questions in the PDI Table.

As illustrated in FIG. 58, the personalization broadcast system may include a content provider (or broadcaster) 707 and/or a receiver 700. The receiver 700 according to the present embodiment may include a PDI engine 701, a filtering engine 702, a PDI store 703, a content store 704, a declarative content module 705, and/or a user interface (UI) module 706. As illustrated in FIG. 58, the receiver 700 according to the present embodiment may receive content, etc. from the content provider 707. The structure of the aforementioned personalization broadcast system may be changed according to a designer's intention.

The content provider 707 according to the present embodiment may transmit content, PDI questionnaire, and/or filtering criteria to the receiver 700. The data structure that encapsulates the questionnaire and the answers given by a particular user is called a PDI questionnaire. According to an embodiment of the present invention, the PDI questionnaire may include questions (or PDI questions) related to profiles, demographics and interests, etc. of a user.

The receiver 700 may process the content, the PDI questionnaire, and/or the filtering criteria, which are received from the content provider 707. Hereinafter, the digital broadcast system will be described in terms of operations of modules included in the receiver 700 illustrated in FIG. 58.

The PDI engine 701 according to the present embodiment may receive the PDI questionnaire provided by the content provider 707. The PDI engine 701 may transmit PDI questions contained in the received in the PDI questionnaire to the UI module 706. When a user's input corresponding to a corresponding PDI question is present, the PDI engine 701 may receive a user's answer and other information (hereafter, referred to as a PDI answer) related to the corresponding PDI question from the UI module 706. Then, the PDI engine 701 may process PDI questions and PDI answers in order to supply the personalization service to generate PDI data. That is, according to an embodiment of the present invention, the PDI data may contain the aforementioned PDI questions and/or PDI answers. Therefore, the PDI answers to the PDI questionnaires, taken together, represent the user's profile, demographics, and interests (or PDI).

In addition, the PDI engine 701 according to the present embodiment may update the PDI data using the received PDI answers. In detail, the PDI engine 701 may delete, add, and/or correct the PDI data using an ID of a PDI answer. The ID of the PDI answer will be described below in detail with regard to an embodiment of the present invention. In addition, when another module requests the PDI engine 701 to transmit PDI data, the PDI engine 701 may transmit PDI data appropriate for the corresponding request to the corresponding module.

The filtering engine 702 according to the present embodiment may filter content according to the PDI data and the filtering criteria. The filtering criteria refers to a set filtering criterions for filtering only contents appropriate for a user using the PDI data. In detail, the filtering engine 702 may receive the PDI data from the PDI engine 701 and receive the content and/or the filtering criteria from the content provider 707. In addition, when the convent provider 707 transmits a parameter related to declarative content, the convent provider 707 may transmit a filtering criteria table related to the declarative content together. Then, the filtering engine 702 may match and compare the filtering criteria and the PDI data and filter and download the content using the comparison result. The downloaded content may be stored in the content store 704. A filtering method and the filtering criteria will be described in detail with reference to FIGS. 84 and 85.

According to an embodiment of the present invention, the UI module 706 may display the PDI received from the PDI engine 701 and receive the PDI answer to the corresponding PDI question from the user. The user may transmit the PDI answer to the displayed PDI question to the receiver 700 using a remote controller. The UI module 706 may transmit the received PDI answer to the PDI engine 701.

The declarative content module 705 according to the present embodiment may access the PDI engine 701 to acquire PDI data. In addition, as illustrated in FIG. 58, the declarative content module 705 may receive declarative content provided by the content provider 707. According to an embodiment of the present invention, the declarative content may be content related to application executed by the receiver 700 and may include a declarative object (DO) such as a triggered declarative object (TDO).

Although no illustrated in FIG. 58, the declarative content module 705 according to the present embodiment may access the PDI store 703 to acquire the PDI question and/or the PDI answer. In this case, the declarative content module 705 may use an application programming interface (API). In detail, the declarative content module 705 may retrieve the PDI store 703 using the API to acquire at least one PDI question. Then, the declarative content module 705 may transmit the PDI question, receive the PDI answer, and transmit the received PDI answer to the PDI store 703 through the UI module 706.

The PDI store 703 according to the present embodiment may store the PDI question and/or the PDI answer.

The content store 704 according to the present embodiment may store the filtered content.

As described above, the PDI engine 701 illustrated in FIG. 58 may receive the PDI questionnaire from the content provider 707. The receiver 700 may display PDI questions of the PDI questionnaire received through the UI module 706 and receive the PDI answer to the corresponding PDI question from the user. The PDI engine 701 may transmit PDI data containing the PDI question and/or the PDI answer to the filtering engine 702. The filtering engine 702 may filter content through the PDI data and the filtering criteria. Thus, the receiver 700 may provide the filtered content to the user to embody the personalization service.

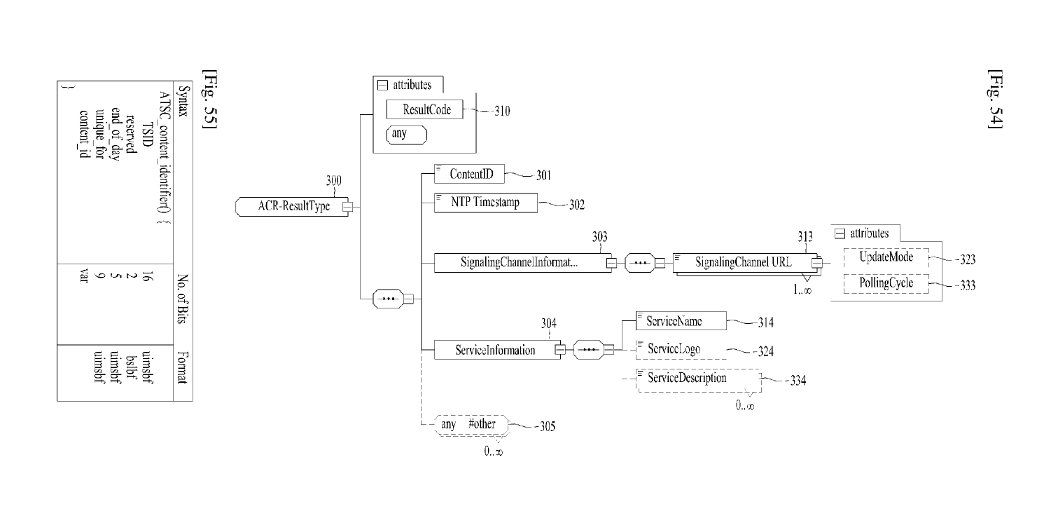

FIG. 59 is a diagram illustrating a digital broadcast system according to an embodiment of the present invention.

In detail, FIG. 59 illustrates the structure of a personalization broadcast system including a receiver for a personalization service. The personalization broadcast system according to the present embodiment may provide an ATSC 2.0 service. Hereinafter, elements of the personalization broadcast system will be described.

As illustrated in FIG. 59, the personalization broadcast system may include a content provider (or broadcaster 807) and/or a receiver 800. The receiver 800 according to the present embodiment may include a PDI engine 801, a filtering engine 802, a PDI store 803, a content store 804, a declarative content module 805, a UI module 806, a usage monitoring engine 808, and/or a usage log module 809. As illustrated in FIG. 58, the receiver 800 according to the present embodiment may receive content, etc. from the content provider 807. Basic modules of FIG. 59 are the same as the modules of FIG. 58, except that the broadcast system of FIG. 59 may further include the usage monitoring engine 808 and/or the usage log module 809 unlike the broadcast system of FIG. 58. The structure of the aforementioned personalization broadcast system may be changed according to a designer's intention. Hereinafter, the digital broadcast system will be described in terms of the usage monitoring engine 808 and the usage log module 809.

The usage log module 809 according to the present embodiment may store information (or history information) regarding a broadcast service usage history of a user. The history information may include two or more usage data. The usage data according to an embodiment of the present invention refers to information regarding a broadcast service used by a user for a predetermined period of time. In detail, the usage data may include information indicating that news is watched for 40 minutes at 9 pm, information indicating a horror movie is downloaded at 11 pm, etc.

The usage monitoring engine 808 according to the present embodiment may continuously monitor a usage situation of a broadcast service of the user. Then, the usage monitoring engine 808 may delete, add, and/or correct the usage data stored in the usage log module 809 using the monitoring result. In addition, the usage monitoring engine 808 according to the present embodiment may transmit the usage data to the PDI engine 801 and the PDI engine 801 may update the PDI data using the transmitted usage data.

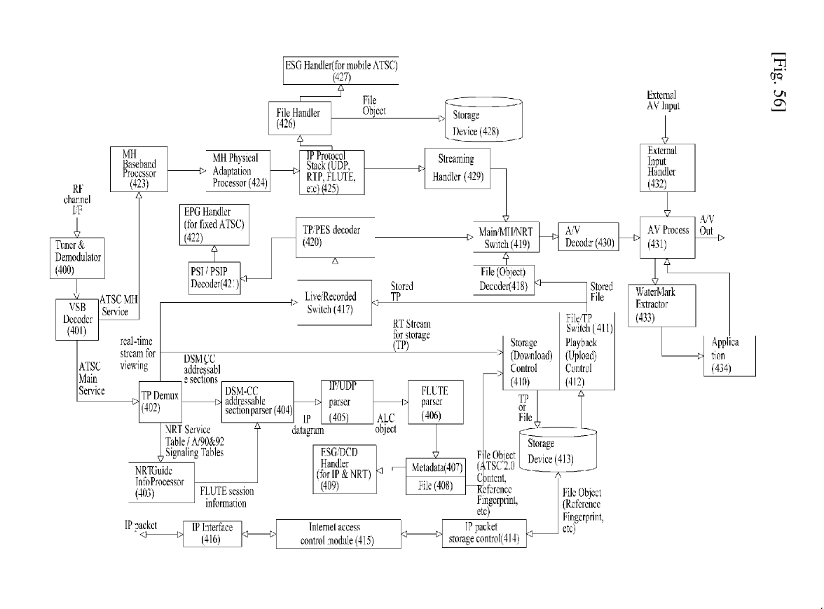

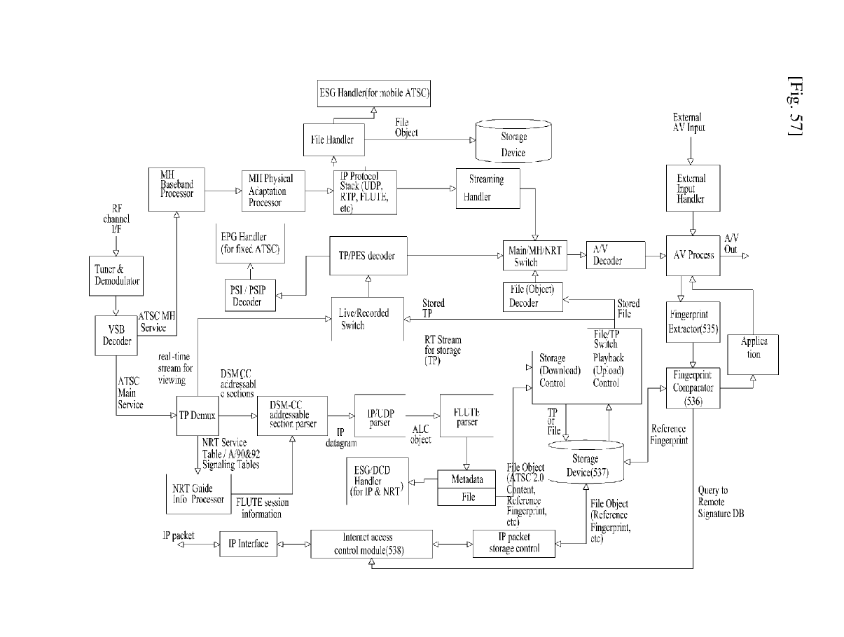

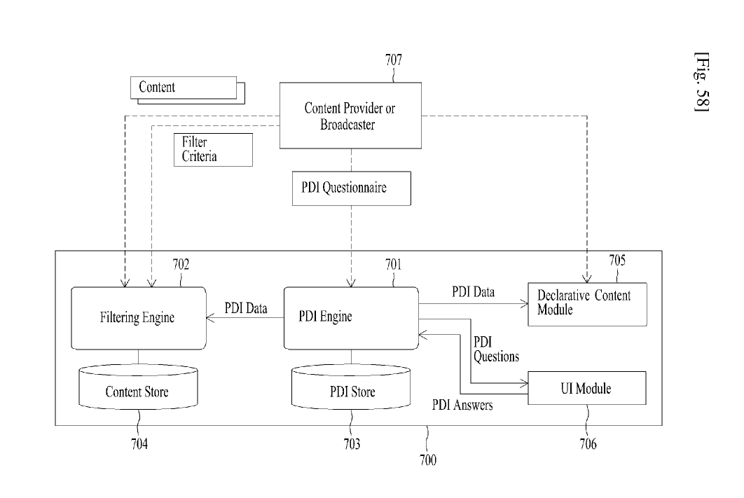

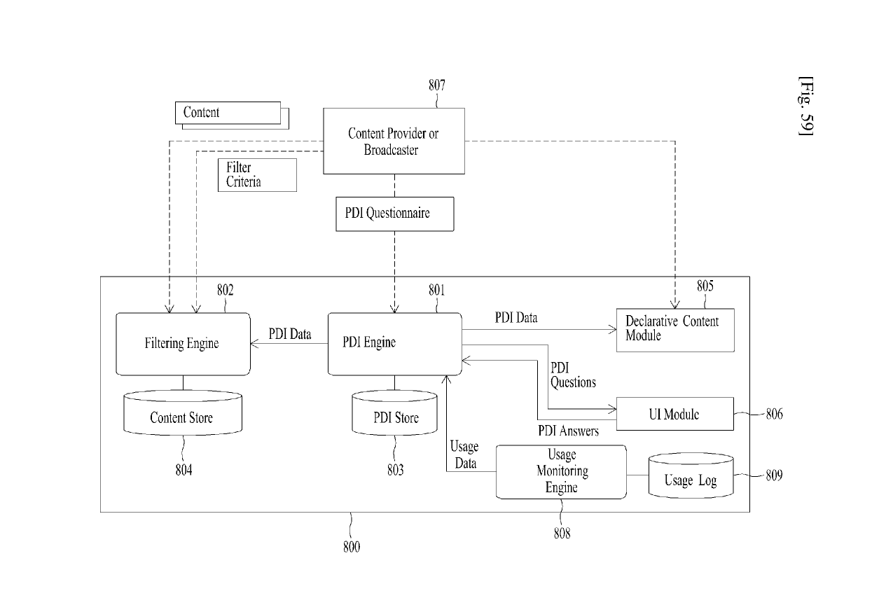

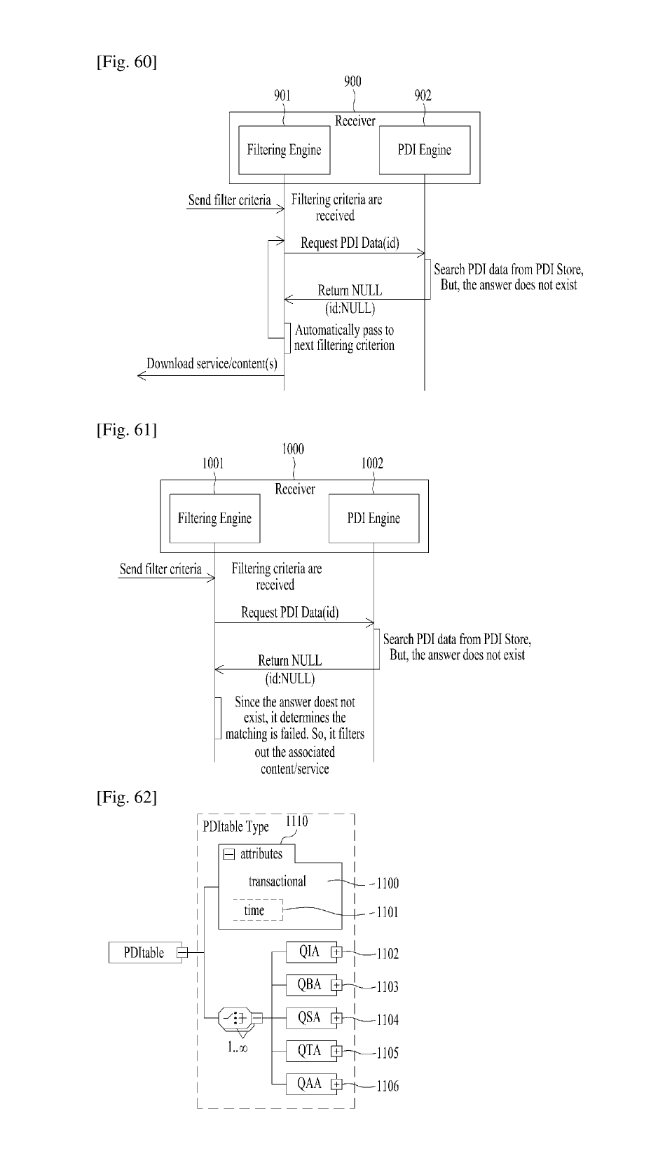

FIG. 60 is a flowchart of a digital broadcast system according to another embodiment of the present invention.

In detail, FIG. 60 is a flowchart of operations of a filtering engine and a PDI engine of the personalization broadcast system described with reference to FIGS. 58 and 59.

As illustrated in FIG. 60, a receiver 900 according to the present embodiment may include a filtering engine 901 and/or a PDI engine 902. Hereinafter, operations of the filtering engine 901 and the PDI engine 902 according to the present embodiment will be described. The structure of the aforementioned receiver may be changed according to a designer's intention.

As described with reference to FIG. 58, in order to filter content, the receiver 900 according to the present embodiment may match and compare filtering criteria and PDI data.

In detail, the filtering engine 901 according to the present embodiment may receive filtering criteria from a content provider and transmit a signal (or a PDI data request signal) for requesting PDI data to the PDI engine 902. The PDI engine 902 according to the present embodiment may search for PDI data corresponding to the corresponding PDI data request signal according to the transmitted PDI data request signal.

The filtering engine 901 illustrated in FIG. 60 may transmit the PDI data request signal including a criterion ID (identifier) to the PDI engine 902. As described above, the filtering criteria may be a set of filtering criterions, each of which may include a criterion ID for identifying the filtering criterions. In addition, according to an embodiment of the present invention, a criterion ID may be used to identify a PDI question and/or a PDI answer.

The PDI engine 902 that has received the PDI data request signal may access a PDI store to search for the PDI data. According to an embodiment of the present invention, the PDI data may include a PDI data ID for identifying a PDI question and/or a PDI answer. The PDI engine 902 illustrated in FIG. 60 may match and compare whether the criterion ID and PDI data ID in order to determine whether the criterion ID and the PDI data ID are identical to each other.

As the matching result, when the criterion ID and the PDI data ID are identical to each other and values thereof are identical to each other, the receiver 900 may download corresponding content. In detail, the filtering engine 901 according to the present embodiment may transmit a download request signal for downloading content to the content provider.

As the matching result, when the criterion ID and the PDI data ID are not identical to each other, the PDI engine 902 may transmit a null ID (identifier) to the filtering engine 901, as illustrated in FIG. 60. The filtering engine 901 that has received the null ID may transmit a new PDI data request signal to the PDI engine 902. In this case, the new PDI data request signal may include a new criterion ID.

The receiver 900 according to the present embodiment may match all filtering criterions contained in the filtering criteria with the PDI data using the aforementioned method. As the matching result, when the all filtering criterions are matched with the PDI data, the filtering engine 901 may transmit the download request signal for downloading contents to the content provider.

FIG. 61 is a flowchart of a digital broadcast system according to another embodiment of the present invention.

In detail, FIG. 61 is a flowchart of operations of a filtering engine and a PDI engine of the personalization broadcast system described with reference to FIGS. 58 and 59.

As illustrated in FIG. 61, a receiver 1000 according to the present embodiment may include a filtering engine 1001 and/or a PDI engine 1002. The structure of the aforementioned receiver may be changed according to a designer's intention. Basic operations of the filtering engine 1001 and the PDI engine 1002 illustrated in FIG. 61 are the same as the operations described with reference to FIG. 60.

However, as the matching result of the filtering criterion and the PDI data, when the criterion ID is not identical to the PDI data ID, the receiver 1000 illustrated in FIG. 61 may not download corresponding content, according to an embodiment of the present invention.

In detail, when the filtering engine 1001 according to the present embodiment receives a null ID, a new PDI data request signal may not be transmitted to the PDI engine 1002, according to an embodiment of the present invention. In addition, when all the filtering criterions contained in the filtering criteria are not matched with the PDI data, the filtering engine 1001 according to the present embodiment may not transmit the download request signal to the content provider, according to an embodiment of the present invention.

FIG. 62 is a diagram illustrating a PDI Table according to an embodiment of the present invention.

The personalization broadcast system described with reference to FIG. 58 may use PDI data in order to provide a personalization service and process the PDI data in the form of PDI Table. The data structure that encapsulates the questionnaire and the answers given by a particular user is called a PDI questionnaire or a PDI Table. A PDI Table, as provided by a network, broadcaster or content provider, includes no answer data, although the data structure accommodates the answers once they are available. The question portion of an entry in a PDI Table is informally called a “PDI question” or “PDI-Q.” The answer to a given PDI question is referred to informally as a “PDI-A.” A set of filtering criteria is informally called a “PDI-FC”. According to an embodiment of the present invention, the PDI table may be represented in XML schema. A format of the PDI table according to the present embodiment may be changed according to a designer's intention.

As illustrated in FIG. 62, the PDI table according to the present embodiment may include attributes 1110 and/or PDI type elements. The attributes 1110 according to the present embodiment may include a transactional attribute 1100 and a time attribute 1101. The PDI type elements according to the present embodiment may include question with integer answer (QIA) elements 1102, question with Boolean answer (QBA) elements 1102, question with selection answer (QSA) elements 1104, question with text answer (QTA) elements 1105, and/or question with any-format answer (QAA) elements 1106. Hereinafter, elements of the PDI table illustrated in FIG. 62 will be described.

In detail, the attributes 1110 illustrated in FIG. 62 may indicate information of attributes of the PDI table according to the present embodiment. Thus, even if the PDI type elements included in the PDI table are changed, the attributes 1110 may not be changed in the PDI table according to the present embodiment. For example, the transactional attribute 1100 according to the present embodiment may indicate information regarding an objective of a PDI question. The time attribute 1101 according to the present embodiment may indicate information regarding time when the PDI table is generated or updated. In this case, even if PDI type elements are changed, PDI tables including different PDI type elements may include the transactional attribute 1100 and/or the time attribute 1101.

The PDI table according to the present embodiment may include one or two or more PDI type elements 1102 as root elements. In this case, the PDI type elements 1102 may be represented in a list form.

The PDI type elements according to the present embodiment may be classified according to a type of PDI answer. For example, the PDI type elements according to the present embodiment may be referred to as “QxA” elements. In this case, “x” may be determined according to a type of PDI answer. The type of the PDI answer according to an embodiment of the present invention may include an integer type, a Boolean type, a selection type, a text type, and any type of answers other than the aforementioned four types.

QIA elements 1103 according to an embodiment of the present invention may include an integer type of PDI answer to one PDI question and/or corresponding PDI question.

QBA elements 1104 according to an embodiment of the present invention may include a Boolean type of PDI answer to one PDI question and/or corresponding PDI question.

QSA elements 1105 according to an embodiment of the present invention may include a multiple selection type of PDI answer to one PDI question and/or corresponding PDI question.

QTA elements 1106 according to an embodiment of the present invention may include a text type of PDI answer to one PDI question and/or corresponding PDI question.

QAA elements 1107 according to an embodiment of the present invention may include a predetermined type of PDI answer, other than integer, Boolean, multiple-selection, and text types, to one PDI question and/or corresponding PDI question.

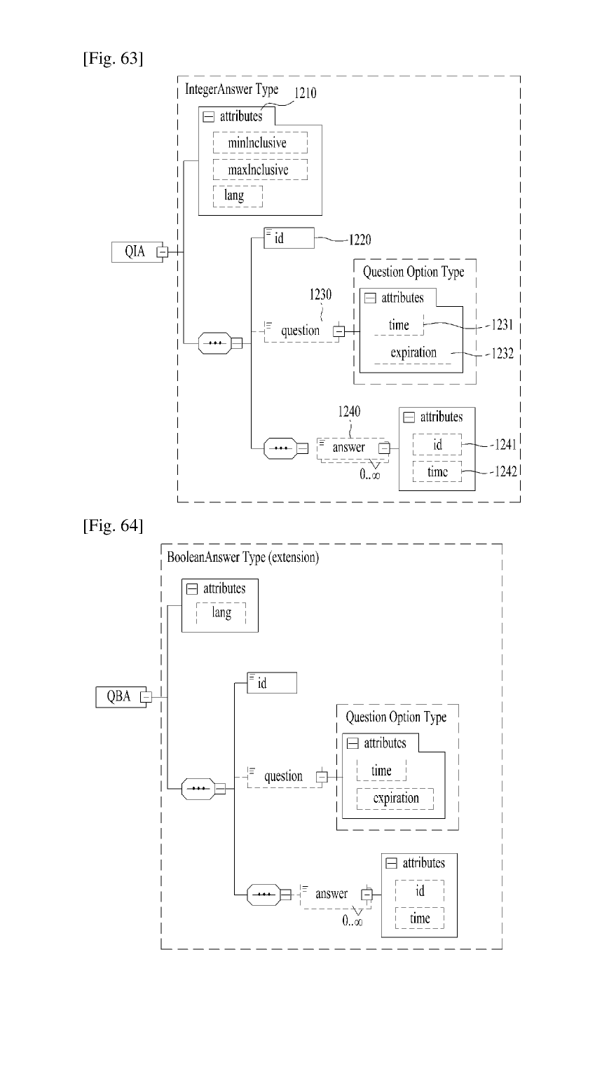

FIG. 63 is a diagram illustrating a PDI Table according to another embodiment of the present invention.

In detail, FIG. 63 illustrates XML schema of QIA elements among the PDI type elements described with reference to FIG. 62.

As illustrated in FIG. 63, the QIA elements may include attributes 1210 indicating information regarding attributes related to a PDI question type, identifier attribute 1220, a question element 1230, and/or an answer element 1240.

In detail, the attributes 1210 according to the present embodiment may include language attribute indicating a language of a PDI question. In addition, the attributes 1210 of the QIA elements according to the present embodiment may include a mininclusive attribute 1230 indicating a minimum integer of a PDI question and/or a maxinclusive attribute 1240 indicating a maximum integer of the PDI question.

The identifier attribute 1220 according to the present embodiment may be used to identify the PDI question and/or the PDI answer.

The question element 1230 according to the present embodiment may include the PDI question. As illustrated in FIG. 63, the question element 1230 may include attributes indicating information regarding the PDI question. For example, the question element 1230 may include time attribute 1231 indicating time when the PDI question is generated or transmitted and/or expiration time of the PDI question.

In addition, the answer element 1240 according to the present embodiment may include the PDI answer. As illustrated in FIG. 63, the answer element 1240 may include attributes indicating information regarding the PDI answer. For example, as illustrated in FIG. 63, the answer element 1240 may include identifier attribute 1241 used to recognize each PDI answer and/or time attribute 1242 indicating time when each PDI answer is generated or corrected.

FIG. 64 is a diagram illustrating a PDI table according to another embodiment of the present invention.

In detail, FIG. 64 illustrates XML schema of QBA elements among the PDI type elements described with reference to FIG. 62.

As illustrated in FIG. 64, basic elements of the XML schema of the QBA elements are the same as the elements described with reference to FIG. 63, and thus, a detailed description thereof is omitted.

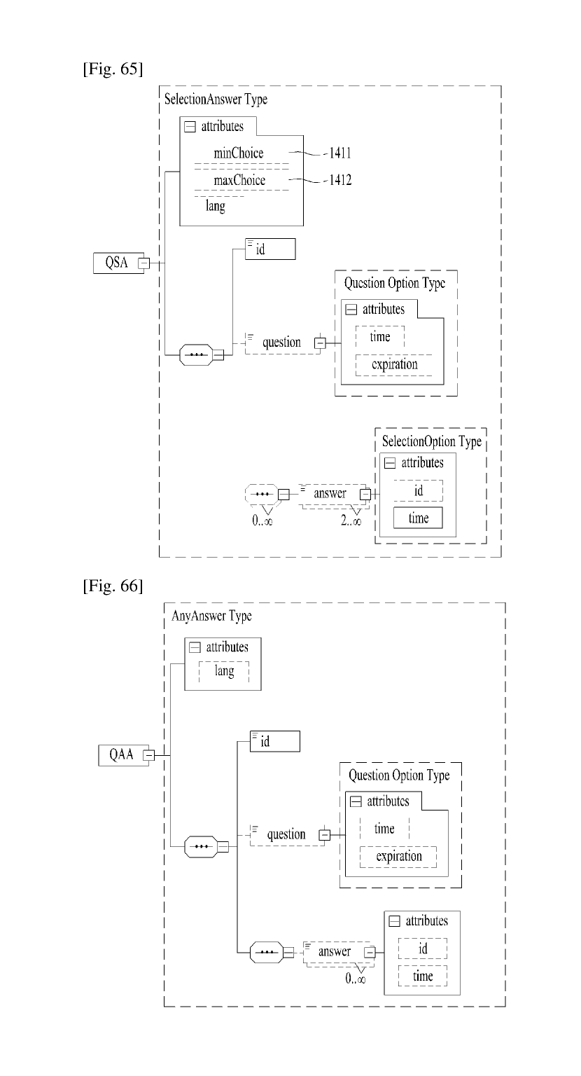

FIG. 65 is a diagram illustrating a PDI table according to another embodiment of the present invention.

In detail, FIG. 65 illustrates XML schema of the QSA elements among the PDI type elements described with reference to FIG. 62.

Basic elements of the XML schema of the QSA elements illustrated in FIG. 65 are the same as the elements described with reference to FIG. 65, and thus, a detailed description thereof is omitted.

However, according to the attribute of multiple selection question, the attribute of the QSA elements according to the present embodiment may further include minchoice attribute 1411 and/or maxchoice attribute 1412. The minchoice attribute 1411 according to the present embodiment may indicate a minimum number of PDI answers that can be selected by the user. The maxchoice attribute 1412 according to the present embodiment may indicate a maximum number of PDI answers that can be selected by the user.

FIG. 66 is a diagram illustrating a PDI table according to another embodiment of the present invention.

In detail, FIG. 66 illustrates XML schema of the QAA elements among the PDI type elements described with reference to FIG. 11.

As illustrated in FIG. 66, basic elements of the XML schema of the QAA elements are the same as the elements described with reference to FIG. 63, and thus, a detailed description thereof is omitted.

FIG. 67 is a diagram illustrating a PDI table according to another embodiment of the present invention.

In detail, FIG. 67 illustrates an extended format of a PDI table in XML schema as the PDI table described with reference to FIGS. 62 through 66.

As described above, according to an embodiment of the present invention, the PDI table is used to provide a personalization service. However, despite of the same user, preferred content may be changed according to a situation to which the user belongs.

Thus, in order to overcome this problem, according to an embodiment of the present invention, the PDI table may further include an element indicating information regarding the situation of the user.

The PDI table illustrated in FIG. 67 may further include situation element 1600 as the element indicating the information regarding the situation of the user. The basic XML schema of the PDI table illustrated in FIG. 67 is the same as the XML schema described with reference to FIGS. 62 through 66, and thus, a detailed description thereof is omitted. Hereinafter, the situation element 1600 will be described.

The situation element 1600 according to the present embodiment may indicate information regarding a timezone and/or location as the information of situation of the user. As illustrated in FIG. 67, the situation element 1600 may further include a time element 1610, a location element 1620, and/or other elements indicating the information of situation of the user. Hereinafter, each element will be described.

The time element 1610 according to the present embodiment may include information regarding time of an area to which the user belongs. For example, the time element 1610 may include time attribute 1611 indicating time information in the form of “yyyy-mm-dd” and/or timezone attribute 1612 indicating a time zone of the area to which the user belongs.

The location element 1620 according to the present embodiment may include information of a location to which the user belongs. For example, as illustrated in FIG. 67, the location element 1620 may include location-desc attribute 1621 indicating information of a corresponding location, latitude attribute 1622 indicating information of latitude of the corresponding location, and/or longitude attribute 1623 indicating information of longitude of the corresponding location.

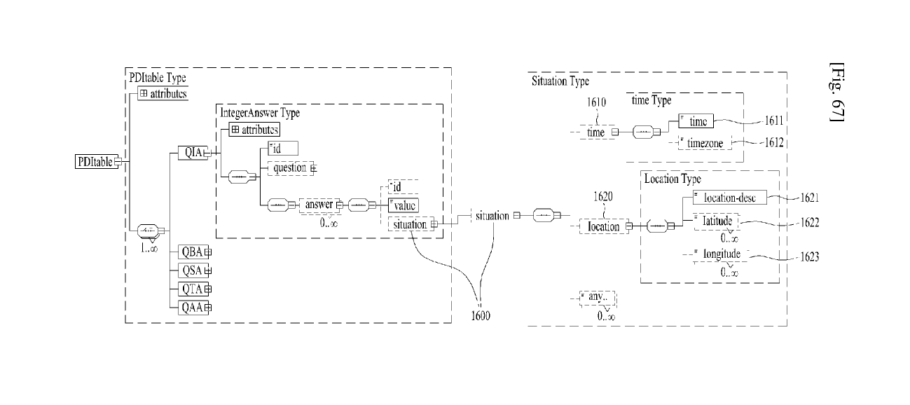

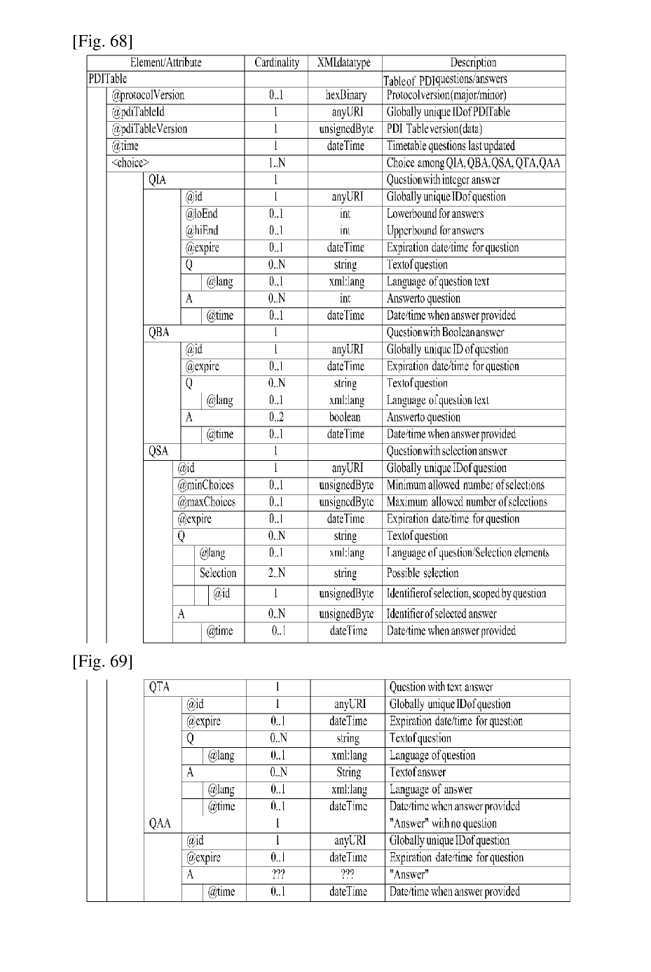

FIGS. 68 and 69 illustrate a PDI table according to another embodiment of the present invention.

In detail, FIGS. 68 and 69 illustrates the PDI table in the XML schema described with reference to FIGS. 62 through 67 with regard to an embodiment of the present invention.

FIGS. 68 and 69 depicts the XML schema definition for a root element called PDI Table, which defines the structure of PDI table instance documents. According to an embodiment of the present invention, the PDI table instance document refers to an actual document obtained by realizing the PDI table in the XML schema.

FIGS. 68 and 69 also depicts the XML schema definitions for root elements QIA, QBA, QSA, QTA, or QAA, which represent individual questions that can be passed back and forth between DOs and the underlying receiver, using the PDI application programming interface (API). The PDI API according to the present embodiment will be described in detail. The elements shown in FIGS. 68 and 69 may conform to the definitions in the XML schema with namespace “http://www.atsc.org/XMLSchemas/iss/pdi/1”.

Differences between PDI question (or PDI-Q) and PDI answer (or PDI-A) are specified in the usage rules rather than the schema itself. The question portion of an entry in a PDI Table is informally called a “PDI Question” or “PDI-Q”. The answer to a given PDI question is referred to informally as a “PDI-A”. For example, while the schema indicates minOccurs=“0” for the “q” element of the various types of questions, when the schema is used for PDI-Q use of the “q” elements in that case are mandatory. When the schema is used for PDI-A, inclusion of the “q” elements is optional.

PDI-Q instance documents can conform to the “PDI Table” XML schema that is part of ATSC 2.0 Standard, with its namespace, and that definition can take precedence over the description provided here in the event of any difference. According to an embodiment of the present invention, the PDI-Q instance document refers to an actual document obtained by realizing the PDI table including PDI-Q in the XML schema.

A PDI-Q instance document consists of one or more elements of type QIA (integer-answer type question), QBA (Boolean-answer type question), QSA (selection-type question), and/or QTA (textual-answer type question).

No “A” (answer) child elements of these top-level elements can be present in a PDI-Q instance.

The identifier attribute (“id”) in each of these elements can serve as a reference or linkage to corresponding elements in a PDI-A instance document. According to an embodiment of the present invention, the PDI-A instance document refers to an actual document obtained by realizing the PDI table including PDI-A in the XML schema.

PDI-A instance documents can conform to the “PDI Table” XML schema that is part of ATSC 2.0 Standard, with its namespace, and that definition can take precedence over the description provided here in the event of any difference.

A PDI-A instance document consists of one or more elements of type QIA (integer-answer type question), QBA (Boolean-answer type question), QSA (selection-type answer question), QTA (textual-answer type question), and/or QAA (any-format answer type question).

Each of these elements has at least one “A” (answer) child element. They may or may not include any “Q” (question string) child elements.

The identifier attribute (“id”) in each of these elements can serve as a reference or linkage to corresponding elements in a PDI-Q instance document.

Hereinafter, semantics of the elements and attributes included in the PDI table illustrated in FIGS. 68 and 69 will be described.

As illustrated in FIGS. 68 AND 69, in the PDI table according to the present embodiment, “@” may be indicated at the front of a name of attribute so as to distinguish between the attributes and the elements.

The PDI table according to the present embodiment may include PDI type elements. In detail, the PDI type elements may include QIA elements, QBA elements, QSA elements, QTA elements, and/or QAA elements, as described with reference to FIG. 62.

As illustrated in FIGS. 68 AND 69, the PDI table according to the present embodiment may include protocolversion attribute, pditableid attribute, pditableversion attribute, and/or time attribute regardless of the question type elements.

The id attributes of the QIA, QBA, QSA, QTA and QAA elements all have the same semantics, as do the expire attributes of each of these elements. Similarly the lang attributes of each of the Q elements each have the same semantics, as do the time attributes of each of the A elements. In addition, the id attributes may refer to the PDI data identifier that has been described with reference to FIG. 60.

A PDITable element contains the list of one or more question elements. Each one is in the format of QIA, QBA, QSA, QTA, or QAA. The use of the <choice> construct with cardinality 0 . . . N means that any number of QIA, QBA, QSA, QTA and QAA elements can appear in any order.

A protocolVersion attribute of the PDITable element consists of 2 hex digits. The high order 4 bits indicates the major version number of the table definition. The low order 4 bits indicates the minor version number of the table definition. The major version number for this version of this standard is set to 1. Receivers are expected to discard instances of the PDI indicating major version values they are not equipped to support. The minor version number for this version of the standard is set to 0. Receivers are expected to not discard instances of the PDI indicating minor version values they are not equipped to support. In this case they are expected to ignore any individual elements or attributes they do not support.

A pdiTableId attribute of the PDITable element can be a globally unique identifier of this PDI Table element.

A pdiTableVersion attribute with 8-bit of the PDITable element indicates the version of this PDI Table element. The initial value can be 0. The value can be incremented by 1 each time this PDI Table element changes, with rollover to 0 after 255.

A time attribute of the PDITable element indicates the date and time of the most recent change to any question in this PDI Table.

A QIA element represents an integer-answer type of question. It includes optional limits specifying the maximum and minimum allowed values of the answer.

A QIA.loEnd attribute of QIA indicates the minimum possible value of an “A” child element of this QIA element. I.e., the value of an “A” element is no less than loEnd. If the loEnd attribute is not present, that indicates that there is no minimum.

A QIA.hiEnd attribute of QIA indicates the maximum possible value of an “A” child element of this QIA element. I.e., the value of an answer is no greater than hiEnd. If the hiEnd attribute is not present, that indicates that there is no maximum.

A QIA.Q element is a child element of the QIA element. The value of the QIA.Q element can represent the question string to be presented to users. The question must be formulated to have an integer-type answer. There may be multiple instances of this element, in different languages.

A QIA.A element as a child element of the QIA element can have a integer-value. The QIA.A element can represent an answer to the question in QIA.Q.

A QBA element represents a Boolean-answer type of question.

A QBA.Q element is a child element of the QBA element. The value of the QBA.Q element can represent the question string to be presented to users. The question must be formulated to have a yes/no or true/false type of answer. There may be multiple instances of this element in different languages.

A QBA.A element as a child element of the QBA element can have a Boolean-value. A QBA.A element can represent an answer to the question in QBA.Q.

A QSA element represents a selection-answer type of question.

A QSA.minChoices attribute of the QSA element can specify the minimum number of selections that can be made by a user.

A QSA.maxChoices attribute of the QSA element can specify the maximum number of selections that can be made by a user.

A QSA.Q element is a child element of the QSA element. The value of the QSA.Q element represents the question string to be presented to users. The question must be formulated to have an answer that corresponds to one or more of the provided selection choices.

A QSA.Q.Selection element is a child element of the QSA.Q element. The value of the QSA.Q.Selection element can represent a possible selection to be presented to the user. If there are multiple QSA.Q child elements of the same QSA element (in different languages), each of them has the same number of Selection child elements, with the same meanings.

A QSA.Q.Selection.id attribute of QSA.Q.Selection can be an identifier for the Selection element, unique within the scope of QSA.Q. If there are multiple QSA.Q child elements of the same QSA element (in different languages), there can be a one-to-one correspondence between the id attributes of their Selection elements, with corresponding Selection elements having the same meaning.

A QSA.A is a child element of the QSA element. Each instance of this child element of the QSA element can specify one allowed answer to this selection-type question, in the form of the id value of one of the Selection elements.

A QTA element represents a textual-answer (free-form entry) type of question.

A QTA.Q element is a child element of the QTA element. The value of the QTA.Q element can represent the question string to be presented to users. The question must be formulated to have a free-form text answer.

A QTA.A element is a child element of the QTA element. The value of the QTA.A element can represent an answer to the question in QTA,Q.

A QAA element may be used to hold various types of information, like an entry in a database.

A QAA.A element is a child element of the QAA element. The value of the QAA.A element contains some type of information.

An id attribute of the QIA, QBA, QSA, QTA, and QAA elements can be a URI which is a globally unique identifier for the element in which it appears.

An expire element of the QIA, QBA, QSA, QTA, and QAA elements can indicate a date and time after which the element in which it appears is no longer relevant and is to be deleted from the table.

A lang attribute of the QIA.Q, QBA.Q, QSA.Q QTA.Q and QTA.A elements can indicate the language of the question or answer string. In the case of QSA.Q the lang attribute can also indicate the language of the Selection child elements of QSA.Q. If the lang attribute is not present, that can indicate that the language is English.

A time attribute of the QIA.A, QBA.A, QSA.A, QTA.A, and QAA.A elements can indicate the date and time the answer was entered into the table.

Although not illustrated in FIGS. 68 AND 69, the PDI table according to the present embodiment may further include QIAD element, QBAD element, QSAD element, QTAD element, and/or QAAD element. The aforementioned elements will be collectively called the QxAD elements. Hereinafter, the QxAD elements will be described.

A QIAD element as a root element shall contain an integer-answer type of question in the QIA child element. QIA includes optional limits specifying the maximum and minimum allowed values of the answer.

A QBAD element as a root element shall represent a Boolean-answer type of question.

A QSAD element as a root element shall represent a selection-answer type of question.

A QTAD element as a root element shall represent a textual-answer (free-form entry) type of question.

A QAAD element as a root element shall be used to hold various types of information, like an entry in a database.

Although not illustrated in FIGS. 68 AND 69, each PDI type element may further include a QText element and/or time attribute.

A QIA.Q.QText element is a child element of the QIA.Q element. The value of the QIA.Q.QText element shall represent the question string to be presented to users. The question must be formulated to have an integer-type answer.

A QIA.A.answer attribute is an integer-valued attribute of the QIA.A element. The QIA.A.answer attribute shall represent an answer to the question in QIA.Q.QText element.

A QBA.Q.Qtext element is a child element of the QBA.Q element. The value of the QBA.Q.Qtext element shall represent the question string to be presented to users. The question must be formulated to have a yes/no or true/false type of answer. There may be multiple instances of this element in different languages.

A QBA.A.answer attribute is a Boolean-valued attribute of the QBA.A element. The QBA.A@answer attribute shall represent an answer to the question in QBA.Q.QText element.

A QSA.Q.QText element is a child element of the QSA.Q element. The QSA.Q.QText element shall represent the question string to be presented to users. The question must be formulated to have an answer that corresponds to one or more of the provided selection choices. There may be multiple instances of this element in different languages.

A QSA.A.answer attribute of the QSA.A child element shall specify one allowed answer to this selection-type question, in the form of the id value of one of the Selection elements.

A QTA.Q.QText element is a child element of the QTA element. The value of the QTA.Q.QText element shall represent the question string to be presented to users. The question must be formulated to have a free-form text answer.

A QTA.A.answer attribute is a child element of the QTA element. The value of the QTA.A.answer element represents an answer to the question in QTA.Q.QText element.

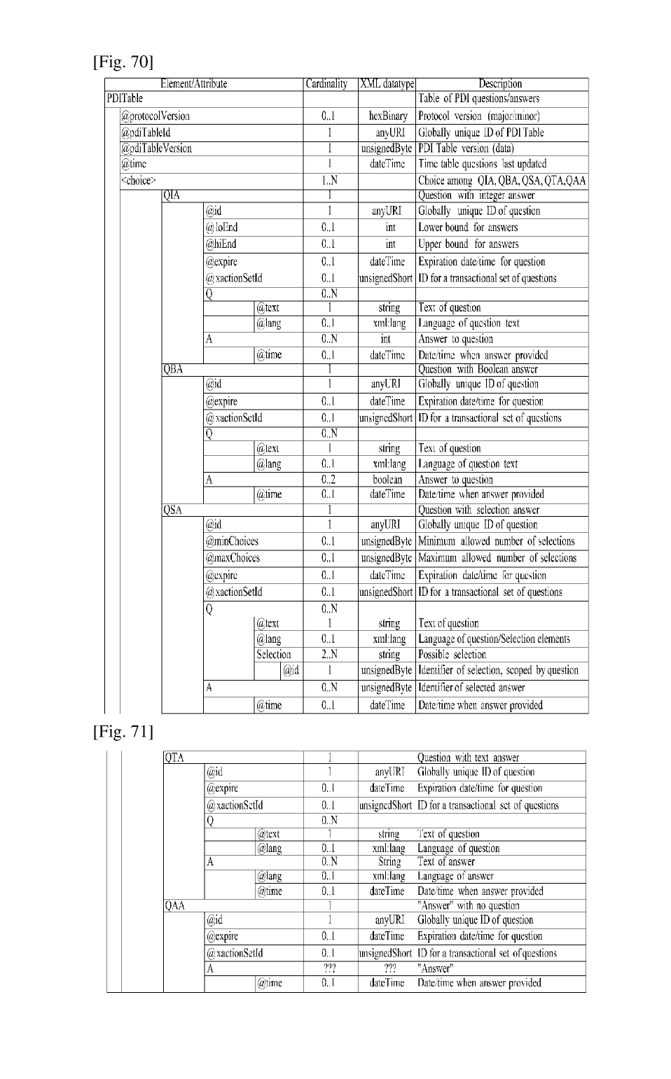

FIGS. 70 and 71 illustrates a PDI table according to another embodiment of the present invention.

In detail, FIGS. 70 AND 71 illustrates the structure of the PDI table in the XML schema described with reference to FIGS. 62 through 67.

The basic structure of the PDI table illustrated in FIGS. 70 AND 71 and semantics of the basic elements and attributes are the same as those in FIGS. 68 AND 69. However, unlike the PDI table illustrated in FIGS. 68 AND 69, the PDI table illustrated in FIGS. 70 AND 71 may further include a xactionSetId attribute and/or a text attribute. Hereinafter, the PDI table will be described in terms of the xactionSetId attribute and/or the text attribute.

A xactionSetId attribute of the QxA elements indicates that the question belongs to a transactional set of questions, where a transactional set of questions is a set that is to be treated as a unit for the purpose of answering the questions. It also provides an identifier for the transactional set to which the question belongs. Thus, the set of all questions in a PDI Table that have the same value of the xactionSetId attribute is answered on an “all or nothing” basis.

A text attribute of the QxA elements is a child element of QxA.Q elements. The value of the text attribute can represents the question string to be presented to users.

FIG. 72 is a diagram illustrating a filtering criteria table according to an embodiment of the present invention. The aforementioned personalization broadcast system of FIG. 58 may use filtering criteria in order to provide a personalization service. The filtering criteria described with reference to FIGS. 58, 60, and 61 may be processed in the form of filtering criteria table. According to an embodiment of the present invention, the filtering criteria table may be represented in the form of XML Schema.

According to an embodiment of the present invention, the filtering criteria table may have a similar format to a format of the PDI table in order to effectively compare the PDI data and the filtering criteria. The format of the filtering criteria table according to the present embodiment may be changed according to a designer's intention.

As illustrated in FIG. 72, the filtering criteria table according to the present embodiment may include a filtering criterion element 1900. The filtering criterion element 1900 may include identifier attribute 1901, criterion type attribute 1902, and/or a criterion value element 1903. The filtering criterion according to the present embodiment may be interpreted as corresponding to the aforementioned PDI question. Hereinafter, elements of the filtering criteria table illustrated in FIG. 72 will be described.

The filtering criterion element 1900 according to the present embodiment may indicate filtering criterion corresponding to the PDI question.

The identifier attribute 1901 according to the present embodiment may identify a PDI question corresponding to the filtering criterion.

The criterion type attribute 1902 according to the present embodiment may indicate a type of the filtering criterion. The type of the filtering criterion will be described in detail.

The criterion value element 1903 according to the present embodiment may indicate a value of the filtering criterion. Each criterion value is a possible answer to the PDI question.

In detail, the type of the filtering criterion according to the present invention may be one of an integer type, a Boolean type, a selection type, a text type, and/or any type.

The filtering criterion of the integer type (or integer type criterion) refers to filtering criterion corresponding to a PDI answer of the integer type.

The filtering criterion of the Boolean type (or Boolean type criterion) refers to filtering criterion corresponding to a PDI answer of the Boolean type.

The filtering criterion of the selection type (or selection type criterion) refers to filtering criterion corresponding to a PDI answer of the selection type.

The filtering criterion of the text type (or text type criterion) refers to filtering criterion corresponding to a PDI answer of the text type.

The filtering criterion of any type (or any type criterion) refers to filtering criterion corresponding to a PDI answer of any type.

[Example 5] below shows XML schema of the filtering criteria table illustrated in FIG. 72

according to an embodiment of the present invention.

[Example 5]

<?xml version=“1.0” encoding=“UTF-8”?>
<xs:schema xmlns:xs=“http://www.w3.org/2001/XMLSchema”

elementFormDefault=“qualified” attributeFormDefault=“unqualified”>

<xs:element name=“FilterCriteriaTable”
type=“FilterCriteriaTableType”/>
<xs:complexType name=“FilterCriteriaTableType”>
<xs:sequence maxOccurs=“unbounded”>
<xs:element name=“FilterCriterion” type=“FilterCriterionType”/>
</xs:sequence>
</xs:complexType>
<xs:complexType name=“FilterCriterionType”>
<xs:sequence>
<xs:element name=“CriterionValue” type=“xs:base64Binary”
maxOccurs=“unbounded”/>
</xs:sequence>
<xs:attribute name=“id” type=“xs:anyURI” use=“required”/>
<xs:attribute name=“CriterionType” type=“xs:unsignedByte”
use=“required”/>
</xs:complexType>
</xs:schema>

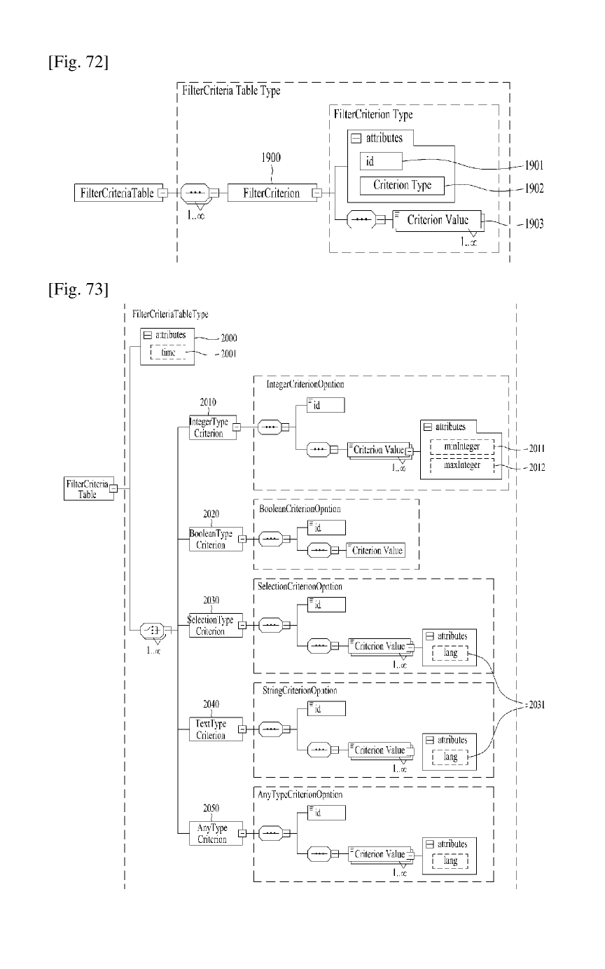

FIG. 73 is a diagram illustrating a filtering criteria table according to another embodiment of the present invention.

In detail, FIG. 73 illustrates an extended format of a filtering criteria table in XML schema as the filtering criteria table described with reference to FIG. 72. When the filtering criteria table is configured in the XML schema of the filtering criteria illustrated in FIG. 72, a type of filtering criterion according to an embodiment of the present invention. and detailed attribute for each type thereof cannot be set. Thus, FIG. 73 illustrates a type of filtering criterion and proposes XML schema for setting attribute for each type. A personalization broadcast system according to an embodiment of the present invention may more precisely filter content using a filtering criteria table configured in the XML schema of FIG. 73.

As illustrated in FIG. 73, the filtering criteria table may include attributes 2000 and/or filtering criterion type elements. The attributes 2000 according to the present embodiment may include time attribute 2001. The filtering criterion type elements according to the present embodiment may include an integer type criterion element (or QIA criterion element) 2010, a Boolean type criterion element (or QBA criterion element) 2020, a selection type criterion element (or QSA criterion element) 2030, a text type criterion element (or QTA criterion element) 2040, and/or any type criterion element (or QAA criterion element) 2050. Hereinafter, elements of the filtering criteria table illustrated in FIG. 73 will be described.

In detail, the attributes 2000 illustrated in FIG. 62 may indicate information of attributes of the filtering criteria table according to the present embodiment. Thus, even if filtering criteria type elements included in the filtering criteria table are changed, the attributes 2000 may not be changed. For example, the time attribute 2001 according to the present embodiment may indicate time when the filtering criteria are generated or updated. In this case, filtering criteria tables including different filtering criteria type elements may include the time attribute 2001 even if the filtering criteria type elements are changed.

The filtering criteria table according to the present embodiment may include one or more or more filtering criteria type elements. The filtering criteria type elements according to the present embodiment may indicate a type of filtering criterion. The type of filtering criterion has been described with reference to FIG. 72. In this case, the filtering criteria type elements may be represented in a list form.

The filtering criteria type elements according to the present embodiment may also be referred to as “QxA” criterion. In this case, “x” may be determined according to a type of filtering criterion.

As illustrated in FIG. 73, each of the filtering criteria type elements may include an identifier attribute and/or a criterion value element. An identifier attribute and a criterion value element illustrated in FIG. 73 are the same as those described with reference to FIG. 72.

However, as illustrated in FIG. 73, an integer type criterion element 2010 may further include a min integer attribute 2011 and/or a max integer attribute 2012. The min integer attribute 2011 according to the present embodiment may indicate a minimum value of the filtering criterion represented as an integer type answer. The max integer attribute 2012 according to the present embodiment may indicate a maximum value of the filtering criterion represented as an integer type answer.

As illustrated in FIG. 73, a selection type criterion element 2030 and/or a text type criterion element 2040 may include lang attribute 2031. The lang attribute 2031 according to the present embodiment may indicate a value of the filtering criterion represented in a text type answer.

[Example 6] below shows XML schema of the filtering criteria table illustrated in FIG. 73 according to an embodiment of the present invention.

[Example 6]

<?xml version=″1.0” encoding=″UTF-8″?>
<xs:schema xmlns:xs=″http://www.w3.org/2001/XMLSchema″

elementFormDefault=″qualified″ attributeFormDefault=″unqualified″>

<xs:element name=″FilterCriteriaTable″
type=″FilterCriteriaTableType″/>
<xs:complexType name=″FilterCriteriaTableType″>
<xs:choice maxOccurs=″unbounded″>
<xs:element name=″IntegerTypeCriterion″
type=″IntegerCriterionOption″/>
<xs:element name=″BooleanTypeCriterion″
type=″BooleanCriterionOpntion″/>
<xs:element name=″SelectionTypeCriterion″
type=″StringCriterionOption″/>
<xs:element name=″TextTypeCriterion″
type=″StringCriterionOption″/>
<xs:element name=″AnyTypeCriterion″
type=″AnyTypeCriterionOption″/>
</xs:choice>
<xs:attribute name=″time″ type=″xs:dateTime″/>
</xs:complexType>
<xs:complexType name=″IntegerCriterionOption″>
<xs:sequence>
<xs:element name=″id″ type=″xs:anyURI″/>
<xs:sequence>
<xs:element name=″CriterionValue” maxOccurs=″unbounded″>
<xs:complexType>
<xs:simpleContent>
<xs:extension base=”xs:integer”>
<xs:attribute name=”minInteger” type=”xs:integer”/
<xs:attribute name=”maxInteger” type=”xs:integer”/>
</xs:extension>
</xs:simpleContent>
</xs:complexType>
</xs:element>
</xs:sequence>
</xs:sequence>
</xs:complexType>
<xs:complexType name=″BooleanCriterionOpntion″>
<xs:sequence>
<xs:element name=″id″ type=″xs:anyURI″/>
<xs:sequence>
<xs:element name=″CriterionValue″ type=″xs:boolean″/>
</xs:sequence>
</xs:sequence>
</xs:complexType>
<xs:complexType name=″StringCriterionOption″>
<xs:sequence>
<xs:element name=″id″ type=″xs:anyURI″/>
<xs:sequence>
<xs:element name=″CriterionValue″ maxOccurs=″unbounded″>
<xs:complexType>
<xs:simpleContent>
<xs:extension base=″xs:string″>
<xs:attribute name=″lang″ type=″xs:string″ default=″EN-US″/>
</xs:extension>
</xs:simpleContent>
</xs:complexType>
</xs:element>
</xs:sequence>
</xs:sequence>
</xs:complexType>
<xs:complexType name=″AnyTypeCriterionOption″>
<xs:sequence>
<xs:element name=″id″ type=″xs:anyURI″/>
<xs:sequence>
<xs:element name=″CriterionValue” maxOccurs=″unbounded″/>
<xs:complexType>
<xs:simpleContent>
<xs:extension base=”xs:base64Binary”>
<xs:attribute name=”any” type=”xs:anySimpleType”/>
</xs:extension>
</xs:simpleContent>
</xs:complexType>
</xs:sequence>
</xs:sequence>
</xs:complexType> </xs:schema>

FIG. 74 is a diagram illustrating a filtering criteria table according to another embodiment of the present invention.

In detail, FIG. 74 illustrates a filtering criteria table in the XML schema described with reference to FIGS. 72 and 73. Basic elements of the filtering criteria table illustrated in FIG. 74 are the same as the elements described with reference to FIGS. 72 and 73. Hereinafter, semantics of the elements and attributes included in the filtering criteria table illustrated in FIG. 74 will be described.

As illustrated in FIG. 74, in the filtering criteria table according to the present embodiment, “@” may be indicated at the front of a name of attribute so as to distinguish between the attributes and the elements.

In each place where an @id attribute appears in the table, it shall be the @id attribute of a question in a PDI Table, thereby identifying the question that corresponds to the filtering criterion in which the @id attribute appears.

A QIA Criterion element shall represent a filtering criterion corresponding to a question with an integer value.

If a Criterion Value child element of a QIA Criterion element does not contain an @extent element, it shall represent an integer answer for the question corresponding to the filtering criterion. If a Criterion Value child element of a QIA Criterion element contains an @extent attribute, then it shall represent the lower end of a numeric range of answers for the question, and the @extent attribute shall represent the number of integers in the range.

A QBA Criterion element shall represent a filtering criterion corresponding to a question with a Boolean value.

A Criterion Value child element of a QBACriterion element shall represent a Boolean answer for the question corresponding to the filtering criterion.

A QSA Criterion element shall represent a filtering criterion corresponding to a question with selection value(s).

A Criterion Value child element of a QSA Criterion element shall represent the identifier of a selection answer for the question corresponding to the filtering criterion.

A QTA Criterion element shall represent a filtering criterion corresponding to a question with string value.

A Criterion Value child element of a QTA Criterion element shall represent a text answer for the question corresponding to the filtering criterion.

A QAA Criterion element shall represent a filtering criterion corresponding to a “question” that has only a text “answer” with no question.

A Criterion Value child element of a QAACriterion element shall represent a text “answer” for the “question” corresponding to the filtering criterion.

If there is only one Criterion Value element in the Filtering Criteria element, then the filtering decision for whether the service or content item passes the filter shall be “true” (yes) if the value of the Criterion Value element matches a value that is among the answers in the PDI-A for the question corresponding to the element containing the Criterion Value element (where the question is indicated by the id attribute of the element containing the Criterion Value element), and it shall be “false” (no) otherwise.

In the case of a Criterion Value child element of a QIA Criterion element in which the “extent” attribute is present, the value of the Criterion Value element shall be considered to match a value that is among the answers in the corresponding PDI-A if the value of the answer is in the interval defined by the Criterion Value and the extent attribute.

If the total number of Criterion Value elements in the Filtering Criteria element is greater than one, the result of each Criterion Value element shall be evaluated as an intermediate term, returning “true” if the Criterion Value matches a value that is among the answers in the PDI-A for the question corresponding to the filtering criterion (as indicated by the id value) and returning “false” otherwise. Among these intermediate terms, those with the same value of their parent element identifier (QIA.id, QBA.id, etc.) shall be logically ORed to obtain the interim result for each targeting criterion, and these interim results shall be logically ANDed together to determine the final result. If the final result evaluates to “true” for a receiver, it shall imply that the associated content item passes the filter.

FIG. 75 is a diagram illustrating a filtering criteria table according to another embodiment of the present invention.

In detail, FIG. 75 illustrates an extended format of the filtering criteria table illustrated in FIG. 74. Basic elements of the filtering criteria table illustrated in FIG. 75 are the same as the elements described with reference to FIG. 74. Hereinafter, the filtering criteria table illustrated in FIG. 75 will be described in terms of differences from the filtering criteria table described with reference to FIG. 74.

The filtering criteria table illustrated in FIG. 75 allows multiple instances of the set of filtering criteria. Each set includes multiple instance of filtering criteria. Each filtering criterion allows multiple values to be provided for some of the filtering criteria. The filtering logic is “OR” logic among multiple instances of the set of filtering criteria. Within each set of filtering criteria, the filtering logic is “OR” logic among multiple values for the same filtering criterion, and “AND” logic among different filtering criteria.

For example, if the filtering criteria is ((age=20) AND (genre=“sport”)) OR ((age=10) AND (genre=“animation”)), filtering criteria table can be represented as an [Example 7] below.

[Example 7]

<FilterCriteriaTable time=”2012-09-03T09:30:47.0Z”

xmlns:xsi=”http://www.w3.org/2001/XMLSchema-instance”>

<FilterCriterionSet>

<IntegerTypeCriterion id=”abc.tv/age/”>

<CriterionValue>20</CriterionValue>

</IntegerTypeCriterion>
<TextTypeCriterion id = ”abc.tv/genre/”>

<CriterionValue>sport</CriterionValue>

</TextTypeCriterion>

```
  </FilterCriterionSet>
  <FilterCriterionSet>
```

<IntegerTypeCriterion id= ”abc.tv/age/”>

<CriterionValue>10</CriterionValue>

</IntegerTypeCriterion>
<TextTypeCriterion id = ”abc.tv/genre//”>

<CriterionValue>animation</CriterionValue>

</TextTypeCriterion>

</FilterCriterionSet>

</FilterCriteriaTable>

FIG. 76 is a flowchart of a digital broadcast system according to another embodiment of the present invention.

In detail, FIG. 76 is a flowchart of a personalization broadcast system that allows a receiver according to the embodiment of the present invention to receive a PDI table and/or a filtering criteria table via a broadcast network.

The basic structure of the personalization broadcast system according to the present embodiment is the same as the structure described with reference to FIGS. 58 through 61. The PDI table according to the present embodiment is the same as the table described with reference to FIGS. 60 through 71. The filtering criteria table according to the present embodiment is the same as the table described with reference to FIGS. 72 through 75.

As illustrated in FIG. 76, the personalization broadcast system according to the present embodiment may include a service signaling channel (SSC) 2300, a file delivery over unidirectional transport (FLUTE) session 2310, a filtering engine 2320, a PDI engine 2330, and/or a UI 2340. The receiver according to the present embodiment may receive a PDI table through a digital storage media command and control (DSM-CC) section. In this case, the receiver according to the present embodiment may receive the PDI table through the FLUTE session 2310. The structure of the aforementioned personalization broadcast system may be changed according to a designer's intention. Hereinafter, operations of elements of FIG. 76 will be described.

First, the receiver according to the present embodiment may receive the PDI table section through the SSC 2300. In detail, the receiver according to the present embodiment may parse IP datagram corresponding to the SSC 2300 among IP datagram received through the DSM-CC section to receive the PDI table section. In this case, the receiver according to the present embodiment may receive the PDI table section using a well-known IP address and/or UDP port number included in the SSC 2300. The PDI table section according to the present embodiment refers to a table obtained by compressing a PDI table according to an embodiment of the present invention in order to transmit the PDI table via a broadcast network. The PDI table section will be described in detail.

The receiver according to the present embodiment may parse the PDI table section received through the SSC 2300 to acquire the PDI table. Then, the receiver according to the present embodiment may transmit the PDI table to the PDI engine 2330.

The PDI engine 2330 according to the present embodiment may process the received PDI table and extract PDI questions included in a corresponding PDI table. Then, the PDI engine 2330 according to the present embodiment may transmit the extracted PDI questions to the UI 2340.

The UI 2340 according to the present embodiment may display the received PDI questions and receive PDI answers to the corresponding PDI questions. In this case, the UI 2340 according to the present embodiment may receive the PDI answers through a remote controller. Then, the PDI engine 2330 according to the present embodiment may update PDI data using the PDI answer received from the UI 2340. A detailed description thereof has been described with reference to FIGS. 58 and 59.

The receiver according to the present embodiment may receive a service map table (SMT) and/or a non real time information table (NRT-IT) through the SSC 2300. The SMT according to the present embodiment may include signaling information for a personalization service. The NRT-IT according to the present embodiment may include announcement information for a personalization service.

Then, the receiver according to the present embodiment may parse the received SMT and/or NRT-IT to acquire a filtering criteria descriptor. The receiver may transmit filtering criteria to the filtering engine 2320 using the filtering criteria descriptor. In this case, according to an embodiment of the present invention the filtering criteria may be a filtering criteria table with a format of xml document. The filtering criteria table has been described in detail with reference to FIGS. 74 and 75.

Then, the filtering engine 2320 according to the present embodiment may transmit a PDI data request signal to the PDI engine 2330. When the PDI engine 2330 according to the present embodiment receives the PDI data request signal, the PDI engine 2330 may search for PDI data corresponding to the corresponding PDI data request signal and transmit the PDI data to the filtering engine 2320. As a result, the receiver according to the present embodiment may download content using a filtering result. Processes subsequent to the filtering according to the present embodiment have been described in detail with reference to FIGS. 60 and 61.

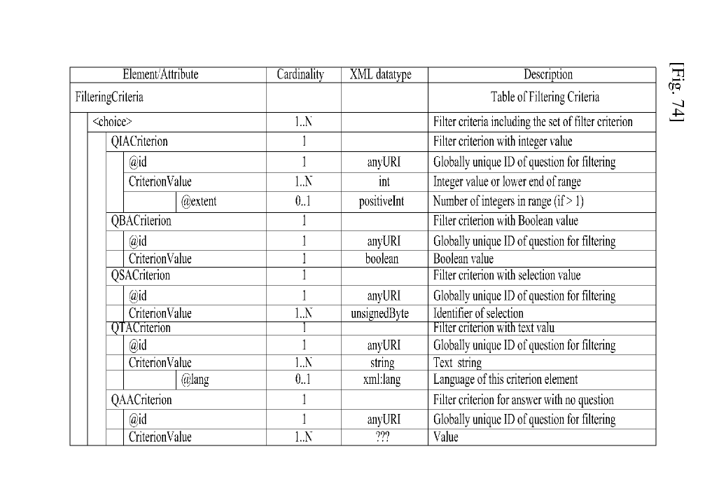

FIG. 77 is a diagram illustrating a PDI table section according to an embodiment of the present invention.

In detail, FIG. 77 illustrates syntax of the PDI table section described with reference to FIG. 76.

When a PDI table is delivered in the broadcast stream, the XML form of the Table defined in FIG. 76 is compressed using the DEFLATE compression algorithm. The resulting compressed table then is encapsulated in NRT-style private sections by dividing it into blocks and inserting the blocks into sections as shown in the Table of FIG. 24.

As a result, the receiver according to the present embodiment may combine blocks of a PDI-Q instance document in an order of section numbers having the same sequence number and release compression. The receiver according to the present embodiment may generate the PDI-Q instance document as a result of compression release. Then, the receiver may transmit the PDI-Q instance document to a PDI Engine according to an embodiment of the present invention. The detailed method has been described with reference to FIG. 76.

Hereinafter, syntax of the PDI table section illustrated in FIG. 77 will be described.

The blocks shall be inserted into the sections in order of ascending section_number field values. The private sections are carried in the Service Signaling Channel (SSC) of the IP subnet of the virtual channel to which the PDI Table pertains, as the terms “Service Signaling Channel” and “IP subnet” are defined in the ATSC NRT standard. The sequence_number fields in the sections are used to distinguish different PDI table instances carried in the same SSC.

A table_id field with 8-bits, shall be set to identify this table section as belonging to a PDI Table instance. The table_id field may indicate that the PDI table section illustrated in FIG. 77 contains information regarding a PDI table according to an embodiment of the present invention.

A section_syntax_indicator field according to the present embodiment may indicate a format of the PDI table section.

A private_indicator field according to the present embodiment may indicate bit information for users.

A section_length field according to the present embodiment may indicate a number of bytes in the PDI table section.

A table_id_extension field according to the present embodiment may identify the PDI table section.

A protocol_version field according to the present embodiment may contain the protocol versions of the PDI table syntax.

The value of the sequence_number field with 8-bits, is the same as the sequence_number of all other sections of this PDI-Q instance and different from the sequence_number of all sections of any other PDI-Q instance carried in this Service Signaling Channel. The sequence_number field is used to differentiate sections belonging to different instances of the PDI-Q that are delivered in the SSC at the same time.

A PDIQ_data_version field with 5-bits indicates the version number of this PDI-Q instance, where the PDI-Q instance is defined by its pdiTableId value. The version number is incremented by 1 modulo 32 when any element or attribute value in the PDI-Q instance changes.

A current_next_indicator field with a 1-bit always is set to ‘1’ for PDI-Q sections indicates that the PDI-Q sent is always the current PDI-Q for the segment identified by its segment_id.

A section_number field with 8-bits gives the section number of this section of the PDI-Q instance. The section_number of the first section in an PDI-Q instance is set to be 0x00. The section_number is incremented by 1 with each additional section in the PDI-Q instance.

A last_section_number field with 8-bits gives the number of the last section (i.e., the section with the highest section_number) of the PDI-Q instance of which this section is a part.

A service_id field with 16-bits is set to 0x0000 to indicate that this PDI-Q instance applies to all data services in the virtual channel in which it appears, rather than to any particular service.

A pdiq_bytes( ) field with a variable length consists of a block of the PDI-Q instance carried in part by this section. When the pdiq_bytes( ) fields of all the sections of this table instance are concatenated in order of their section_number fields, the result is the complete PDI-Q instance.

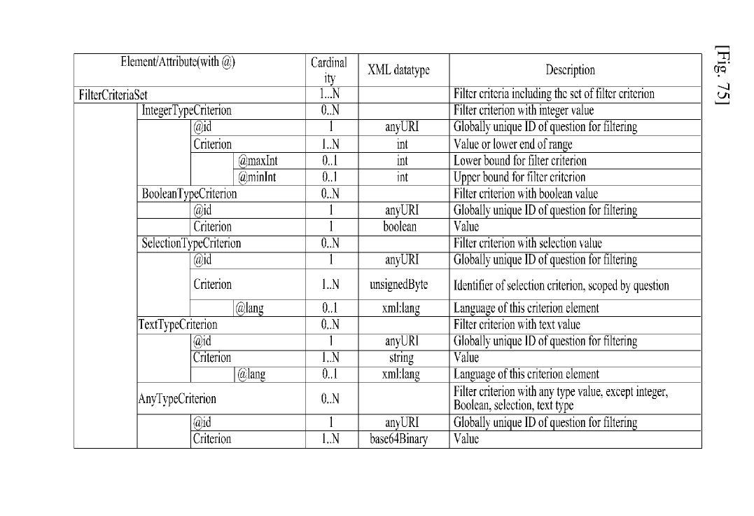

FIG. 78 is a diagram illustrating a PDI table section according to another embodiment of the present invention.

In detail, FIG. 78 illustrates syntax of the PDI table section described with reference to FIG. 76. A basic description has been given with reference to FIG. 77. However, unlike the PDI table section illustrated in FIG. 77, the PDI table section illustrated in FIG. 78 may not include a sequence_number field. Hereinafter, the syntax of the PDI table section illustrated in FIG. 78 will be described.

A num_questions field according to the present embodiment may indicate the number of PDI questions included in the PDI table.

A question_id_length field according to the present embodiment may indicate a length of an ID of one PDI question.

A question_id field according to the present embodiment may indicate an ID of one PDI question.

A question_text_length field according to the present embodiment may indicate a length of question_text.

A question_text field according to the present embodiment may include actual content of one PDI question.

An answer_type_code field according to the present embodiment may indicate a type of a PDI answer to a PDI question. In detail, the answer_type_code field according to the present embodiment may include answer type codes represented in Table 1 below. Hereinafter, each answer type code shown in Table 1 below may indicate a type of each of the PDI answers described with reference to FIG. 62.

TABLE 1

| answer_type_code | value |
|---|---|
| 0x00 | Reserved |
| 0x01 | Integer type |
| 0x02 | Boolean type |
| 0x03 | String type (including selection type/text type) |
| 0x04-0x07 | Reserved for future ATSC use |

A num_answer field according to the present embodiment may indicate the number of PDI answers to a PDI question.

An answer_value_length field according to the present embodiment may indicate an actual length of answer_value.

An answer_value field according to the present embodiment may include actual content of a PDI answer represented as answer_type_code.

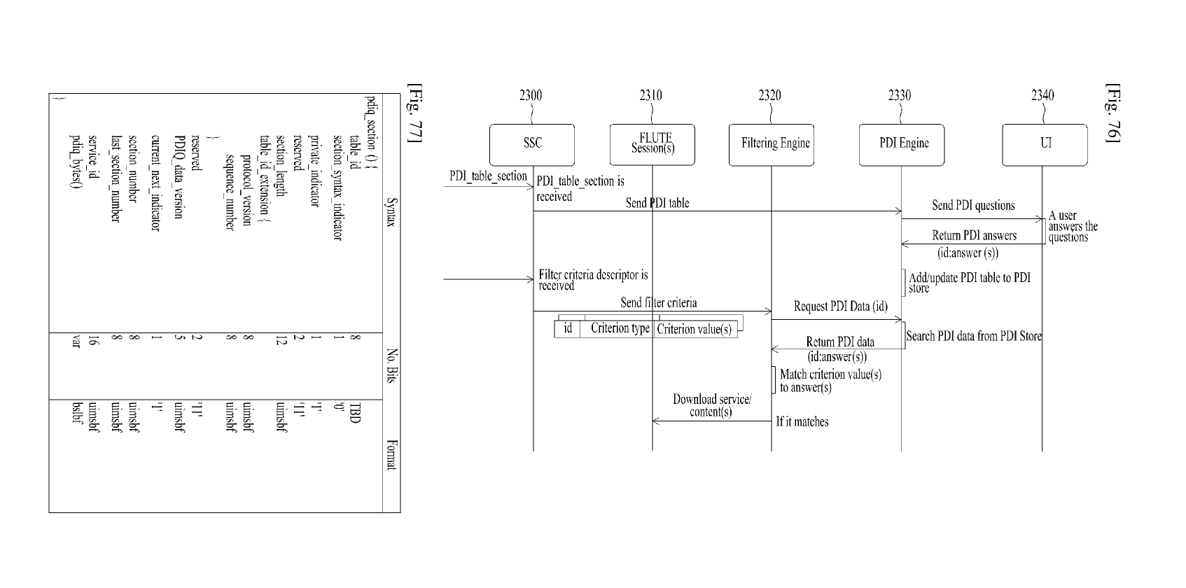

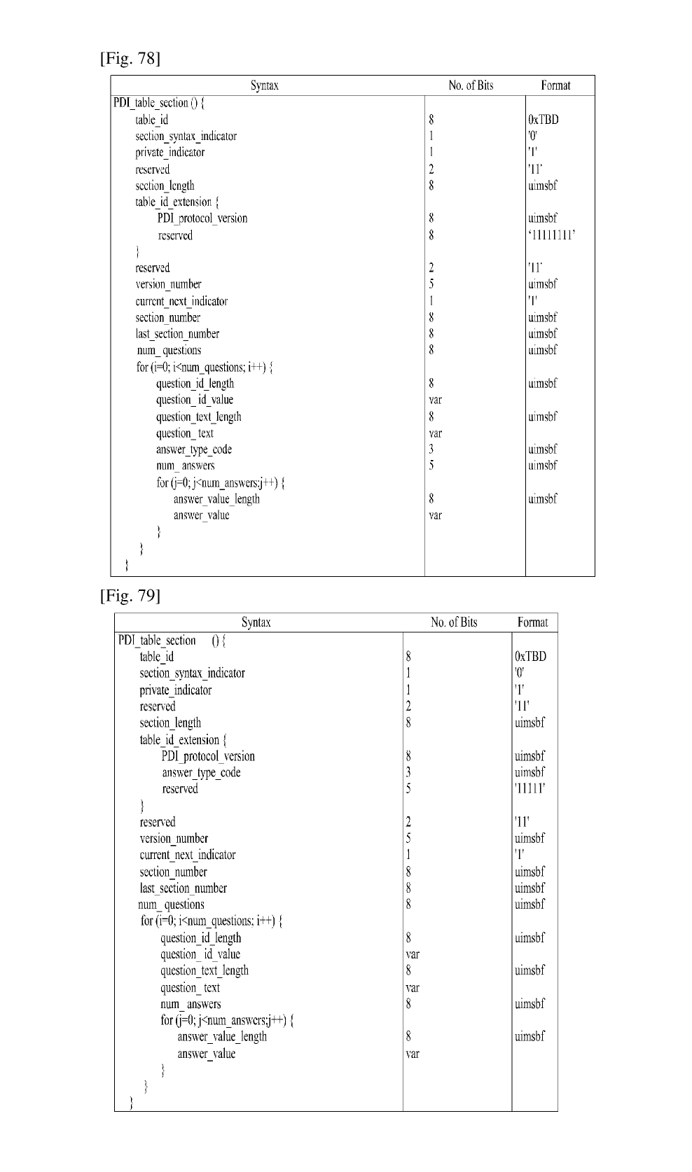

FIG. 79 is a diagram illustrating a PDI table section according to another embodiment of the present invention.

In detail, FIG. 79 illustrates syntax of the PDI table section described with reference to FIG. 76. A basic description has been given with reference to FIGS. 77 and 78. Fields constituting the syntax of FIG. 79 are the same as fields constituting the syntax of FIG. 78, and thus, a detailed description thereof is omitted.

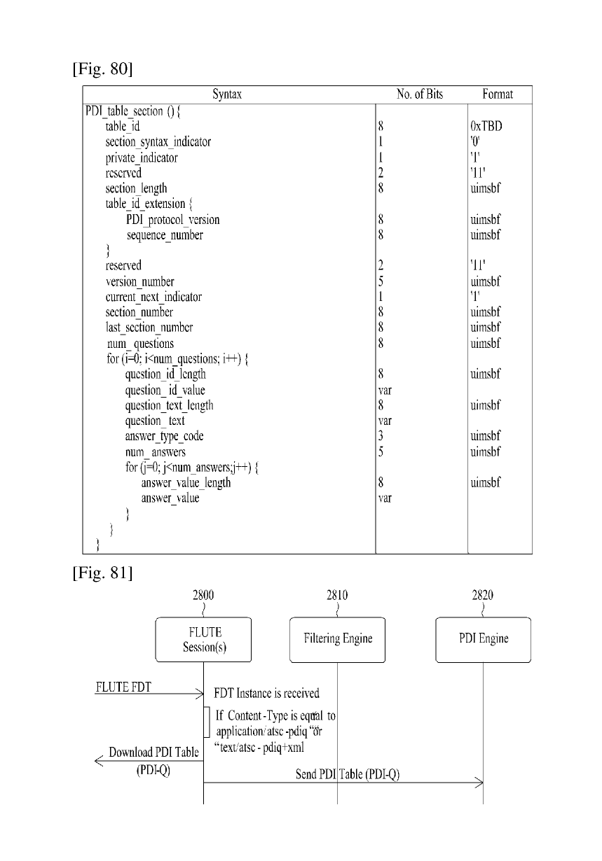

FIG. 80 is a diagram illustrating a PDI table section according to another embodiment of the present invention.

In detail, FIG. 80 illustrates syntax of the PDI table section described with reference to FIG. 76. A basic description has been given with reference to FIGS. 77 and 78. Basic fields constituting the syntax of FIG. 80 are the same fields constituting the syntax of FIG. 78, and thus, a detailed description thereof is omitted.

However, unlike the syntax of FIG. 78, the syntax of FIG. 80 may further include a sequence_number field. The sequence_number field according to the present embodiment is the same as the sequence_number field described with reference to FIG. 77.

FIG. 81 is a flowchart of a digital broadcast system according to another embodiment of the present invention.

In detail, FIG. 81 illustrates operations of a FLUTE session, a filtering engine, and/or a PDI engine in the personalization broadcast system described with reference to FIG. 76 according to an embodiment of the present invention.

As illustrated in FIG. 81, the personalization broadcast system according to the present embodiment may include a FLUTE session 2800, a filtering engine 2810, and/or a PDI engine 2820. The personalization broadcast system according to the present embodiment may provide a next generation broadcast service for providing an ATSC 2.0 service or a personalization service. The structure of the aforementioned personalization broadcast system may be changed according to a designer's intention.

As described with reference to FIG. 76, the receiver according to the present embodiment may receive a PDI table through a FLUTE session. Hereinafter, a method of receiving a PDI table through a FLUTE session by a receiver will be described with regard to an embodiment of the present invention with reference to FIG. 81.

The receiver according to the present embodiment may receive a field delivery table (FDT) instance through the FLUTE session 2800. The FDT instance is a transmission unit of content transmitted through the same FLUTE session 2800. The FDT instance according to the present embodiment may include content type attribute indicating a type of content. In detail, the content type attribute according to the present embodiment may include content indicating that a file transmitted through the FLUTE session 2800 is a PDI-Q instance document (or a PDI table). The content type attribute according to the present embodiment will be described in detail.

The receiver according to the present embodiment may recognize that a field transmitted through the FLUTE session 2800 is the PDI-Q instance document using the FDT instance. Then, the receiver according to the present embodiment may transmit the PDI-Q instance document to the PDI engine 2820. A detailed description thereof has been described with reference to FIG. 76.

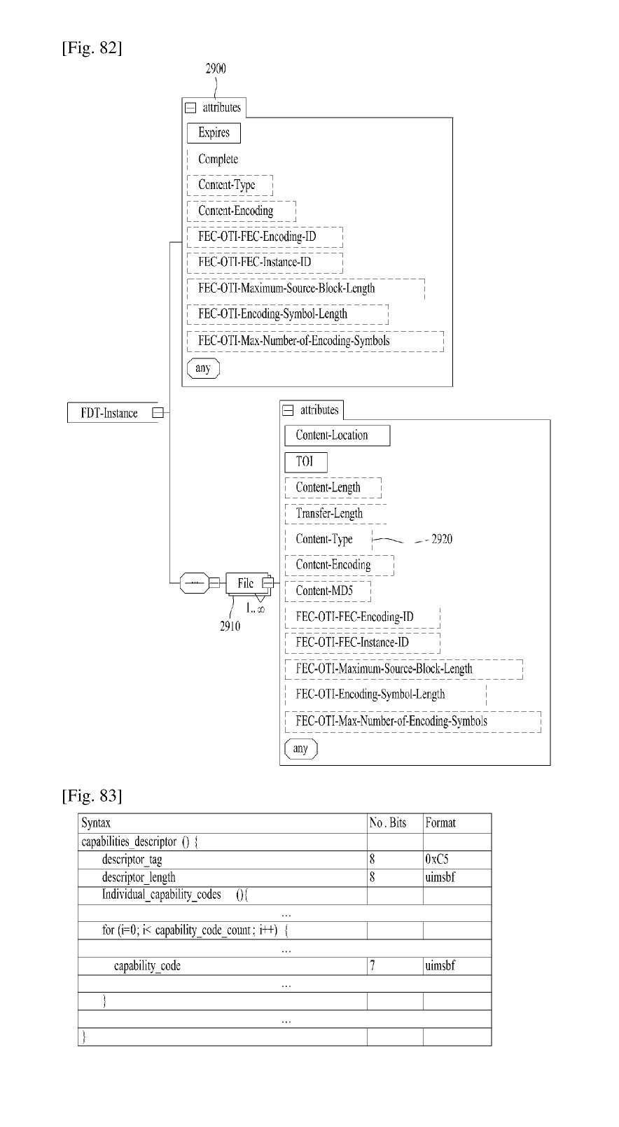

FIG. 82 is a diagram illustrating XML schema of an FDT instance according to another embodiment of the present invention.

In detail, FIG. 82 illustrates XML schema of the FDT instance described with reference to FIG. 81. Hereinafter, the aforementioned content type attribute 2900 will be described.

As illustrated in FIG. 82, the FDT instance according to the present embodiment may include attributes 2900 indicating information of attributes of the FDT instance and/or file elements 2910 indicating a file transmitted through the FLUTE session. The file elements 2910 illustrated in FIG. 82 may include attributes indicating information of attributes of a file. As illustrated in FIG. 82, the file elements 2910 may include content type attribute 2920 according to the present embodiment.

As described with reference to FIG. 81, the receiver according to the present embodiment may identify a PDI-Q instance document using a value included in the content type attribute 2920. For example, the content type attribute 2920 illustrated in FIG. 82 may have a value, etc. in the form of MIME protocol represented by “application/atsc-pdiq” or “text/atsc-pdiq+xml”.

FIG. 83 is a diagram illustrating capabilities descriptor syntax according to an embodiment of the present invention.

In detail, FIG. 83 illustrates syntax for identifying a PDI table by a receiver according to the embodiment of the present invention, in the personalization broadcast system described with reference to FIG. 76.

The capabilities descriptor according to the present embodiment can be used to indicate that the services in SMT service level or the contents in NRT-IT content level are PDI table or not. Receivers according to the present embodiment utilize this information to notice the service/content is PDI Table or not, and decide whether the service/content should be downloaded or not according to their capabilities, such as supporting PDI engine.

Codes represented in Table 2 below can be added to capability_code in capabilities descriptor for PDI Table signaling. A capablilty_code value according to the present embodiment cannot be assigned to other value. A capability_code value represented in Table 2 below may be differently set according to a designer's intention.

TABLE 2

| Capability_code value | Meaning |
|---|---|
| . . . | . . . |
| 0x4F | HE ACC v2 with MPEG Surround |
| 0x50 | PDI Table(including PDI-Q) |
| . . . | . . . |

FIG. 84 is a diagram illustration a consumption model according to an embodiment of the present invention.

In detail, FIG. 84 illustrates a field added onto an SMT in order to identify a PDI table by a receiver according to the embodiment of the present invention, in the personalization broadcast system described with reference to FIG. 76.

NRT service descriptor is located in the service level of NRT SMT, and its NRT_service_category will be 0x04 (PDI) when the service provides PDI Table. So, receivers can notice that PDI Table is providing if the field value is 0x04.

A value of the consumption model illustrated in FIG. 84 may be differently set according to a designer's intention.

FIG. 85 is a diagram illustrating filtering criteria descriptor syntax according to an embodiment of the present invention.

In detail, FIG. 85 illustrates the bit stream syntax of the Filtering Criteria Descriptor for receiving a filtering criteria table by a receiver according to the embodiment of the present invention, in the personalization broadcast system described with reference to FIG. 76.

Filtering criteria according to an embodiment of the present invention are associated with downloadable content, so that the receiver according to the present embodiment can decide whether or not to download the content. There are two categories of downloadable content in an ATSC 2.0 environment: Non-Real Time (NRT) content in stand-alone NRT services and NRT content items used by TDOs in adjunct interactive data services.

Hereinafter, filtering criteria for filtering NRT content in stand-alone NRT services will be described with reference to FIG. 85.

In a filtering Criteria for NRT Services and Content Items according to the embodiment of the present invention, one or more instances of the Filtering Criteria Descriptor defined below can be included in a service level descriptor loop in an SMT, to allow receivers to determine whether to offer the NRT service to the user or not, or it can be included in a content item level descriptor loop in a NRT-IT, to allow receivers to determine whether to download that particular content item and make it available to the user or not.

The one or more instances of the Filtering Criteria Descriptor allow multiple values to be provided for the same or different targeting criteria. The intended targeting logic is “OR” logic among multiple values for the same targeting criterion, and “AND” logic among different targeting criteria.

Hereinafter, semantic definition of each field of the bit stream syntax of the Filtering Criteria Descriptor illustrated in FIG. 85 will be described.

A descriptor_tag field, a 8-bit field can be set to 0xTBD to indicate that the descriptor is a Filtering Criteria Descriptor according to the embodiment of the present invention.

A descriptor_length field, a 8-bit unsigned integer field can indicate the number of bytes following the descriptor_length field itself.

A num_{—} filter_criteria field, a 8-bit field can indicate the number of filtering criteria contained in this descriptor shown in FIG. 85.

A criterion_id_length field, a 8-bit field can indicate the length of the criterion_id field.

A criterion_id field, a variable length field can give the identifier of this filtering criterion, in the form of a URI matching the id attribute of a question (QIA, QBA, QSA, QTA, or QAA element) in the PDI Table of the virtual channel in which this descriptor appears.

A criterion_type_code field, a 3-bit field can give the type of this criterion (question), according to Table 3 below.

TABLE 3

| criterion_type_code | Value |
|---|---|
| 0x00 | Reserved |
| 0x01 | Integer type(including selection id), in uimsbf |
| | format |
| 0x02 | Boolean type, 0x01 for “true” and 0x00 for |
| | “False” |
| 0x03 | String type |
| 0x04-0x07 | Reserved for future ATSC use |

A num_criterion_values field, a 5-bit field gives the number of targeting criterion values in this loop for this filtering criterion, where each value is a possible answer to the question (QIA, QBA, QSA, QTA, or QAA) identified by the criterion_id.

A criterion_value_length field, a 8-bit field gives the number of bytes needed to represent this targeting criterion value.

A criterion_value field, a variable length field gives this targeting criterion value.

The Filtering Criteria Descriptor according to the embodiment of the present invention indicates values for certain targeting criteria associated with services or content items. In an ATSC 2.0 emission, one or more instances of the filtering_criteria_descriptor( ) defined above may go in the descriptor loop of an NRT service in an SMT or in the descriptor loop of a content item in an NRT-IT. In the former case, they shall apply to the service itself (all content items). In the latter case they shall apply to the individual content item.

If there is only one Filtering Criteria Descriptor in a descriptor loop, and if it has only one criterion value, then the decision for whether the service or content item passes the filter shall be “true” (yes) if the criterion value matches a value that is among the answers in the PDI-A for the question corresponding to the filtering criterion (as indicated by the criterion_id), and it shall be “false” (no) otherwise.

If the total number of criterion values in all Filtering Criteria Descriptors in a single descriptor loop is greater than one, the result of each criterion value shall be evaluated as an intermediate term, returning “true” if the criterion value matches a value that is among the answers in the PDI-A for the question corresponding to the filtering criterion (as indicated by the criterion_id) and returning “false” otherwise. Among these intermediate terms, those with the same value of filtering criterion (as determined by the criterion_id) shall be logically ORed to obtain the interim result for each targeting criterion, and these interim results shall be logically ANDed together to determine the final result. If the final result evaluates to “true” for a receiver, it shall imply that the associated NRT service or content item passes the filter and is available to be downloaded to the receiver.

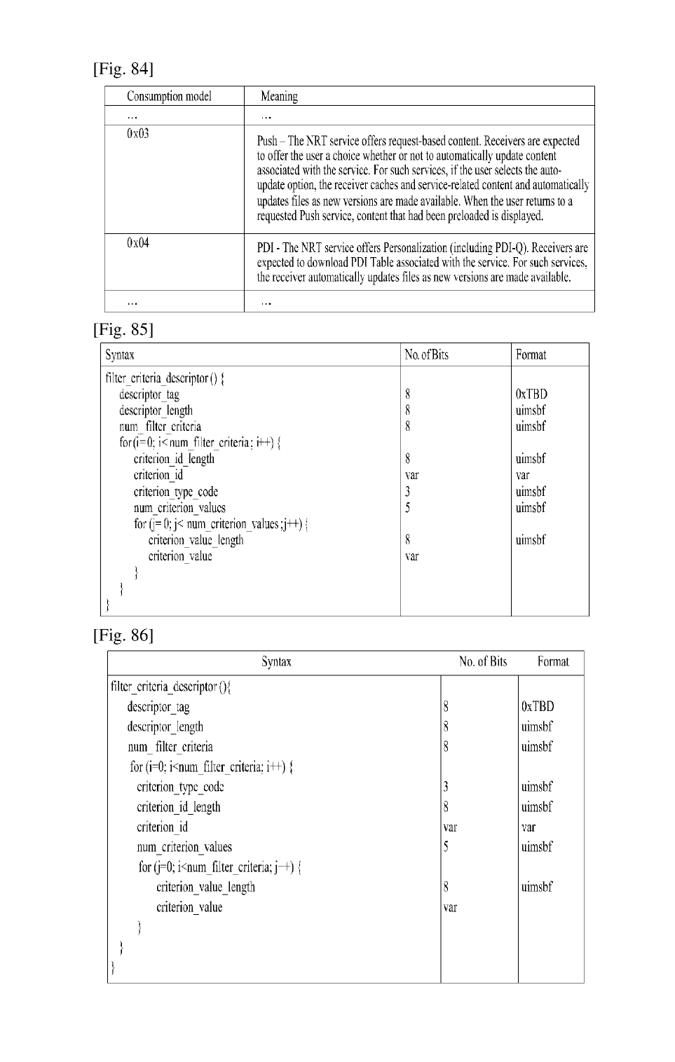

FIG. 86 is a diagram illustrating filtering criteria descriptor syntax according to another embodiment of the present invention.

In detail, FIG. 86 illustrates the bit stream syntax of the Filtering Criteria Descriptor for receiving a filtering criteria table by a receiver according to the embodiment of the present invention, in the personalization broadcast system described with reference to FIG. 76.

Basic content of the filtering criteria descriptor syntax illustrated in FIG. 86 has been described with reference to FIG. 85.

However, a criterion_type_code field can give the type of this criterion (question), according to Table 4 below.

TABLE 4

| criterion_type_code | Value |
|---|---|
| 0x00 | Reserved |
| 0x01 | Integer type |
| 0x02 | Boolean type |
| 0x03 | String type(including selection type/text type) |
| 0x04-0x07 | Reserved for future ATSC use |

FIG. 87 is a flowchart of a digital broadcast system according to another embodiment of the present invention.

In detail, FIG. 87 is a flowchart of a personalization broadcast system for receiving a PDI table and/or a filtering criteria table through a broadcast network by a receiver according to the embodiment of the present invention.

The basic structure of the personalization broadcast system according to the present embodiment is the same as the structure described with reference to FIGS. 58 through 61. The PDI table according to the present embodiment is the same as the table described with reference to FIGS. 60 through 71. The filtering criteria table according to the present embodiment is the same as the table described with reference to FIGS. 72 through 75.

As illustrated in FIG. 87, the personalization broadcast system according to the present embodiment may include a signaling server 3410, a filtering engine 3420, a PDI engine 3430, and/or a UI 3440. The structure of the aforementioned personalization broadcast system may be changed according to a designer's intention.

Operations of the filtering engine 3420, the PDI engine 3430, and/or the UI 3440 for processing the PDI table and the filtering criteria according to the present embodiment are the same as the operations described with reference to FIG. 76. Hereinafter, the digital broadcast system will be described in terms of an operation of the signaling server 3410 illustrated in FIG. 87.

First, a receiver according to the present embodiment may transmit a request signal for receiving a PDI table section to the signaling server 3410. In this case, the receiver according to the present embodiment may transmit the request signal using a query term. A query will be described in detail.

The signaling server 3410 according to the present embodiment may transmit a PDI table section corresponding to a corresponding query to the receiver. A detailed description of the PDI table section has been given with reference to FIGS. 77 through 80.

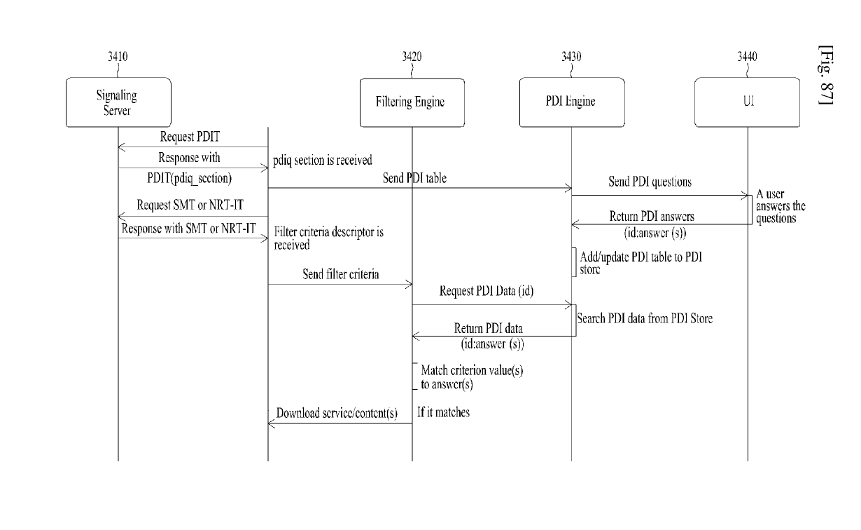

FIG. 88 is a diagram illustrating an HTTP request table according to an embodiment of the present invention.

In detail, FIG. 88 illustrates an HTTP protocol for transmitting a query to the signaling server described with reference to FIG. 87 by a receiver according to the present embodiment.

When supported by broadcasters, the protocol shown in FIG. 88 can provides two capabilities. First, for devices that get DTV broadcast signals via a path that delivers only uncompressed audio and video, this protocol is typically the only way for them to access a broadcaster's stand-alone NRT services. Second, even for a device that has access to the full broadcast stream, this protocol provides a way to retrieve data for populating a Program/Service Guide without cycling through all the broadcast streams available in the local broadcast area and waiting for the desired tables to show up. It also allows retrieval of such data at any time, even while a viewer is watching TV, without needing a separate tuner.

The HTTP request table illustrated in FIG. 88 may include a type of a table to be received and a query term indicating a base URL for receiving the corresponding table.

A receiver according to the embodiment of the present invention may receive a specific table using the query term of the HTTP request table illustrated in FIG. 88. In detail, the receiver according to the present embodiment may transmit a request signal to a signaling server using a query term “?table=PDIT[&chan=<chan_id>]”. A detailed description thereof has been described with reference to FIG. 87.

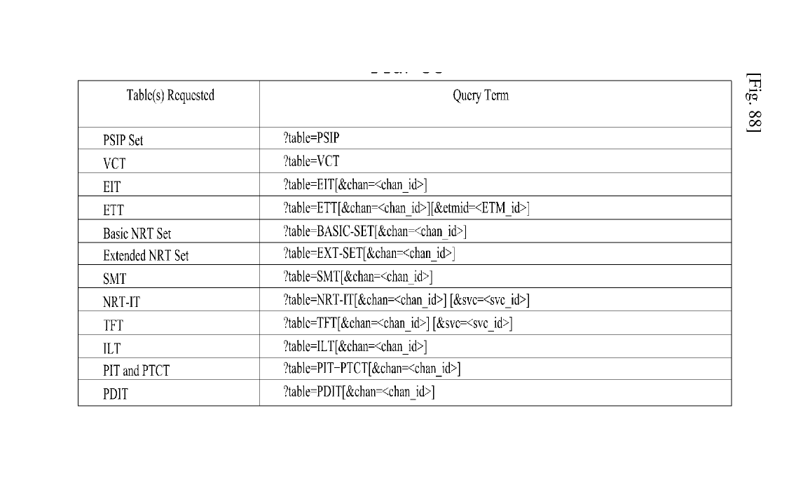

FIG. 89 is a flowchart illustrating a digital broadcast system according to another embodiment of the present invention.

In detail, FIG. 89 is a diagram illustrating a personalization broadcast system for receiving a PDI table and/or a filtering criteria table through the Internet by a receiver according to the embodiment of the present invention.

The basic structure of the personalization broadcast system according to the present embodiment is the same as the structure described with reference to FIGS. 58 through 61. The PDI table according to the present embodiment is the same as the structure described with reference to FIGS. 60 through 71. The filtering criteria table according to the present embodiment is the same as the table described with reference to FIGS. 72 through 75.

When delivered over the Internet, PDI Table instances shall be delivered via HTTP or HTTPS. The Content-Type of a PDI Table in the HTTP Response header shall be “text/xml”.

The URL used to retrieve a PDI Table via Internet can be delivered via SDOPrivateDataURIString commands which are transported in Standard caption service #6 in the DTV closed caption channel, or it can be delivered in a UrlList XML element delivered along with a TPT.

A TPT (TDO Parameters Table) contains metadata about the TDOs of a segment and the Events targeted to them. The term “Triggered Declarative Object” (TDO) is used to designate a Declarative Object that has been launched by a Trigger in a Triggered interactive adjunct data service, or a DO that has been launched by a DO that has been launched by a Trigger, and so on iteratively. A trigger is a signaling element whose function is to identify signaling and establish timing of playout of interactive events.

As illustrated in FIG. 89, the personalization broadcast system according to the present embodiment may include a PDI server 3600, a content server 3650, and/or a receiver. The receiver according to the present embodiment may include a TDO parameter table (TPT) client 3610, a filtering engine 3620, a PDI engine 3630, and/or a UI 3640. The structure of the aforementioned personalization broadcast system may be changed according to a designer's intention. Hereinafter, operations of elements illustrated in FIG. 89 will be described.

The TPT client 3610 according to the present embodiment may receive a TPT and/or a URL list table. A TDO parameters table (TPT) according to the embodiment of the present invention contains metadata about the triggered declarative objects (TDOs) of a segment and the events targeted to them. The TPT according to the present embodiment may include information regarding a PDI table and a filtering criteria table. The URL list table according to an embodiment of the present invention may include URL information of the PDI server 3600. The TPT and the URL list table will be described in detail.

The TPT client 3610 according to the present embodiment may acquire URL information of the PDI server 3600 from the URL list table. The TPT client 3610 may access the PDI server 3600 using the acquired URL information and request the PDI server 3600 to transmit the PDI table according to the present embodiment. The PDI server 3600 according to the present embodiment may transmit the corresponding PDI table to the TPT client 3610 according to the request of the TPT client 3610.

As illustrated in FIG. 89, the TPT client 3610 according to the present embodiment may transmit the received PDI table to the PDI engine 3630. The PDI engine 3630 according to the present embodiment may process the received PDI table and extract PDI questions included in the corresponding PDI table. Then, the PDI engine 3630 according to the present embodiment may transmit the extracted PDI questions to the UI 3640.

The UI 3640 according to the present embodiment may display the received PDI questions and receive PDI answers to the corresponding PDI questions. The UI 3640 according to the present embodiment may receive the PDI answers through a remote controller. Then, the PDI engine 3630 according to the present embodiment may update PDI data using the PDI answer received from the UI 3640. A detailed description thereof has been described with reference to FIGS. 58 and 59.

The TPT client 3610 according to the present embodiment may parse TPT to acquire filtering criteria. As illustrated in FIG. 89, the TPT client 3610 may transmit the filtering criteria to the filtering engine 3620. In this case, according to an embodiment of the present invention, the filtering criteria may be filtering criteria table with a format of xml document. The filtering criteria table has been described in detail with reference to FIGS. 74 and 75.

Then, the filtering engine 3620 according to the present embodiment may transmit a PDI data request signal to the PDI engine 3630. When the PDI engine 3630 according to the present embodiment receives the PDI data request signal, the PDI engine 3630 may search for PDI data corresponding to the corresponding PDI data request signal and transmit the PDI data to the filtering engine 3620. Processes subsequent to the filtering according to the present embodiment have been described in detail with reference to FIGS. 60 and 61.

As a result, a receiver according to the present embodiment may download content using the filtering result. In more detail, the TPT client 3610 may receive the filtering result from the filtering engine 3620 and transmit TDO and/or content download request signal to the content server 3650. The content server 3650 may transmit the TDO and/or the content to the TPT client 3610 according to the TDO and/or the content download request signal.

FIG. 90 is a diagram illustrating a URL list table according to an embodiment of the present invention.

In detail, FIG. 90 is a table containing URL information for receiving PDI table and/or filtering criteria through the Internet by a receiver according to the embodiment of the present invention. A process of transmitting and receiving a URL list table according to an embodiment of the present invention has been described in detail with reference to FIG. 89.

When a URL List table is delivered via the Internet, it can be delivered via HTTP along with a TPT, in the form of a multi-part MIME message.

When delivered over the Internet, TPTs can be delivered via HTTP. The URL information for the TPT of the current segment shall appear in Triggers, delivered either via DTV Closed Caption service #6 or via an ACR server. The response to a request for a TPT may consist of just the TPT for the current segment, or it may consist of a multipart MIME message, with the requested TPT in the first part, and optionally the AMT for the segment in the second part, and optionally a UrlList XML document in the next part.

Hereinafter, semantics of elements included in a URL list table will be described with regard to an embodiment of the present invention.

An UrlList element shown in FIG. 90 contains a list of URLs that are useful to a receiver according to the embodiment of the present invention.

A TptUrl element of the UrlList element shown in FIG. 90 can contain the URL information of a TPT for a future segment in the current interactive adjunct service. When multiple TptUrl elements are included, they shall be arranged in order of the appearance of the segments in the broadcast.

A NrtSignalingUrl element of the UrlList element shown in FIG. 90 can contain the URL information of a server from which receivers can obtain NRT signaling tables for all the virtual channels in the current transport stream, using the request protocol defined in Section 18 of this standard.

An UrsUrl element of the UrlList element shown in FIG. 90 can contain the URL information of a server to which receivers can send usage (audience measurement) reports, using the protocol defined in Section 10 of this standard.

A PdiUrl element of the UrlList element shown in FIG. 90 can contain the URL information of a PDITable. That is, the PdiUrl element according to the present embodiment may indicate URL information of a server that transmits a PDI table and/or filtering criteria.

The aforementioned URL list table of FIG. 90 may be configured in the format shown in Table 5 below.

TABLE 5

| Element/ | No. | Data | Description & |
|---|---|---|---|
| Attribute(with @) | allowed | type | Value |
| UrlList | | | List of potentially |
| | | | useful URLs |
| TptUrl | 0 . . . N | anyURI | URL of TPT for |
| | | | future segment |
| NrtSignalingUrl | 0 . . . 1 | anyURI | URL of NRT |
| | | | Signaling Server |
| UrsUrl | 0 . . . 1 | anyURI | URL of Usage |
| | | | Reporting Server |
| PDIUrl | 0 . . . 1 | anyURI | URL of PDI-Q |

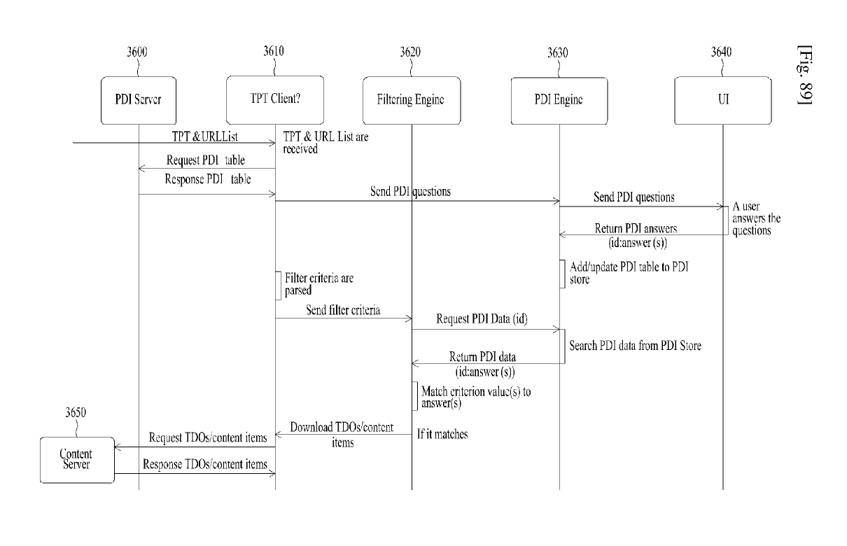

FIG. 91 is a diagram illustrating a TPT according to an embodiment of the present invention.

In detail, the TPT illustrated in FIG. 91 may include URL information of a PDI table and/or filtering criteria. A process of transmitting and receiving the TPT according to the present embodiment has been described with reference to FIG. 89. Hereinafter, an element of filtering criteria included in the TPT will be described.

In detail, the filter criterion element illustrated in FIG. 91 may include information regarding filtering criteria.

The id attribute according to the present embodiment may indicate a PDI question of the corresponding filtering criteria.

The criterion type attribute according to the present embodiment may indicate a filtering criteria type (or filtering criteria type elements). A type of the filtering criteria according to the present embodiment has been described with reference to FIG. 73.

The criterion value attribute according to the present embodiment may indicate a value of the filtering criteria according to the aforementioned criterion type attribute.

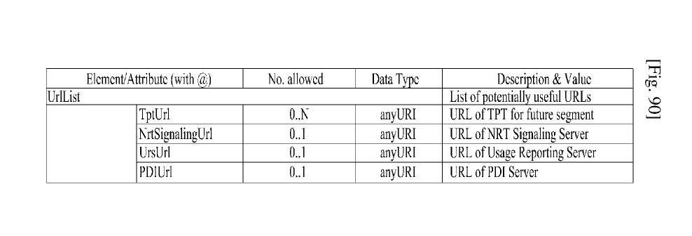

FIG. 92 is a flowchart of a digital broadcast system according to another embodiment of the present invention.

In detail, FIG. 92 is a diagram illustrating a personalization broadcast system for receiving a PDI table and/or a filtering criteria table in an ACR system by a receiver according to the embodiment of the present invention.

The ACR system according to the present embodiment is the same as the system described with reference to FIG. 52. The basic structure of the personalization broadcast system according to the present embodiment is the same as the structure described with reference to FIGS. 58 through 61. The PDI table according to the present embodiment is the same as the table described with reference to FIGS. 60 through 71 The filtering criteria table according to the present embodiment is the same as the table described with reference to FIGS. 72 through 75.

As illustrated in FIG. 92, the personalization broadcast system according to the present embodiment may include an ACR server 3900, a TPT server 3950, a PDI server 3960, a content server 3970, an ACR client 3910, a filtering engine 3920, a PDI engine 3930, and/or a UI 3940. The structure of the aforementioned personalization broadcast system may be changed according to a designer's intention. Operations of elements illustrated in FIG. 92 will be described.

The ACR client 3910 according to the present embodiment may extract signature from fingerprint and transmit a request together with the signature to the ACR server 3900. The ACR server 3900 according to the present embodiment may receive the signature and transmit a response together with trigger, etc. related to the corresponding signature to the ACR client 3910, which has been described in detail with reference to FIGS. 52 through 57.

The ACR client 3910 according to the present embodiment may request a TPT and/or a URL list table to the TPT server 3950 using the received trigger, etc. The TPT server 3950 according to the present embodiment may transmit the TPT and/or the URL list table to the ACR client 3910 according to the request of the ACR client 3910. A detailed description of the TPT and/or the URL list table has been given. Then, the TPT server 3950 according to the present embodiment may transmit the received TPT and/or URL list table to the ACR client 3910.

The ACR client 3910 according to the present embodiment may acquire URL information of the PDI server 3960 from the URL list table. The ACR client 3910 may access the PDI server 3960 using the acquired URL information and request the PDI server 3960 to transmit the PDI table according to the present embodiment. The PDI server 3960 according to the present embodiment may transmit the corresponding PDI table to the ACR client 3910 according to the request of the ACR client 3910.

As illustrated in FIG. 87, the ACR client 3910 according to the present embodiment may transmit the received PDI table to the PDI engine 3930. The PDI engine 3930 according to the present embodiment may process the received PDI table and extract PDI questions included in the corresponding PDI table. Then, the PDI engine 3930 according to the present embodiment may transmit the extracted PDI questions to the UI 3940.

The UI 3940 according to the present embodiment may display the received PDI questions and receive PDI answers to the corresponding PDI questions. The UI 3940 according to the present embodiment may receive the PDI answers through a remote controller. Then, the PDI engine 3930 according to the present embodiment may update PDI data using the PDI answer received from the UI 3940. A detailed description thereof has been described with reference to FIGS. 58 and 59.

In addition, the ACR client 3910 according to the present embodiment may parse TPT to acquire filtering criteria. As illustrated in FIG. 92, the ACR client 3910 may transmit the filtering criteria to the filtering engine 3920. In this case, according to an embodiment of the present invention, the filtering criteria may be a filtering criteria table with a format of xml document. The filtering criteria table has been described in detail with reference to FIGS. 74 and 75.

Then, the filtering engine 3920 according to the present embodiment may transmit a PDI data request signal to the PDI engine 3930. When the PDI engine 3930 according to the present embodiment receives the PDI data request signal, the PDI engine 3930 searches for PDI data corresponding to the corresponding PDI data request signal and transmits the PDI data to the filtering engine 3920. Processes subsequent to the filtering according to the present embodiment have been described in detail with reference to FIGS. 60 and 61.

As a result, a receiver according to the present embodiment may download content using a filtering result. In detail, the ACR client 3910 may receive the filtering result from the filtering engine 3920 and transmit a TDO and/or content download request signal to the content server 3970. The content server 3970 may transmit the TDO and/or the content to the ACR client 3910 according to the TDO and/or content download request signal.

FIG. 93 is a flowchart of a digital broadcast system according to another embodiment of the present invention.

In detail, FIG. 93 is a diagram illustrating a personalization broadcast system for avoiding duplication of PDI answers according to an embodiment of the present invention.

In more detail, FIG. 93 illustrates a personalization broadcast system for updating PDI data using a pre-stored PDI answer when a receiver according to the embodiment of the present invention receives the same PDI question from a plurality of broadcasters and content providers. Due to the personalization broadcast system illustrated in FIG. 93, a user may reduce inconvenience of inputting redundant PDI answers to the same PDI question.

As illustrated in FIG. 93, the personalization broadcast system according to the present embodiment may include two or more broadcasters (or content providers) and/or a receiver. The two or more broadcasters according to the present embodiment may include a broadcaster A 4010 and/or a broadcaster B 4020. The receiver according to the present embodiment may include a PDI engine 4030 and/or a UI 4040. The personalization broadcast system according to the present embodiment may provide an ATSC 2.0 service. The structure of the aforementioned personalization broadcast system may be changed according to a designer's intention. Hereinafter, operations of elements illustrated in FIG. 93 will be described.

First, a receiver according to the present embodiment may receive a first PDI table 4011 from the broadcaster A 4010. The receiver that receives the first PDI table 4011 may transmit the first PDI table 4011 to the PDI engine 4030. The first PDI table 4011 according to the present embodiment may include a first PDI type element 4012. Each of first PDI type elements 4012 according to the present embodiment may include a first identifier element (or first ID) and/or a first PDI question, as described with reference to FIGS. 68, 69, 70 and 71. In addition, as illustrated in FIG. 93, the first PDI table 4011 may include two or more first PDI type elements 4012 having different first IDs.

The PDI engine 4030 according to the present embodiment may extract a first PDI question from the first PDI type element 4012 and transmit the extracted first PDI question to the UI 4040. Then, the UI 4040 according to the present embodiment may receive a first PDI answer to a first PDI question from the user. The PDI engine 4030 may add the first PDI answer to the first PDI type element 4012 and correct the first PDI answer. Detailed operations of the PDI engine 4030 and the UI 4040 according to the present embodiment are the same as the operations described with reference to FIG. 76.

In addition, the PDI engine 4030 according to the present embodiment may receive a second PDI table 4021 from the broadcaster B 4020. The second PDI table 4021 according to the present embodiment may include a second PDI type element 4022. As described with reference to FIGS. 68, 69, 70 and 71, the second PDI type element 4022 may include a second identifier element (or second ID) and/or a second PDI question.

The PDI engine 4030 that receives the second PDI table may access a PDI store and search for the first PDI table that is pre-stored in the PDI store. Then, the PDI engine 4030 according to the present embodiment may compare a second ID and a first ID. As the comparison result, when the second ID and the first ID are identical to each other, the first PDI answer may be added to the second PDI type element 4022 and/or corrected.

As a result, when a receiver according to the present embodiment receives the same PDI question as the pre-stored PDI question, the receiver may not repeatedly display the PDI question and may process the PDI question using the pre-stored PDI answer. Thus, in the personalization broadcast system according to the present embodiment, the user does not have to repeatedly input PDI answers of the same content to the same PDI question so as to receive a personalization service more conveniently.

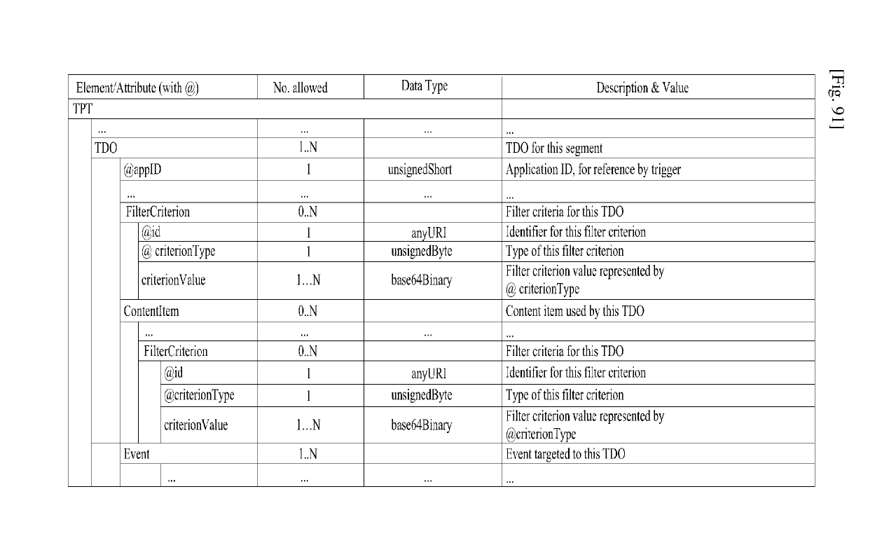

FIG. 94 is a flowchart of a digital broadcast system according to another embodiment of the present invention.

In detail, FIG. 94 is a diagram of personalization broadcast system for avoiding duplication of PDI answers according to an embodiment of the present invention. The personalization broadcast system described with reference to FIG. 93 may use a PDI table that is pre-stored in a receiver according to the present invention in order to avoid duplication of PDI answers. As another embodiment of the present invention for avoiding duplication of PDI answers, FIG. 94 proposes a personalization broadcast system using registration of a PDI question.

In order to support reuse of questions by different broadcasters, so that consumers are not prompted to answer essentially the same question over and over again, questions can be registered with a registrar to be designated by the ATSC. Each registration record can include information about a question ID which is globally unique, as specified in FIGS. 68 AND 69 and FIG. 18, a question type (QIA, QBA, QSA, or QTA), question text in one or more languages, a date of registration and/or contact information for the organization submitting the question for registration. Also, in the case of a QSA, each registration record (or Pre-registered PDI question) can include the allowable selections such as an identifier of each selection, and the text of each selection in one or more languages.

A PDI table may contain a mix of registered questions and non-registered questions.

Both registered and non-registered questions may appear in multiple PDI tables. Whenever a user answers a question that appears in multiple PDI tables, whether by a function provided by the receiver or by an application, the answer is expected to propagate to all instances of the question in all the questionnaires where it appears. Thus, a user only needs to answer any given question once, no matter any many times it appears in different questionnaires.

To avoid having users be deluged with questions, it is recommended that questionnaire creators use registered questions whenever possible, and only use non-registered questions when the questionnaire creator has unique targeting needs that cannot be met with registered questions.

The receiver according to the present embodiment may extract a pre-registered PDI question using the receiver targeting criteria. The receiver targeting criteria according to the present embodiment complies with the standard of ATSC NRT, A/103.

As illustrated in FIG. 94, the personalization broadcast system according to the present embodiment may include a SSC 4100, a FLUTE session 4110, a filtering engine 4120, a PDI engine 4130, and/or a UI 4140. The personalization broadcast system according to the present embodiment may provide an ATSC 2.0 service. The structure of the aforementioned personalization broadcast system may be changed according to a designer's intention. Hereinafter, the personalization broadcast system illustrated in FIG. 94 will be described.

A receiver according to the present embodiment may receive SMT and/or NRT-IT through the SSC 4100 and acquire receiver targeting criteria included in the SMT and/or NRT-IT. According to an embodiment of the present invention, the receiver targeting criteria may be a receiver targeting descriptor or a receiver targeting criterion table.

Then, the PDI engine 4130 according to the present embodiment may convert the acquired receiver targeting criteria to generate a PDI question. The UI 4140 according to the present embodiment may receive the aforementioned question from the PDI engine 4130, display the PDI question, and receive a PDI answer of a user. Detailed operations of the PDI engine 4130 and the UI 4140 according to the present embodiment have been described with reference to FIG. 76.

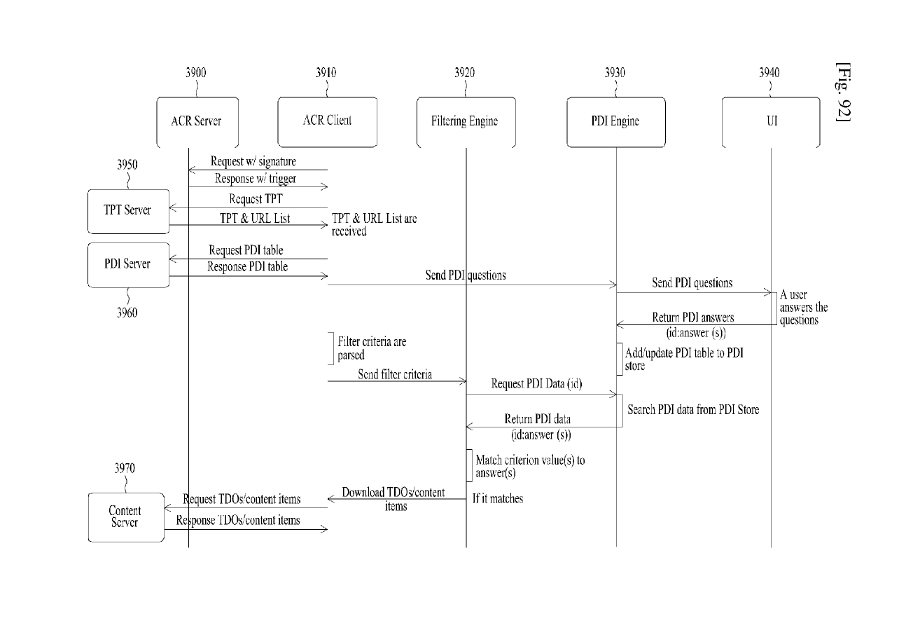

FIG. 95 is a flowchart of a digital broadcast system according to another embodiment of the present invention.

In detail, FIG. 95 illustrates a personalization broadcast system for registering a PDI question.

As illustrated in FIG. 95, the personalization broadcast system according to the present embodiment may include a signaling server 4200, a receiver 4210, a filtering engine 4220, a PDI engine 4230, and a UI 4240. The receiver 4210 may be interpreted as including the filtering engine 4220, the PDI engine 4230, and/or the UI 4240, which may be changed according to a designer's intention. In addition, the personalization broadcast system according to the present embodiment may provide an ATSC 2.0 service. The personalization broadcast system illustrated in FIG. 94 will be described.

Operations of basic elements of FIG. 95 are the same as operations described with reference to FIG. 94. However, the receiver 4210 illustrated in FIG. 95 may request SMT and/or NRT-IT to the signaling server 4200. According to the request of the receiver 4210 according to the present embodiment, the signaling server 4200 may transmit the corresponding SMT and/or NRT-IT to the receiver 4210.

Detailed operations of the receiver 4210, the PDI engine 4230, and/or the UI 4240 after the receiver according to the present embodiment receives the SMT and/or the NRT-IT are the same as the operation described with reference to FIG. 94.

FIG. 96 is a diagram illustrating a receiver targeting criteria table according to an embodiment of the present invention.

In detail, FIG. 96 is a diagram of receiver targeting criteria obtained by representing the receiver targeting criteria described with reference to FIGS. 94 and 95 in the form of table.

As illustrated in FIG. 96, the receiver targeting criteria table may include information regarding a targeting criterion type code, a targeting value length, and/or a targeting value. The targeting criterion type code illustrated in FIG. 96 refers to a code for identifying each targeting criteria. The targeting value length illustrated in FIG. 96 refers to the number of bytes for representing the targeting criteria value. The targeting value illustrated in FIG. 96 refers to information indicated by the targeting criteria.

The receiver according to the present embodiment may convert the targeting criteria according to the targeting criterion type code and acquire a pre-registered PDI question.

In detail, when the targeting criterion type code according to the present embodiment is 0x00, the targeting value is reserved and the targeting value length is not determined.

When the targeting criterion type code according to the present embodiment is 0x01, the targeting value is geographical location as defined in Table 6.21 of A/65, using only the low order 3 bytes, and the targeting value length is 3 bytes. The aforementioned A/65 is ATSC standard for program and system information protocol (PSIP).

When the targeting criterion type code according to the present embodiment is 0x02, the targeting value is alphanumeric postal code as defined in section 6.7.2 of A/65, using the number of bytes appropriate to the region (up to 8), and the targeting value length is variable, which will be described below in more detail.

When the targeting criterion type code according to the present embodiment is 0x03, the targeting value is demographic category as defined in Table 6.18 of A/65, using only the low order 2 bytes, and the targeting value length is 2 bytes, which will be described below in more detail.

When the targeting criterion type code according to the present embodiment is 0x04-0x0F, the targeting value is reserved for future ATSC use and the targeting value length is not determined.

When the targeting criterion type code according to the present embodiment is 0x10-0x1F, the targeting value is available for private use and the targeting value length is not determined.

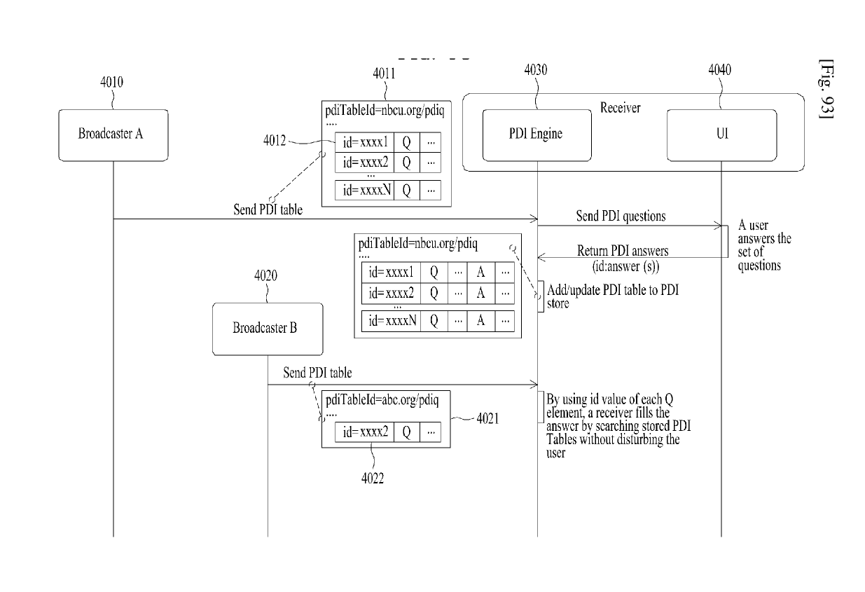

FIGS. 97 through 100 are diagrams illustrating a pre-registered PDI question according to an embodiment of the present invention.

In detail, FIGS. 97 through 100 show tables representing a pre-registered PDI question when the targeting criterion type code described with reference to FIG. 96 is 0x01, according to an embodiment of the present invention.

As illustrated in FIGS. 97 through 100, when the targeting criterion type code is 0x01, the targeting criteria table according to the present embodiment may include pre-registered PDI question information regarding a geographical location. In this case, the receiver according to the present embodiment may convert the targeting criteria table using only the low order 3 bytes to acquire the pre-registered PDI question.

FIG. 97 is a table showing a pre-registered PDI question regarding a location code when the targeting criterion type code is 0x01. Pre-registered PDI question information included in the pre-registered PDI question table illustrated in FIG. 97 is the same as the information described with reference to FIG. 94.

In detail, as illustrated in FIG. 97, when the targeting criterion type code is 0x01, a question ID according to the present embodiment may include information regarding the location code. In addition, the pre-registered PDI question illustrated in FIG. 97 may be a QTA type and may include a question text including content of requesting a PDI answer of a text type of the location code.

[Example 8] below is obtained by representing the table illustrated in FIG. 97 in xml schema according to an embodiment of the present invention.

[Example 8]

<a20:QTA id=“atsc.org/PDIQ/location-code”>

<a20:Q xml:lang=“en-us”>

<a20:Text>What is your location code?</a20:Text>

</a20:Q>

</a20:QTA>

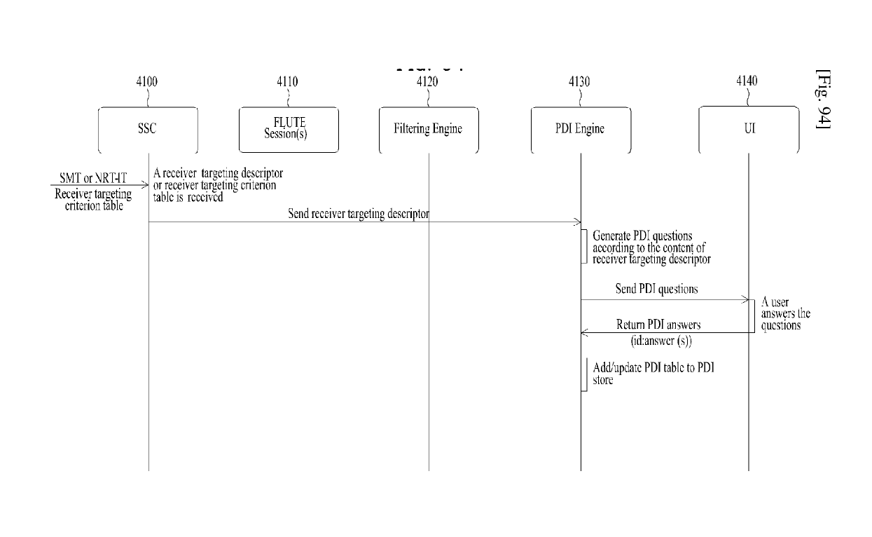

FIG. 98 is a table showing a pre-registered PDI question of federal information processing standards publication state (FIPS) when the targeting criterion type code is 0x01. Basic content included in the pre-registered PDI question illustrated in FIG. 98 is the same as the content described with reference to FIG. 94. However, the pre-registered PDI question illustrated in FIG. 98 may further include information regarding question xactionSetId. The question xactionSetId will be described below in detail with regard to an embodiment of the present invention.

In detail, as illustrated in FIG. 98, when the targeting criterion type code is 0x01, the question ID according to the present embodiment may include information regarding the FIPS state. In addition, the pre-registered PDI question illustrated in FIG. 98 may be a QTA type and may include a question text including content of requesting a PDI answer of a text type of the FIPS state.

[Example 9] below is obtained by representing the table illustrated in FIG. 98 in xml schema according to an embodiment of the present invention.

[Example 9]

<a20:QTA id=″atsc.org/PDIQ/state” xactionSetId=”1”>

<a20:Q xml:lang=″en-us″>

<a20:Text>What state are you located in?</a20:Text>

</a20:Q>

</a20:QTA>

FIG. 99 is a table showing a pre-registered PDI question regarding an FIPS country when the targeting criterion type code is 0x01. Basic content included in the pre-registered PDI question illustrated in FIG. 99 is the same as the content described with reference to FIG. 94. However, the pre-registered PDI question illustrated in FIG. 99 may further include information regarding question xactionSetId. The question xactionSetId will be described below in detail with regard to an embodiment of the present invention.

In detail, as illustrated in FIG. 99, when the targeting criterion type code is 0x01, the question ID according to the present embodiment may include information regarding the FIPS country. In addition, the pre-registered PDI question illustrated in FIG. 46 may be a QTA type and may include a question text including content of requesting a PDI answer of a text type of the FIPS country.

[Example 10] below is obtained by representing the table illustrated in FIG. 99 in xml schema according to an embodiment of the present invention.

[Example 10]

<a20:QTA id=″atsc.org/PDIQ/county” xactionSetId=”1”>
<a20:Q xml:lang=″en-us″>

<a20:Text>What county are you located in?</a20:Text>

</a20:Q>

</a20:QTA>

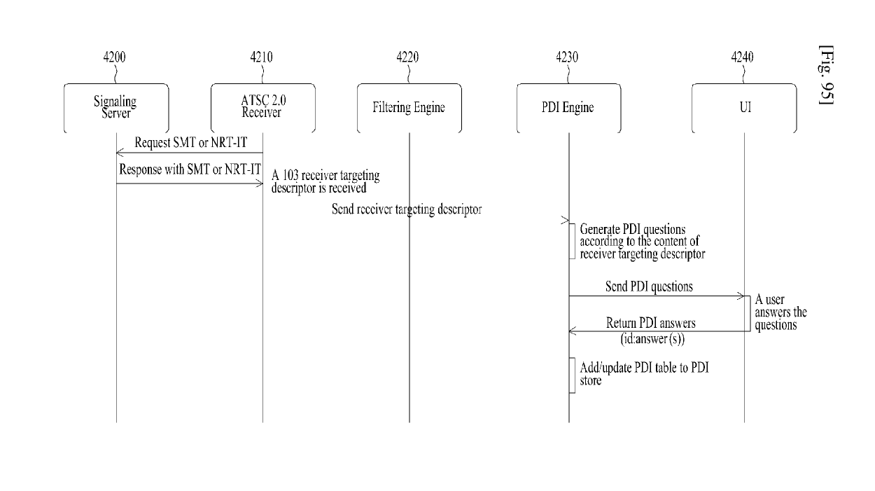

FIG. 100 is a table showing a pre-registered PDI question regarding county subdivision when the targeting criterion type code is 0x01. Basic content included in the pre-registered PDI question illustrated in FIG. 100 is the same as the content described with reference to FIG. 94. However, the pre-registered PDI question illustrated in FIG. 100 may further include information regarding question xactionSetId. The question xactionSetId will be described below in detail with regard to an embodiment of the present invention.

In detail, as illustrated in FIG. 100, when the targeting criterion type code is 0x01, the question ID according to the present embodiment may include sector information regarding the country subdivision. The pre-registered PDI question illustrated in FIG. 100 may be a QSA type and may include a question text including content of requesting a PDI answer of a selection type of the country subdivision.

The pre-registered PDI question of the QSA type according to the present embodiment may include selection information of the PDI answer. For example, the pre-registered PDI question of the country subdivision illustrated in FIG. 100 may include 9 selection information regarding northwest, north central, northeast, west central, center, east central, southwest, south central and southeast.

[Example 11] below is obtained by representing the table in xml schema according to an embodiment of the present invention.

[Example 11]

<a20:QSA id=″atsc.org/PDIQ/sector” xactionSetId=”1”>

<a20:Q xml:lang=″en-us″>

<a20:Text>What part of your county are you located in?

</a20:Text>

<a20:Selection id=″1″>NW</a20:Selection>
<a20:Selection id=″2″>NC</a20:Selection>
<a20:Selection id=″3″>NE</a20:Selection>
<a20:Selection id=″4″>WC</a20:Selection>
<a20:Selection id=″5″>C</a20:Selection>
<a20:Selection id=″6″>EC</a20:Selection>
<a20:Selection id=″7″>SW</a20:Selection>
<a20:Selection id=″8″>SC</a20:Selection>
<a20:Selection id=″9″>SE</a20:Selection>

</a20:Q>

</a20:QTA>

The aforementioned question xactionSetId illustrated in FIGS. 98 through 100 may indicate a set of PDI questions including similar contents. A receiver according to the embodiment of the present invention may combine pre-registered PDI questions containing the same question xactionSetId and use the pre-registered PDI questions in a personalization broadcast service.

For example, the receiver targeting criteria illustrated in FIG. 97 may also be represented as the receiver targeting criteria of FIGS. 98 through 100 having the same question xactionSetId. A receiver according to the embodiment of the present invention may provide a personalization broadcast service using a result obtained by combining the receiver targeting criteria illustrated in FIG. 97 and/or the receiver targeting criteria illustrated in FIGS. 98 through 100.

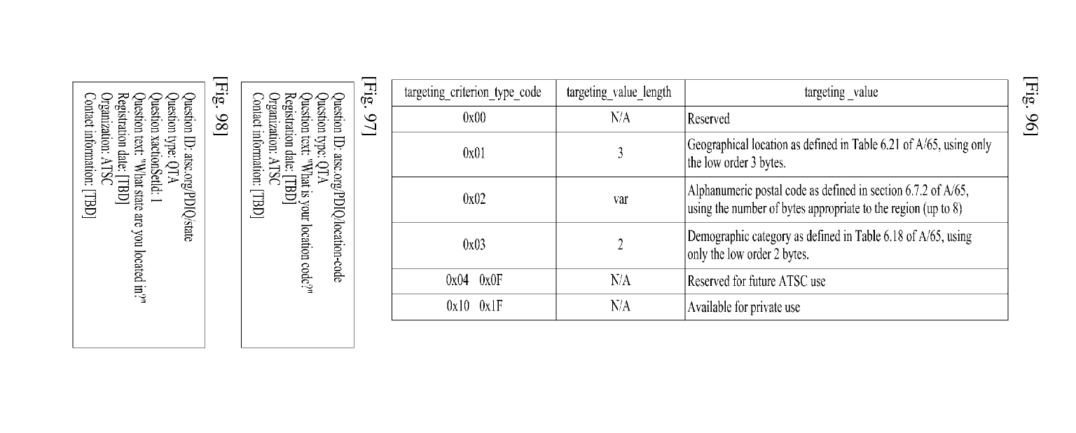

FIGS. 101 and 102 are diagrams illustrating a pre-registered PDI question according to an embodiment of the present invention.

In detail, FIGS. 101 and 102 are tables illustrating a pre-registered PDI question when the targeting criterion type code described with reference to FIG. 96 is 0x02.

As illustrated in FIGS. 101 and 102, when the targeting criterion type code is 0x02, the targeting criteria table according to the present embodiment may include pre-registered PDI question information regarding an alphanumeric postal code. In this case, a receiver according to the embodiment of the present invention may convert the targeting criteria table using an appropriate number of bytes according to a region to acquire a pre-registered PDI question. The receiver according to the present embodiment may use a maximum of 8 bytes in order to convert the targeting criteria table.

FIG. 101 is a table showing a pre-registered PDI question regarding a 5-digit zip code when the targeting criterion type code is 0x02. The 5-digit zip code refers to the alphanumeric postal code used in US. Content included in the pre-registered PDI question illustrated in FIG. 101 is the same as content described with reference to FIG. 94.

In detail, as illustrated in FIG. 101, when the targeting criterion type code is 0x02, a question ID according to the present embodiment may include information regarding a zip code. The pre-registered PDI question illustrated in FIG. 101 may be a QTA type and may include a question text including content of requesting a PDI answer of a text type of the zip code.

[Example 12] below is obtained by representing the table illustrated in FIG. 101 in xml schema according to an embodiment of the present invention.

[Example 12]

<a20:QTA id=″atsc.org/PDIQ/ZIPcode″>

<a20:Q xml:lang=”en-us”>

<a20:Text>What is your 5-digit ZIP code?</a20:Text>

</a20:Q>

</a20:QTA>

FIG. 102 is a table showing a pre-registered PDI question regarding a numeric postal code when the targeting criterion type code is 0x02. The numeric postal code refers to an alphanumeric postal code used in regions other than US. Content included in the pre-registered PDI question illustrated in FIG. 102 is the same as content described with reference to FIG. 94.

In detail, as illustrated in FIG. 102, when the targeting criterion type code is 0x02, the question ID according to the present embodiment may include information regarding a postal code. The pre-registered PDI question illustrated in FIG. 102 and may include a question text including content of requesting a PDI answer of a text type of the postal code.

[Example 13] below is obtained by representing the table illustrated in FIG. 102 in xml schema according to an embodiment of the present invention.

[Example 13]

<a20:QTA id=″atsc.org/PDIQ/ZIPcode″>

<a20:Q xml:lang=”en-us”>

<a20:Text>What is your 5-digit ZIP code?</a20:Text>

</a20:Q>

</a20:QTA>

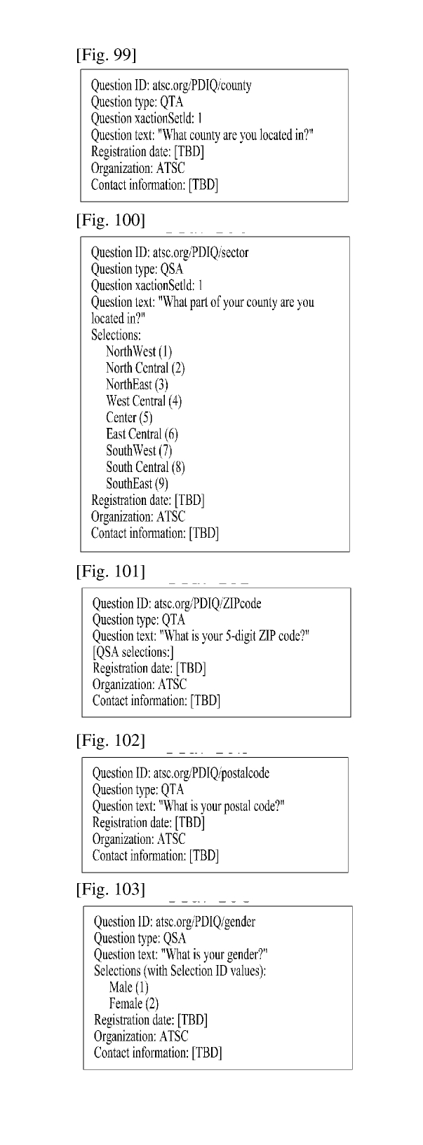

FIGS. 103 through 106 are diagrams illustrating a pre-registered PDI question according to an embodiment of the present invention.

In detail, FIGS. 103 through 106 are tables illustrating a pre-registered PDI question when the targeting criterion type code described with reference to FIG. 96 is 0x03.

As illustrated in FIGS. 103 through 106, when the targeting criterion type code is 0x03, the targeting criteria table according to the present embodiment may include pre-registered PDI question information regarding a demographic category of a user. In this case, a receiver according to the embodiment of the present invention may convert the targeting criteria table using only the low order 2 bytes to acquire a pre-registered PDI question.

FIG. 103 is a table showing a pre-registered PDI question regarding a gender of a user when the targeting criterion type code is 0x03. Content included in the pre-registered PDI question illustrated in FIG. 103 is the same as content described with reference to FIG. 94.

In detail, as illustrated in FIG. 103, when the targeting criterion type code is 0x03, the question ID according to the present embodiment may include information regarding a gender. In addition, the pre-registered PDI question illustrated in FIG. 103 may be a QSA type and may include a question text including content of requesting a PDI answer of a selection type of the gender of the user.

In addition, the pre-registered PDI question illustrated in FIG. 103 is a QSA type, and thus, may include selection information regarding a PDI answer. For example, the pre-registered PDI question regarding the gender illustrated in FIG. 103 may include two types of male and female selection information.

[Example 14] below is obtained by representing the table illustrated in FIG. 103 in xml schema according to an embodiment of the present invention.

[Example 14]

<a20:QSA id=″atsc.org/PDIQ/gender” minChoices=″1″>

<a20:Q xml:lang=″en-us″>

<a20:Text>What is your gender?</a20:Text>

<a20:Selection id=″1″>Male</a20:Selection>
<a20:Selection id=″2″>Female</a20:Selection>

</a20:Q>

</a20:QSA>

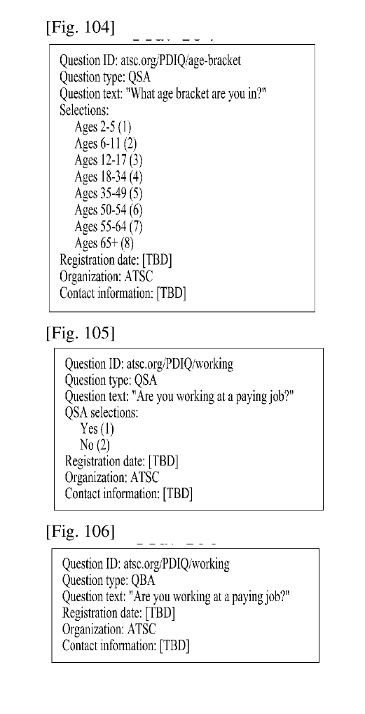

FIG. 104 is a table showing a pre-registered PDI question regarding an age bracket of a user when the targeting criterion type code is 0x03. Content included in the pre-registered PDI question illustrated in FIG. 104 is the same as content described with reference to FIG. 94.

In detail, as illustrated in FIG. 104, when the targeting criterion type code is 0x03, the question ID according to the present embodiment may include information regarding the age bracket. The pre-registered PDI question illustrated in FIG. 104 may be a QSA type and may include a question text including content of requesting a PDI answer of a selection type of the age bracket.

In addition, the pre-registered PDI question illustrated in FIG. 104 is a QSA type, and thus, may include selection information regarding a PDI answer. For example, the pre-registered PDI question regarding the age bracket illustrated in FIG. 104 may include 8 types of selection information regarding ages 2-5, ages 6-11, ages 12-17, ages 18-34, ages 35-49, ages 50-54, ages 55-64, and ages over 65.

[Example 15] below is obtained by representing the table illustrated in FIG. 104 in xml schema according to an embodiment of the present invention.

[Example 15]

<a20:QSA id=″atsc.org/PDIQ/age-bracket″ minChoices=″1″>
<a20:Q xml:lang=″en-us″>

<a20:Text> What age bracket are you in</a20:Text>
<a20:Selection id=”1″>Ages 2-5</a20:Selection>
<a20:Selection id=”2″>Ages 6-11</a20:Selection>
<a20:Selection id=”3″>Ages 12-17</a20:Selection>
<a20:Selection id=”4″>Ages 18-34</a20:Selection>
<a20:Selection id=”5″>Ages 35-49</a20:Selection>
<a20:Selection id=”6″>Ages 50-54</a20:Selection>
<a20:Selection id=”7″>Ages 55-64</a20:Selection>
<a20:Selection id=”8″>Ages 65+</a20:Selection>

</a20:Q>

</a20:QSA>

FIG. 105 is a table illustrating a pre-registered PDI question regarding whether a user is working when the targeting criterion type code is 0x03. Content included in the pre-registered PDI question illustrated in FIG. 105 is the same as content described with reference to FIG. 94.

In detail, as illustrated in FIG. 105, when the targeting criterion type code is 0x03, the question ID according to the present embodiment may include information regarding working. The pre-registered PDI question illustrated in FIG. 105 may be a QSA type and may include a question text including content of requesting a PDI answer of a selection type regarding whether the user is working.

In addition, the pre-registered PDI question illustrated in FIG. 105 is a QSA type, and thus, may include selection information regarding a PDI answer. For example, the pre-registered PDI question regarding working illustrated in FIG. 103 may include 2 types of selection information regarding yes and no.

[Example 16] below is obtained by representing the table illustrated in FIG. 105 in xml schema according to an embodiment of the present invention.

[Example 16]

<a20:QSA id=″atsc.org/PDIQ/working″ minChoices=″1″>

<a20:Q xml:lang=″en-us″>

<a20:Text>Are you working at a paying job?
</a20:Text>

<a20:Selection id=”l”>Yes</a20:Selection>
<a20:Selection id=”2″>No</a20:Selection>

</a20:Q>

</a20:QSA>

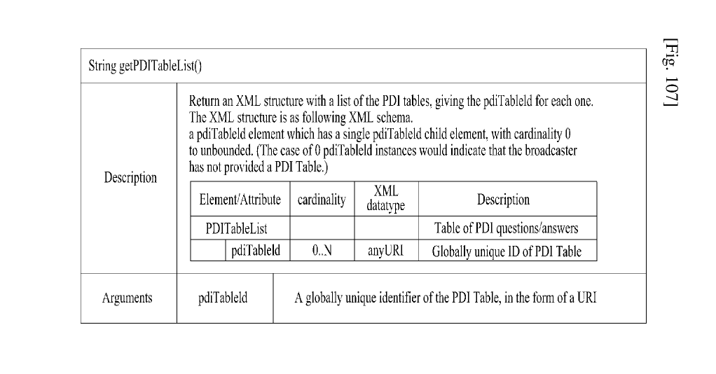

FIG. 106 is a table showing a pre-registered PDI question regarding a gender of a user when the targeting criterion type code is 0x03. Content included in the pre-registered PDI question illustrated in FIG. 106 is the same as content described with reference to FIG. 94.

In detail, as illustrated in FIG. 106, when the targeting criterion type code is 0x03, the question ID according to the present embodiment may include information regarding working. In addition, the pre-registered PDI question illustrated in FIG. 106 may be a QBA type and may include a question text including content of requesting a PDI answer of a Boolean type regarding whether the user is working.

[Example 17] below is obtained by representing the table illustrated in FIG. 82in xml schema according to an embodiment of the present invention.

[Example 17]

<a20:QBA id=“atsc.org/PDIQ/working” >

<a20:Q xml:lang=“en-us”>

<a20:Text>Are you working at a paying job?

</a20:Q>

</a20:QBA>

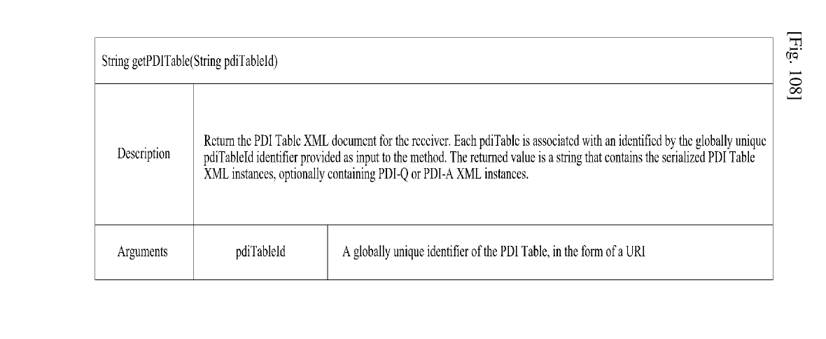

FIG. 107 is a diagram illustrating an application programming interface (PDI API) according to an embodiment of the present invention.

In detail, FIG. 107 is a diagram illustrating a function for using PDI data by application such as the aforementioned declarative content object (DO), etc. The PDI API according to the present embodiment refers to an interface for access of a receiver according to the embodiment of the present invention to a PDI store.

An ATSC 2.0 client device supports the PDI APIs to enable accessing (e.g. search or update) PDI Questions.

The APIs provided as part of the ATSC 2.0 DAE allow a DO, given the ID of a given question, to fetch the text of that question from storage, to fetch a previously supplied answer to that question (if available), and to store an answer to that question.

No attempt is made to define or enforce any rules that would prevent a TDO from accessing or writing any particular question or answer. It is envisioned that multiple entities may provide questionnaires usable on a given channel. Such entities could include, but are not limited to, the national network operator, the local broadcaster affiliate, and various program producers/providers.

The ATSC 2.0 client device implements APIs for PDI data storage and retrieval. To implement PDI functionality, the device can use a native application, a file system/database, or even use a remote service to provide the PDI database. The PDI Store is bound to an ATSC client. Only one PDI Store instance exists for the client. The PDI Store allows the DOs to access the client's PDI data and also allows the user, through native applications, to manage (e.g. update, add, or delete) PDI Questions in a consistent manner across different service providers.

FIG. 107 is a table showing PDI API according to an embodiment of the present invention. A receiver according to the embodiment of the present invention may acquire a PDI table list using the PDI API illustrated in FIG. 107.

Hereinafter, the API illustrated in FIG. 107 will be described.

A name of the API illustrated in FIG. 107 is getPDITableList( ) and may be changed according to a designer's intention. Description illustrated in FIG. 107 refers to details of a getPDITableList( ) API function. Arguments illustrated in FIG. 107 refer to a parameter of the getPDITableList( ) API function.

More specifically, the description shown in FIG. 107 indicates that the getPDITableList( ) API function is for returning an XML structure with a list of the PDI tables, giving the pdiTableId for each one. The XML structure is as following XML schema. A pdiTableList element which has a single pdiTableId child element, with cardinality 0 to unbounded. The case of 0 pdiTableId instances would indicate that the broadcaster has not provided a PDI Table.

The arguments shown in FIG. 54 indicate that pdiTableId is a globally unique identifier of the PDI Table, in the form of a URI.

Thus, a receiver according to the embodiment of the present invention may receive the PDI table list with a table format according to XML schema. As illustrated in FIG. 107, the PDI table list may include a pdiTableId element. When cardinality of the pdiTableId element illustrated in FIG. 107 indicates 0, this means that a receiver according to the embodiment of the present invention does not receive a PDI table from a broadcaster.

FIG. 108 is a diagram showing PDI API according to another embodiment of the present invention.

In detail, FIG. 108 is a diagram showing PDI API for acquiring a PDI table by a receiver according to the embodiment of the present invention.

Hereinafter, the API illustrated in FIG. 108 will be described.

A name of the API illustrated in FIG. 108 is getPDITable(String pdiTableId) and may be changed according to a designer's intention. Description illustrated in FIG. 108 refers to details of a getPDITable(String pdiTableId) API function. Arguments illustrated in FIG. 108 refer to a parameter of the getPDITable(String pdiTableId) API API function.

More specifically, the description shown in FIG. 55 indicates that the getPDITable(String pdiTableId) API function is for returning the PDI Table XML document for the receiver. Each pdiTable is associated with an identified by the globally unique pdiTableId identifier provided as input to the method. The returned value is a string that contains the serialized PDI Table XML instances, optionally containing PDI-Q or PDI-A XML instances.

The arguments shown in FIG. 55 indicate that pdiTableId is a globally unique identifier of the PDI Table, in the form of a URI.

Thus, a receiver according to the embodiment of the present invention may receive the PDI table list described with reference to FIG. 107 and then receive a PDI table. In detail, the receiver that receives the PDI table list may receive a PDI table XML document associated with the pdiTableId illustrated in FIG. 107.

In detail, an operation of a receiver based on the PDI API illustrated in FIG. 108 is the same as the operation described with reference to FIGS. 58 through 61, 76, 87, 89, and 92 through 71. In addition, the receiver based on the PDI API illustrated in FIG. 108 may receive the PDI table list in the PDI table format described with reference to FIGS. 62 through 72.

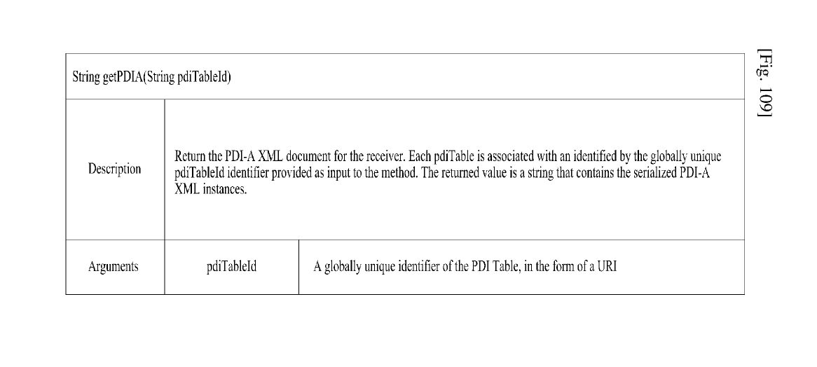

FIG. 109 is a diagram showing PDI API according to another embodiment of the present invention.

In detail, FIG. 109 is a diagram showing PDI API for acquiring a PDI answer by a receiver according to the embodiment of the present invention.

Hereinafter, the API illustrated in FIG. 109 will be described.

A name of the API illustrated in FIG. 109 is getPDIA(String pdiTableId) and may be changed according to a designer's intention. Description illustrated in FIG. 109 refers to details of a getPDIA(String pdiTableId) API function. Arguments illustrated in FIG. 109 refers to a parameter of the getPDIA(String pdiTableId) API function.

More specifically, the description shown in FIG. 109 indicates that the getPDIA(String pdiTableId) API function is for returning the PDI-A XML document for the receiver. Each pdiTable is associated with an identified by the globally unique pdiTableId identifier provided as input to the method. The returned value is a string that contains the serialized PDI-A XML instances.

The arguments shown in FIG. 109 indicate that pdiTableId is a globally unique identifier of the PDI Table, in the form of a URI.

Thus, a receiver that receives the PDI table list described with reference to FIG. 107 and then receive an XML document (or PDI-A instance document) of a PDI-A table associated with the pdiTableId illustrated in FIG. 107. The PDI-A instance document according to the present embodiment is the same as the document described with reference to FIG. 68 and FIG. 69.

In detail, an operation of a receiver based on the PDI API illustrated in FIG. 109 is the same as the operation described with reference to previous FIGs.

Although not illustrated in FIGS. 107 through 109, the PDI API according to the present embodiment can be described as Table 6 and/or Table 7 below.

TABLE 6
Object getPDI(String id)

| Description | Returns an XML DOM object representing an XML | |
|---|---|---|
| | document containing as its root element a PDI QxAD element, | |
| | the QxA child element of which is the PDI Question identified | |
| | by the given id, QxA@id. If no PDI Questions with the | |
| | given value of id exist, this method shall return null. | |
| | Note: Only one PDI Question with a given value of | |
| | question id can exist in a PDI Store. More than one PDI Table | |
| | could hold a PDI Question of the same question id so long as | |
| | the consistency is maintained. | |
| Arguments | id | Identification of the PDI Question |

TABLE 7
void setPDI(object id)

| Description | First checks if the PDI Question corresponding to the QxA | |
|---|---|---|
| | element in the QxAD document represented by the given object | |
| | already exists in the PDI Store. If it does not, then the method | |
| | shall do nothing. If it does exist, then the stored PDI question | |
| | shall be updated to the one provided. Only the answer element | |
| | QxA.A of the PDI Question can be updated. The value of | |
| | PDITable@pdiTableVersion of the PDI Table is not changed. | |
| | If the updated PDI Question is shared by different PDI Tables, | |
| | those related tables shall be changed without any version | |
| | update. The method shall throw a QUOTA_EXCEEDED_ERR | |
| | exception if the storage capacity has been exceeded, or a | |
| | WRONG_DOCUMENT_ERR exception if an invalid document | |
| | is specified. The method shall be atomic with respect to failure. | |
| | In the case of failure, the method does nothing. That is, changes | |
| | to the data storage area must either be successful, or the data | |
| | storage area must not be changed at all. | |
| arguments | id | Object representing the PDI Question |
| | | object for which the answer is to be stored. |

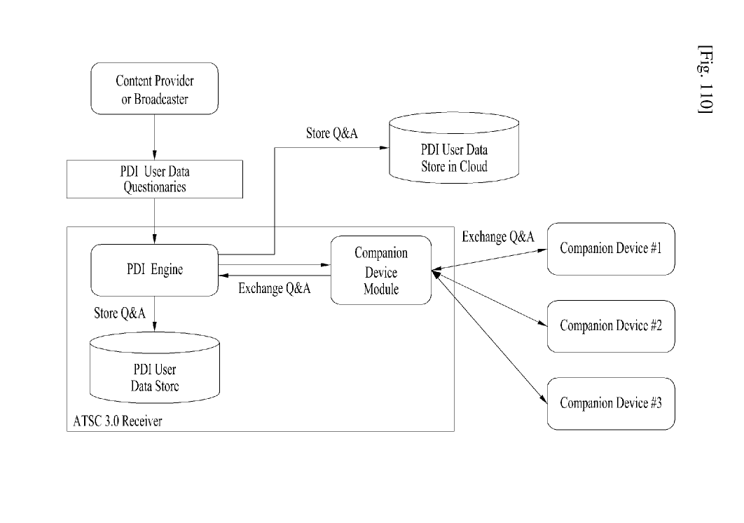

FIG. 110 is a view showing a relationship between a receiver and a companion device in exchange of user data according to an embodiment of the present invention.

In the present invention, PDI(profile, demographics, and interests) user data (e.g. viewing preference, geo-location data, etc.) may be exchanged between different types of companion devices including a broadcast receiver.

When PDI user data questionnaires created by a content provider or a broadcaster are transmitted to the receiver, the receiver may provide the corresponding questionnaires to a user, receive answers to the questionnaires, and store the received answers in a user data store. The store may be located in the receiver or outside the receiver (e.g. cloud). The basically stored user data may be transmitted to the companion device. On the other hand, the receiver may receive and store an answer set by the companion device. A protocol for communication between the receiver and the companion device is not limited to a specific protocol. In the present invention, an embodiment is prepared based on UPnP. In the present invention, configuration in the form of XML will be described as an embodiment although the form of PDI user data is also not limited.

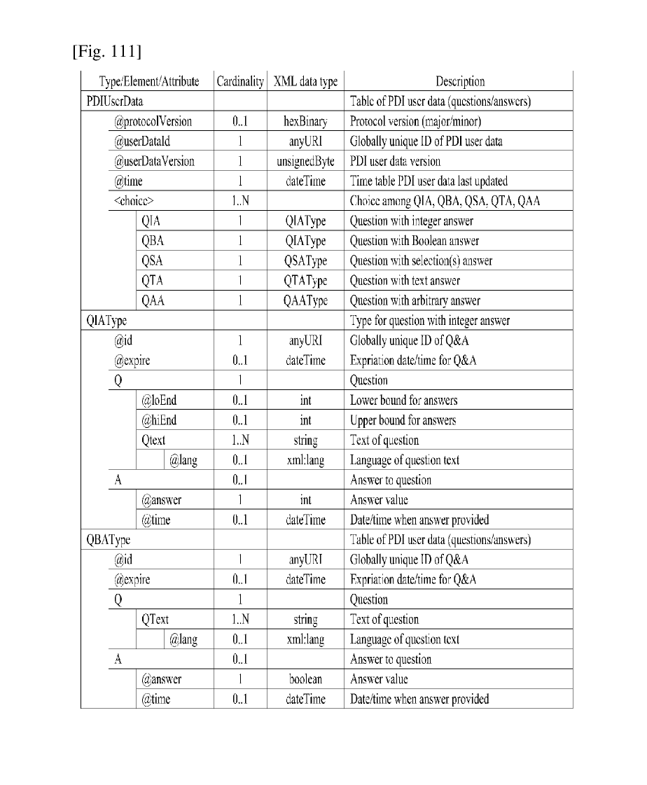

FIG. 111 is a view showing a portion of XML of PDI user data according to another embodiment of the present invention.

A description of each element included in the PDI user data is replaced with a description shown in the figure and/or a description of elements having similar names included in the XML form of the above-described PDI table.

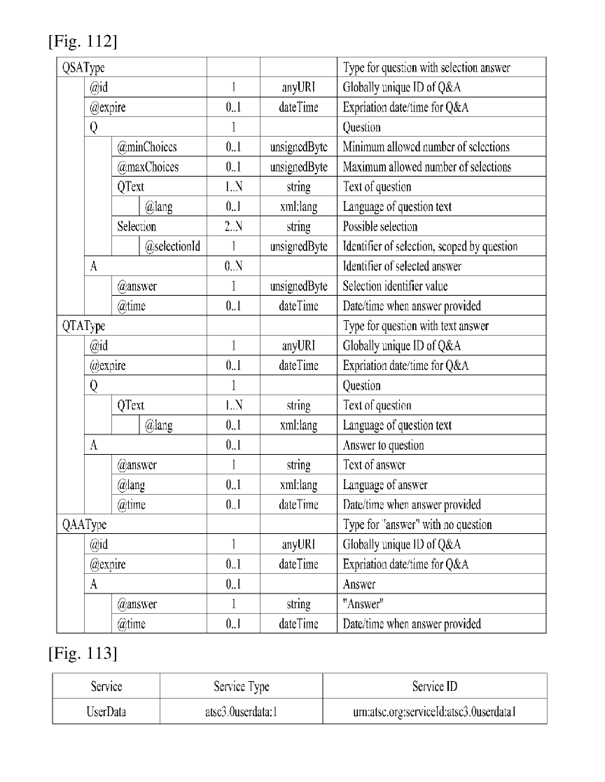

FIG. 112 is a view showing another portion of XML of PDI user data according to another embodiment of the present invention.

A description of each element included in the PDI user data is replaced with a description shown in the figure and/or a description of elements having similar names included in the XML form of the above-described PDI table.

FIG. 113 is a view showing service type and service ID defined to exchange PDI user data between a broadcast receiver and a companion device according to an embodiment of the present invention.

Device type for compatibility between a receiver and a companion device may be defined to exchange PDI user data.

The following device type may be defined to exchange PDI user data between devices.

UPnP Device Type—urn:atsc.org:device:atsc3.0rcvr

In an embodiment, it may be set such that services described in the present invention cannot be used between devices which are not suitable for device type. A broadcast receiver (for example, an ATSC3.0 receiver) supporting the defined device type and companion devices may designate service type and service ID to exchange PDI user data.

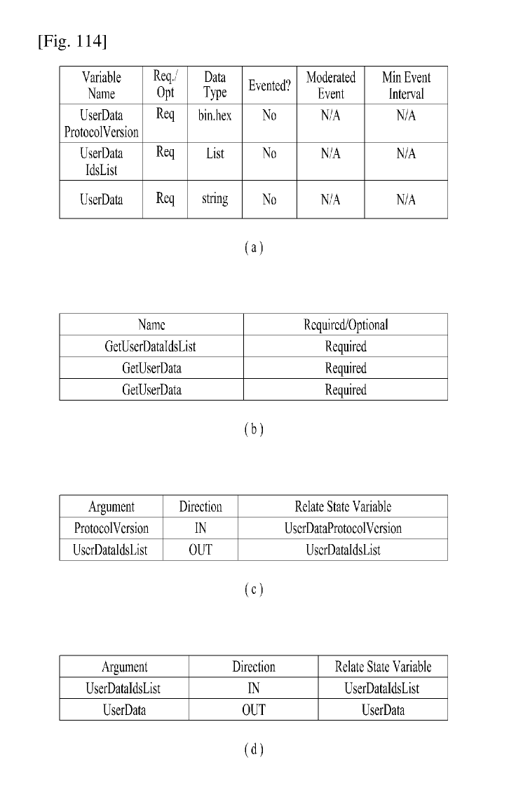

FIG. 114 is a view showing information defined to exchange PDI user data by UPnP according to an embodiment of the present invention.

Referring to (a) of the figure, UPnP UserData service may define the following state variables to exchange PDI user data. The state variables may include UserDataProtocolVersion, UserDataIdsList, and/or UserData.

UserDataProtocolVersion indicates a PDI user data protocol version.

UserDataIdsList indicates an ID list of PDI user data stored in a PDI store.

UserData indicates PDI User Data consisting of a plurality of questionnaires and answers.

Referring to (b) of the figure, an action of a UPnP UserData service is defined. The action of the UPnP UserData service may include a GetUserDataIdsList action, a GetUserData action, and/or a SetUserData action.

The GetUserDataIdsList action is an action for bringing ID of PDI user data stored in the PDI store. State variables related to arguments for the action may be the same as (c) of the figure. Only ID of PDI user data supporting a corresponding protocol may be brought with reference to Protocol Version of the PDI user data.

The GetUserData action is an action for bringing PDI user data stored in the PDI store. State variables related to arguments for the action may be the same as (d) of the figure.

The SetUserData action may be used when a companion device sets PDI user data and transmits the set PDI user data to a receiver. State variables related to arguments for the SetUserData action will hereinafter be described.

FIG. 115 is a sequence diagram showing a method of exchanging PDI user data according to an embodiment of the present invention.

A companion device may bring PDI user data from a broadcast receiver. The companion device and the receiver are paired with each other. A paring process between the companion device and the receiver is omitted from the figure.

A content provider or a broadcaster may transmit PDI user data to the receiver so as to provide a personalized service to a user. The PDI user data may include several questionnaires provided to the user and/or answers, which are answerable items.

The receiver transmits PDI user data to a PDI engine (step 1).

The PDI engine may be controlled to display questionnaires to the user (step 2).

The user may set an answer to each questionnaire (step 3).

Completed Q&A are stored in a PDI user data store (step 4).

The companion device requests IDs of PDI user data from the receiver through a GetUserDataIdsList action to obtain the PDI user data (step 5).

A companion device module requests IDs of PDI user data from the PDI engine (step 6).

The PDI engine retrieves IDs of PDI user data stored in the PDI user data store (step 7).

The PDI engine transmits IDs of PDI user data to the companion device module (step 8). The companion device module may be provided in the broadcast receiver. The companion device module functions to interface with the companion device.

The companion device module transmits IDs of PDI user data to the companion device (step 9).

PDI user data may be requested through a GetUserData action based on IDs of PDI user data received from the companion device (step 10).

The companion device module requests PDI user data from the PDI engine (step 11).

The PDI engine retrieves PDI user data stored in the PDI user data store (step 12).

The PDI engine transmits PDI user data to the companion device module (step 13).

The companion device module transmits PDI user data to the companion device and the companion device stores the received data (step 14).

In a case in which an additional user data storage space is present in the companion device, PDI user data, exchange of which has been completed, may be semi-permanently stored in the companion device. On the other hand, in a case in which there is no store, the PDI user data may be temporarily stored in a space, such as a memory.

A time at which the GetUserDataIdsList action and/or the GetUserData action is executed is not limited to the above-described sequence. For example, the GetUserDataIdsList action and/or the GetUserData action may be generated immediately after the companion device and the broadcast receiver are paired with each other or according to a request of the companion device during periodic polling.

FIG. 116 is a view showing state variables related to arguments for a SetUserData action according to an embodiment of the present invention.

As previously described, a SetUserData action may be used when a companion device sets PDI user data and transmits the set PDI user data to a receiver. That is, the SetUserData action is an action used to transmit information to the receiver when a user of the companion device selects an answer to a questionnaire included in PDI user data.

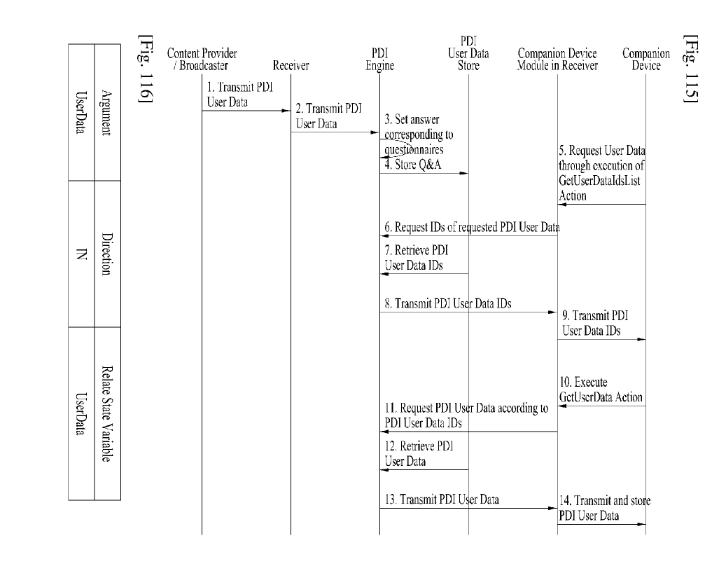

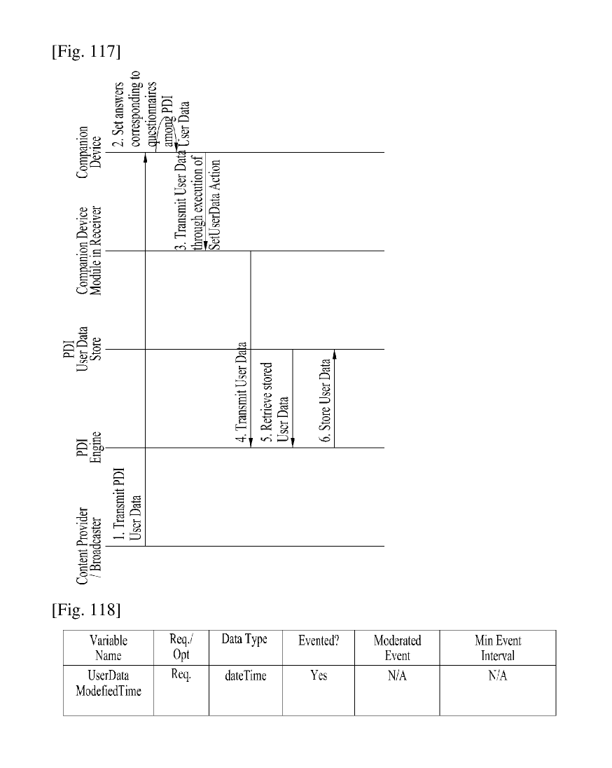

FIG. 117 is a sequence diagram showing a method of a companion device setting PDI user data and transmitting the set PDI user data to a receiver such that the PDI user data are stored in the receiver according to an embodiment of the present invention.

It is assumed that the companion device and the receiver are paired with each other.

A content provider or a broadcaster may transmit PDI user data to the companion device so as to provide a personalized service to a user. A PDI list may include several questionnaires requiring answers from the user (step 1).

The companion device may show the user questionnaires among the received PDI user data and the user may set answers corresponding to the questionnaires (step 2).

The companion device transmits the PDI user data to a companion device module in the receiver through a SetUserData action (step 3).

The companion device module transmits the received user data to a PDI engine (step 4).

The PDI engine retrieves whether there are present PDI user data which are already stored in a PDI user data store (step 5). At this time, the receiver may determine whether there is already present a PDI table received related to a specific application using PDI table identification information or application identification information included in the PDI table.

In a case in which there are present no PDI user data which are already stored at the retrieval result of the PDI engine, PDI user data may be newly stored. In a case in which there are present PDI user data which are already stored at the retrieval result of the PDI engine, on the other hand, the corresponding PDI user data may be updated (step 6).

FIG. 118 is a view showing state variables for transmitting PDI user data in a case in which the PDI user data are changed according to an embodiment of the present invention.

A UPnP UserData service may set additional state variables to transmit PDI user data to a companion device only in a case in which the PDI user data are changed, e.g. updated. For example, a time when the PDI user data have been finally modified may be indicated using UserDataModefiedTime and a corresponding state variable may be transmitted when the PDI user data are modified into event type.

FIG. 119 is a sequence diagram showing a method of transmitting PDI user data in a case in which the PDI user data are changed according to an embodiment of the present invention.

In an embodiment of the present invention, there is shown a method of a companion device bringing PDI user data from a receiver when new PDI user data are transmitted and changed. The companion device and the receiver are paired with each other. A paring process between the companion device and the receiver is omitted from the sequence diagram.

The companion device subscribes to a companion device module to receive UserDataModefiedTime, which is a state variable, when a value of UserDataModefiedTime is changed (step 1).

A content provider or a broadcaster may transmit new questionnaires to the receiver (step 2).

The receiver transmits the questionnaires to a PDI engine (step 3).

A PDI user data engine may show questionnaires to a user and the user may set answers corresponding to the respective questionnaires (step 4).

Completed Q&A are stored in a PDI user data store (step 5).

The PDI engine updates UserDataIdxCount, which is a state variable (step 6).

When UserDataIdxCount is updated, the companion device may be notified that questionnaires have been changed through an event (step 7).

Subsequently, the PDI user data may be brought to the companion device through a GetUserDataIdsList action and/or a GetUserData action. This procedure may refer to the above-described procedure. In a case in which new PDI user data are not transmitted but answers of the PDI user data which are already stored are changed, the procedure may be carried out from step 3 excluding step 1 and step 2.

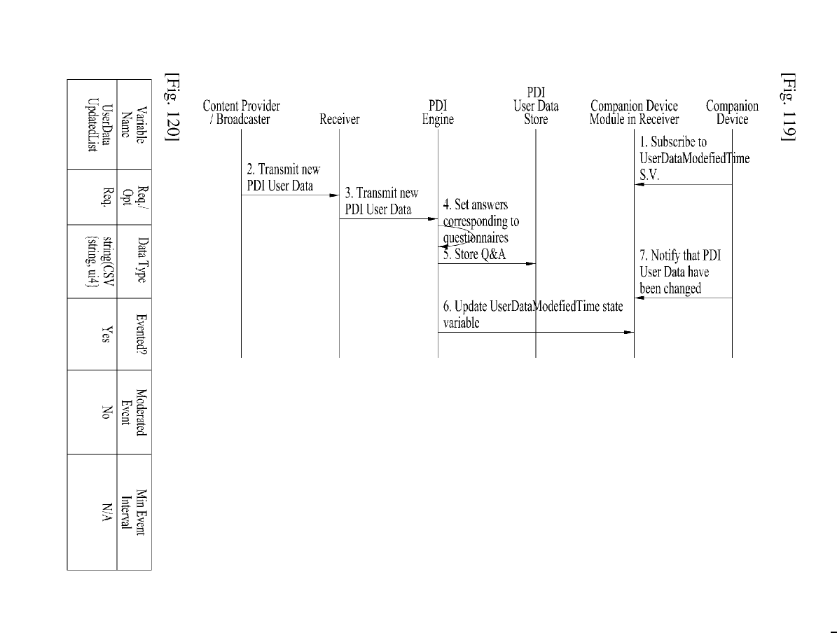

FIG. 120 is a sequence diagram showing a method of transmitting PDI user data in a case in which the PDI user data are changed according to another embodiment of the present invention.

A UPnP UserData service may set additional state variables to transmit PDI user data to a companion device only in a case in which the PDI user data are changed, e.g. updated. To this end, UserDataUpdatedList may be set. This is a CSV list form and a list in a pair form of user data ID and user data version corresponding thereto. For example, UserDataUpdatedList may be expressed in a form, such as (UserDataId#1, 1.0). In a case in which PDI user data ID is changed or PDI user data version is changed, UserDataUpdatedList may also be updated and the companion device may be notified of the change into even type. PDI user data ID may be added or deleted. Whenever PDI user data version is modified, a value of the PDI user data version may be increased by 1.

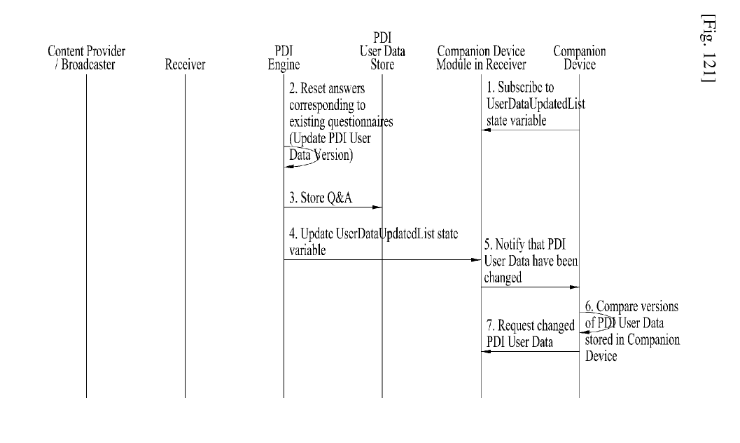

FIG. 121 is a sequence diagram showing a method of transmitting PDI user data in a case in which the PDI user data are changed according to another embodiment of the present invention.

In an embodiment of the present invention, there is shown a method of a companion device bringing PDI user data from a receiver when answers of PDI user data which are already stored are changed. The companion device and the receiver are paired with each other. A paring process between the companion device and the receiver is omitted from the sequence diagram.

The companion device subscribes to a UserDataUpdatedList state variable such that the companion device is notified of user data in a case in which the user data are updated (in a case in which user data ID or user data version is changed) (step 1).

Answers to questionnaires stored in an existing receiver are changed. Since existing PDI user data are changed, a PDI user data version is updated (step 2).

Completed Q&A are stored in a PDI user data store (step 3).

A value of UserDataUpdatedList, which is a state variable, is updated according to the changed PDI user data version (step 4).

Since a value of UserDataUpdatedList declared into event type is changed, a companion device module notifies the companion device of the change (step 5).

The companion device compares versions of PDI user data which are already stored with reference to UserDataUpdatedList, which is a changed state variable (step 6).

The companion device may perform an action on PDI user data, PDI user data version of which has been changed, to bring the PDI user data. Only the changed PDI user data may be brought or all PDI user data may be brought (step 7).

Subsequently, the companion device may bring PDI user data through a GetUserData action. This procedure is omitted from the sequence diagram. In a case in which PDI user data are newly added, a procedure of transmitting PDI user data from a content provider/broadcaster to the receiver may be added. This procedure is omitted from the sequence diagram.

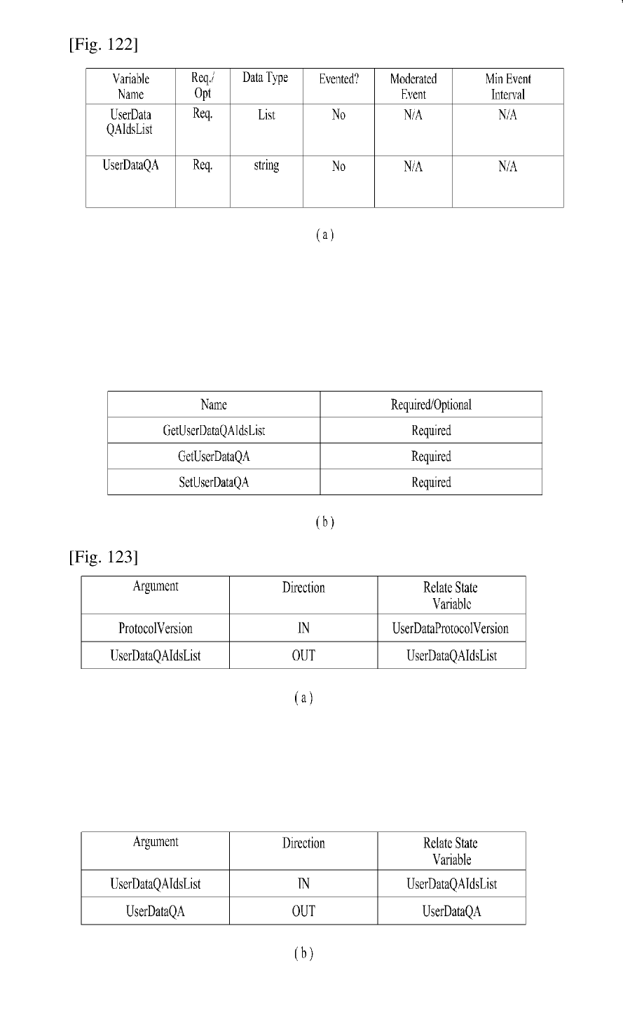

FIG. 122 is a view showing state variables for bringing PDI user data on a per pair basis of question and answer according to an embodiment of the present invention.

When PDI user data are exchanged between a receiver and a companion device, overload may occur sue to a large amount of data. Therefore, PDI user data may be transmitted on a per pair basis of questions and answers.

Referring to (a) of the figure, state variables may be defined to exchange a Q&A pair. To this end, the state variables may include UserDataQAIdsList and/or UserDataQA.

UserDataQAIdsList indicates a list of pair IDs of questions stored in a PDI store and answers related thereto.

UserDataQA indicates a pair set of questions and answers.

Referring to (b) of the figure, a UPnP UserData service may have the following three actions.

A GetUserDataIdsList action is an action for bringing IDs of question/answer pairs stored in the PDI store.

A GetUserDataQA action is an action for bringing question/answer pairs stored in the PDI store.

A SetUserDataQA action may be used when the companion device sets Q&A and transmits the set Q&A to the receiver.

FIG. 123 is a view showing state variables related to arguments for a GetUserDataIdsList action and a GetUserDataQA action according to an embodiment of the present invention.

Referring to (a) of the figure, there are shown state variables related to arguments for the GetUserDataIdsList action. Only Q&A IDs of PDI user data supporting a corresponding protocol may be brought with reference to ProtocolVersion of the above-described PDI user data.

Referring to (b) of the figure, there are shown state variables related to arguments for the GetUserDataQA action.

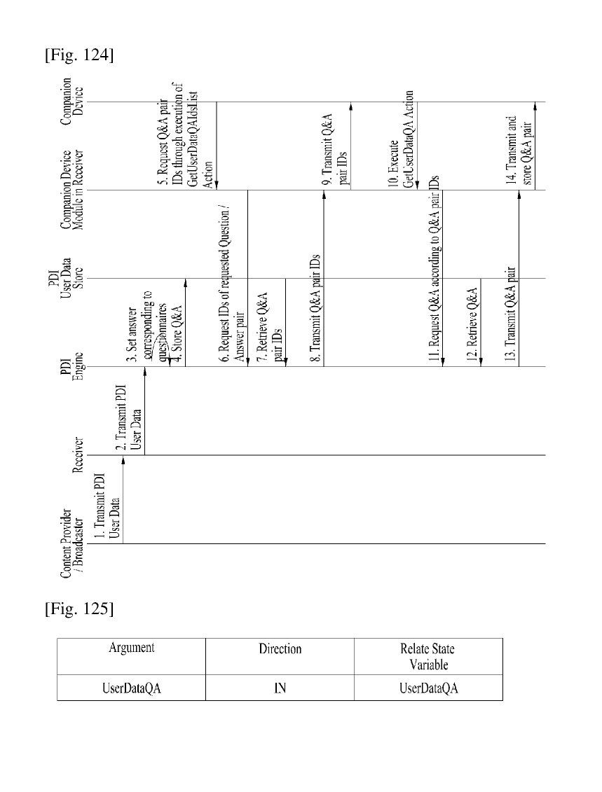

FIG. 124 is a sequence diagram showing a method of exchanging question/answer pairs according to an embodiment of the present invention.

A companion device may bring PDI user data from a receiver. The companion device and the receiver are paired with each other. A paring process between the companion device and the receiver is omitted from the figure.

A content provider or a broadcaster may transmit PDI user data to the receiver so as to provide a personalized service to a user (step 1). The PDI user data may be a combination of several questionnaires and answers.

The receiver transmits PDI user data to a PDI engine (step 2).

The PDI engine may show questionnaires to a user and the user may set answers corresponding to the respective questionnaires (step 3).

Completed Q&A are stored in a PDI user data store (step 4).

The companion device requests pair IDs of questions and answers from the receiver through a GetUserDataQAIdsList action to obtain pair data of questions and answers thereto (step 5).

A companion device module requests Q&A IDs from the PDI engine (step 6).

The PDI engine retrieves Q&A IDs stored in the PDI user data store (step 7).

The PDI engine transmits Q&A IDs to the companion device module (step 8).

The companion device module transmits Q&A IDs to the companion device (step 9).

Q&A pair data may be requested through a GetUserDataQA action based on Q&A IDs received from the companion device (step 10).

The companion device module requests Q&A pairs from the PDI engine (step 11).

The PDI engine retrieves Q&A pairs stored in the PDI user data store (step 12).

The PDI engine transmits Q&A pairs to the companion device module (step 13).

The companion device module transmits Q&A pairs to the companion device and the companion device stores the received data (step 14).

In a case in which an additional user data storage space is present in the companion device, Q&A pair data, exchange of which has been completed, may be semi-permanently stored in the companion device. On the other hand, in a case in which there is no store, the Q&A pair data may be temporarily stored in a space, such as a memory.

A time at which the GetUserDataQAIdsList action and/or the GetUserDataQA action is executed may be immediately after the companion device and the broadcast receiver are paired with each other. Alternatively, the companion device may request the above action during periodic polling.

FIG. 125 is a view showing a state variable related to arguments for a SetUserDataQA action according to an embodiment of the present invention.

A SetUserDataQA (or UserDataQA) action may be used when a companion device sets Q&A and transmits the set Q&A to a receiver. A state variable related to arguments for a SetUserDataQA action may be as follows.

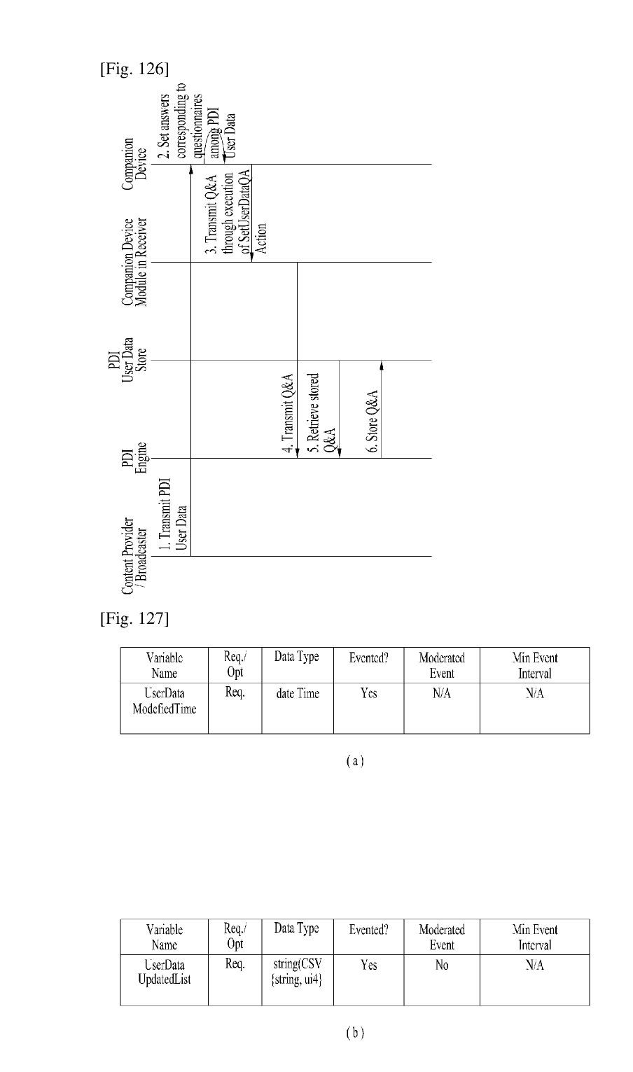

FIG. 126 is a sequence diagram showing a method of a companion device setting Q&A and transmitting the set Q&A to a receiver such that the Q&A are stored in the receiver according to an embodiment of the present invention.

The companion device and the receiver are paired with each other. A paring process between the companion device and the receiver is omitted from the sequence diagram.

A content provider or a broadcaster may transmit PDI user data to the companion device so as to provide a personalized service to a user (step 1). A PDI list may include several questionnaires requiring answers from the user.

The companion device may show the user questionnaires among the received PDI user data and the user may set answers corresponding to the questionnaires (step 2).

The companion device transmits Q&A to a companion device module in the receiver through a SetUserDataQA action (step 3).

The companion device module transmits the received Q&A to a PDI engine (step 4).

The PDI engine retrieves whether there are present Q&A which are already stored in a PDI user data store (step 5).

In a case in which there are present no Q&A which are already stored at the retrieval result of the PDI engine, Q&A may be newly stored. In a case in which there are present Q&A which are already stored at the retrieval result of the PDI engine, on the other hand, the corresponding Q&A may be updated (step 6).

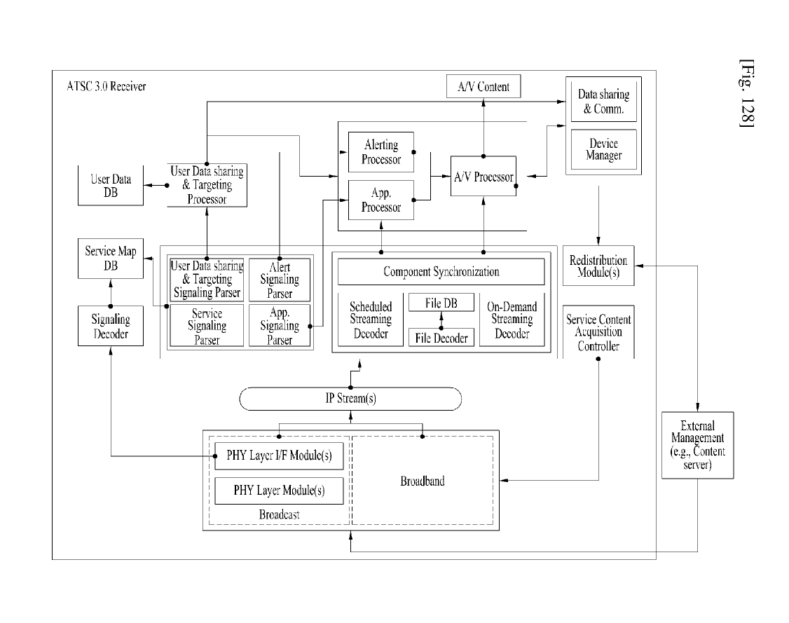

FIG. 127 is a view showing state variables for transmitting Q&A in a case in which the Q&A are changed, e.g. updated, according to an embodiment of the present invention.

Referring to (a) of the figure, a UPnP UserData service may set additional state variables to transmit Q&A to a companion device only in a case in which the Q&A are changed, e.g. updated. In this case, UserDataModefiedTime may be set. This indicates a time when the Q&A have been finally modified. When PDI user data are modified into event type, a corresponding state variable may be transmitted.

An action for transmitting Q&A to the companion device is the same as an action for transmitting all PDI user data. Consequently, an embodiment of a sequence diagram for such an action is replaced with the above description of the PDI user data.

Referring to (b) of the figure, the UPnP UserData service may set additional state variables to transmit PDI user data to the companion device only in a case in which the PDI user data are changed, e.g. updated. In this case, UserDataUpdatedList may be set. This is a CSV list form and a list in a pair form of user data ID and user data version corresponding thereto. For example, UserDataUpdatedList may be expressed in a form, such as (UserDataId#1, 1.0). In a case in which PDI user data ID is changed or PDI user data version is changed, UserDataUpdatedList may also be updated and the companion device may be notified of the change into even type. PDI user data ID may be added or deleted. Whenever PDI user data version is modified, a value of the PDI user data version may be increased by 1.

An action for transmitting PDI user data to the companion device is the same as an action for transmitting all PDI user data. Consequently, an embodiment of a sequence diagram for such an action is replaced with the above description of the PDI user data.

FIG. 128 is a view showing a receiver according to another embodiment of the present invention.

The receiver shown in the figure is similar to the above-described receiver and includes devices similar to those included in the above-described receiver. Consequently, a description of devices having the same names is replaced with the above description.

The above-described targeting signaling parser may be named a user data sharing & targeting signaling parser and may further function to parse the above-described user data (for example, PDI user data or Q&A).

The above-described targeting processor may be named a user data sharing & targeting processor and may further function to process the above-described user data (for example, PDI user data or Q&A).

The receiver according to the embodiment of the present invention may further include a user data DB. The user data DB stores processed user data.

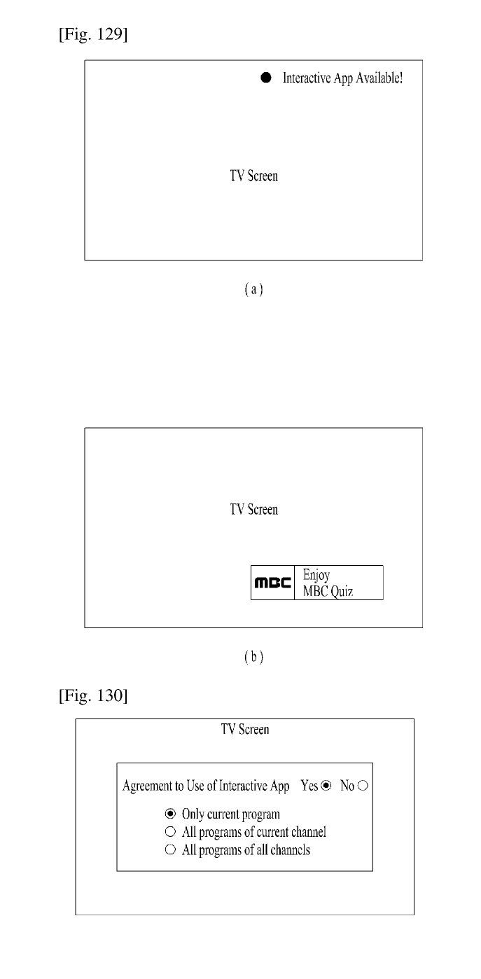

FIG. 129 is a view showing notification for entry into a synchronized application according to an embodiment of the present invention.

The synchronized application is an application expressed while being interlocked with a content of a non-real time broadcast and/or a real time broadcast. The synchronized application is an application set such that a corresponding application can be executed or expressed in a broadcast content at a necessary appropriate time.

An application may be used as a meaning of a general application. Alternatively, an application may be used as a meaning indicating an object displayed on a broadcast content while being related to the content. For example, in a case in which a profile of a specific player is displayed on a screen during broadcasting of a sport game, an application may be defined as a subject enabling the corresponding profile to be displayed.

A non-real time broadcast is a kind of broadcast in which a broadcast signal or data for a real time broadcast are not transmitted and data for a broadcast content are transmitted/received through an unused band of the broadcast signal. The unused band may be defined as a time domain in which a real time broadcast is not provided. Alternatively, in a case in which a bandwidth of a broadcast signal is left even while a real time broadcast is being transported, the unused band may be defined as the bandwidth. Since a broadcast content is transported to the unused band, the broadcast content may be discontinuously transported while being separated into one or more files (or objects). A receiver may receive and store such files and, upon receiving all files included in a broadcast content, may reproduce the corresponding broadcast content according to a user's request.

According to an embodiment of the present invention, a user interface and/or format for notification of the synchronized application may be controlled by the receiver.

Referring to (a) of the figure, for an application related to an existing data broadcast, notification for notifying the application of an entry route includes a simple notification in the form of a red dot provided by a broadcaster.

On the other hand, the present invention provides a method and/or apparatus for enabling the receiver to adjust or realize notification of such an application. In a case in which the receiver adjusts notification of an application, information for adjusting the notification may be configured based on information provided by a content provider and a broadcaster.

According to the present invention, the details of notification may be displayed in a unique form per channel and/or per application. At this time, data regarding the form and/or operating attribute of application notification synchronized to be suitable for characteristics per channel or per application may be received from the content provider and the broadcaster per channel and/or per application. This scheme is different from an application of an existing data broadcast in that the synchronized application notification may be reconfigured by the receiver based on information provided by the content provider and the broadcaster. In addition, the receiver may internally intercept collection of viewing information (for example, information such as a time when a user pushes application notification to enter an application immediately after the user starts to view a broadcast) excluding real use information of the application by the content provider and the broadcaster to set protection of personal information of the user. On the other hand, the receiver may be set such that viewing information, internally allowed in the receiver, excluding the real use information of the application, is provided to the content provider and the broadcaster. Information that can be provided for a form of the synchronized application notification may include notification location information on a screen, display size information of the notification, the details of a message, an image indicating the application, and/or a logo of the broadcaster (or the content provider). Information that can be provided for an operating attribute may include information regarding a time when notification appears for the first time, information regarding duration of the notification, and/or information regarding cycle of the notification.

(b) of the figure shows an embodiment in which notification for entry into an synchronized application is created and displayed using display size information of a notification, notification location information on a screen, the details of a message, and information regarding a logo of the broadcaster provided from the broadcaster per channel.

FIG. 130 is a view showing a user interface for interlocking synchronized application notification and a user agreement interface according to an embodiment of the present invention.

A synchronized application or notification therefor may be set to be executed or expressed after user agreement is obtained. For example, whether to obtain user agreement may be set per application, program, or channel.

In a case in which user agreement is not set, a corresponding synchronized application may be intercepted. In this case, a receiver does not provide the corresponding application to a user. In a case in which whether to obtain user agreement is not set, on the other hand, all applications may be intercepted or all application may be provided without interception.

An interface for user agreement to a synchronized application may be configured in the receiver. Various conditions and schemes of user agreement may be provided.

For smooth interlocking between the user agreement interface and the application, the receiver may more actively control the application.

For example, for an existing data broadcast, even when an application is finished by a user for the reason that the user does not wish to view the application, the receiver cannot control the application with the result that notification of the application is exposed again.

In an embodiment of the present invention, as shown, a scheme in which, for an application agreed or disagreed by the user once, the details of the corresponding agreement are set to be continuously maintained within a current program/current channel/all channels on the assumption that each broadcast program does not maximally disturb user's viewing of a broadcast in connection with user agreement.

According to an embodiment of the present invention, the user interface for user agreement to a synchronized application may include an item for setting agreement to the use of the synchronized application (an application) (or expression of application notification).

The user interface may further include an item for setting a range of agreement or disagreement to the use of an application.

For example, whether to agree to the use of an application may be applied within a range of a current program. In a case in which user agreement is obtained, the user agreement may be effective only for a corresponding broadcast program. When the corresponding broadcast program is finished, the user agreement interface for the corresponding application may be initialized. In a case in which user disagreement is obtained, the user disagreement may be effective only for a corresponding broadcast program. When the corresponding broadcast program is finished, the user agreement interface for the corresponding application may be initialized.

For example, whether to agree to the use of an application may be applied within a range of a current channel. In a case in which user agreement is obtained, the user agreement may be effective for all broadcast programs of the corresponding channel. When the user changes the channel, the user agreement interface for the corresponding application may be initialized. In a case in which user disagreement is obtained, the user disagreement may be effective only for a corresponding broadcast channel. When the broadcast channel is changed, the user agreement interface for the corresponding application may be initialized.

For example, whether to agree to the use of all applications may be applied. In a case in which user agreement is obtained, the user agreement may be effective for all broadcast programs of all channels, which may be applied until the user changes a set value on a user agreement interface menu for a corresponding application. In a case in which user disagreement is obtained, all applications are not provided to the user until another user setting is performed.

Although a specific setting is selected by the proposed illustration, an additional user agreement interface menu may be provided such that the user can change setting of an application afterwards.

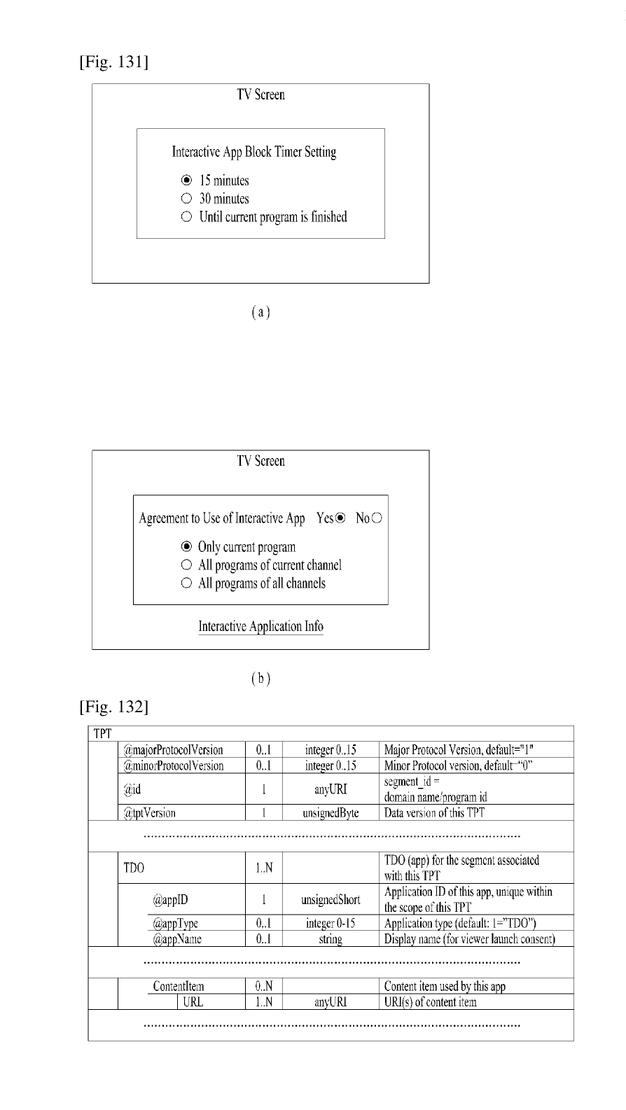

FIG. 131 is a view showing a user interface for agreement to the use of an application according to another embodiment of the present invention.

A user interface as shown may be provided to the above-described user interface by addition or change.

Referring to (a) of the figure, a receiver may provide a user with a user interface (an application notification block timer) for setting application notification to be blocked for a predetermined period of time after the application notification is exposed. For example, the application notification block timer provided by the receiver may include items for setting application notification to be blocked on a per time basis (for example, 15 minutes or 30 minutes) or on a per program basis (for example, setting a period of time to a time when a current program is finished).

Similarly, although the user disagrees to the use of an application (or application notification), application notification may be exposed again in a case in which a set time or condition is satisfied.

Referring to (b) of the figure, a link for enabling detailed information of an application, such as introduction of the application, interaction timeline information of the application, and/or real time user statistics of the application, to be shown may be provided before setting user agreement to the use of an application (or application notification). The user may acquire information necessary to decide whether to use the corresponding application through this link.

FIG. 132 is a view showing a portion of a TDO parameter table (TPT) (or a TDO parameter element) according to an embodiment of the present invention.

The TDO parameter table (or the TDO parameter element) according to the embodiment of the present invention includes metadata regarding an application (or TDP) associated with a segment and/or an event.

The TDO parameter table includes a TPT element, a MajorProtocolVersion element, a MinorProtocolVersion element, an id element, a tptVersion element, an expireDate element, a serviceID element, a baseURL element, a Capabilities element, a LiveTrigger element, a URL element, a pollPeriod element, a TDO element, an appID element, an appType element, an appName element, a globalID element, an appVersion element, a cookieSpace element, a frequencyOfUse element, an expireDate element, a testTDO element, an availInternet element, an availBroadcast element, a URL element, a Capabilities element, a ContentItem element, a URL element, a updatesAvail element, a pollPeriod element, a Size element, an availInternet element, an availBroadcast element, an Event element, an eventID element, an action element, a destination element, a diffusion element, and a Data element.

The TPT element is a root element of the TPT.

The MajorProtocolVersion element indicates a major version number of definition of a table. A receiver may discard a TPT having a major version number which is not supported by the receiver.

The MinorProtocolVersion element indicates a minor version number of definition of a table. A receiver does not discard a TPT having a minor version number which is not supported by the receiver. In this case, the receiver ignores the information or element which is not supported by the receiver so as to process the TPT.

The id element may have a URI form and identifies an interactive programming segment (or an interactive service segment) related to this TPT. This id element may become “locator_part” of a corresponding trigger.

The tptVersion element indicates version information of the TPT identified by the id element.

The expireDate element indicates an expiration date and time of information included in a TPT instance. When the receiver stores the TPT, the TPT may be reused until the date and time indicated by the expireDate element.

The serviceID element indicates the identifier of the NRT service related to an interactive service described in the TPT instance.

The baseURL element indicates a base URL combined and used in a front end of a URL in the TPT. The baseURL element indicates absolute URLs of files.

The Capabilities element indicates essential capabilities for displaying an interactive service related to the TPT.

The LiveTrigger element includes information used when an activation trigger is provided via the Internet. The LiveTrigger element provides information necessary for the receiver to obtain the activation trigger.

The URL element indicates the URL of a server for transmitting the activation trigger. The activation trigger may be transmitted via the Internet using HTTP short polling, HTTP long polling or HTTP streaming.

If the pollPeriod element is present, this indicates that short polling is used to transmit the activation trigger. The pollPeriod element indicates a polling period.

The TDO element includes information about an application (e.g., TDO) for providing a part of an interactive service during a segment described by a TPT instance.

The appID element identifies an application (e.g., TDO) within the range of the TPT. The activation trigger identifies a target application for applying a trigger using the appID element.

The appType element identifies a format type of an application. For example, if the value of the appType element is set to “1”, then this indicates that the application is a TDO.

The appName element indicates the name of an application which is displayed to a viewer and is human-readable.

The globalID element indicates a global identifier of an application. If the global ID element is present, the receiver may store an application code and reuse the application code for later display of the same application in the segment of the same or different broadcast station.

The appVersion element indicates the version number of an application (TDO).

The cookieSpace element indicates the size of a space necessary to store data required by an application between application invocations.

The frequencyOfUse element indicates how frequently the application is used in a broadcast. For example, the frequencyOfUse element may indicate that the application is repeatedly used on a time-to-time, day-to-day, weekly or monthly basis or is used only once.

The expireDate element indicates a date and time when the receiver securely deletes an application and/or resources related thereto.

The testTDO element indicates whether the application is used for the purpose of testing. If the application is used for the purpose of testing, a general receiver may ignore this application.

The availInternet element indicates whether the application may be downloaded via the Internet.

The availBroadcast element indicates whether the application may be extracted from a broadcast signal.

Each instance of the URL element identifies a file which is a part of an application. If one or more instances are present, a first instance specifies a file which is an entry point. The file which is the entry point should be executed in order to execute the application.

The Capabilities element indicates capabilities of the receiver necessary to meaningfully display the application. Information about capabilities will be described below with reference to FIG. 34.

The ContentItem element includes information about a content item composed of one or more files required by the application. The URL element identifies a file which is a part of the content item. The URL element may identify URL information provided by the content item. If one or more instances are present, a first instance specifies a file which is an entry point.

The updatesAvail element indicates whether the content item can be updated. The updatesAvail element may indicate whether the content item is composed of static files or is an RT data feed.

If the pollPeriod element is present, short polling is used to transmit the activation trigger. The pollPeriod indicates a time used by the receiver as a polling period.

The Size element indicates the size of the content item.

The availInternet element indicates whether the content item may be downloaded via the Internet.

The availBroadcast element indicates whether the content item may be extracted from a broadcast signal.

The event element includes information about an event for a TDO.

The eventID element serves to identify an event within the range of the TDO. The activation trigger identifies a target application and/or event, to which a trigger is applied, using a combination of the appID element and the eventID element.

The action element indicates the type of a TDO action which should be applied when an event occurs. The action value may include the following meanings.

“register” means that resources of the application are acquired and pre-cached, if possible.

“suspend-execute” means that another application which is currently being executed is suspended and a current application is executed. If a target application is suspended, the receiver resumes the application in a previous state.

“terminate-execute” means that another application which is currently being executed is terminated and a current application is executed. If a target application is suspended, the receiver resumes the application in a previous state.

“terminate” means that the application is terminated.

“suspend” means that the application is suspended. A UI and/or application engine state is required to be preserved until the application is re-executed.

“stream_event” means that a specific action defined by the application is appropriately performed. The destination element indicates a target device type for an event. For example, the value of the destination element may indicate that the event is executed on a main screen and/or a secondary screen. The destination element may be used as a placeholder.

The diffusion element indicates a parameter for smoothing server peak load. The diffusion element may indicate a period T in seconds. The receiver may compute a random time in a range from 0 to T seconds and perform delay by the computed time before accessing an Internet server in order to obtain content referred to by URLs of the TPT.

The data element includes information about data related to the event. If the event occurs, the target application may read and use this data in order to perform desired operation.

According to an embodiment of the present invention, the link regarding detailed information of the above-described application may be transmitted to a URL element of a ContentItem element included in a TDO as in an embodiment of the TDO parameter table (TPT).

In a state in which the detailed information of the application is treated as one content included in the application, link information of the corresponding content may be provided.

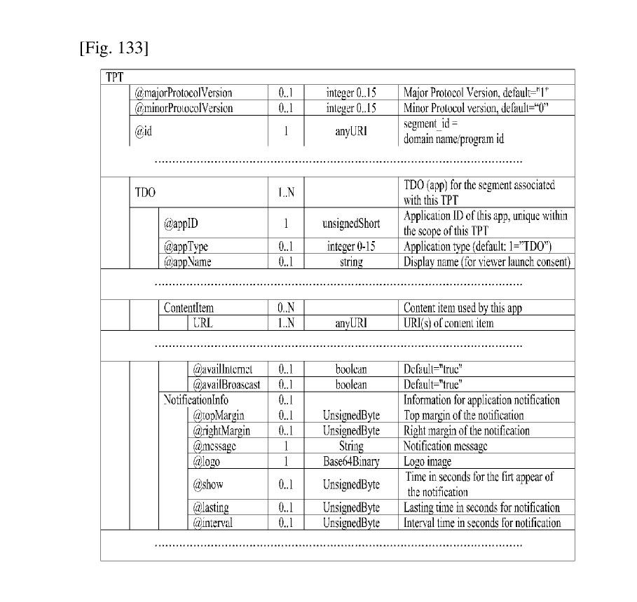

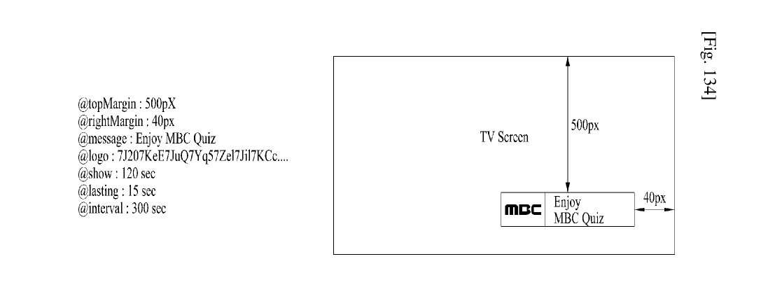

FIG. 133 is a view showing a portion of a TDO parameter table (TPT) (or a TDO parameter element) according to another embodiment of the present invention.

In order for a receiver to adjust the form and operating attribute of the above-described synchronized application notification, information regarding to notification of an application provided by a broadcaster or a content provider may be transported while being included in the above-described TDO parameter element. That is, information regarding the form and operating attribute of notification of the synchronized application provided by the broadcaster may be transmitted through extension of a signaling element (for example, TPT) defining parameter for an application trigger that can be used in a next generation hybrid broadcast.

Consequently, the above-described TDO parameter element may further include a NotificationInfo element and attributes belonging thereto.

Attributes added to below the NotificationInfo element may include a topMargin element and/or rightMargin element that is capable of deciding the location of notification, a message element indicating a message of the notification, a logo element which may indicate a logo per channel, a show element that is capable of indicating a time when the notification appears for the first time, a lasting element that is capable of indicating duration of the notification, and/or an interval element that is capable of setting a notification appearance interval.

That is, the elements added to the TDO parameter element shown in the figure include the following signaling information.

The NotificationInfo element is information regarding the form and operating attribute of notification of a synchronized application (for example, an application or TDO).

The topMargin element indicates a top margin value, which is one of the attributes indicating location information of the notification.

The rightMargin element indicates a right margin value, which is one of the attributes indicating location information of the notification.

The message element includes information, such as a welcome message, included in the notification.

The logo element includes logo or image information per content provider or broadcaster included in the notification. The logo image may be received through URL of a content item.

The show element indicates a time when the notification is shown to a user after a broadcast program is started.

The lasting element indicates duration in which the notification is shown to the user.

The interval element, which is an interval time between notifications, includes information for enabling the notification to be periodically shown to the user.

The receiver may set the location of the notification on the screen using the topMargin element and the rightMargin element. The receiver may adjust a time when the notification is shown to the user for the first time and timing based on characteristics of each broadcast program using the show element, the lasting element, and the interval element.

A subject that realizes the notification of a synchronized application may be the receiver such that it is possible to prevent outflow of unnecessary viewing information. In addition, the receiver may actively control an application. Meanwhile, an application or the form and/or operating attribute of application notification may be flexibly used by the content provider or the broadcaster.

On the other hand, the receiver may modify information of corresponding items of the above-described elements. In this case, information provided by the broadcaster or the content provider may be used for reference and the receiver may change corresponding information of corresponding elements according to a value set by the user or a preset value of the receiver. In this case, it is possible for the receiver to control a state of application notification. The above-described change of information is possible since the TPT (or the TDO parameter element) is transported to and stored in the receiver in advance and the receiver can change the stored information.

FIG. 134 is a view showing a screen on which notification of a synchronized application is expressed using information of a NotificationInfo element according to an embodiment of the present invention.

Referring to the figure, the notification may be located at a position distant by 500 pixels from the top of the screen and 40 pixels from the right of the screen. A message included in the notification may be “Enjoy MBC Quiz!” The notification may be exposed to a user for the first time 120 second after the notification of the application is executed according to set values of a shown element and a lasting element. In a case in which the user takes no action with respect to the exposed notification, the notification may disappear after 15 seconds, which is the set value of the lasting element. The notification may be exposed to the user again 300 seconds after the notification disappears according to a set value of an interval element. The set values related to the notification exposure time are relative time values based on a time when the synchronized application is executed for the first time.

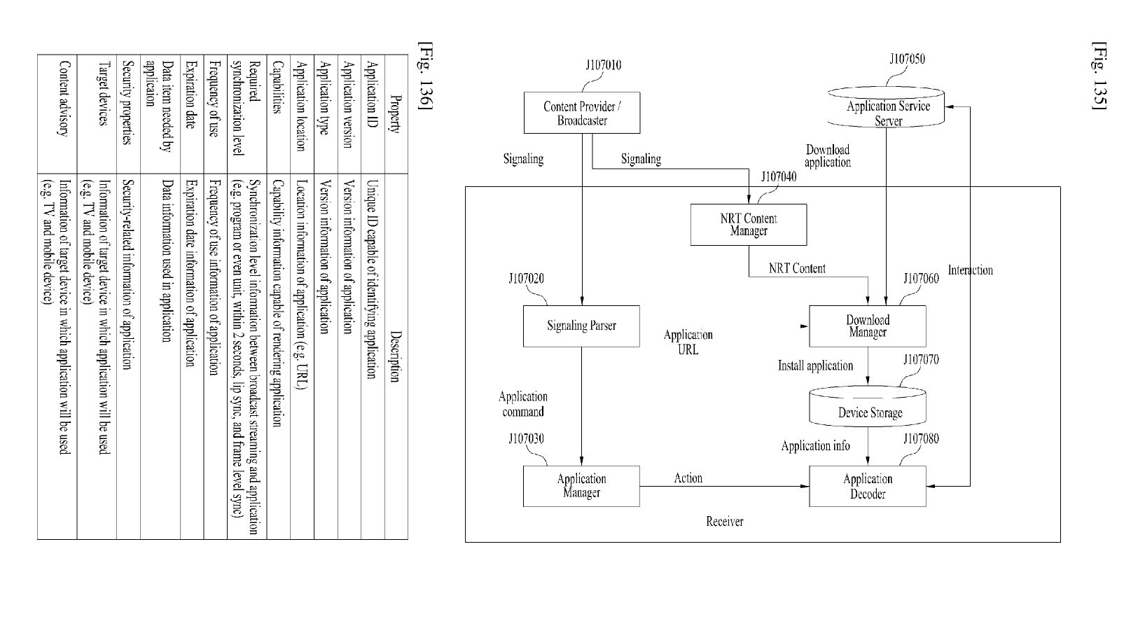

FIG. 135 is a view showing a broadcasting server and a receiver according to an embodiment of the present invention.

The receiver according to the embodiment of the present invention includes a signaling parser J107020, an application manager J107030, a download manager J107060, a device storage J107070, and/or an application decoder J107080. The broadcasting server includes a content provider/broadcaster J107010 and/or an application service server J107050.

Each device included in the broadcasting server or the receiver may be embodied by hardware or software. In a case in which each device is embodied by hardware, the term ‘manager’ may be replaced with a term ‘processor’.

The content provider/broadcaster J107010 indicates a content provider or a broadcaster.

The signaling parser J107020 is a module for parsing a broadcast signal provided by the content provider or the broadcaster. The broadcast signal may include signaling data/element, broadcast content data, additional data related to broadcasting, and/or application data.

The application manager J107030 is a module for managing an application in a case in which the application is included in a broadcast signal. The application manager J107030 controls location, operation, and operation execution timing of an application using the above-described signaling information, signaling element, TPT, and/or trigger. The operation of the application may be activate (launch), suspend, resume, or terminate (exit).

The application service server J107050 is a server for providing an application. The application service server J107050 may be provided by the content provider or the broadcaster. In this case, the application service server J107050 may be included in the content provider/broadcaster J107010.

The download manager J107060 is a module for processing information related to an NRT content or an application provided by the content provider/broadcaster J107010 and/or the application service server J107050. The download manager J107060 acquires NRT-related signaling information included in a broadcast signal and extracts an NRT content included in the broadcast signal based on the signaling information. The download manager J107060 may receive and process an application provided by the application service server J107050.

The device storage J107070 may store the received broadcast signal, data, content, and/or signaling information (signaling element).

The application decoder J107080 may decode the received application and perform a process of expressing the application on the screen.

FIG. 136 is a view showing attribute information related to an application according to an embodiment of the present invention.

The attribute information related to the application may include content advisory information.

The attribute information related to the application, which may be added according to the embodiment of the present invention, may include application ID information, application version information, application type information, application location information, capabilities information, required synchronization level information, frequency of use information, expiration date information, data item needed by application information, security properties information, target devices information, and/or content advisory information.

The application ID information indicates a unique ID that is capable of identifying an application.

The application version information indicates version of an application.

The application type information indicates type of an application.

The application location information indicates location of an application. For example, the application location information may include URL that is capable of receiving an application.

The capabilities information indicates a capability attribute that is capable of rendering an application.

The required synchronization level information indicates synchronization level information between a broadcast streaming and an application. For example, the required synchronization level information may indicate a program or even unit, a time unit (for example, within 2 seconds), lip sync, and/or frame level sync.

The frequency of use information indicates a frequency of use of an application.

The expiration date information indicates expiration date and time of an application.

The data item needed by application information indicates data information used in an application.

The security properties information indicates security-related information of an application.

The target devices information indicates information of a target device in which an application will be used. For example, the target devices information may indicate that a target device in which a corresponding application is used is a TV and/or a mobile device.

The content advisory information indicates a level that is capable of using an application. For example, the content advisory information may include age limit information that is capable of using an application.

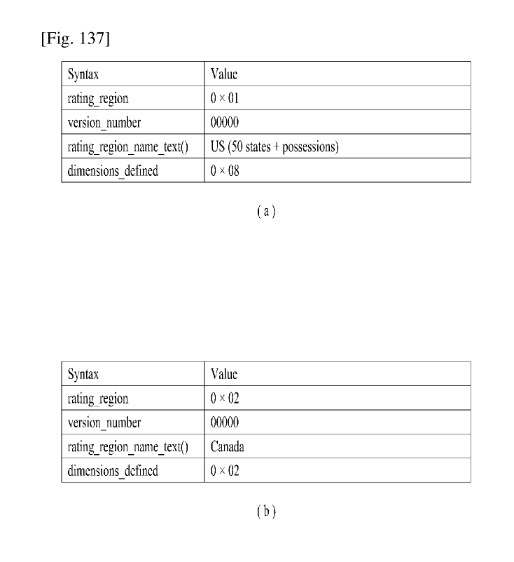

FIG. 137 is a view showing a Rated_dimension element in a ContentAdvisoryInfo element according to an embodiment of the present invention.

The Rated_dimension element may indicate the number of rating regions predefined per nation. As shown in the figure, USA defined by rating_region has 8 rating regions and Canada defined by rating_region has 2 rating regions.

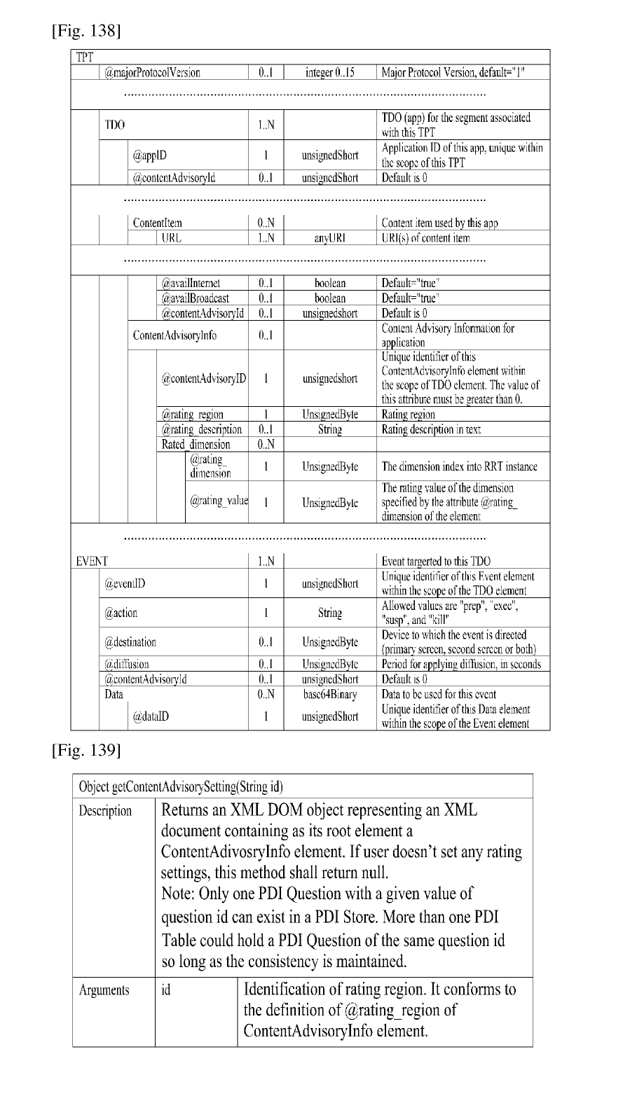

FIG. 138 is a view showing a TPT including content advisory information (ContentAdvisoryInfo element) according to an embodiment of the present invention.

A receiver may decide whether a synchronized application provided by a broadcaster can be used in the receiver based on rating information set for a TV by a user.

An application (for example, TDO) that can be used in next generation hybrid broadcasting may be configured as a content according to set rating information and provided as an app service.

The content advisory information may be transported as signaling information while being included in a broadcast signal. Alternatively, the content advisory information may be included in the above-described TPT.

In order to include the content advisory information in the TPT, the ContentAdvisoryInfo element may be further signaled in the TPT.

The ContentAdvisoryInfo element includes rating information of given ContentItem or Event. This value may have the same value as rating information per region declared in a rating region table (RRT).

In order to include the content advisory information in the TPT, one or more of the following elements may be signaled through the TPT.

A contentAdvisoryId element indicates a delimiter that is capable of only recognizing ContentAdvisoryInfo from a TDO element scope.

A rating_region element means a rating region. For example, in a case in which a value of the rating_region element is 1, it may indicate USA. On the other hand, in a case in which a value of the rating_region element is 2, it may indicate Canada.

A rating_description element includes text expressing a rating value in an abbreviated form.

A Rated_dimension element may indicate the number of rating regions predefined per nation.

A rating_dimension element indicates a dimension index in the rating region table (RRT).

A rating_value element indicates a rating value of a dimension indicated by the rating_dimension element. For example, the rating_value element may have a value of TV-G, TV-PG, etc. according to the dimension.

The contentAdvisoryId element may be added to a TDO element, ContentItem element, or Event element. Consequently, the rating information may be applied to the entirety of the TDO. Alternatively, the rating information may be applied per ContentItem or Event. In a case in which a corresponding element has no rating information, a value of 0 is provided as a default value. In a case in which a corresponding element is associated with rating information, a value of the contentAdvisoryId element is provided below the ContentAdvisoryInfo element.

FIG. 139 is a view showing an application programming interface (API) for acquiring a rating value according to an embodiment of the present invention.

In order to obtain a rating value set in a TV from an application (or TDO), an API for the application is needed.

As shown in the figure, a function for obtaining a rating value may be added to an API for an existing broadcasting system.

The application provides rating_region information to the API to obtain a rating information value set by a user. A rating information value stored in a receiver may be transmitted to the above-described ContentAdvisoryInfo element.

Although the description of the present invention is explained with reference to each of the accompanying drawings for clarity, it is possible to design new embodiment(s) by merging the embodiments shown in the accompanying drawings with each other. And, if a recording medium readable by a computer, in which programs for executing the embodiments mentioned in the foregoing description are recorded, is designed in necessity of those skilled in the art, it may belong to the scope of the appended claims and their equivalents.

An apparatus and method according to the present invention may be non-limited by the configurations and methods of the embodiments mentioned in the foregoing description. And, the embodiments mentioned in the foregoing description can be configured in a manner of being selectively combined with one another entirely or in part to enable various modifications.

In addition, a method according to the present invention can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Both apparatus and method inventions are mentioned in this specification and descriptions of both of the apparatus and method inventions may be complementarily applicable to each other.

### MODE FOR INVENTION

Various embodiments have been described in the best mode for carrying out the invention.

### INDUSTRIAL APPLICABILITY

The present invention is available in a series of broadcast signal provision fields. It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A receiver for processing a broadcast signal including a broadcast content and an application related to the broadcast content, the receiver comprising:
a receiving device for receiving a data structure that encapsulates a questionnaire which represent individual questions that can be answered by the receiver, wherein the data structure includes a first application identifier which uniquely identifies the application;
a PDI engine for acquiring the questionnaire from the data structure, receiving a setting option of a user for the application identified by the application identifier, and storing the setting option in relation to the data structure;
an application signaling parser for parsing a trigger which is a signaling element to establish timing of playout of the application; and
a processor for parsing a second application identifier from the trigger, acquiring the stored setting option in relation to the data structure of which a value of the first application identifier matches to a value of the second application identifier, and determining whether process the application to be launched or not based on the setting option.

2. The receiver of claim 1,
wherein the trigger includes location information specifying a location of a TDO (Triggered Declarative Object) parameter element containing metadata about applications and broadcast events targeted to the applications.

3. The receiver of claim 2, further comprising:
an application signaling parser for parsing the TDO parameter element from the location identified by the location information,
wherein the TDO parameter element includes top margin information specifying a top margin of a notification for the application, right margin information specifying a right margin of the notification, and lasting information specifying a lasting time for the notification.

4. The receiver of claim 3, wherein the processor further:
displays a user interface for receiving the setting option from the user based on the top margin information, right margin information and lasting information.

5. The receiver of claim 4, wherein the processor further:
processes the user interface to show a question for first selection on whether the application to be activated or not.

6. The receiver of claim 5, wherein the processor further:
processes the user interface to show a question for second selection on whether the first selection applies to a current broadcast content, all broadcast contents in a current channel, or all broadcast contents in all channel.

7. The receiver of claim 2,
wherein the TDO parameter element includes content advisory information specifying a rating for the application.

8. A method for processing a broadcast signal including a broadcast content and an application related to the broadcast content, the method comprising:
receiving a data structure that encapsulates a questionnaire which represent individual questions that can be answered by the receiver, wherein the data structure includes a first application identifier which uniquely identifies the application;
acquiring the questionnaire from the data structure, receiving a setting option of a user for the application identified by the application identifier, and storing the setting option in relation to the data structure;
parsing a trigger which is a signaling element to establish timing of playout of the application; and
parsing a second application identifier from the trigger, acquiring the stored setting option in relation to the data structure of which a value of the first application identifier matches to a value of the second application identifier, and determining whether process the application to be launched or not based on the setting option.

9. The method of claim 8,
wherein the trigger includes location information specifying a location of a TDO (Triggered Declarative Object) parameter element containing metadata about applications and broadcast events targeted to the applications.

10. The method of claim 9, further comprising:
parsing the TDO parameter element from the location identified by the location information,
wherein the TDO parameter element includes top margin information specifying a top margin of a notification for the application, right margin information specifying a right margin of the notification, and lasting information specifying a lasting time for the notification.

11. The method of claim 10, further comprising:
displaying a user interface for receiving the setting option from the user based on the top margin information, right margin information and lasting information.

12. The method of claim 11, further comprising:
processing the user interface to show a question for first selection on whether the application to be activated or not.

13. The method of claim 12, further comprising:
processing the user interface to show a question for second selection on whether the first selection applies to a current broadcast content, all broadcast contents in a current channel, or all broadcast contents in all channel.

14. The method of claim 9,
wherein the TDO parameter element includes content advisory information specifying a rating for the application.
